(19) United States
(12) Patent Application Publication
(10) Pub. No.: US 2025/0254587 A1
(43) Pub. Date: Aug. 7, 2025

(54) APPARATUS AND METHOD FOR SERVICE CONTINUITY IN NON-TERRESTRIAL NETWORK

(71) Applicant: THINKWARE CORPORATION, Seongnam-si (KR)

(72) Inventors: Taekyu Han, Seongnam-si (KR); Donghee Lim, Seongnam-si (KR); Daewon Kim, Seongnam-si (KR)

(73) Assignee: THINKWARE CORPORATION, Seongnam-si (KR)

(21) Appl. No.: 18/971,599

(22) Filed: Dec. 6, 2024

(30) Foreign Application Priority Data
Dec. 6, 2023 (KR) 10-2023-0176101
Dec. 5, 2024 (KR) 10-2024-0180021

(51) Int. Cl. H04W 36/08; H04W 36/00; H04W 36/32; H04W 84/06

(52) U.S. Cl. CPC H04W 36/083; H04W 36/0072; H04W 36/324; H04W 84/06

(57) ABSTRACT

In embodiments, a device of a first satellite for providing non-terrestrial network (NTN) access is provided. The device may comprise memory including instructions, at least one processor, and at least one transceiver. The instructions may, when executed by the at least one processor, cause the device to perform a communication between a first terminal and a second terminal via the first satellite, by transmitting data received from the first terminal to the second terminal or transmitting data received from the second terminal to the first terminal; identify, within a satellite group associated with the first satellite, a second satellite different from the first satellite; and transmit a configuration message including configuration information related to the communication to the second satellite through the at least one transceiver.

### TECHNICAL FIELD

The disclosure generally relates to a non-terrestrial network (NTN) that provides wireless communication services through a satellite located in the Earth's orbit or an aerial vehicle flying at a high altitude, other than a ground-based base station, and more specifically, to an apparatus and method for service continuity in a non-terrestrial network.

### BACKGROUND ART

A non-terrestrial network (NTN) has been introduced to supplement a terrestrial network that provides a wireless communication system. Such anon-terrestrial network may provide communication services even in areas where it is difficult to construct a terrestrial network or in disaster situations. Furthermore, owing to the recent decrease in launch costs of satellites, an efficient access network environment may be provided.

### SUMMARY OF INVENTION

### Technical Solution

In embodiments, provided is a device of a first satellite for providing non-terrestrial network (NTN) access. The device may comprise memory including instructions, at least one processor, and at least one transceiver. The instructions may, when executed by the at least one processor, cause the device to perform a communication between a first terminal and a second terminal via the first satellite, by transmitting data received from the first terminal to the second terminal or transmitting data received from the second terminal to the first terminal; identify, within a satellite group associated with the first satellite, a second satellite different from the first satellite; and transmit a configuration message including configuration information related to the communication to the second satellite through the at least one transceiver.

In embodiments, provided is a device of a satellite for providing non-terrestrial network (NTN) access. The device may comprise memory including instructions, at least one processor, and at least one transceiver. The instructions may, when executed by the at least one processor, cause the device to: perform a communication between a first terminal and a second terminal via the satellite by transmitting data received from the first terminal to the second terminal or transmitting data received from the second terminal to the first terminal; based on detecting that the second terminal is located outside the coverage of a first cell of the satellite, identify a second cell for the second terminal; and transmit a configuration message including configuration information related to the communication via a network entity to a node providing the second cell.

### BRIEF DESCRIPTION OF DRAWINGS

FIG. 1 is a diagram illustrating a wireless communication system.

FIGS. 2A and 2B illustrate examples of a non-terrestrial network (NTN).

FIG. 2C is a diagram illustrating examples of network connectivity in non-terrestrial (e.g., satellite cellular network) and terrestrial (e.g., mobile cellular network) configuration.

FIG. 3A is a diagram illustrating an example of a control plane (C-plane).

FIG. 3B is a diagram illustrating an example of a user plane (U-plane).

FIG. 4 is a diagram illustrating an example of a resource structure in a time-frequency domain in a wireless communication system.

FIG. 5 is a diagram illustrating an example of a network structure for an NTN.

FIG. 6A is a diagram illustrating an example of a control plane of a regenerative satellite.

FIG. 6B is a diagram illustrating an example of a user plane of a regenerative satellite.

FIG. 7A is a diagram illustrating a first example of a scenario for service continuity.

FIG. 7B is a diagram illustrating a second example of a scenario for service continuity.

FIGS. 8A and 8B are diagrams for explaining a Space Area, and FIG. 8C is a diagram for explaining an example of a constellation of a satellite LEO according to an embodiment of the disclosure.

FIG. 8D is a configuration diagram of Walker star LEO satellite group, illustrating various inter-satellite link (ISL) structures between satellites 826.

FIG. 8E is an orbital configuration diagram of the LEO satellite network, illustrating an arrangement of satellites 862 and a structure of an inter-satellite communication link (ISL) according to an orbital period (Orbit Period, To, 859).

FIG. 8F is a diagram illustrating an inter-satellite link between LEO satellites 863 and satellites located on a LEO orbital plane 862.

FIG. 8G is a diagram illustrating an example of an inter-satellite communication path through a space area.

FIG. 8H is a diagram illustrating a structure of a global satellite network to which a space area is applied.

FIG. 8I is a diagram illustrating a dynamic configuration of ascending and descending satellites within a space area.

FIGS. 9A and 9B illustrate examples of satellite grouping

FIG. 10 is a diagram illustrating an example of signaling through an XN interface in an NTN.

FIGS. 11A and 11B illustrate an example of signaling through an F1 interface in an NTN.

FIGS. 12A and 12B illustrate an example of signaling through an NG interface in an NTN.

FIG. 13 is a diagram illustrating an example of components of a satellite.

FIG. 14 is a diagram illustrating an example of components of a terminal.

FIG. 15 is a diagram illustrating a structure of a space area management system according to an embodiment of the disclosure.

FIG. 16 is a diagram illustrating an operating model of a space area management system according to an embodiment of the disclosure.

FIG. 17 is a diagram illustrating a hierarchical structure of a space area management system according to an embodiment of the disclosure.

FIG. 18 is a diagram illustrating a connection structure of a space area management system according to an embodiment of the disclosure.

FIG. 19 is a diagram illustrating an interface structure of a space area management system according to an embodiment of the disclosure.

FIG. 20 is a block diagram of a satellite group management unit 2000 according to an embodiment of the disclosure.

FIG. 21 is a flowchart illustrating an operation of a satellite group management unit 2000 according to an embodiment of the disclosure.

FIG. 22 is a diagram illustrating satellite switching operation characteristics according to an embodiment of the disclosure.

FIG. 23 is a diagram illustrating a satellite grouping structure according to an embodiment of the disclosure.

FIG. 24 is a diagram illustrating a configuration of a space area-based edge computing layer 2400 according to an embodiment of the disclosure.

FIG. 25 is a diagram illustrating a hierarchical structure of an edge computing layer 2500 according to an embodiment of the disclosure.

FIG. 26 is a diagram illustrating a switching process of an edge computing layer between space areas according to an embodiment of the disclosure.

FIG. 27 is a diagram illustrating an integrated structure of a space area management system 1500 and an edge computing layer 2720 according to an embodiment of the disclosure

### MODE FOR CARRYING OUT THE INVENTION

The terms used in the disclosure are merely used to better describe a certain embodiment and may not be intended to limit the scope of other embodiments. A singular expression may include a plural expression, unless the context explicitly dictates otherwise. The terms used herein, including technical and scientific terms, may have the same meanings as those commonly understood by those skilled in the art to which the disclosure pertains. Terms defined in a general dictionary among the terms used in the disclosure may be interpreted as having the same or similar meaning as those in the context of the related art, and they are not to be construed in an ideal or overly formal sense, unless explicitly defined in the disclosure. In some cases, even the terms defined in the disclosure may not be interpreted to exclude embodiments of the disclosure.

In various examples of the disclosure described below, a hardware approach will be described as an example. However, since various embodiments of the disclosure may include a technology that utilizes both the hardware-based approach and the software-based approach, the various embodiments are not intended to exclude the software-based approach.

As used in the following description, terms referring to a signal (e.g., signal, information, message, signaling), terms referring to a resource (e.g., symbol, slot, subframe, radio frame, subcarrier, resource element (RE), resource block (RB), bandwidth part (BWP), occasion), terms for an operation state (e.g., step, operation, procedure), terms referring to data (e.g., packet, user stream, information, bit, symbol, codeword), terms referring a channel, terms referring to network objects, terms referring to a component of a device or apparatus, and so on are only exemplified for convenience of description. Therefore, the disclosure is not limited to those terms described below, and other terms having the same or equivalent technical meaning may be used therefor.

In the following description, the terms ‘physical channel’ and ‘signal’ may be used interchangeably with ‘data’ or ‘control signal’. For example, the term ‘physical downlink shared channel (PDSCH)’ may refer to a physical channel over which data is transmitted, but PDSCH may also be used to refer to data. In other words, throughout the disclosure, the expression “transmitting a physical channel” may be interpreted equivalently to the expression “transmitting data or signals over a physical channel”.

Hereinafter, throughout the disclosure, ‘higher signaling’ refers to a method of transmitting signals from a base station to a terminal using a downlink data channel of a physical layer, or from the terminal to the base station using an uplink data channel of a physical layer. Higher-level signaling may be understood as radio resource control (RRC) signaling or MAC control element (CE) signaling.

Further, throughout the disclosure, an expression, such as e.g., ‘above (more than)’ or ‘below (less than)’ may be used to determine whether a specific condition is satisfied or fulfilled, but it is merely of a description for expressing an example and is not intended to exclude the meaning of ‘more than or equal to’ or ‘less than or equal to’. A condition described as ‘more than or equal to’ may be replaced with an expression, such as ‘above’, a condition described as ‘less than or equal to’ may be replaced with an expression, such as ‘below’, and a condition described as ‘more than or equal to and below’ may be replaced with ‘above and less than or equal to’, respectively. Furthermore, hereinafter, ‘A’ to ‘B’ means at least one of the elements from A (including A) to B (including B). Hereinafter, ‘C’ and/or ‘D’ means including at least one of ‘C’ or ‘D’, that is, {‘C’, ‘D’, or ‘C’ and ‘D’}.

Throughout the disclosure, the signal quality may be, for example, at least one of RSRP (reference signal received power), BRSRP (beam reference signal received power), RSRQ (reference signal received quality), RSSI (received signal strength indicator), SINR (signal to interference and noise ratio), CINR (carrier to interference and noise ratio), SNR (signal to noise ratio), EVM (error vector magnitude), BER (bit error rate), and BLER (block error rate). In addition to the above-described examples, it will be apparent that other terms having equivalent technical meanings or other metrics indicating channel quality may be used. Hereinafter, in the disclosure, high signal quality may refer to a case where a signal quality value related to a signal size is relatively large or a signal quality value related to an error rate is relatively small. The higher the signal quality, the smoother wireless communication environment is guaranteed. Further, the optimal beam may refer to a beam having the highest signal quality among those beams.

The disclosure describes various embodiments using terms used in some communication standards (e.g., 3rd Generation Partnership Project (3GPP), European Telecommunications Standards Institute (ETSI), etc.), but they are only examples for explanation. Various embodiments of the disclosure may be easily modified and applied to other communication systems.

The disclosure relates generally to a communication system using a Non-Geostationary Orbit (NGSO) satellite system, and more particularly, to an efficient satellite communication system for constructing a global communication network.

In modem society, constructing such a global communication network has become an essential requirement, but terrestrial infrastructure alone has various limitations. Especially, in sparsely populated areas, oceans, and polar regions, there are geographical constraints that make it physically difficult or impossible to build ground-based communication infrastructure, and therefore, despite the advances of conventional mobile communication technologies, there are economic limits to the expansion of terrestrial infrastructure over wide geographic areas that make it significantly less cost-effective.

Satellite communication systems have been proposed to address these problems, but conventional satellite communication systems also have several limitations. In the case of a Geostationary Earth Orbit (GEO) satellite system, the altitude is very high at approximately 35,786 km, so that the propagation delay of more than 500 ms is made, and its signal attenuation is large, thereby causing deterioration in communication quality. Further, it is not suitable for communication with some low-power Internet of Things (IoT) devices, and it is also difficult to provide polar region coverage. In the case of a Medium Earth Orbit (MEO) satellite system, a large number of satellites are required to provide good global coverage, and problems such as e.g., the complexity of orbital arrangements and the relatively high costs of system construction remain unsettled.

With a view to overcoming the limitations of such existing technologies, the disclosure is based on a non-geostationary orbit (NGSO) satellite system and has the technical features such as minimized propagation delay utilizing low Earth Orbit (LEO) satellites, securing good global coverage with multi-satellite deployment, configuring an efficient network through inter-satellite communication, organic association with ground-based systems and so on.

The NGSO satellite system of the disclosure may be utilized in various technical fields. Backhauling, enabling data transmission between ground stations through satellite-to-satellite communications, can secure communication service stability in remote areas, and in any areas where communication traffic is concentrated, network offloading may be used to distribute the load and supplement the network capacity during large-scale events. In addition, it can contribute to resilience enhancement as a backup communication network in the event of a large-scale of natural disaster, thereby ensuring service continuity. Furthermore, this system may also be utilized as an edge computing and AIaaS (Edge Computing and AI as-a-Service) platform to overcome limitations in the processing capacity of IoT devices, and can also perform Earth surface and atmosphere observation missions through high-resolution Earth Observation.

### DEFINITION OF TERMS

The definitions of terms used in this specification are as follows:
“Service Availability” refers to a ratio of time during which communication between a satellite system and ground terminals is possible.
“Transport Capacity” refers to a maximum amount of data that a satellite system may transmit per unit time.
“Throughput” refers to a data transfer speed experienced by an actual user.
“Scalability” refers to a maximum number of terminals that a satellite system can accommodate per unit area.
“Inter-satellite Connectivity” refers to an index indicating the efficiency of inter-satellite communication connections.
“Latency” refers to a time duration required for data transmission, and “Reliability” refers to a success rate of data transmission.
“Energy Efficiency” refers to an amount of energy consumed per unit data transmission.

The disclosure aims to build an efficient and stable global communication network maximizing the advantages of a NGSO satellite system, based on the foregoing technical background.

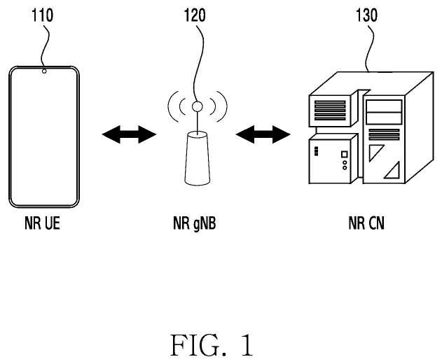

FIG. 1 is a diagram illustrating a wireless communication system.

Referring to FIG. 1, FIG. 1 illustrates, as a wireless interface of Radio Access Technology (RAT), a terminal 110 and a base station 120 as part of nodes using a wireless channel in a wireless communication system using New Radio (NR). While FIG. 1 illustrates only one base station, the wireless communication system may further include other base stations that are identical or similar to the base station (e.g., NR gNB) 120.

The terminal 110 is a device used by a user to communicate with the base station 120 over a wireless channel. The link from the base station 120 to the terminal 110 may be referred to as a downlink (DL), and the link from the terminal 110 to the base station 120 may be referred to as an uplink (UL). Further, although not shown in FIG. 1, the terminal 110 and other terminals may communicate with each other through the wireless channel. In such a case, a device-to-device link (D2D) between the terminal 110 and other terminals is referred to as a sidelink, and the sidelink may be used interchangeably with a PC5 interface. In some other embodiments, the terminal 110 may be operated without any involvement of the user. According to an embodiment, the terminal 110 is a device for performing machine type communication (MTC) and may not be carried by a user. Further, according to an embodiment, the terminal 110 may be an NB (narrowband)-IoT (internet of things) device.

Describing the systems and methods in this specification, the terminal 110 may be an electronic device used to communicate voice and/or data to the base station 120, and the base station 120 may in turn communicate with a network of devices (e.g., a public switched telephone network (PSTN), the Internet, or the like).

Further, the terminal 110 may be referred to as ‘user equipment (UE)’, ‘vehicle’, ‘customer premises equipment (CPE)’, ‘mobile station’, ‘subscriber station’, ‘remote terminal’, ‘wireless terminal’, ‘electronic device’, ‘user device’, ‘access terminal’, ‘mobile terminal’, ‘remote station’, ‘user terminal’, ‘subscriber unit’, ‘mobile device’ or other terms having an equivalent technical meaning thereto.

Further, examples of the terminals 110 may include cellular phones, smart phones, personal digital assistants (PDAs), laptop computers, netbooks, e-readers, wireless modems, and so on. In the 3GPP standards, the terminal 110 may be typically referred to as a UE.

According to an embodiment of the disclosure, a UE may include software for providing a seamless communication service even while moving between a satellite communication network of Non-Terrestrial Network (NTN) and a terrestrial communication network of Terrestrial Network (TN). The UE implements a protocol stack inclusive of a physical layer (PHY), a medium access control layer (MAC), a radio link control layer (RLC), a radio resource control layer (RRC), and a non-access layer (NAS), and the protocol stack may be configured to be extendable to accommodate NTN standards beyond 3GPP Rel-17.

Specifically, the physical layer of the UE may be implemented with reconfigurable hardware (e.g., Field Programmable Gate Array (FPGA), Application-Specific Integrated Circuit (ASIC), etc.) and may be programmed using various hardware description languages (e.g., VHSIC Hardware Description Language (VHDL), Verilog or the like). The UE may be flexibly configured to support a spectrum of variable bandwidth, and may accommodate new modulation and multiplexing schemes using future-proof design.

According to another embodiment of the disclosure, the UE implements a number of functions optimized for a satellite communication network environment and is configured to accommodate new satellite communication technologies that may be introduced in the future. For example, the UE may perform functions such as, e.g., System Information Block reception processing, layer-by-layer timer control, RACH (Random Access Channel) adaptation, discontinuous coverage support or the like, and such functions may be modularized such that they may be updated according to new satellite communication standards and technological developments.

Further, the UE may support various data plane and control plane optimization techniques, and may include an extendable security framework capable of accommodating new security algorithms and protocols. The UE may have a flexible structure that can accommodate new power-saving technologies in terms of power management.

According to another embodiment of the disclosure, the UE may be developed in a platform-independent programming language so that it may be transplanted to various current and future hardware platforms, thereby supporting various authentication methods and security modules. With such a configuration, the UE may be compatible with not only current satellite communication networks and terrestrial communication networks, but also new types of communication networks that may appear in the future.

Additionally, the UE may include a scalable architecture to accommodate future-oriented features, such as, e.g., artificial intelligence/machine learning-based network optimization, automated network selection and handover, enhanced quality of service (QoS) management, and so on. Further, the UE may also be designed to support new use cases such as, e.g., multi-satellite simultaneous access, satellite constellation network support, optimized operation for emergency communication and disaster recovery scenarios, and so on.

With these features, the UE of the disclosure may not only provide efficient and stable communication services even in the current satellite communication network environment, but also provide scalability to flexibly accommodate future technological advancements and new requirements.

However, the scope disclosed in this specification should not be limited to 3GPP standards, so the terms “UE” and “terminal” may be used interchangeably herein to refer to more general term such as, e.g., “wireless communication device.” The UE may also be more generally referred to as a terminal device.

The base station 120 is a network infrastructure that provides wireless access to a terminal 110. The terminal 110 has a certain coverage that is defined based on a distance over which it may transmit signals. In 3GPP standards, the base station 120 may generally be referred to as ‘node B’, ‘evolved node B (eNodeB, eNB)’, ‘5G node (5th generation node’, ‘next generation nodeB (gNB)’, ‘home enhanced or evolved node B (HeNB)’, ‘access point (AP)’, ‘wireless point’, ‘transmission/reception point (TRP)’, or other terms having an equivalent technical meaning.

Since the scope of the subject matter disclosed herein should not be limited to 3GPP standards, the terms “base station”, “node B”, “eNB”, and “HeNB” may be used interchangeably herein to refer to more general term “base station”. Additionally, the term “base station” may be used to refer to an access point. The access point may be an electronic device that provides access to a network (e.g., local area network (LAN), Internet, etc.) for wireless communication devices. The term “communication device” may be used to refer to both a wireless communication device and/or a base station. An eNB or gNB may also be more generally referred to as a base station device.

The base station 120 may communicate with an NR Core Network (NR CN) entity 130. For example, the core network entity 130 may include an Access and Mobility Management Function (AMF) that is in charge of a control plane, such as access to the terminal 110, mobility control function or the like, and a User Plane Function (UPF) that is in charge of a control function for user data.

The terminal 110 may perform beamforming with the base station 120. The terminal 110 and the base station 120 may transmit and receive wireless signals in a relatively low frequency band (e.g., FR 1 (frequency range 1) of NR). Further, the terminal 110 and the base station 120 may transmit and receive wireless signals in a relatively high frequency band (e.g., FR 2 (or FR 2-1, FR 2-2, FR 2-3) or FR 3 of NR), millimeter wave (mmWave) band (e.g., 28 GHz, 30 GHz, 38 GHz, 60 GHz). To improve channel gain, the terminal 110 and the base station 120 may perform beamforming. Here, the beamforming may include transmission beamforming and reception beamforming. The terminal 110 and the base station 120 may assign directivity to the transmission signal or the reception signal. To this end, the terminal 110 and the base station 120 may select serving beams with a beam search or beam management procedure. After the serving beams are selected, subsequent communication may be performed through resources that are in a QCL (Quasi Co-Location) relationship with the resources that transmitted the serving beams.

If the large-scale characteristics of the channel that transmitted a symbol on a first antenna port may be inferred from the channel that transmitted a symbol on a second antenna port, the first antenna port and the second antenna port may be evaluated to be in such a QCL relationship. For example, the broad characteristics may include at least one of delay spread, doppler spread, doppler shift, average gain, average delay, or spatial receiver parameter.

While both the terminal 110 and the base station 120 may perform beamforming, the embodiments of the disclosure are not necessarily limited thereto. In some embodiments, the terminal 110 may or may not perform beamforming. Further, the base station 120 may or may not perform beamforming. That is to say, either one of the terminal 110 and the base station 120 may perform beamforming, or neither the terminal 110 nor the base station 120 may perform beamforming.

Throughout the disclosure, a beam refers to a spatial flow of a signal in a wireless channel, and is formed by one or more antennas (or antenna elements), and this forming process may be referred to as beamforming. The beamforming may include at least one of analog beamforming or digital beamforming (e.g., precoding). A reference signal transmitted based on the beamforming may include, for example, a demodulation-reference signal (DM-RS), a channel state information-reference signal (CSI-RS), a synchronization signal/physical broadcast channel (SS/PBCH), or a sounding reference signal (SRS). Further, an information element (IE) such as a CSI-RS resource or an SRS-resource may be used as a configuration for each reference signal, and this configuration may include information associated with the beam. Information associated with a beam may indicate whether that configuration (e.g., CSI-RS resource) uses the same spatial domain filter as another configuration (e.g., another CSI-RS resource in the same CSI-RS resource set) or a different spatial domain filter, or with which reference signal it is QCLed (quasi-co-located), and if QCLed, what type (e.g., QCL type A, B, C, or D) it is.

Hereinafter, for the purpose of explaining the embodiments, a terminal may be referred to as a UE 110 and a base station may be referred to as a gNB 120.

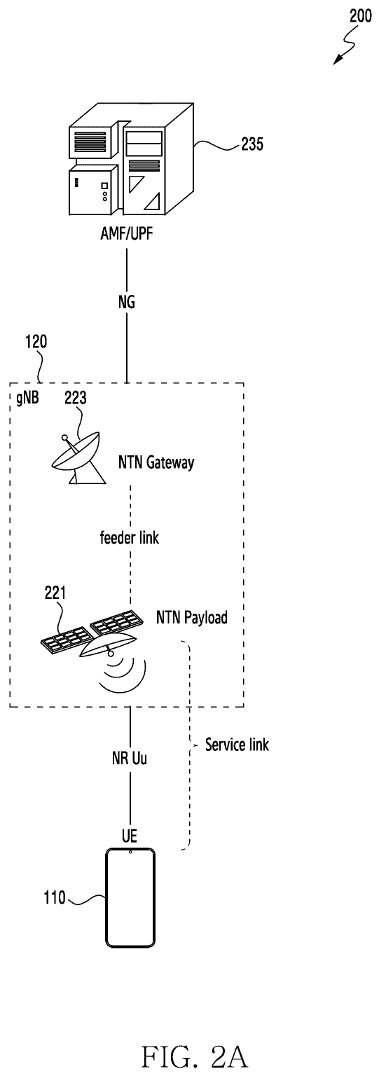

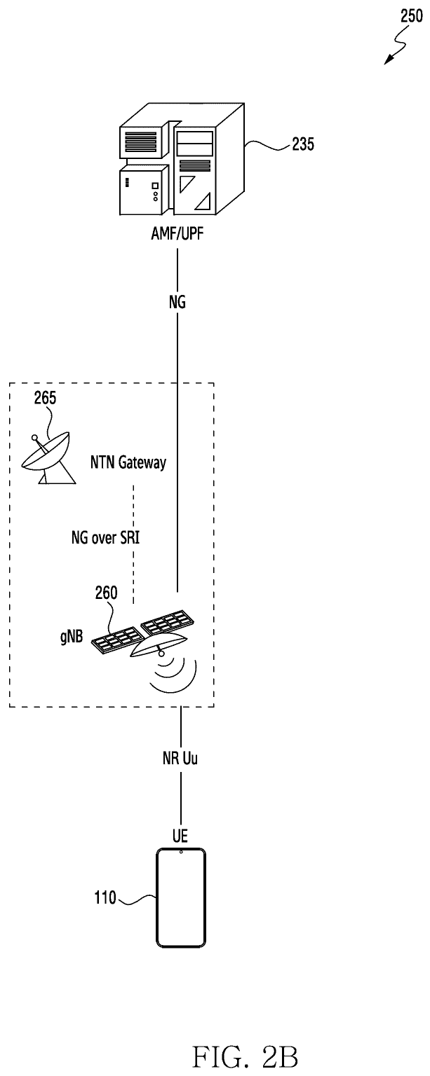

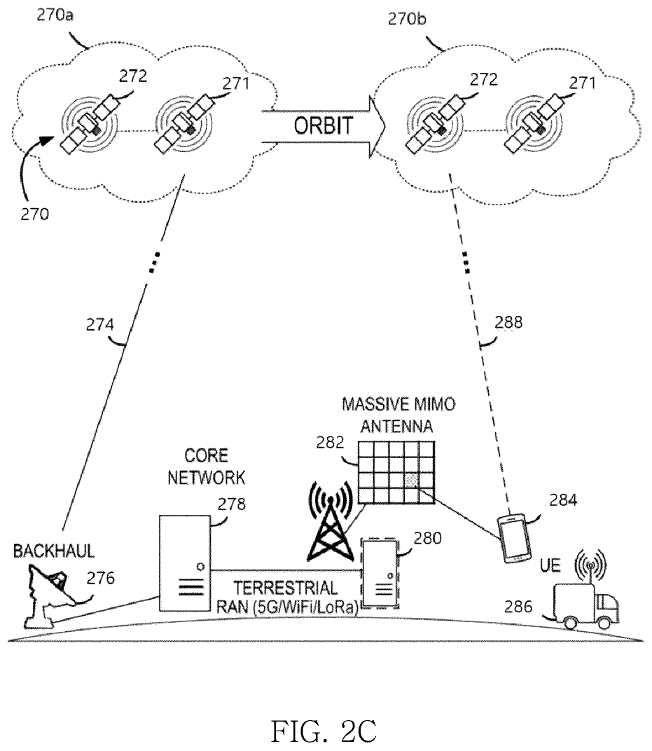

FIG. 2A and FIG. 2B illustrate examples of a non-terrestrial network (NTN). FIG. 2A illustrates an example of a non-terrestrial network (NTN) using a transparent satellite. FIG. 2B illustrates an example of a non-terrestrial network (NTN) utilizing a regenerative satellite. The NTN refers to NG-RAN that provides non-terrestrial NR access to a UE (e.g., UE 110) via an NTN payload and an NTN gateway mounted on an airborne or space-borne NTN vehicle. The NG-RAN may include one or more gNBs (e.g., gNB 120).

Referring to FIG. 2A, NTN 200 represents a network environment according to the transparent satellite. NTN 200 may include an NTN payload 221 and an NTN gateway 223 as the gNB 120. NTN payload 221 is a network node mounted on a satellite or a high altitude platform station (HAPS) that provides a connection function between a service link (described later) and a feeder link (described later). The NTN gateway 223 is an earth station located on the surface of the earth, providing connection to the NTN payload 221 using the feeder link. The NTN gateway 223 is a transport network layer (TNL) node. The NTN 200 may provide non-terrestrial NR access to the UE 110. The NTN 200 may provide non-terrestrial NR access to the UE 110 through the NTN payload 221 and the NTN gateway 223. The link between the NTN payload 221 and the UE 110 may be referred to as a service link. The link between the NTN gateway 223 and the NTN payload 221 may be referred to as a feeder link. The feeder link may correspond to a wireless link.

The NTN payload 221 may receive wireless protocol data from the UE 110 through the service link. The NTN payload 221 may transparently transmit the wireless protocol data to the NTN gateway 223 through the feeder link. Therefore, the NTN payload 221 and the NTN gateway 223 may be seen as one gNB 120 from the perspective of the UE 110. The NTN payload 221 and the NTN gateway 223 may communicate with the UE 110 through a Uu interface, which is of a general wireless protocol. That is, the NTN payload 221 and the NTN gateway 223 may perform wireless protocol communication with the UE 110 like a single gNB 120. The NTN gateway 223 may communicate with a core network entity 235 (AMF or UPF) through an NG interface.

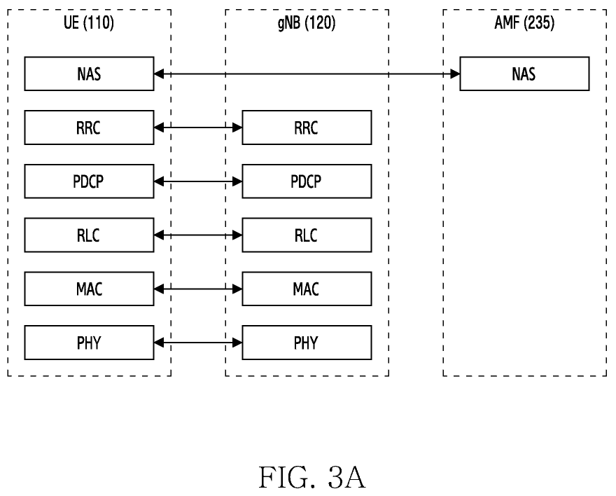

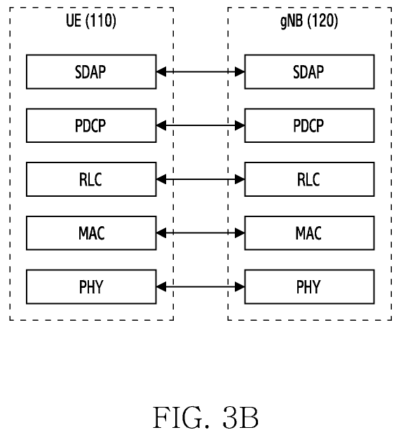

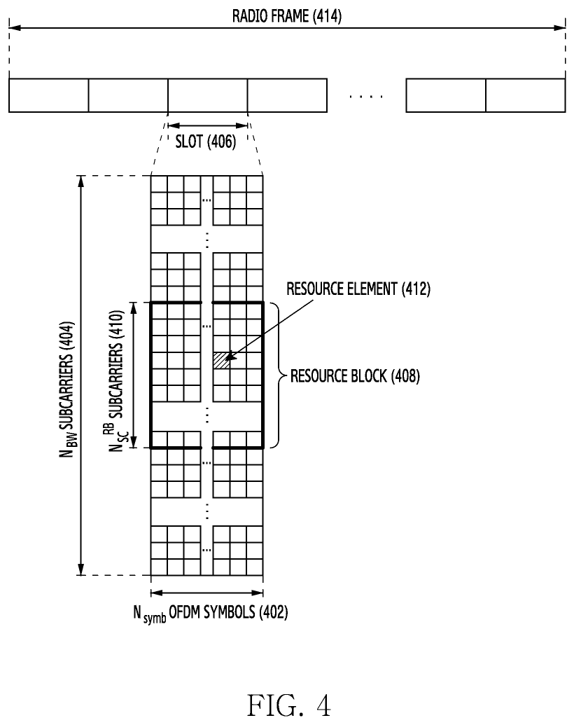

According to an embodiment, the NTN payload 221 and the NTN gateway 223 may use a wireless protocol stack in the control plane of FIG. 3A, which will be described later. Further, according to an embodiment, the NTN payload 221 and the NTN gateway 223 may use a wireless protocol stack in the user plane of FIG. 3B.

In FIG. 2A, one NTN payload 221 and one NTN gateway 223 included in the gNB 120 are described, but the embodiments of the disclosure are not limited thereto. For example, the gNB may include multiple NTN payloads. Further, for example, the NTN payload may be provided by multiple gNBs. That is, the implementation scenario illustrated in FIG. 2A is only of an example and does not limit the embodiments of the disclosure thereto.

Referring to FIG. 2B, the NTN 250 represents a network environment according to the regenerated satellite. The NTN 250 may include a satellite 260 operating as the gNB 120. The satellite 260 is a space-borne vehicle that carries a regenerative payload communication transmitter deployed in a low-earth orbit (LEO), a medium-earth orbit (MEO), or a geostationary earth orbit (GEO). The satellite 260 may be referred to as a regenerative payload or a regenerative satellite. The satellite 260 indicates a payload configured to convert and amplify an uplink RF signal prior to transmitting the same to the downlink, wherein conversion of the signal may refer to digital processing, which may include demodulation, decoding, re-encoding, re-modulation, and/or filtering. The NTN 250 may include an NTN gateway 265, which is an entity deployed on the earth ground and connected to the satellite 260. The NTN gateway 265 is an earth station located on the surface of the Earth, providing connectivity to the satellite 260 using the feeder link. The NTN 250 may provide non-terrestrial NR access to the UE 110. The NTN 250 may provide non-terrestrial NR access to the UE 110 via the satellite 260 and the NTN gateway 265.

The satellite 260 may be configured to reproduce signals received from the Earth. The Uu interface may be defined between the satellite 260 and the terminal 110. A satellite radio interface (SRI) may be defined over the feeder link between the satellite 260 and the NTN gateway 265. Although not shown in FIG. 2B, the satellite 260 may provide inter-satellite links (ISLs) between satellites. The ISL is a transmission link between satellites, and the ISL may be a 3GPP or non-3GPP defined wireless interface (e.g., XN interface) or an optical interface. The satellite 260 may communicate with the core network entity 235 (AMF or UPF) through the NG interface based on the NTN gateway 265. According to an embodiment, the satellite 260 may utilize a wireless protocol stack in the control plane of FIG. 3A to be described below. Further, according to an embodiment, the satellite 260 may utilize a wireless protocol stack in the user plane of FIG. 3B.

While FIG. 2B describes the satellite 260 operating as the gNB 120, embodiments of the disclosure are not limited thereto. The gNB 120 according to the embodiments may be implemented in a distributed deployment using a centralized unit (CU) configured to perform functions of upper layers of an access network (e.g., packet data convergence protocol (PDCP), radio resource control (RRC)) and a distributed unit (DU) configured to perform functions of lower layers. An interface between the CU and the DU may be referred to as an F1 interface. The centralized unit (CU) may be connected to one or more DUs and may be responsible for functions of a higher layer than the DU. For example, the CU may be responsible for functions of the radio resource control (RRC) and the packet data convergence protocol (PDCP) layers, and the DU and a radio unit (RU) may be responsible for functions of lower layers. The DU may be responsible for functions of radio link control (RLC), media access control (MAC), and physical (PHY) layers. In such a distributed deployment, the satellite 260 may be utilized as the CU or the DU making up the gNB 120.

FIG. 2C illustrates an example of network connectivity in non-terrestrial (e.g., satellite cellular network) and terrestrial (e.g., mobile cellular network) configuration.

The satellite constellation (or a group of satellites) 270 illustrated in FIG. 2C (the satellite group depicted in orbital locations 270a and 270b of FIG. 2C) may include a plurality of satellites (e.g., satellite 271 and satellite 272) that are communicatively connected to each other and connected to one or more terrestrial networks. The individual satellites of the satellite group 270 orbit the Earth, and their orbital speed increases as the satellite gets closer to the Earth. The LEO satellite group typically includes satellites orbiting between 160 km and 1,000 km, at which altitude each satellite makes a complete orbit around the Earth every 90 to 120 minutes.

The satellite group 270 may include individual satellites (e.g., satellite 271 and satellite 272) (and multiple other satellites, not shown), and may use multiple satellites to provide communications coverage for a certain geographic area on the Earth. The satellite group 270 may also cooperate with other satellite groups (not shown) and ground-based networks to selectively provide connectivity and services to individual devices (user equipment) or ground-based network systems (network equipment).

In FIG. 2C, the satellite group 270 may be connected to a backhaul network 276 via a satellite link 274, which may in turn be connected to a 5G core network 278. The 5G core network 278 may be used to support 5G communication operations with the satellite network (or non-terrestrial network) and a terrestrial 5G radio access network (RAN) 280. For example, the 5G core network 278 may be located in a remote location and may use the satellite group 270 as a sole mechanism for reaching a wide area network and the Internet.

In FIG. 2C, the satellite group 270 may be connected to the backhaul network 276 via the satellite link 274, which may in turn be connected to the 5G core network 278. The 5G core network 278 provides the following key functions to support 5G communication operations with satellite networks and the terrestrial 5G radio access network (RAN) 280:
Control Plane Function: session management, mobility management, authentication and security
User Plane Function: data packet routing, QoS processing, traffic management
Network Slicing: providing service-specific virtual networks in a satellite-terrestrial integrated network

This integrated structure allows for seamless interworking between a satellite network and a terrestrial network, which provides the following advantages:
Providing uninterrupted wide area network services
Providing complementary coverage for shadow areas of a terrestrial network
Improved network resilience in disaster situations

For example, the 5G core network 278 may be located in a remote location and may use the satellite group 270 as the sole mechanism to reach the wide area network and the Internet.

FIG. 2C illustrates a terrestrial 5G RAN 280 providing wireless connectivity to a user equipment (UE), such as a user device 284 or a vehicle 286, via a massive MIMO antenna 282. For simplicity, FIG. 2C does not show all of the various 5G and other network communication components and devices. In some examples, each UE 282 or 284 may have its own satellite connection hardware (e.g., receiver circuitry and antenna) to directly connect to the satellite group 270 via a satellite link 288.

Other variations (not shown) may include direct connectivity of the 5G RAN 280 and the satellite group 270 (e.g., the 5G core network 278 accessible via satellite link), coordination with other wired (e.g., fiber optic), laser or optical, wireless links and backhaul, multi-access wireless connectivity between UE, RAN, and other UEs, and other variations of terrestrial and non-terrestrial connectivity. The satellite network connectivity may be coordinated with the 5G network equipment and the user equipment based on satellite orbital coverage, available network services and equipment, cost and security, geographic or geopolitical considerations, and so on. With these basic entities in mind, and in consideration of the changing configuration of mobile users and orbiting satellites, the embodiments of the disclosure described below will describe methods for extending the terrestrial and satellite networks.

FIG. 3A illustrates an example of a control plane (C-plane). Hereinafter, at least some of the descriptions of the gNB 120 may be understood as referencing to the satellite 260.

Referring to FIG. 3A, in the C-plane, the UE 110 and an AMF 235 may perform NAS (non-access stratum) signaling. In the C-plane, the UE 110 and the gNB 120 may perform communication according to the protocols specified in the RRC layer, the PDCP layer, the RLC layer, the MAC layer, and the PHY layer, respectively.

In the NTN access, the key functions of the RRC layer may include at least some of the following functions:
Broadcasting of system information related to AS (Access Stratum) and NAS
Paging initiated by 5GC (5G Core) or NG-RAN (Next Generation-Radio Access network)
Establishment, maintenance and release of RRC connection between UE and NG-RAN including the following, more particularly, including control of RLC, MAC, PHY:
   Addition, modification and release of carrier aggregation
   Addition, modification and release of dual connectivity between NR or E-UTRA and NR
Security functions including key management;
Establishment, configuration, maintenance and release of SRB (Signaling Radio Bearer) and DRB (Data Radio Bearer)
Mobility function including the following:
   Handover and context transfer;
   UE cell selection and reselection and cell selection and reselection control; and
   Inter-RAT mobility.
Quality of service (QoS) management function;
UE measurement reporting and reporting control;
Radio link failure detection and recovery; and
Message transfer from/to UE to/from NAS.

In NTN access, the key functions of the PDCP layer may include at least some of the following functions:
Header compression and decompression: ROHC only;
Transfer of user data;
In-sequence delivery of upper layer PDUs;
Out-of-sequence delivery of upper layer PDUs;
PDCP PDU reordering for reception;
Duplicate detection of lower layer SDUs;
Retransmission of PDCP SDUs;
Ciphering and deciphering; and
Timer-based SDU discard in uplink.

In NTN access, the key functions of the RLC layer may include at least some of the following functions:
Transfer of upper layer PDUs;
In-sequence delivery of upper layer PDUs;
Out-of-sequence delivery of upper layer PDUs;
Error Correction through ARQ;
Concatenation, segmentation and reassembly of RLC SDUs;
Re-segmentation of RLC data PDUs;
Reordering of RLC data PDUs;
Duplicate detection;
Protocol error detection;
RLC SDU discard;
RLC re-establishment.

In NTN access, the MAC layer may be connected to multiple RLC layer devices configured in one terminal, and the key functions of the MAC may include at least some of the following functions:
Mapping between logical channels and transport channels;
Multiplexing/demultiplexing of MAC SDUs;
Scheduling information reporting;
Error correction through HARQ;
Priority handling between logical channels of one UE;
Priority handling between UEs by means of dynamic scheduling;
MBMS service identification;
Transport format selection;
Padding.

In NTN access, the physical layer may perform operations of channel coding and modulating upper layer data, converting the same into OFDM symbols and transmitting it over a radio channel, or demodulating and channel decoding the OFDM symbols received over the radio channel and transferring it to the upper layer.

FIG. 3B illustrates an example of a user plane (U-plane). Hereinafter, at least some of the descriptions of the gNB 120 may be understood as referencing to the satellite 260.

Referring to FIG. 3B, in the U-plane, the UE 110 and the gNB 120 may perform communication according to the protocols specified in each of SDAP layer, PDCP layer, RLC layer, MAC layer, and PHY layer. For the PDCP layer, the RLC layer, the MAC layer, and the PHY layer, excluding the SDAP layer, the description of FIG. 3A may be referred to.

In NTN access, the SDAP layer may provide QoS flow of 5GC. A single protocol entity of SDAP may be configured for each individual PDU session, and the functionality of the SDAP layer may include at least some of the following functions:
Mapping between QoS flow and a data radio bearer; and
Indication of QoS flow identifier (QFI) in both DL and UL packets.

FIG. 4 illustrates an example of a resource structure in a time-frequency domain supported by a wireless communication system to which an embodiment proposed in this specification can be applied. FIG. 4 illustrates a basic structure of the time-frequency domain, which is a radio resource domain in which data or control channels are transmitted in downlink or uplink in a 5G NR system to which the present embodiment is applied.

Referring to FIG. 4, the horizontal axis represents the time domain, and the vertical axis represents the frequency domain. The minimum transmission unit in the time domain is an OFDM symbol, and N_{symb} OFDM symbols 402 are grouped to form one slot 406. Referring to FIG. 4, in the wireless communication system to which the disclosure is applied, one radio frame 414 may be defined as having a length of 10 ms, including 10 subframes having the same length of 1 ms. Further, one radio frame 414 may be divided into half-frames of 5 ms, and each half-frame may include 5 subframes. In FIG. 4, the slot 406 is composed of 14 OFDM symbols, but the length of the slot may vary depending on the subcarrier spacing. For example, in the case of a numerology having a subcarrier spacing of 15 kHz, the slot is composed of the same length as a subframe, having 1 ms in length. In contrast, in the case of a numerology having a subcarrier spacing of 30 kHz, the slot is composed of 14 OFDM symbols, but two slots may be included in one subframe with a length of 0.5 ms.

In other words, subframes and frames are defined with fixed time lengths, and slots are defined with the number of symbols, so that the time length may vary depending on the subcarrier interval. Referring again to FIG. 4, the radio resource supported by the wireless communication system to which the invention proposed in this specification is applied may be composed of a plurality of symbols, which are time resources, and a plurality of subcarriers, which are frequency resources, wherein each of time resource and frequency resource may be expressed as a two-dimensional resource grid 411. In FIG. 4, one square, which is the smallest physical resource composed of one subcarrier and one symbol in the resource grid 411, is called a resource element (RE) 412.

In the wireless communication system to which the invention proposed in this specification is applied, the minimum transmission unit in the frequency domain is a subcarrier, and the carrier bandwidth constituting the resource grid 411 includes N_{BW} subcarriers 404.

In the time-frequency domain, the basic unit of resources is a resource element (hereinafter, referred to as ‘RE’) 412, which may be expressed by an OFDM symbol index and a subcarrier index. A resource block (RB) 408 may include a plurality of resource elements 412. In the wireless communication system to which the invention proposed in this specification is applied, the resource block 408 (or a physical resource block, hereinafter referred to as ‘PRB’) may be defined as N_{symb} consecutive OFDM symbols in the time domain and N_{SC}^{RB} consecutive subcarriers in the frequency domain. In the NR system, the resource block (RB) 408 may be defined as N_{SC}^{RB} consecutive subcarriers 410 in the frequency domain. One RB 408 includes N_{SC}^{RB} REs 412 in the frequency axis.

In general, the minimum transmission unit of data is an RB and the number of subcarriers is N_{SC}^{RB}=12. The frequency domain may include common resource blocks (CRBs). A physical resource block (PRB) may be defined in a bandwidth part (BWP) on the frequency domain. The CRB and PRB numbers may be determined according to the subcarrier spacing. The data rate may increase in proportion to the number of RBs scheduled to the terminal.

In the NR system, for a frequency division duplex (FDD) system where the downlink and the uplink operate divided by frequency, the downlink transmission bandwidth and the uplink transmission bandwidth may be different from each other. The channel bandwidth represents the radio frequency (RF) bandwidth corresponding to the system transmission bandwidth. Table 1 represents some of the correspondence between the system transmission bandwidth, the subcarrier spacing (SCS), and the channel bandwidth defined in the NR system in a frequency band (e.g., frequency range (FR) 1 (410 to 7125 MHz)) that is lower than the upper limit (e.g., 7.125 GHz) defined in the standard. And Table 2 represents some of the correspondences between the transmission bandwidth, the subcarrier spacing, and the channel bandwidth defined in the NR system in a frequency band (e.g., FR2 (24250 to 52600 MHz) or FR2-2 (52600 to 71000 MHz)) that is higher than the lower limit (e.g., 24.25 GHz) defined in the standard. For example, the NR system having a channel bandwidth of 100 MHz with a subcarrier spacing of 30 kHz has a transmission bandwidth composed of 273 RBs. In Table 1 and Table 2, N/A may be a bandwidth-subcarrier combination not supported by the NR system.

TABLE 1

| | Channel Bandwidth [MHz] | | | | | | |
|---|---|---|---|---|---|---|---|
| | SCS | 5 | 10 | 20 | 50 | 80 | 100 |
| Channel | 15 kHz | 25 | 52 | 106 | 207 | N/A | N/A |
| Bandwidth | 30 kHz | 11 | 24 | 51 | 133 | 217 | 273 |
| Configuration | 60 kHz | N/A | 11 | 24 | 65 | 107 | 135 |
| N_{RB} | | | | | | | |

TABLE 2

| | Channel Bandwidth [MHz] | | | | |
|---|---|---|---|---|---|
| | SCS | 50 | 100 | 200 | 400 |
| Channel | 60 kHz | 66 | 132 | 264 | N/A |
| Bandwidth | 120 kHz | 32 | 66 | 132 | 264 |
| Configuration | | | | | |
| N_{RB} | | | | | |

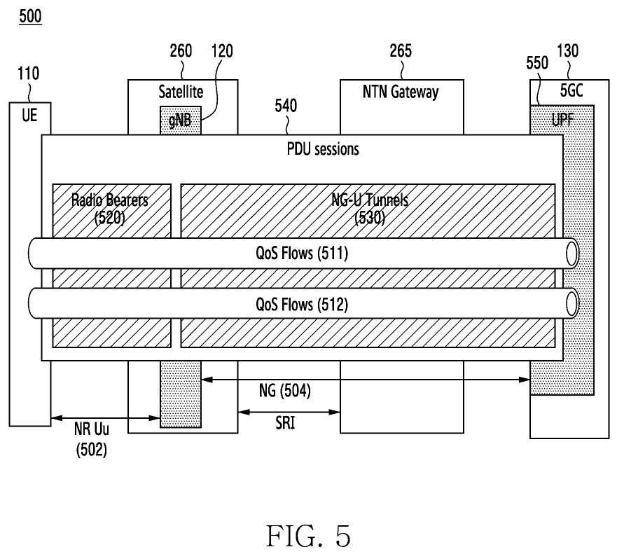

FIG. 5 illustrates an example network architecture for NTN. The satellite 260 may be mounted onto a space vehicle or an aerial vehicle to provide structure, power, command, telemetry, satellite attitude control (corresponding HAPS) and appropriate thermal environment, radiation shielding, and so on. In FIG. 5, an example is described where the satellite 260 is a regenerative payload, operating as a complete base station (e.g., gNB 120).

Referring to FIG. 5, the satellite 260 may operate as the gNB 120. The gNB 120 may communicate with a terminal 110 or with a core network entity 130. In FIG. 5, a UPF 550 is illustrated as the core network entity 130. An NR Uu interface 502 may be utilized between the satellite 260 and the terminal 110. According to an embodiment, at least one radio bearer 520 may be created between the satellite 260 and the terminal 110. For example, the radio bearer 520 may include a data radio bearer (DRB). For example, the radio bearer 520 may include a signaling radio bearer (SRB). An NG interface 504 may be utilized between the satellite 260 and the core network entity (e.g., AMF, UPF). For example, an N3 interface may be utilized between the satellite 260 and the UPF. For example, an N2 interface may be utilized between the satellite 260 and the AMF. According to an embodiment, a traffic tunnel may be created between the satellite 260 and the core network entity 130. For example, an NG-U tunnel 530 may be created between a satellite 260 and a UPF 550.

A packet data unit (PDU) session 540 may be created between the UE 110 and the core network entity 130 (e.g., UPF 550). The PDU session 540 may be used to provide end-to-end user plane connectivity between the UE 110 and the data network via the UPF 550. The PDU session 540 may support one or more quality of service (QoS) flows. For example, the PDU session 540 may support a first QoS flow 511 and a second QoS flow 512. In the user plane, the radio bearer 520 may be mapped to the QoS flow (e.g., the first QoS flow 511, the second QoS flow 512). According to an embodiment, the satellite 260 may perform mapping between the DRB and the QoS flow as the gNB 120.

Referring to FIG. 5, the PDU session 540 established between a UE 110 and the UPF 550 may include multiple QoS flows. For example, the first QoS flow 511 and the second QoS flow 512 may be provided through the PDU session 540. The first QoS flow 511 and the second QoS flow 512 may be configured to carry data traffic having different QoS requirements. For example, the first QoS flow 511 may be configured to transmit data traffic having a relatively high priority (e.g., real-time voice or video call), and the second QoS flow 512 may be configured to transmit data traffic having a relatively low priority (e.g., email or web browsing). These QoS flows are transmitted through the radio bearer 520 in a wireless section, and through the NG-U tunnel 530 in a core network section. The radio bearer 520 refers to a data transmission path established through the NR Uu interface 502 between the UE 110 and the satellite 260, and one or more DRBs (Data Radio Bearers) may be established according to the characteristics of the QoS flow. For example, a first DRB for the first QoS flow 511 and a second DRB for the second QoS flow 512 may be established separately. Each DRB may be configured to satisfy the QoS requirements of the corresponding QoS flow. The NG-U tunnel 530 refers to a data transmission path established through the NG interface 504 between the satellite 260 and the UPF 550. The NG-U tunnel 530 may be established using GPRS Tunneling Protocol-User Plane (GTP-U) protocol, and may be mapped to the DRB established for each QoS flow. That is, data of the QoS flow transmitted through the radio bearer 520 is transmitted to the UPF 550 through the NG-U tunnel 530, or data of the QoS flow received from the UPF 550 through the NG-U tunnel 530 is transmitted to the UE 110 through the radio bearer 520. With such a structure, each QoS flow within the PDU session 540 may be provided with differentiated data transmission services that meet its respective QoS requirement in the radio section and the core network section. In particular, in the NTN environment, the satellite 260 relays data transmission between the radio bearer 520 and the NG-U tunnel 530, and thus the same level of QoS management as the terrestrial network is available.

Although not shown in FIG. 5, O&M (operation and maintenance) may be used to provide a radio access network via the satellite 260. The O&M may provide one or more parameters related to the NTN 500 to the gNB 120 (e.g., the satellite 260). For example, the O&M (operation and maintenance) may provide at least the following NTN-related parameters for each beam type to the gNB 120, for its operation.

### a) Earth Fixed Beams:

This beam is responsible for a fixed location on the Earth, and the following parameters may be provided for each beam provided by a given NTN payload:
Cell identifier mapped to the beam (for NG and Uu interfaces);
Reference location information of the cell (e.g., center point coordinates and service coverage of the cell).

### b) Quasi Earth Fixed Beams:

This beam has quasi-stationary characteristics, and the following parameters may be provided for each beam provided by a given NTN payload:
Cell identifiers mapped to the beam (for NG and Uu interfaces) and operation time window information
Reference location information of the cell/beam (e.g., center point coordinates and service coverage of the cell)
Time window information for continuous switch-over (switching timing of feeder link and service links)
Service provision information (identifiers of all satellites providing the service, identifiers of NTN gateways and time zones of operation for each element.

### c) Earth Moving Beams

This beam is a dynamic beam moving along the surface of the Earth, and the following parameters may be provided for each beam provided by a given NTN payload:
Uu cell identifier mapped to the beam
Geographic mapping information (mapping information for fixed geographical areas reported to NG and movement trajectory information of beam foot-print on Earth)
Elevation information for NTN payload
Service continuity information (continuous service schedule of NTN gateways/gNBs)
Link switch-over information (continuous switch-over schedule for feeder links and service links)

The above parameters may be differentiated and managed according to the characteristics of each beam type, enabling real-time location tracking, service area optimization, switching-over point management for uninterrupted service, and efficient cooperation between network elements.

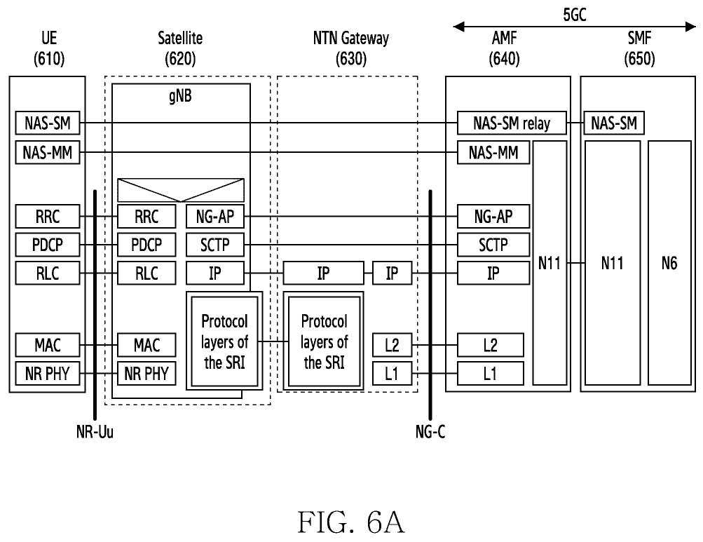

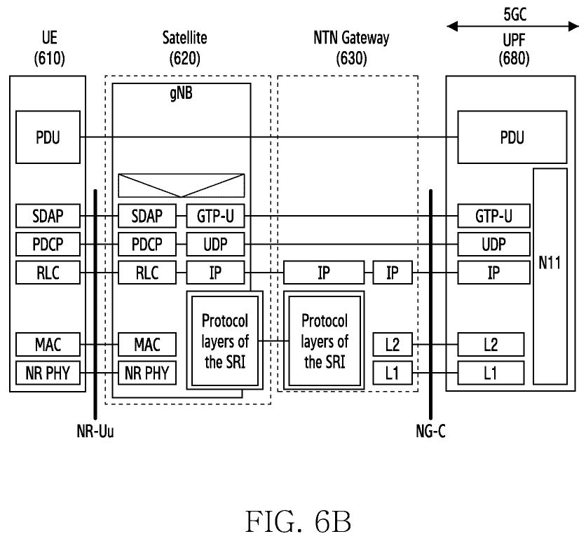

FIG. 6A illustrates an example of a control plane of a regenerative satellite (e.g., the satellite 260).

Referring to FIG. 6A, a UE 610 may support protocols of PHY layer, MAC layer, RLC layer, PDCP layer, and RRC layer. A satellite 620 is a gNB and may support protocols of PHY layer, MAC layer, RLC layer, PDCP layer, and RRC layer. For the satellite 620, reference may be made to the description of satellite 260. For the description of the protocols of each layer, reference may be made to the description of FIG. 3A. An interface between the UE 610 and the satellite 620 may be a Uu interface.

The satellite 620 may be a gNB mounted on board (gNB on board) or a part of the gNB, and may perform an NG-RAN protocol function. The satellite 620 may perform communication (e.g., IP communication) with an NTN gateway 630 located on the ground via the SRI. The satellite 620 may access the 5GC via the NTN gateway 630. As network entities for the 5GC, an AMF 640 (e.g., the AMF 235) and an SMF 650 are exemplified. The satellite 620 may support protocols of an NG-AP layer, a stream control transmission protocol (SCTP) layer, and an IP layer for communication with the 5GC. The NG-AP layer may be utilized on SCTP between the AMF 640, which is a 5GC entity, and the satellite 620 through the NTN gateway. NAS signaling between the UE 610 and the AMF 640 may be performed through the satellite 620 and the NTN gateway 630. The NAS signaling may include an NAS-MM (mobility management) interface for the AMF 640. The NAS signaling may include an NAS-SM relay and/or NAS-SM (session management) for the SMF 650. The NAS signaling may be transmitted through the protocol of the NG-AP layer between the 5GC entity AMF 640 and the satellite 620 through the NTN gateway 630.

While an example in which the satellite operates as a full gNB is described in FIG. 6A, embodiments of the disclosure are not limited thereto. As a non-limiting example, the satellite may operate as a gNB-DU according to function split. Accordingly, the satellite may be configured to support the protocols of the RLC layer, the MAC layer, and the PHY layer.

FIG. 6B illustrates an example of a user plane of a regenerated satellite (e.g., satellite 260).

Referring to FIG. 6B, the UE 610 may support protocols of the PHY layer, the MAC layer, the RLC layer, the PDCP layer, and the SDAP layer. The satellite 620 may be a gNB and may support protocols of the PHY layer, the MAC layer, the RLC layer, the PDCP layer, and the SDAP layer. For descriptions of the protocols of each layer, reference may be made to the description of FIG. 3B. The interface between the UE 610 and the satellite 620 may be a Uu interface.

The satellite 620 may be a gNB mounted on board and may perform an NG-RAN protocol function. The satellite 620 may perform communication (e.g., IP communication) with the NTN gateway 630 located on the ground through the SRI. The satellite 620 may access the 5GC through the NTN gateway 630. As a network entity for the 5GC, a UPF 680 is exemplified. The satellite 620 may support protocols of the GTP-U (GPRS (General Packet Radio Service) tunneling protocol-user plane) layer, the UDP (user datagram protocol) layer, and the IP layer for communication with the 5GC. A PDU session (e.g., the PDU session 540 of FIG. 5) may be created between the UE 610 and the UPF 680. The protocol stack of the SRI may be used to transmit a UE user plane between the satellite and the NTN gateway. The signals on the PDU session may be transmitted through the NTN gateway 630 between the UPF 680 of the 5GC and the satellite 620 through the GTP-U tunnel.

Although an example in which the satellite operates as a full gNB is described in FIG. 6B, the embodiments of the disclosure are not limited thereto. As a non-limiting example, the satellite may operate as a gNB-DU according to function split. Accordingly, the satellite may be configured to support protocols of the RLC layer, the MAC layer, and the PHY layer.

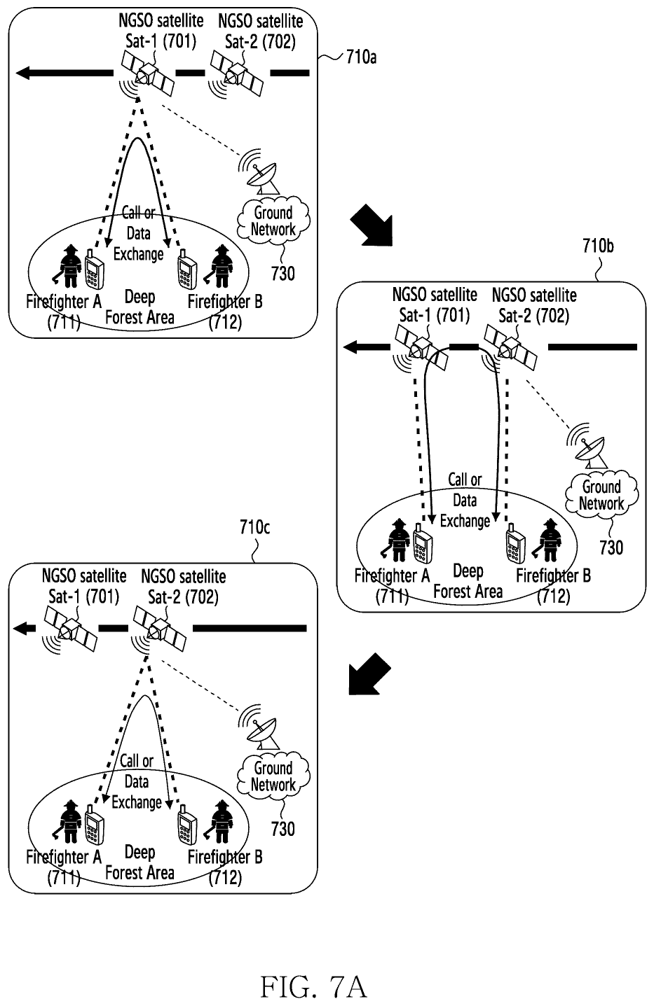

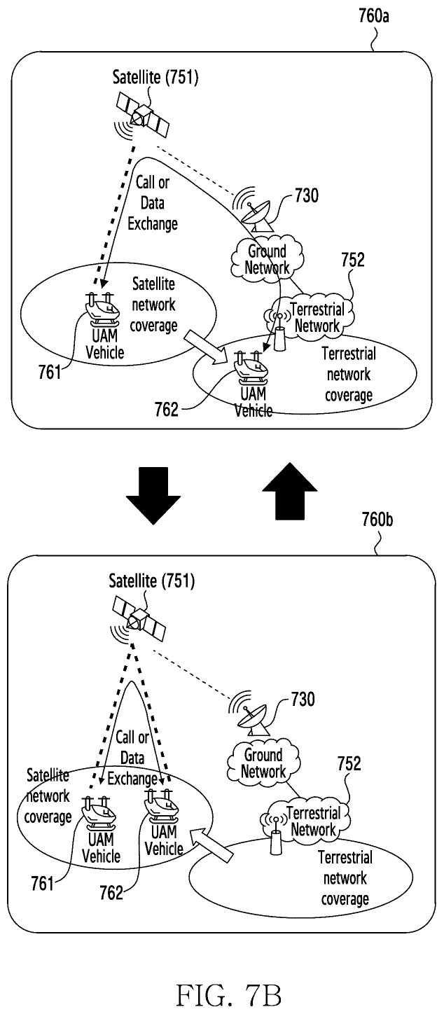

FIG. 7A illustrates a first example of a scenario for service continuity. Low Earth Orbit (LEO) satellites orbit about 500 to 2000 km above the Earth's surface to provide communication services. Compared to the geostationary orbiting satellites, the LEO satellites have the advantage of less communication delay and less propagation loss than geostationary satellites due to their closer proximity to the Earth, but since they orbit the Earth every 90 to 120 minutes, their service provision time for a specific area is limited. Therefore, in order to provide seamless and continuous services to the specific area on the ground, multiple LEO satellites must cooperate to ensure service continuity.

This LEO satellite communication may be effectively utilized to suppress forest fires and support search and rescue missions. These satellites may be used to detect and fight fires, drop water, and transport firefighters and equipment to rural and remote areas. Reliable communication between firefighters is possible by allowing the UEs to communicate directly with those satellites, especially in areas without terrestrial cellular networks. At this time, a ground station 730 may support the control and management functions of the satellite network via a feeder link with the satellite. Referring to FIG. 7A, a first UE 711 of firefighter A and a second UE 712 of firefighter B may be located within the service area of the first satellite 701 (e.g., NGSO satellite) to communicate through the first satellite 701. Such fire-related missions may take several hours or several days to complete, which may be a time duration exceeding a visibility time of a single LEO satellite. Since the first satellite 701 travels along a designated orbit, a method of inter-satellite cooperation may be required to ensure service continuity within the area.

FIG. 7A assumes a situation where the firefighter A and the firefighter B make a phone call or exchange some data (e.g., photos, a video stream) with each other while working through the first UE 711 and the second UE 712.

Reference number 710a of FIG. 7A represents an initial situation where both the firefighter A and the firefighter B are located within the service area of the first satellite 701.

At this time, communication between the first UE 711 and the second UE 712 may be directly routed through the first satellite 701. As time passes and the first satellite 701 then travels along the orbit, the second UE 712 enters the service area of the second satellite 702 as shown by reference number 710b.

In such a situation, the second UE 712 performs direct communication with the second satellite 702, and communication between the first UE 711 and the second UE 712 is maintained through an inter-satellite link (ISL) established between the first satellite 701 and the second satellite 702. As the satellites continue to orbit, a situation occurs in which the service area of the second satellite 702 includes the area where the first UE 711 of firefighter A and the second UE 712 of firefighter B are located, as shown in a reference number 710c. At this time, for the service efficiency, the second satellite 702 completely takes over the data sessions for the firefighter A and the firefighter B from the first satellite 701, and routes all data traffic directly through the second satellite 702. During this entire process, the ground station 730 continuously performs the control and management functions of the satellite network through the feeder link.

According to the regulatory requirements and the operator policies according to the embodiments of the disclosure, the 5G system with satellite access should be able to support the establishment of communication paths between UEs through one or more service satellites without going through the terrestrial network.

According to the regulatory requirements and operator policies according to embodiments of the disclosure, the 5G system with satellite access should be able to support the service continuity of communications between UEs without going through the terrestrial network, when the UE communication path travels between service satellites.

According to the regulatory requirements and operator policies according to the embodiments of the disclosure, the 5G system with satellite access capability should be able to support the service continuity of communications between UEs without going through the terrestrial network, when the communication path between UEs via one or more service satellites extends across multiple satellites (via an inter-satellite link (ISL)).

FIG. 7B illustrates a second example of a scenario for service continuity. Urban Air Mobility (UAM) refers to a next-generation air transportation system that transports passengers or cargo via three-dimensional air paths in urban and suburban areas, as a kind of urban air mobility. One of the most important factors in the UAM operation is to secure safe and reliable communication connectivity. A UAM vehicle may be referred to as a vehicular UE from the perspective of a mobile terminal performing NTN communication via satellite. Unlike typical terrestrial UEs, the vehicular UE has mobility in three-dimensional space and is characterized by high movement speed and frequent network switching. In consideration of the characteristics of such a vehicular UE, each vehicular UE has to be registered with the terrestrial network 730 (e.g., gateway) prior to its initial operation, so that it is configured to enable seamless switching-over between the satellite network and the terrestrial network.

The UAM vehicles fly at various altitudes due to their operation characteristics. In general, they may be operated at low altitudes of less than about 100 m during the takeoff and landing phase, at medium altitudes between about 300 m and 1 km during the cruising phase, or at high altitudes of more than 1 km if necessary. These various flight altitudes have important meanings from the perspective of communication network, because the network entity capable of providing the optimal communication service varies depending on the altitude.

Reference numerals 760a and 760b of FIG. 7B represent examples of network access scenarios according to the flight altitudes of UAM vehicles. At the reference numeral 760a, the first vehicle UE 761 is flying at a high altitude in the satellite network coverage area 751a and is performing direct communication with the satellite 751. On the other hand, the second vehicle UE 762 is in operation at a low altitude in the terrestrial network coverage area 752a, and thus communicates with the eNodeB 751 of the ground station 752. Both the vehicular UEs are initially registered with the terrestrial network 730, and thus share authentication and security information required for network switching. The reference number 760b indicates a situation in which both UAM vehicles have moved to the satellite network coverage area 751a. This situation may correspond to a case in which the second vehicle UE 762 has entered the cruising phase by increasing its altitude, or has moved to an area with limited terrestrial network coverage. Under this situation, both the vehicles may communicate directly with the satellite 751. At this time, a seamless service switching-over may be also achieved based on the initial terrestrial network registration information. In order to operate the UAM vehicle safely, the following information needs to be exchanged in real time:
Flight path and altitude information;
Relative position information between vehicles;
Weather and flight environment information;
Emergency information;
Traffic control information; and
Network status and switching-over information.

Since this information requires very low latency and high reliability, the communications must be performed by selecting an optimal network according to the location and altitude of each UAM vehicle. The ground station 730 supports connection between the satellite network and the terrestrial network through a feeder link with the satellite 751, thereby enabling seamless and uninterrupted services even when switching between networks. In particular, when the UAM vehicle needs to switch the service networks due to altitude change or flight path change (e.g., from a satellite network to a terrestrial network, or vice versa), the following service continuity should be ensured:
\textcircled{1} Maintaining communication quality before and after network switching;
\textcircled{2} Uninterrupted transmission of real-time flight information;
\textcircled{3} Securing communication continuity with other UAM vehicles;
4̅ Maintaining stable connection with the control system; and
\textcircled{5} Rapid authentication and switching processing based on initial registration information.

In accordance with the embodiments of the disclosure, depending on the regulatory requirements and the operator policies, the 5G system with satellite access may be required to support the service continuity when a UE communication path moves between the 5G terrestrial access network and the 5G satellite access network, which are owned by the same operator or by different operators in contract with that operator.

As exemplified in the scenarios described above, the satellite may provide a non-terrestrial network independent of the terrestrial network. However, in order to ensure uninterrupted service continuity, the following network relationship setting is required:

### 1. Inter-Satellite Relationship Setting:

As illustrated in FIG. 7A, the relationship setting between the first satellite 701 and the second satellite 702 is required. Since LEO satellites move along a designated orbit at a frequency of approximately 90 to 120 minutes, the service area of each satellite changes after a certain period of time. Therefore, efficient transfer of data sessions through an inter-satellite link (ISL) is required in order to provide continuous communication networks in the same service area.

### 2. Relationship Setting Between Satellite and Terrestrial Network:

As illustrated in FIG. 7B, relationship setting between the satellite 751 and the terrestrial network (e.g., the ground station 752) is required. In particular, for the vehicle UEs operating at various altitudes such as UAM, seamless switching-over between the satellite network and the terrestrial network is essential. To this end, the satellite must be disposed within the communication range (e.g., the feeder link) of the network entity (e.g., gateway, AMF) connected to the ground station, and rapid network switching-over through the initial registration information must be supported.

In the disclosure, communication between UEs implies that a UE performs communication with another UE through a satellite or a satellite, ground station, or gateway. It has the following characteristics:
1. Relay communication via a satellite or terrestrial network;
2. Guaranteeing service continuity even during network switching;
3. Meeting QoS (Quality of Service) requirements; and
4. Supporting real-time data exchange.

This is distinguished from communication between UEs through a separate data network or sidelink performing direct communication between UEs.

In order to effectively satisfy such service continuity requirements, embodiments of the disclosure propose a technique for grouping service satellites. Satellite grouping may provide the following advantages:
1. Ensuring continuous coverage for the same service area;
2. Efficient session handover between satellites;
3. Improved interoperability with terrestrial networks; and
4. Efficient utilization of network resources.

### 1. Satellite Grouping

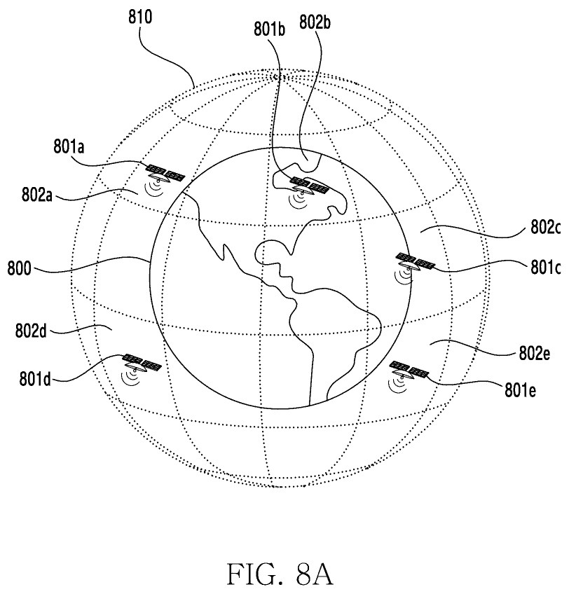

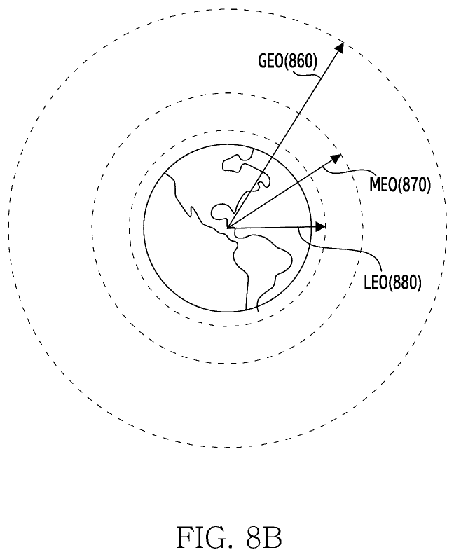

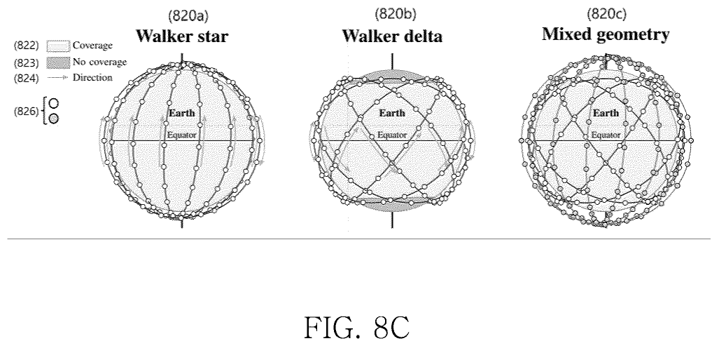

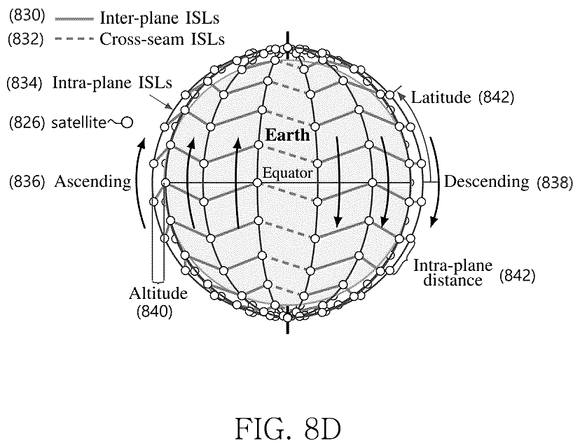

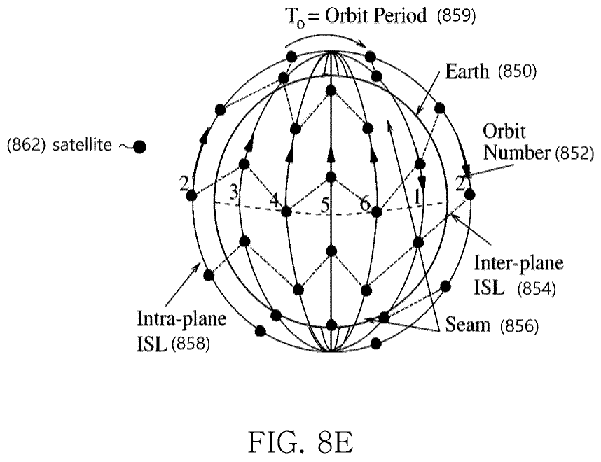

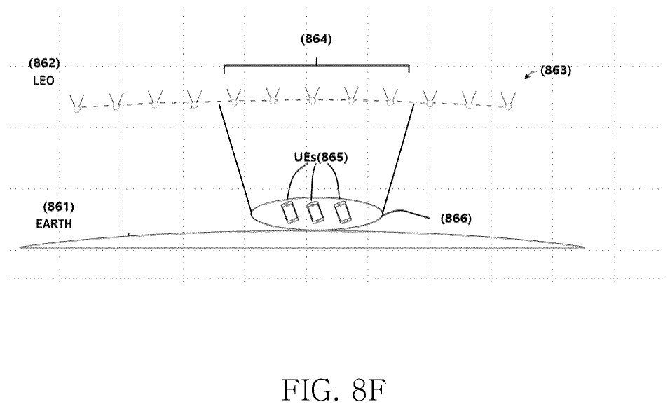

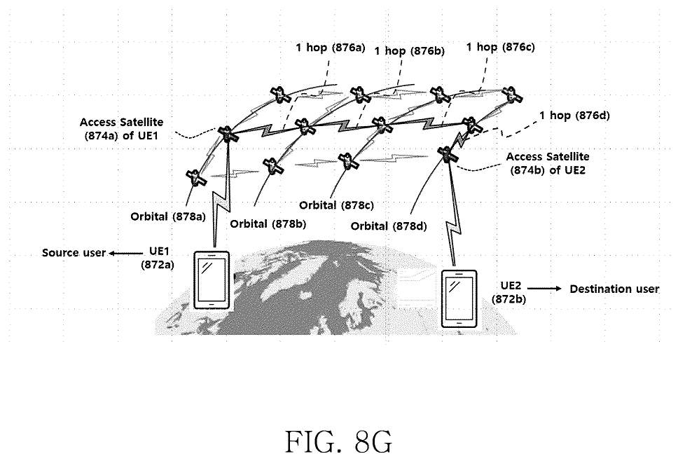

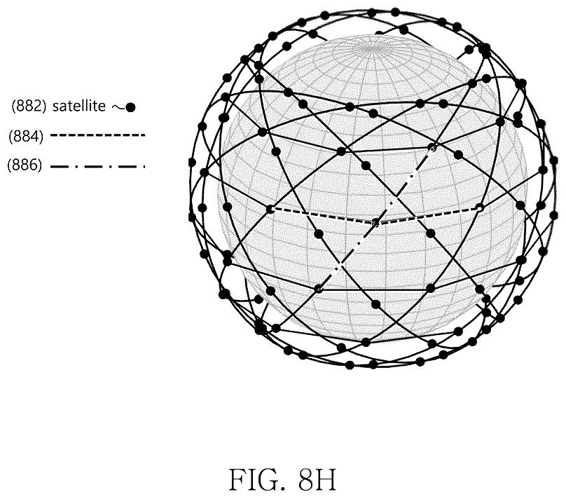

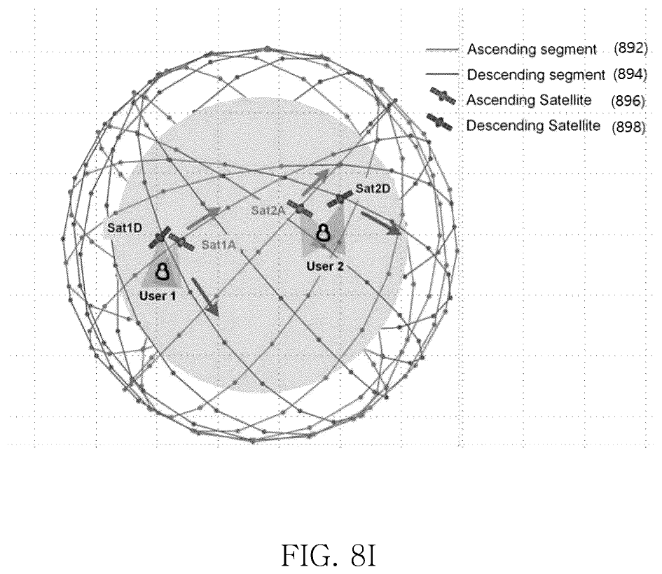

FIGS. 8A and 8B are diagrams for explaining a space area. The space area may represent one area among spaces including a planet.

In the embodiments of the disclosure, the space area refers to a three-dimensional service area that provides satellite services in space, which includes a two-dimensional service area and an altitude range projected onto the surface of the Earth.

FIGS. 8A and 8B are diagrams for explaining the space area.

Referring to FIG. 8A, a virtual sphere 810 (indicated by a dotted line) centered on a planet 800 may be defined. In the specification of the disclosure, the planet may refer to the Earth, as a celestial body that determines an orbit of a satellite. The sphere 810 may be divided into multiple segmented areas, and each segmented area may be defined as an area that extends a geographical area corresponding to the surface of the planet 800 into a three-dimensional space. For example, the sphere 810 may be divided into a plurality of grid shapes according to the longitude and latitude, and each grid may define one space area.

In FIG. 8A, different segmented areas of the sphere 810 are represented split by dotted lines. Each segmented area may represent an independent space area.

Satellites located in each space area may have the following characteristics:
1. The satellites in the same space area may have easy setting of an ISL (Inter-Satellite Link) with each other.
2. The satellites in the same space area may cooperatively provide service continuity for ground UEs in the corresponding area.
3. The satellites in adjacent space areas may exchange information for handover.

Referring to FIG. 8B, the satellites may be deployed at different orbital heights. For example, the satellites may be deployed at different altitudes of orbits, such as GEO 860, MEO 870, and LEO 880. According to an embodiment of the disclosure, a space area may also be referred to as a specific altitude range. For example:
First height range (8 km or more and less than 500 km): first space area
Second height range (500 km or more and less than 1000 km): second space area
Third height range (1000 km to 1500 km): third space area

This division of space areas by altitude provides the following advantages:
1. Efficient grouping of satellites with similar propagation delay characteristics;
2. Ease of ISL setting (easy to set up links between satellites with similar altitudes); and
3. Efficiency of service area management according to orbital characteristics.

Satellites located in the same space area at a certain timing point in time may be managed as one satellite group, and such a satellite group may be dynamically changed over time. For example, a first satellite group including satellites located in the first space area at a first time may be composed of different satellites at a second time. Such dynamic grouping enables providing continuous services.

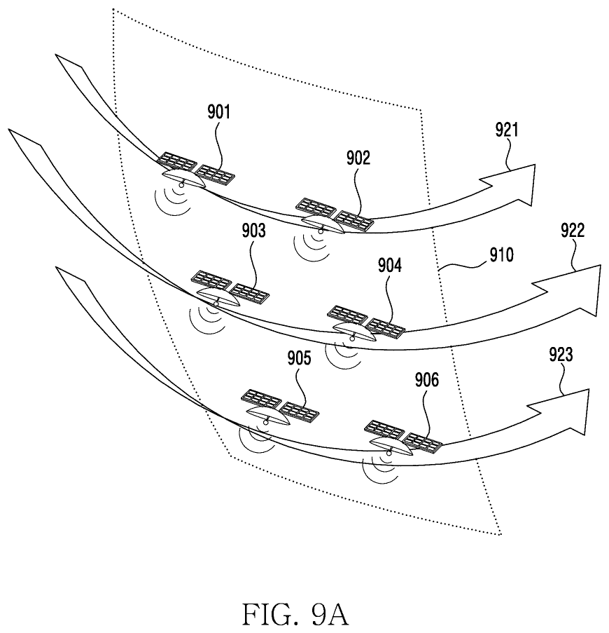

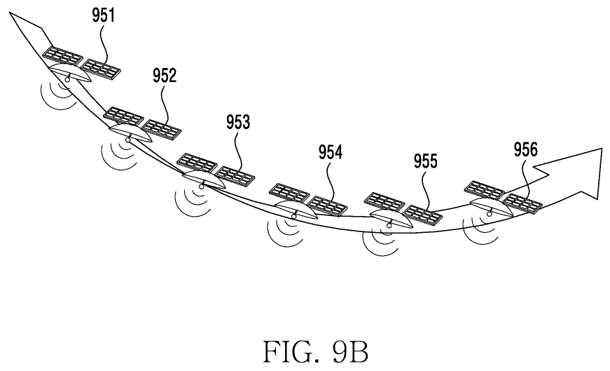

FIGS. 9A and 9B illustrate examples of satellite grouping.

Referring to FIG. 8A, a plurality of satellites may orbit the planet 800. For example, the plurality of satellites may include a first satellite 801a, a second satellite 801b, a third satellite 801c, a fourth satellite 801d, and a fifth satellite 801e. The virtual sphere 810 may surround the planet 800. The virtual sphere 810 may have a plurality of distinct areas on its surface. For example, the plurality of segmented areas may form a grid. The plurality of segmented areas may include a first segmented area 802a, a second segmented area 802b, a third segmented area 802c, a fourth segmented area 802d, and a fifth segmented area 802e. Each location of the satellite may be specific to a segmented area. For example, a first satellite 801a may correspond to a first segmented area 802a. A second satellite 801b may correspond to a second segmented area 802b. A third satellite 801c may correspond to a third segmented area 802c. A fourth satellite 801d may correspond to a fourth segmented area 802d. A fifth satellite 801e may correspond to a fifth segmented area 802e.

Satellites may move along an orbit over time. Each satellite may have an independent orbit. For example, the orbit of the first satellite 801a may be different from the orbit of the second satellite 801b. The orbital plane of the first satellite 801a may not be parallel to the orbital plane of the second satellite 801b. Since the locations and orbits of each satellite at a specific time point are independent of each other, it may be required to group satellites that are located in the same segmented area at a specific time point. These satellites may be understood as being located in the same space area. In other words, the satellites that have the same space area may belong to the same satellite group. Further, as the space area in which each satellite is located may vary from time to time, the space area as well as time information for the space area may be defined.

In FIG. 8A, it is assumed that the sphere 810 is located at a certain distance from the center of the planet 800, but the heights of the orbits (hereinafter, orbital heights) of the actual satellites may be different from each other. Referring to FIG. 8B, for example, the satellite may be deployed in the GEO 860, the MEO 870, or the LEO 880, depending on its orbital height.

TABLE 3

| | | | Typical beam |
|---|---|---|---|
| Platforms | Altitude range | Orbit | footprint size |
| Low-Earth Orbit | 300-1500 km | Circular around the earth | 100-1000 km |
| (LEO) satellite | | | |
| Medium-Earth | 7000-25000 km | | 100-1000 km |
| Orbit (MEO) | | | |
| satellite | | | |
| Geostationary Earth | 35 786 km | Notional station keeping | 200-3500 km |
| Orbit (GEO) | | position fixed in terms of | |
| satellite | | elevation/azimuth with | |
| UAS platform | 8-50 km (20 km for | respect to a given earth point | 5-200 km |
| (including HAPS) | HAPS) | | |
| High Elliptical | 400-50000 km | Elliptical around the earth | 200-3500 km |
| Orbit (HEO) | | | |
| satellite | | | |

According to an embodiment, the space area may be defined as a space corresponding to a distance from the center of the planet 800 to a certain segmented area that is the surface of the sphere 810, assuming taking a very high orbital height (e.g., radius of the sphere 810, assuming a height greater than the upper limit of the HEO). When viewing the certain segmented area in the direction of the center of the planet 800, the satellites shown may be understood to be located in the same space area, regardless of the height of the satellite orbit. For example, a low-orbit satellite and a geostationary satellite may be located in the same space area.

Assume a scenario of FIG. 7A. As an example, in a first time interval, the first UE 711 of firefighter A and the second UE 712 of firefighter B may communicate through the first satellite 701 (e.g., NGSO). The first satellite 701 may identify satellites located in the space area where the first satellite 701 was located in the first time interval during the second time interval after the first time interval. The first satellite 701 may identify a specific satellite (e.g., LEO) among the satellites. Communication between the firefighter A and the firefighter B may be provided through a link (e.g., ISL) between the first satellite 701 and the specific satellite.

Assume a scenario of FIG. 7B. For example, in the first time interval, the first UE 711 of firefighter A may be in connection with the non-terrestrial network of the satellite 751. The second UE 712 of firefighter B may be in connection with the terrestrial network of the ground station 752. Since the satellite 751 continues to move, entities of the terrestrial network 730 (e.g., gateway 223, gateway 265) may be required to know in advance information about the satellite to be deployed subsequent to the satellite 751, for the service continuity. For example, the geographic area of a satellite that can connect to a gateway located in a specific area of the ground may be limited. The geographic area may be associated with the space area described above. The gateway may include a space area corresponding to the location range of the satellite that may be directly connected to the gateway. The gateway may manage satellites included in one space area on a time interval basis. For example, the gateway may identify satellites located in a space area associated with the location of the gateway in a second time interval following the first time interval. The gateway may identify a subsequent satellite to be connected to the first UE 711 following the satellite 751 among those satellites. In the second time interval, the space area of the subsequent satellite may be the same as the space area of the satellite 751 in the first time interval.

In FIGS. 8A and 8B, the concept of a satellite group is described assuming that it is in the same space area, if it is located in a space corresponding to the segmented area of the sphere 810 from the center of the planet 800, regardless of the orbital height, but the embodiments of the disclosure are not limited thereto. When assuming that it is communication between satellites, it may be difficult to establish an ISL between satellites that are too far apart. According to another embodiment, a range of heights for specifying a space area may be defined. Considering the performance constraints of the ISL, the space area may be specified by the segmented area of the sphere 810 as well as the height range. For example, even if a specific segmented area of the sphere 810 is the same, the space areas having different height ranges may be set. For example, when looking at the specific segmented area in the direction of the center of the planet 800, satellites located in a first height range (8 km or more and less than 500 km), among the satellites that are visible, may be located in the first space area, satellites located in a second height range (500 km or more and less than 1000 km) may be located in the second space area, satellites located in a third height range (1000 km to 1500 km) may be located in the third space area, and other satellites may be located in the fourth space area. The space area to which a specific satellite belongs in the current time interval may be occupied by specific satellites in the next time interval. These specific satellites may be viewed as the same satellite group.

In FIG. 8A, a space area is defined as units of a segmented area corresponding to the surface of the sphere, but the embodiments of the disclosure are not limited thereto. In addition to geographical segmentation, the airspace above the ground surface may be designated as a space area, depending on the type of the earth surface (e.g., ocean, city center, island). Further, satellites with the same space area (i.e., satellites in the same group) may share data with each other. Therefore, the satellites in the same group may perform data forwarding through an ISL.

In addition to the concept of space area described in FIG. 8A or FIG. 8B, a tracking area for managing mobility of a UE in 3GPP may be used as a criterion for defining a group of satellites. A satellite may provide an access network to a terminal through a cell. A tracking area (TA) may be understood as a set of one or more cells. At least some of the one or more cells may be provided by a satellite. For example, a cell provided by a first satellite and a cell provided by another satellite may be included in the same TA. Tracking area information (e.g., a tracking area identity (TAI), a tracking area code (TAC), and/or a TAI list) for each satellite may be managed. The tracking area information may dynamically change depending on the movement of the satellite.

FIG. 8C is a drawing for explaining an example of a LEO satellite constellation according to an embodiment of the disclosure.

Satellite constellations are a group of satellites arranged in orbital planes. One orbital plane has Np satellites (where N is the number of satellites and p is the number of orbital planes) that move sequentially along the same orbital trajectory, wherein the satellites are generally spaced uniformly around the orbit.

In FIG. 8C, a reference numeral 822 represents a ground surface area covered by satellites arranged in an orbital plane, and a reference numeral 823 represents a ground surface area not covered by the satellites arranged in the orbital plane. And, in FIG. 8C, a reference numeral 824 indicates the direction of satellite movement on the orbital plane, and a reference numeral 826 indicates satellites arranged on the orbits constituting each orbital shell.

An orbital shell includes a group of P orbital planes arranged at approximately the same altitude in a satellite constellation. Some orbital shells include a slight variation of several kilometers, which is called orbital separation. Such an orbital separation is to consider a slight difference in the altitude of the orbital plane even within the same orbital shell, which helps reduce the risk of collision between satellites.

To maximize communication range, the arrangement of satellites in an orbital shell generally follows one of two basic types: Walker Star 820a or Walker Delta (also called Rosette) 820b. Such a satellite constellation design may include one or more orbital shells.

The main differences and features of the Walker Star and Delta configurations are as follows:

### Walker Star 820a:

Advantages: Optimized polar region coverage, simple orbital structure, stable ISL configuration;
Disadvantages: Relative weakness in equatorial coverage, increased number of satellites required; and
ISL characteristics: Average delay 40 ms, maximum bandwidth 10 Gbps.

### Walker Delta 820b:

Advantages: Optimal coverage of densely populated areas, efficient satellite operation;
Disadvantages: Limited polar region coverage, complex ISL topology; and
ISL characteristics: Average delay 25 ms, maximum bandwidth 20 Gbps.

The Walker Star orbital shell 820a has a configuration of all orbital planes distributed over 180 degrees, intersecting in polar region. It mainly uses polar or near-polar orbits, and in this case, the inclination (d) of the orbit is close to 90 degrees (d 90°). Since the satellites are evenly spaced within 180°, the angle between neighboring orbital planes becomes 180°/P. Therefore, the Walker Star orbital shell 820a is a configuration optimized for polar region coverage.

On the other hand, the Walker Delta orbital shell 820b generally uses an inclination orbit (δ<60°). Since the satellites are evenly spaced within 360°, the angle between neighboring orbital planes becomes 360°/P. Here, the spacing (σ) between orbital planes visually represents a vertical distance between respective orbital planes, as in FIG. 8C. The spacing (σ) between orbital planes is used to represent relative spacing rather than absolute values.

The Walker delta orbital shell 820b, which is composed of multiple inclined orbital planes, does not provide complete coverage of the polar regions or the northernmost regions. However, as shown in FIG. 8C, the Walker delta orbital shell 820b is advantageous in covering the entire area where most of the population resides except for the polar regions.

As described above, the Walker star 820a and Walker delta 820b geometries each have its own advantages and disadvantages, and thus a design may be considered combining the Walker star 820a and the Walker delta 820b to form an orbital shell, such as reference number 820c.

FIG. 8D is a configuration diagram of the Walker star LEO satellite group, showing various inter-satellite link (ISL) structures between satellites 826. Specifically, it may include intra-plane ISL 834, inter-plane ISL 830, and cross-seam ISL 832.

Referring to FIG. 8D, the orbital planes of ascending (836) and descending (838) directions are arranged around the equator, with each satellite 826 distributed according to a specific altitude 840 and latitude 842. Each satellite is operated while maintaining an intra-plane distance 842.

Meanwhile, the ISL may be further subdivided into intra-plane ISL between satellites in the same orbital plane and inter-plane ISL between satellites in different orbital planes. Furthermore, the ISL between satellites in orbital planes that move in almost opposite directions, such as e.g., one ascending and the other descending, may be referred to as cross-seam ISL.

The satellite group illustrated in FIG. 8D has a typical Walker star configuration with seven orbital planes, with P polar orbital planes deployed at a minimum altitude of 600 km, and having orbital separation (i.e., altitude difference). The satellites in each orbital plane are connected by intra-plane ISLs 834, and satellites in adjacent orbital planes are connected by inter-plane ISLs 830. Cross-seam ISLs 832 are formed between the ascending (836) and descending (838) orbital planes to ensure network connectivity of the entire satellite group.

FIG. 8E is an orbital configuration diagram of a LEO satellite network, showing the arrangement of satellites 862 according to an orbit period (To) 859 and the structure of the inter-satellite communication link (ISL).

Referring to FIG. 8E, the LEO satellites 862 are arranged along a circular polar orbit around the Earth 850, and each orbit is distinguished by an orbit number 852. The illustrated embodiment is configured with six orbits, wherein the satellites in orbit 1 and the orbit 6 rotate in opposite directions while the satellites in other adjacent orbit pairs rotate in the same direction.

In a circular orbit, the speed of the satellites 862 is constant, and assuming that the orbit is maintained, the satellites are operated while maintaining the same inter-satellite gap during the orbit period (Tₒ) 860. In the LEO system of this embodiment, the satellite travels at a speed of about 26,000 km/h (7 km/s), rotating the Earth once in an orbit period of about 100 minutes. The satellite visibility period is less than 10 minutes, and considering this short visibility period, the user mobility and the Earth's rotation may be ignored when designing a mobility management algorithm.

The satellite network of this embodiment may route connections without ground resources, using inter-satellite communication links (ISLs) and on-board processing. The ISLs are divided into intra-plane ISLs 858 connecting satellites in the same orbit and inter-plane ISLs 854 connecting satellites in adjacent orbits. While the intra-plane ISLs 858 may be maintained permanently, the inter-plane ISLs 854 may be temporarily blocked due to changes in the distance and view angle between adjacent orbit satellites.

In particular, in the region of seam 856, the ISL between satellites rotating in opposite directions is maintained limited to the latitudes of about 60° north or south. In regions beyond 60° latitude, when satellites rotating in opposite directions enter the seam 856, the ISL with neighboring orbit satellites is temporarily blocked, and a satellite passing through the polar region is also blocked for the ISL with the neighboring orbit satellites.

FIG. 8F illustrates inter-satellite links between LEO satellites 863 located in the LEO orbital plane 862 and satellites, the LEO satellites 863 providing a communication path to the Earth 861. As illustrated, user terminals (UEs) 865 communicate with the LEO satellites 863, and reference numeral 864 indicates the LEO satellites located within the space area, and reference numeral 866 indicates a ground surface area that may receive services from the LEO satellites located in the space area.

FIG. 8G illustrates an example of a communication path between satellites via a space area. A transmitting user UE1 872a and a receiving user UE2 872b communicate via their respective access satellites 874a and 874b, wherein the access satellites refer to satellites that can cover the users and provide services to the users. The satellites are arranged along orbitals 878a to 878d, and when a starting user and a destination user are served by different access satellites, a communication path via an inter-satellite link (ISL) of 1-hop (876a-876d) units is formed between the satellites. Since a change in the network topology is regular when the satellites are uniformly distributed, the number of hops between two user terminals may be maintained relatively stable except for minor fluctuations. Each access satellite provides services to users within its own space area, and the space areas may be defined as three-dimensional service areas of the satellites.

FIG. 8H illustrates a structure of a global satellite network with space area applied. Satellites 882 are uniformly arranged on an orbit surrounding the Earth, and each satellite provides a service within its own space area. The paths indicated by a dotted lines 884 and a dashed lines 886 represent examples of communication paths passing through different space areas, and this space area-based network structure enables efficient inter-satellite routing and resource management.

FIG. 8I illustrates a dynamic configuration of ascending and descending satellites within space area. Ascending satellites 896 and descending satellites 898 moving along an ascending segment 892 and a descending segment 894 provide services within each space area, wherein the ascending satellite 896 moves toward the northeast where the latitude increases, and the descending satellite 898 moves toward the southeast where the latitude decreases. As illustrated, the user 1 may be located in the space area of Sat1A (ascending satellite) and Sat1D (descending satellite), and the user 2 may be located in the space area of Sat2A and Sat2D, respectively, receiving services through overlapping coverage. Due to link instability caused by high-speed movement, the ascending satellite 896 may be connected only with other ascending satellites, and the descending satellite 898 may be connected only with other descending satellites to form an ISL (Inter-Satellite Link), and this space area-based overlapping satellite network configuration can improve the service continuity and reliability.

Referring to FIG. 9A, a satellite group may include a plurality of satellites. The plurality of satellites may correspond to space area 910. The plurality of satellites may include a first satellite 901, a second satellite 902, a third satellite 903, a fourth satellite 904, a fifth satellite 905, and a sixth satellite 906. Even though these satellites move along different orbits, the satellites may correspond to the same space area 910. For example, the first satellite 901 and the second satellite 902 may move along the first orbit 921. For example, the third satellite 903 and the fourth satellite 904 may move along the second orbit 922. For example, the fifth satellite 905 and the sixth satellite 906 may move along the third orbit 923.

Referring to FIG. 9B, a satellite group may include a plurality of satellites. The plurality of satellites may correspond to the same orbit. While FIG. 9A depicts the space area, which is a geographical space in the outer space, or the tracking region, which is a geographical space on the ground, but the embodiments of the disclosure are not limited thereto. In order to efficiently manage the movement of the satellite, ephemeris information (e.g., orbital information) specific to the satellite may be used to define the satellite group. For example, the plurality of satellites may include a first satellite 951, a second satellite 952, a third satellite 953, a fourth satellite 954, a fifth satellite 955, and a sixth satellite 956 having the same or similar orbital information.

As an example, for ephemeris information, the following 3GPP IEs may be referenced.

TABLE 4
- EphemerisInfo
The IE EphemerisInfo provides satellite ephemeris.
Ephemeris may be expressed either in format of position and v
elocity state vector in ECEF or in format of orbital
parameters in ECI. Note: The ECI and ECEF coincide at epoch
Time, i.e., x,y,z axis in ECEF are aligned with x,y,z axis in ECI at epochTime.

EphemerisInfo information element

-- ASN1START
-- TAG-EPHEMERISINFO-START

| | |
|---|---|
| EphemerisInfo-rxx ::= | CHOICE { |
| positionVelocity-rxx | PositionVelocity-rxx, |
| orbital-rxx | Orbital-rxx |

}

| | |
|---|---|
| PositionVelocity-rxx ::= | SEQUENCE { |
| positionX-rxx | PositionStateVector-rxx, |
| positionY-rxx | PositionStateVector-rxx, |
| positionZ-rxx | PositionStateVector-rxx, |
| velocityVX-rxx | VelocityStateVector-rxx, |
| velocityVY-rxx | VelocityStateVector-rxx, |
| velocityVZ-rxx | VelocityStateVector-rxx |

}

| | |
|---|---|
| Orbital-rxx ::= | SEQUENCE { |
| semiMajorAxis-rxx | INTEGER (0..8589934591), |
| eccentricity-rxx | INTEGER (0..1048575), |
| periapsis-rxx | INTEGER (0..268435455), |
| longitude-rxx | INTEGER (0..268435455), |
| inclination-rxx | INTEGER (−67108864..67108863), |
| meanAnomaly-rxx | INTEGER (0..268435455) |

}
PositionStateVector-rxx ::= INTEGER (−33554432..33554431)
VelocityStateVector-rxx ::= INTEGER (−131072..131071)
-- TAG-EPHEMERISINFO-STOP
-- ASN1STOP

Wherein, ‘positionX’, ‘positionY’, and ‘positionZ’ represent position state vectors of ECEF (earth-centered, earth-fixed) in the xyz coordinate system, respectively. The unit is indicated by meters, and one step indicates 1.3 m (meter). For example, the actual value may be field value*1.3. ‘velocityX’, ‘velocityY’, and ‘velocityZ’ represent velocity state vectors of ECEF in the xyz coordinate system, respectively. One step indicates 0.06 m/s (meter per second). For example, the actual value may be field value*0.06. ‘semiMajorAxis’ represents a semi-major axis, ‘eccentricity’ represents the eccentricity, ‘periapsis’ represents the periapsis, ‘longitude’ represents the longitude, ‘inclination’ represents the inclination, and ‘meanAnomaly’ represents the mean anomaly, indicating a ratio of the elliptical orbital period that has elapsed after an orbiting object passes the periapsis.

For example, the first ephemeris information of the first satellite may include the first orbital information. The second ephemeris information of the second satellite may include the second orbital information. Each orbital information represents the semi-major axis, the eccentricity, the periapsis, the longitude, and/or the inclination. If the difference between the first orbital information and the second orbital information is less than a certain threshold, the first satellite and the second satellite may belong to the same satellite group. For example, if the first orbit information and the second orbit information are the same, the first satellite and the second satellite may belong to the same satellite group.

### 2. Satellite Group and Signaling

A satellite group may be defined in various ways. Although examples of defining a satellite group are described in FIGS. 8A, 8B, 9A, and 9B, it should be noted that the above-described methods are only examples of defining a satellite group, and are not interpreted as limiting the method of defining such a satellite group thereto when explaining signaling to be described below. A satellite group may be defined in advance by an operator of satellites, an operator providing a ground gateway connected to satellites, or a network operator, or may be set by a configuration of network entities (e.g., AMF, NG RAN node).

For example, referring to FIG. 7A, as a serving satellite (e.g., the first satellite 701) moves along an orbit, a target satellite (e.g., satellite 702) instead of the serving satellite can perform communication with the first UE 711. The target satellite may perform communication with the first UE 711. In order for the first UE 711 to continuously receive the services seamless, the serving satellite may provide the target satellite with information related to communication. The information related to communication may include, for example, items in the following table.

TABLE 5

| Information | Description |
|---|---|
| Serving Satellite ID | indicates serving satellite for UE-to-UE |
| | communication using satellite |
| Target Satellite ID | indicates next satellite subsequent to serving |
| | satellite for UE-to-UE communication using satellite |
| Serving Satellite Beam ID | indicates spotbeam for serving satellite |
| Target Satellite Beam ID | indicates spotbeam for target satellite |
| UE #1 ID | first UE for UE-to-UE communication using satellite |
| | e.g., IMSI, GUTI, |
| UE #2 ID | second UE for UE-to-UE communication using |
| | satellite |
| Session Information | Session ID maintained between serving satellite |
| | and target satellite. |
| | e.g., PDU session |
| Bearer Information | DRB(data radio bearer) ID, SRB(signaling radio |
| | bearer) ID |
| Cell Information | cell information, PCI(physical cell identity), CGI(cell |
| | global identity) |
| Space Area Information | |
| >Space Area id | indicates a specified space area |
| >height threshold | a range of space area |
| Satellite Group ID | indicates satellite group for service |
| Candidate Satellite list | Satellite set within space area |
| >time interval id | time interval related to space area |
| >satellites per time interval | satellites within space area in corresponding time |
| | interval |
| Validity Time | |
| Tracking Area Information | |
| >Tracking Area List | TAC, TAI, PLMN Identity |
| Orbit ID | indicates orbital. |
| | e.g., ephemeris info, semiMajorAxis, eccentricity, |
| | periapsis, longitude, inclination, meanAnomaly |

The serving satellite may find a target satellite which will take over the service information. For example, when the serving satellite broadcasts a connection request message, a satellite (i.e., a target satellite) having the same space area as the serving satellite may respond to the connection request message. The target satellite may transmit a connection response message to the serving satellite. If multiple satellites within the same space area transmit connection response messages to the serving satellite, then the serving satellite may transmit a connection completion message only to a specific satellite, thereby establishing an ISL between the serving satellite and the specific satellite. For another example, the serving satellite may obtain information about the target satellite from another network entity (e.g., gateway, AMF). The serving satellite may transmit a request message for a take-over of the session to the target satellite. The serving satellite may transmit the request message via the ISL between the serving satellite and the target satellite. In the above-described examples, the message between the satellites provided through the ISL may be considered as a message between base stations from the perspective that each satellite operates as an independent RAN node. The message between the satellites may be understood as being provided via an XN interface.

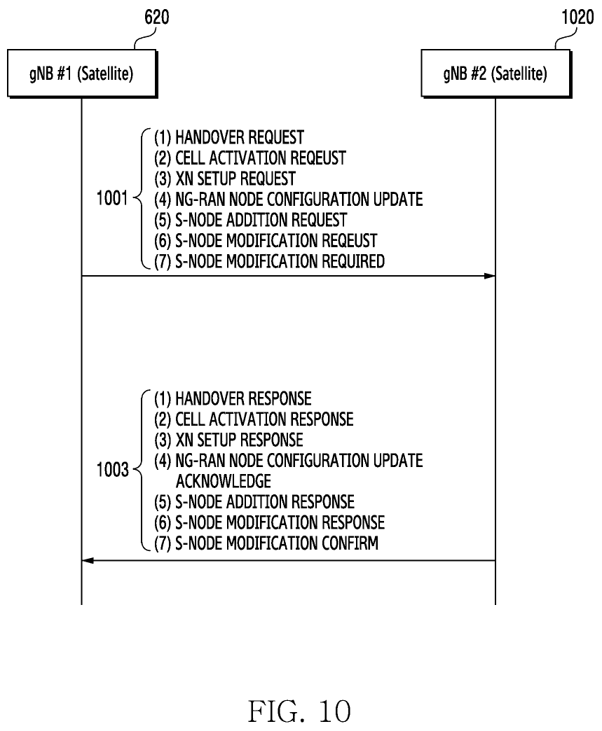

FIG. 10 illustrates an example of signaling via an XN interface in the NTN. Although signaling between a non-terrestrial base station and a terrestrial base station is described as an example in FIG. 10, embodiments of the disclosure are not limited thereto. The messages on the XN interface described in FIG. 10 may be transmitted not only between a non-terrestrial base station and a terrestrial base station, but also between a non-terrestrial base station and a non-terrestrial base station, or between a terrestrial base station and a terrestrial base station. Further, although the messages described in FIG. 10 are described as being first transmitted from a non-terrestrial base station to a terrestrial base station, the disclosure is not limited thereto. For example, a request message may be transmitted from a terrestrial base station to a non-terrestrial base station first, and then a response message may be transmitted from the non-terrestrial base station to the terrestrial base station. For example, the non-terrestrial base station may include a satellite 620. For example, the terrestrial base station may include a base station 1020.

Referring to FIG. 10, in operation 1001, the satellite 620 may transmit a first message to the base station 1020 via the XN interface. The base station 1020 may receive the first message from the satellite 620.

In operation 1003, the base station 1020 may transmit a second message to the satellite 620 via the XN interface. The satellite 620 may receive the second message from the base station 1020.

According to an embodiment, the first message may be a handover request message, and the second message may be a handover response message. The satellite 620 may transmit the handover request message to the base station 1020 via the XN interface. The base station 1020 may transmit the handover response message to the satellite 620 via the XN interface. The handover request message may include at least one item of the information in Table 5. The handover response message may include at least one item of the information in Table 5. For example, the first message may include the following IEs as illustrated as an example in Table 6.

TABLE 6

| IE/Group | | | IE type and | | | Assigned |
|---|---|---|---|---|---|---|
| Name | Presence | Range | reference | Semantics description | Criticality | Criticality |
| Message | M | | 9.2.3.1 | | YES | reject |
| Type | | | | | | |
| Source NG- | M | | NG-RAN | Allocated at the source NG- | YES | reject |
| RAN node | | | node UE | RAN node | | |
| UE XnAP ID | | | XnAP ID | | | |
| reference | | | 9.2.3.16 | | | |
| Cause | M | | 9.2.3.2 | | YES | reject |
| Target Cell | M | | 9.2.3.25 | Includes either an E-UTRA | YES | reject |
| Global ID | | | | CGI or an NR CGI | | |
| GUAMI | M | | 9.2.3.24 | | YES | reject |
| UE Context | | 1 | | | YES | reject |
| Information | | | | | | |
| >NG-C UE | M | | AMF UE | Allocated at the AMF on the | — | |
| associated | | | NGAP ID | source NG-C connection. | | |
| Signalling | | | 9.2.3.26 | | | |
| reference | | | | | | |
| >Signalling | M | | CP | This IE indicates the AMF's | — | |
| TNL | | | Transport | IP address of the SCTP | | |
| association | | | Layer | association used at the | | |
| address at | | | Information | source NG-C interface | | |
| source NG-C | | | 9.2.3.31 | instance. | | |
| side | | | | Note: If no UE TNLA | | |
| | | | | binding exists at the source | | |
| | | | | NG-RAN node, the source | | |
| | | | | NG-RAN node indicates the | | |
| | | | | TNL association address it | | |
| | | | | would have selected if it | | |
| | | | | would have had to create a | | |
| | | | | UE TNLA binding. | | |
| >UE Security | M | | 9.2.3.49 | | — | |
| Capabilities | | | | | | |
| >AS Security | M | | 9.2.3.50 | | — | |
| Information | | | | | | |
| >Index to | O | | 9.2.3.23 | | — | |
| RAT/Frequency | | | | | | |
| Selection | | | | | | |
| Priority | | | | | | |
| >UE | M | | 9.2.3.17 | | — | |
| Aggregate | | | | | | |
| Maximum Bit | | | | | | |
| Rate | | | | | | |
| >PDU Session | | 1 | 9.2.1.1 | Similar to NG-C signalling, | — | |
| Resources | | | | containing UL tunnel | | |
| To Be Setup | | | | information per PDU | | |
| List | | | | Session Resource; | | |
| | | | | and in addition, the source | | |
| | | | | side QoS flow Û DRB | | |
| | | | | mapping | | |
| >RRC | M | | OCTET | Either includes the | — | |
| Context | | | STRING | HandoverPreparationInformation | | |
| | | | | message as defined in | | |
| | | | | subclause 10.2.2. of TS | | |
| | | | | 36.331 [14], or the | | |
| | | | | HandoverPreparationInformation- | | |
| | | | | NB message as | | |
| | | | | defined in subclause 10.6.2 | | |
| | | | | of TS 36.331 [14], if the | | |
| | | | | target NG-RAN node is an | | |
| | | | | ng-eNB, | | |
| | | | | or the | | |
| | | | | HandoverPreparationInformation | | |
| | | | | message as defined in | | |
| | | | | subclause 11.2.2 of TS | | |
| | | | | 38.331 [10], if the target | | |
| | | | | NG-RAN node is a gNB. | | |
| >Location | O | | 9.2.3.47 | Includes the necessary | — | |
| Reporting | | | | parameters for location | | |
| Information | | | | reporting. | | |
| >Mobility | O | | 9.2.3.53 | | — | |
| Restriction | | | | | | |
| List | | | | | | |
| >5GC | O | | 9.2.3.100 | | YES | ignore |
| Mobility | | | | | | |
| Restriction | | | | | | |
| List | | | | | | |
| Container | | | | | | |
| >NR UE | O | | 9.2.3.107 | This IE applies only if the | YES | ignore |
| Sidelink | | | | UE is authorized for NR | | |
| Aggregate | | | | V2X services. | | |
| Maximum Bit | | | | | | |
| Rate | | | | | | |
| >LTE UE | O | | 9.2.3.108 | This IE applies only if the | YES | ignore |
| Sidelink | | | | UE is authorized for LTE | | |
| Aggregate | | | | V2X services. | | |
| Maximum Bit | | | | | | |
| Rate | | | | | | |
| >Management | O | | MDT PLMN | | YES | ignore |
| Based MDT | | | List | | | |
| PLMN List | | | 9.2.3.133 | | | |
| >UE Radio | O | | 9.2.3.138 | | YES | reject |
| Capability ID | | | | | | |
| >MBS | O | | 9.2.1.36 | | YES | ignore |
| Session | | | | | | |
| Information | | | | | | |
| List | | | | | | |
| >5G ProSe | O | | NR UE | This IE applies only if the | YES | ignore |
| UE PC5 | | | Sidelink | UE is authorized for 5G | | |
| Aggregate | | | Aggregate | ProSe services. | | |
| Maximum Bit | | | Maximum Bit | | | |
| Rate | | | Rate | | | |
| | | | 9.2.3.107 | | | |
| >UE Slice | O | | 9.2.3.167 | | YES | ignore |
| Maximum Bit | | | | | | |
| Rate List | | | | | | |
| Trace | O | | 9.2.3.55 | | YES | ignore |
| Activation | | | | | | |
| Masked | O | | 9.2.3.32 | | YES | ignore |
| IMEISV | | | | | | |
| UE History | M | | 9.2.3.64 | | YES | ignore |
| Information | | | | | | |
| UE Context | O | | | | YES | ignore |
| Reference at | | | | | | |
| the S-NG- | | | | | | |
| RAN node | | | | | | |
| >Global NG- | M | | 9.2.2.3 | | — | |
| RAN Node | | | | | | |
| ID | | | | | | |
| >S-NG-RAN | M | | NG-RAN | | — | |
| node UE | | | node UE | | | |
| XnAP ID | | | XnAP ID | | | |
| | | | 9.2.3.16 | | | |
| Conditional | O | | | | YES | reject |
| Handover | | | | | | |
| Information | | | | | | |
| Request | | | | | | |
| >CHO | M | | ENUMERATED | | — | |
| Trigger | | | (CHO- | | | |
| | | | initiation, | | | |
| | | | CHO- replace, | | | |
| | | | . . . ) | | | |
| >Target NG- | C- | | NG-RAN | Allocated at the target NG- | — | |
| RAN node | ifCHOmod | | node UE | RAN node | | |
| UE XnAP ID | | | XnAP ID | | | |
| | | | 9.2.3.16 | | | |
| >Estimated | O | | INTEGER | | — | |
| Arrival | | | (1 . . . 100) | | | |
| Probability | | | | | | |
| NR V2X | O | | 9.2.3.105 | | YES | ignore |
| Services | | | | | | |
| Authorized | | | | | | |
| LTE V2X | O | | 9.2.3.106 | | YES | ignore |
| Services | | | | | | |
| Authorized | | | | | | |
| PC5 QoS | O | | 9.2.3.109 | This IE applies only if the | YES | ignore |
| Parameters | | | | UE is authorized for NR | | |
| | | | | V2X services. | | |
| Mobility | O | | BIT STRING | Information related to the | YES | ignore |
| Information | | | (SIZE (32)) | handover; the source NG- | | |
| | | | | RAN node provides it in | | |
| | | | | order to enable later | | |
| | | | | analysis of the conditions | | |
| | | | | that led to a wrong HO. | | |
| UE History | O | | 9.2.3.110 | | YES | ignore |
| Information | | | | | | |
| from the UE | | | | | | |
| IAB Node | O | | ENUMERATED | | YES | reject |
| Indication | | | (true, . . . ) | | | |
| No PDU | O | | ENUMERATED | This IE applies only if the | YES | ignore |
| Session | | | (true, . . . ) | UE is an IAB-MT. | | |
| Indication | | | | | | |
| Time | O | | 9.2.3.153 | | YES | ignore |
| Synchronisation | | | | | | |
| Assistance | | | | | | |
| Information | | | | | | |
| QMC | O | | 9.2.3.156 | | YES | ignore |
| Configuration | | | | | | |
| Information | | | | | | |
| 5G ProSe | O | | 9.2.3.159 | | YES | ignore |
| Authorized | | | | | | |
| 5G ProSe | O | | 9.2.3.160 | This IE applies only if the | YES | ignore |
| PC5 QoS | | | | UE is authorized for 5G | | |
| Parameters | | | | ProSe services. | | |
| Serving | O | | | indicates serving satellite | | |
| Satellite ID | | | | for UE-to-UE communication | | |
| | | | | using satellite | | |
| Target | O | | | indicates next satellite | | |
| Satellite ID | | | | subsequent to serving | | |
| | | | | satellite for UE-to-UE | | |
| | | | | communication using | | |
| | | | | satellite | | |
| Serving | O | | | indicates spotbeam for | | |
| Satellite | | | | serving satellite | | |
| Beam ID | | | | | | |
| Target | O | | | indicates spotbeam for | | |
| Satellite | | | | target satellite | | |
| Beam ID | | | | | | |
| UE #1 ID | O | | | first UE for UE-to-UE | | |
| | | | | communication using | | |
| | | | | satellite | | |
| | | | | e.g., IMSI, GUTI, | | |
| UE #2 ID | O | | | second UE for UE-to-UE | | |
| | | | | communication using | | |
| | | | | satellite | | |
| Session | O | | | Session ID maintained | | |
| Information | | | | between serving satellite | | |
| | | | | and target satellite. | | |
| | | | | e.g., PDU session | | |
| Bearer | O | | | e.g., DRB ID, SRB ID | | |
| Information | | | | | | |
| Cell | O | | | cell information, | | |
| Information | | | | PCI(physical cell identity), | | |
| | | | | CGI(cell global identity) | | |
| Space Area | O | | | | | |
| Information | | | | | | |
| >Space Area | O | | | indicates a specified space | | |
| id | | | | area | | |
| >height | O | | | a range of space area | | |
| threshold | | | | | | |
| Satellite | O | | | indicates satellite group for | | |
| Group ID | | | | service | | |
| Candidate | O | | | Satellite set within space | | |
| Satellite list | | | | area | | |
| > time | O | | | time interval related to | | |
| interval id | | | | space area | | |
| > satellites | O | | | satellites within space area | | |
| per time | | | | in corresponding time | | |
| interval | | | | interval | | |
| Validity Time | O | | | | | |
| Tracking | O | | | | | |
| Area | | | | | | |
| Information | | | | | | |
| >Tracking | O | | | TAC, TAI, PLMN Identity | | |
| Area List | | | | | | |
| Orbit ID | O | | | indicates orbital. | | |
| | | | | e.g., ephemeris info, | | |
| | | | | semiMajorAxis, eccentricity, | | |
| | | | | periapsis, longitude, | | |
| | | | | inclination, meanAnomaly | | |

For the IEs according to the above Table 6, the 3GPP TS 38.423 standard may be referenced.

According to an embodiment, the first message may be a cell activation request message, and the second message may be a cell activation response message. The satellite 620 may transmit the cell activation request message to the base station 1020 through the XN interface. The base station 1020 may transmit the cell activation response message to the satellite 620 through the XN interface. The cell activation request message may include at least one item of the information in Table 5 above. The cell activation response message may include at least one item of the information in Table 5 above. For example, the first message may include the following IEs as illustrated as an example in Table 7 below.

TABLE 7

| IE/Group | | | IE type and | Semantics | | Assigned |
|---|---|---|---|---|---|---|
| Name | Presence | Range | reference | description | Criticality | Criticality |
| Message | M | | 9.2.3.1 | | YES | reject |
| Type | | | | | | |
| CHOICE | M | | | | YES | reject |
| Served | | | | | | |
| Cells To | | | | | | |
| Activate | | | | | | |
| >NR Cells | | | | | | |
| >>NR | | 1 | | | — | |
| Cells List | | | | | | |
| >>>NR | | 1 . . . | | | — | |
| Cells item | | <maxnoofCellsinNG- | | | | |
| | | RANnode> | | | | |
| >>>>NR | M | | 9.2.2.7 | | — | |
| CGI | | | | | | |
| >E-UTRA | | | | | | |
| Cells | | | | | | |
| >>E-UTRA | | 1 | | | — | |
| Cells List | | | | | | |
| >>>E- | | 1 . . . | | | — | |
| UTRA | | <maxnoofCellsinNG- | | | | |
| Cells item | | RANnode> | | | | |
| >>>>E- | M | | 9.2.2.8 | | — | |
| UTRA CGI | | | | | | |
| Activation | M | | INTEGER | Allocated by | YES | reject |
| ID | | | (0 . . . 255) | the NG-RAN | | |
| | | | | node₁ | | |
| Interface | O | | 9.2.2.39 | | YES | reject |
| Instance | | | | | | |
| Indication | | | | | | |
| Serving | O | | | indicates | | |
| Satellite ID | | | | serving | | |
| | | | | satellite for | | |
| | | | | UE-to-UE | | |
| | | | | communication | | |
| | | | | using satellite | | |
| Target | O | | | indicates next | | |
| Satellite ID | | | | satellite | | |
| | | | | subsequent to | | |
| | | | | serving | | |
| | | | | satellite for | | |
| | | | | UE-to-UE | | |
| | | | | communication | | |
| | | | | using satellite | | |
| Serving | O | | | indicates | | |
| Satellite | | | | spotbeam for | | |
| Beam ID | | | | serving | | |
| | | | | satellite | | |
| Target | O | | | indicates | | |
| Satellite | | | | spotbeam for | | |
| Beam ID | | | | target satellite | | |
| UE #1 ID | O | | | first UE for UE- | | |
| | | | | to-UE | | |
| | | | | communication | | |
| | | | | using satellite | | |
| | | | | e.g., IMSI, | | |
| | | | | GUTI, | | |
| UE #2 ID | O | | | second UE for | | |
| | | | | UE-to-UE | | |
| | | | | communication | | |
| | | | | using satellite | | |
| Session | O | | | Session ID | | |
| Information | | | | maintained | | |
| | | | | between | | |
| | | | | serving | | |
| | | | | satellite and | | |
| | | | | target satellite. | | |
| | | | | e.g., PDU | | |
| | | | | session | | |
| Bearer | O | | | e.g., DRB ID, | | |
| Information | | | | SRB ID | | |
| Cell | O | | | cell | | |
| Information | | | | information, | | |
| | | | | PCI(physical | | |
| | | | | cell identity), | | |
| | | | | CGI(cell global | | |
| | | | | identity) | | |
| Space Area | O | | | | | |
| Information | | | | | | |
| >Space | O | | | indicates a | | |
| Area id | | | | specified | | |
| | | | | space area | | |
| >height | O | | | a range of | | |
| threshold | | | | space area | | |
| Satellite | O | | | indicates | | |
| Group ID | | | | satellite group | | |
| | | | | for service | | |
| Candidate | O | | | Satellite set | | |
| Satellite | | | | within space | | |
| list | | | | area | | |
| > time | O | | | time interval | | |
| interval id | | | | related to | | |
| | | | | space area | | |
| > satellites | O | | | satellites within | | |
| per time | | | | space area in | | |
| interval | | | | corresponding | | |
| | | | | time interval | | |
| Validity | O | | | | | |
| Time | | | | | | |
| Tracking | O | | | | | |
| Area | | | | | | |
| Information | | | | | | |
| >Tracking | O | | | TAC, TAI, | | |
| Area List | | | | PLMN Identity | | |
| Orbit ID | O | | | indicates | | |
| | | | | orbital. | | |
| | | | | e.g., | | |
| | | | | ephemeris info, | | |
| | | | | semiMajorAxis, | | |
| | | | | eccentricity, | | |
| | | | | periapsis, | | |
| | | | | longitude, | | |
| | | | | inclination, | | |
| | | | | meanAnomaly | | |

For the IEs according to Table 7, the 3GPP TS 38.423 standard may be referred to.

According to an embodiment, the first message may be an XN setup request message, and the second message may be an XN setup response message. The satellite 620 may transmit the XN setup request message to the base station 1020 through the XN interface. The base station 1020 may transmit the XN setup response message to the satellite 620 through the XN interface. The XN setup request message may include at least one item of the information in Table 5. The XN setup response message may include at least one item of the information in Table 5. For example, the first message may include the following IEs as exemplified in Table 8.

TABLE 8

| IE/Group | | | IE type and | Semantics | | Assigned |
|---|---|---|---|---|---|---|
| Name | Presence | Range | reference | description | Criticality | Criticality |
| Message | M | | 9.2.3.1 | | YES | reject |
| Type | | | | | | |
| Global NG- | M | | 9.2.2.3 | | YES | reject |
| RAN Node | | | | | | |
| ID | | | | | | |
| TAI Support | M | | 9.2.3.20 | List of | YES | reject |
| List | | | | supported | | |
| | | | | TAs and | | |
| | | | | associated | | |
| | | | | characteristics. | | |
| AMF | M | | 9.2.3.83 | Contains a | YES | reject |
| Region | | | | list of all the | | |
| Information | | | | AMF Regions | | |
| | | | | to which the | | |
| | | | | NG-RAN | | |
| | | | | node | | |
| | | | | belongs. | | |
| List of | | 0 . . . | | Contains a | YES | reject |
| Served | | <maxnoofCellsinNG- | | list of cells | | |
| Cells NR | | RAN node> | | served by the | | |
| | | | | gNB. If a | | |
| | | | | partial list of | | |
| | | | | cells is | | |
| | | | | signalled, it | | |
| | | | | contains at | | |
| | | | | least one cell | | |
| | | | | per carrier | | |
| | | | | configured at | | |
| | | | | the gNB | | |
| >Served | M | | 9.2.2.11 | | — | |
| Cell | | | | | | |
| Information | | | | | | |
| NR | | | | | | |
| >Neighbour | O | | 9.2.2.13 | | — | |
| Information | | | | | | |
| NR | | | | | | |
| >Neighbour | O | | 9.2.2.14 | | — | |
| Information | | | | | | |
| E-UTRA | | | | | | |
| >Served | O | | 9.2.2.102 | | YES | ignore |
| Cell | | | | | | |
| Specific | | | | | | |
| Info | | | | | | |
| Request | | | | | | |
| List of | | 0 . . . | | Contains a | YES | reject |
| Served | | <maxnoofCellsinNG- | | list of cells | | |
| Cells E- | | RAN node> | | served by the | | |
| UTRA | | | | ng-eNB. If a | | |
| | | | | partial list of | | |
| | | | | cells is | | |
| | | | | signalled, it | | |
| | | | | contains at | | |
| | | | | least one cell | | |
| | | | | per carrier | | |
| | | | | configured at | | |
| | | | | the ng-eNB | | |
| >Served | M | | 9.2.2.12 | | — | |
| Cell | | | | | | |
| Information | | | | | | |
| E-UTRA | | | | | | |
| >Neighbour | O | | 9.2.2.13 | | — | |
| Information | | | | | | |
| NR | | | | | | |
| >Neighbour | O | | 9.2.2.14 | | — | |
| Information | | | | | | |
| E-UTRA | | | | | | |
| >SFN | O | | 9.2.2.75 | Associated | YES | ignore |
| Offset | | | | with the | | |
| | | | | ECGI IE in | | |
| | | | | the Served | | |
| | | | | Cell | | |
| | | | | Information | | |
| | | | | E-UTRA IE | | |
| Interface | O | | 9.2.2.39 | | YES | reject |
| Instance | | | | | | |
| Indication | | | | | | |
| TNL | O | | 9.2.3.96 | | YES | ignore |
| Configuration | | | | | | |
| Info | | | | | | |
| Partial List | O | | Partial | Value | YES | ignore |
| Indicator | | | List | “partial” | | |
| NR | | | Indicator | indicates that | | |
| | | | 9.2.2.46 | a partial list | | |
| | | | | of cells is | | |
| | | | | included in | | |
| | | | | the List of | | |
| | | | | Served Cells | | |
| | | | | NR IE. | | |
| Cell and | O | | 9.2.2.41 | Contains NR | YES | ignore |
| Capacity | | | | cell related | | |
| Assistance | | | | assistance | | |
| Information | | | | information. | | |
| NR | | | | | | |
| Partial List | O | | Partial | Value | YES | ignore |
| Indicator E- | | | List | “partial” | | |
| UTRA | | | Indicator | indicates that | | |
| | | | 9.2.2.46 | a partial list | | |
| | | | | of cells is | | |
| | | | | included in | | |
| | | | | the List of | | |
| | | | | Served Cells | | |
| | | | | E-UTRA. | | |
| Cell and | O | | 9.2.2.42 | Contains E- | YES | ignore |
| Capacity | | | | UTRA cell | | |
| Assistance | | | | related | | |
| Information | | | | assistance | | |
| E-UTRA | | | | information. | | |
| Local NG- | O | | 9.2.2.101 | | YES | ignore |
| RAN Node | | | | | | |
| Identifier | | | | | | |
| Neighbour | | 0 . . . | | | YES | ignore |
| NG-RAN | | <maxnoofNeighbour | | | | |
| Node List | | NG-RAN nodes> | | | | |
| >Global | M | | 9.2.2.3 | | — | |
| NG-RAN | | | | | | |
| Node ID | | | | | | |
| >Local NG- | M | | 9.2.2.101 | | — | |
| RAN Node | | | | | | |
| Identifier | | | | | | |
| Serving | O | | | indicates | | |
| Satellite ID | | | | serving | | |
| | | | | satellite for | | |
| | | | | UE-to-UE | | |
| | | | | communication | | |
| | | | | using | | |
| | | | | satellite | | |
| Target | O | | | indicates next | | |
| Satellite ID | | | | satellite | | |
| | | | | subsequent | | |
| | | | | to serving | | |
| | | | | satellite for | | |
| | | | | UE-to-UE | | |
| | | | | communication | | |
| | | | | using | | |
| | | | | satellite | | |
| Serving | O | | | indicates | | |
| Satellite | | | | spotbeam for | | |
| Beam ID | | | | serving | | |
| | | | | satellite | | |
| Target | O | | | indicates | | |
| Satellite | | | | spotbeam for | | |
| Beam ID | | | | target | | |
| | | | | satellite | | |
| UE #1 ID | O | | | first UE for | | |
| | | | | UE-to-UE | | |
| | | | | communication | | |
| | | | | using satellite | | |
| | | | | e.g., IMSI, | | |
| | | | | GUTI, | | |
| UE #2 ID | O | | | second UE | | |
| | | | | for UE-to-UE | | |
| | | | | communication | | |
| | | | | using satellite | | |
| Session | O | | | Session ID | | |
| Information | | | | maintained | | |
| | | | | between | | |
| | | | | serving | | |
| | | | | satellite and | | |
| | | | | target | | |
| | | | | satellite. | | |
| | | | | e.g., PDU | | |
| | | | | session | | |
| Bearer | O | | | e.g., DRB ID, | | |
| Information | | | | SRB ID | | |
| Cell | O | | | cell | | |
| Information | | | | information, | | |
| | | | | PCI(physical | | |
| | | | | cell identity), | | |
| | | | | CGI(cell | | |
| | | | | global | | |
| | | | | identity) | | |
| Space Area | O | | | | | |
| Information | | | | | | |
| >Space | O | | | indicates a | | |
| Area id | | | | specified | | |
| | | | | space area | | |
| >height | O | | | a range of | | |
| threshold | | | | space area | | |
| Satellite | O | | | indicates | | |
| Group ID | | | | satellite | | |
| | | | | group for | | |
| | | | | service | | |
| Candidate | O | | | Satellite set | | |
| Satellite | | | | within space | | |
| list | | | | area | | |
| > time | O | | | time interval | | |
| interval id | | | | related to | | |
| | | | | space area | | |
| > satellites | O | | | satellites | | |
| per time | | | | within space | | |
| interval | | | | area in | | |
| | | | | corresponding | | |
| | | | | time interval | | |
| Validity | O | | | | | |
| Time | | | | | | |
| Tracking | O | | | | | |
| Area | | | | | | |
| Information | | | | | | |
| >Tracking | O | | | TAC, TAI, | | |
| Area List | | | | PLMN | | |
| | | | | Identity | | |
| Orbit ID | O | | | indicates | | |
| | | | | orbital. | | |
| | | | | e.g., | | |
| | | | | ephemeris | | |
| | | | | info, | | |
| | | | | semiMajorAxis, | | |
| | | | | eccentricity, | | |
| | | | | periapsis, | | |
| | | | | longitude, | | |
| | | | | inclination, | | |
| | | | | meanAnomaly | | |

For the IEs according to the above Table 8, the 3GPP TS 38.423 standard may be referred to.

According to an embodiment, the first message may be an NG-RAN node configuration update message, and the second message may be an NG-RAN node configuration update confirmation message. The satellite 620 may transmit the NG-RAN node configuration update message to the base station 1020 through the XN interface. The base station 1020 may transmit the NG-RAN node configuration update confirmation message to the satellite 620 through the XN interface. The NG-RAN node configuration update message may include at least one item of the information in Table 5. The NG-RAN node configuration update confirmation message may include at least one item of the information in Table 5. For example, the first message may include the following IEs as exemplified in Table 9.

TABLE 9

| IE/Group | | | IE type and | Semantics | | Assigned |
|---|---|---|---|---|---|---|
| Name | Presence | Range | reference | description | Criticality | Criticality |
| Message | M | | 9.2.3.1 | | YES | reject |
| Type | | | | | | |
| TAI | O | | 9.2.3.20 | List of | GLOBAL | reject |
| Support | | | | supported | | |
| List | | | | TAs | | |
| | | | | and | | |
| | | | | associated | | |
| | | | | characteristics. | | |
| CHOICE | M | | | | YES | ignore |
| Initiating | | | | | | |
| Node Type | | | | | | |
| >gNB | | | | | | |
| >>Served | O | | 9.2.2.15 | | YES | ignore |
| Cells | | | | | | |
| To | | | | | | |
| Update | | | | | | |
| NR | | | | | | |
| >>Cell | O | | 9.2.2.17 | | YES | ignore |
| Assistance | | | | | | |
| Information | | | | | | |
| NR | | | | | | |
| >>Cell | O | | 9.2.2.43 | | YES | ignore |
| Assistance | | | | | | |
| Information | | | | | | |
| E-UTRA | | | | | | |
| >>Served | O | | 9.2.2.102 | | YES | ignore |
| Cell | | | | | | |
| Specific | | | | | | |
| Info | | | | | | |
| Request | | | | | | |
| >ng-eNB | | | | | | |
| >>Served | O | | 9.2.2.16 | | YES | ignore |
| Cells | | | | | | |
| to | | | | | | |
| Update | | | | | | |
| E-UTRA | | | | | | |
| >>Cell | O | | 9.2.2.17 | | YES | ignore |
| Assistance | | | | | | |
| Information | | | | | | |
| NR | | | | | | |
| >>Cell | O | | 9.2.2.43 | | YES | ignore |
| Assistance | | | | | | |
| Information | | | | | | |
| E-UTRA | | | | | | |
| TNLA | | 0 . . . 1 | | | YES | ignore |
| To Add | | | | | | |
| List | | | | | | |
| >TNLA | | 1 . . . | | | — | |
| To Add | | <maxnoofTNLAssociations> | | | | |
| Item | | | | | | |
| >>TNLA | M | | CP | CP | — | |
| Transport | | | Transport | Transport | | |
| Layer | | | Layer | Layer | | |
| Information | | | Information | Information | | |
| | | | 9.2.3.31 | of | | |
| | | | | NG-RAN | | |
| | | | | node₁ | | |
| >>TNL | M | | 9.2.3.84 | | — | |
| Association | | | | | | |
| Usage | | | | | | |
| TNLA | | 0 . . . 1 | | | YES | ignore |
| To | | | | | | |
| Update | | | | | | |
| List | | | | | | |
| >TNLA | | 1 . . . | | | — | |
| To | | <maxnoofTNLAssociations> | | | | |
| Update | | | | | | |
| Item | | | | | | |
| >>TNLA | M | | CP | CP | — | |
| Transport | | | Transport | Transport | | |
| Layer | | | Layer | Layer | | |
| Information | | | Information | Information | | |
| | | | 9.2.3.31 | of | | |
| | | | | NG-RAN | | |
| | | | | node₁ | | |
| >>TNL | O | | 9.2.3.84 | | — | |
| Association | | | | | | |
| Usage | | | | | | |
| TNLA | | 0 . . . 1 | | | YES | ignore |
| To | | | | | | |
| Remove | | | | | | |
| List | | | | | | |
| >TNLA | | 1 . . . | | | — | |
| To | | <maxnoofTNLAssociations> | | | | |
| Remove | | | | | | |
| Item | | | | | | |
| >>TNLA | M | | CP | CP | — | |
| Transport | | | Transport | Transport | | |
| Layer | | | Layer | Layer | | |
| Information | | | Information | Information | | |
| | | | 9.2.3.31 | of | | |
| | | | | NG-RAN | | |
| | | | | node₁ | | |
| Global | O | | 9.2.2.3 | | YES | reject |
| NG-RAN | | | | | | |
| Node ID | | | | | | |
| AMF | O | | AMF Region | List of all | YES | reject |
| Region | | | Information | added | | |
| Information | | | 9.2.3.83 | AMF | | |
| To | | | | Regions | | |
| Add | | | | to which | | |
| | | | | the NG- | | |
| | | | | RAN | | |
| | | | | node | | |
| | | | | belongs. | | |
| AMF | O | | AMF Region | List of all | YES | reject |
| Region | | | Information | deleted | | |
| Information | | | 9.2.3.83 | AMF | | |
| To | | | | Regions | | |
| Delete | | | | to which | | |
| | | | | the NG- | | |
| | | | | RAN | | |
| | | | | node | | |
| | | | | belongs. | | |
| Interface | O | | 9.2.2.39 | | YES | reject |
| Instance | | | | | | |
| Indication | | | | | | |
| TNL | O | | 9.2.3.96 | | YES | ignore |
| Configuration | | | | | | |
| Info | | | | | | |
| Coverage | | 0 . . . 1 | | List of | GLOBAL | reject |
| Modification | | | | cells with | | |
| List | | | | modified | | |
| | | | | coverage. | | |
| >Coverage | | 0 . . . | | | — | |
| Modification | | <maxnoofCellsinNG- | | | | |
| Item | | RAN node> | | | | |
| >>Global | M | | Global NG- | NG-RAN | — | |
| NG-RAN | | | RAN Cell | Cell | | |
| Cell | | | Identity | Global | | |
| Identity | | | 9.2.2.27 | Identifier | | |
| | | | | of the | | |
| | | | | cell to be | | |
| | | | | modified. | | |
| >>Cell | M | | INTEGER | Value ‘0’ | — | |
| Coverage | | | (0 . . . 63, . . . ) | indicates | | |
| State | | | | that the | | |
| | | | | cell is | | |
| | | | | inactive. | | |
| | | | | Other | | |
| | | | | values | | |
| | | | | Indicates | | |
| | | | | that the | | |
| | | | | cell is | | |
| | | | | active | | |
| | | | | and also | | |
| | | | | indicates | | |
| | | | | the | | |
| | | | | coverage | | |
| | | | | configuration | | |
| | | | | of the | | |
| | | | | concerned | | |
| | | | | cell. | | |
| >>Cell | O | | ENUMERATED | Indicates | — | |
| Deployment | | | (pre-change- | the Cell | | |
| Status | | | notification, . . . ) | Coverage | | |
| Indicator | | | | State is | | |
| | | | | planned | | |
| | | | | to be | | |
| | | | | used at | | |
| | | | | the next | | |
| | | | | reconfiguration. | | |
| >>Cell | C- | | | | — | |
| Replacing | ifCellDeploymentStatus- | | | | | |
| Info | IndicatorPresent | | | | | |
| >>>Replacing | | 0 . . . | | | — | |
| Cells | | <maxnoofCellsinNG- | | | | |
| | | RAN node> | | | | |
| >>>>Global | | | Global NG- | NG-RAN | — | |
| NG- | | | RAN Cell | Cell | | |
| RAN | | | Identity | Global | | |
| Cell | | | 9.2.2.27 | Identifier | | |
| Identity | | | | of a cell | | |
| | | | | that may | | |
| | | | | replace | | |
| | | | | all or part | | |
| | | | | of the | | |
| | | | | coverage | | |
| | | | | of the | | |
| | | | | cell to be | | |
| | | | | modified. | | |
| >>SSB | | 0 . . . 1 | | List of | — | |
| Coverage | | | | SSB | | |
| Modification | | | | beams | | |
| List | | | | with | | |
| | | | | modified | | |
| | | | | coverage. | | |
| >>>SSB | | 0 . . . | | | — | |
| Coverage | | <maxnoofSSBAreas> | | | | |
| Modification | | | | | | |
| Item | | | | | | |
| >>>>SSB | M | | INTEGER | Identifier | — | |
| Index | | | (0 . . . 63) | of the | | |
| | | | | SSB | | |
| | | | | beam to | | |
| | | | | be | | |
| | | | | modified. | | |
| >>>>SSB | M | | INTEGER | Value ‘0’ | — | |
| Coverage | | | (0 . . . 15, . . . ) | indicates | | |
| State | | | | that the | | |
| | | | | SSB | | |
| | | | | beam is | | |
| | | | | inactive. | | |
| | | | | Other | | |
| | | | | values | | |
| | | | | Indicates | | |
| | | | | that the | | |
| | | | | SSB | | |
| | | | | beam is | | |
| | | | | active | | |
| | | | | and also | | |
| | | | | indicates | | |
| | | | | the | | |
| | | | | coverage | | |
| | | | | configuration | | |
| | | | | of the | | |
| | | | | concerned | | |
| | | | | SSB | | |
| | | | | beam. | | |
| >>Coverage | O | | ENUMERATED | Indicates | YES | ignore |
| Modification | | | (coverage, | the | | |
| Cause | | | cell edge | reason | | |
| | | | capacity, . . . ) | for the | | |
| | | | | coverage | | |
| | | | | modification | | |
| | | | | in NG-RAN | | |
| | | | | node₁. | | |
| Local | O | | 9.2.2.101 | | YES | ignore |
| NG-RAN | | | | | | |
| Node | | | | | | |
| Identifier | | | | | | |
| Neighbour | | 0 . . . | | | YES | ignore |
| NG-RAN | | <maxnoofNeighbourNG- | | | | |
| Node | | RAN nodes> | | | | |
| List | | | | | | |
| >Global | M | | 9.2.2.3 | | — | |
| NG-RAN | | | | | | |
| Node ID | | | | | | |
| >Local | M | | 9.2.2.101 | | — | |
| NG-RAN | | | | | | |
| Node | | | | | | |
| Identifier | | | | | | |
| Local | O | | Local NG- | | YES | ignore |
| NG-RAN | | | RAN Node | | | |
| Node | | | Identifier | | | |
| Identifier | | | 9.2.2.101 | | | |
| Removal | | | | | | |
| Serving | O | | | indicates | | |
| Satellite | | | | serving | | |
| ID | | | | satellite | | |
| | | | | for UE- | | |
| | | | | to-UE | | |
| | | | | communication | | |
| | | | | using | | |
| | | | | satellite | | |
| Target | O | | | indicates | | |
| Satellite | | | | next | | |
| ID | | | | satellite | | |
| | | | | subsequent | | |
| | | | | to serving | | |
| | | | | satellite | | |
| | | | | for UE- | | |
| | | | | to-UE | | |
| | | | | communication | | |
| | | | | using | | |
| | | | | satellite | | |
| Serving | O | | | indicates | | |
| Satellite | | | | spotbeam | | |
| Beam ID | | | | for serving | | |
| | | | | satellite | | |
| Target | O | | | indicates | | |
| Satellite | | | | spotbeam | | |
| Beam ID | | | | for target | | |
| | | | | satellite | | |
| UE #1 | O | | | first UE | | |
| ID | | | | for UE- | | |
| | | | | to-UE | | |
| | | | | communication | | |
| | | | | using | | |
| | | | | satellite | | |
| | | | | e.g., | | |
| | | | | IMSI, | | |
| | | | | GUTI, | | |
| UE #2 | O | | | second | | |
| ID | | | | UE for | | |
| | | | | UE-to- | | |
| | | | | UE | | |
| | | | | communication | | |
| | | | | using | | |
| | | | | satellite | | |
| Session | O | | | Session | | |
| Information | | | | ID | | |
| | | | | maintained | | |
| | | | | between | | |
| | | | | serving | | |
| | | | | satellite | | |
| | | | | and | | |
| | | | | target | | |
| | | | | satellite. | | |
| | | | | e.g., | | |
| | | | | PDU | | |
| | | | | session | | |
| Bearer | O | | | e.g., | | |
| Information | | | | DRB ID, | | |
| | | | | SRB ID | | |
| Cell | O | | | cell | | |
| Information | | | | information, | | |
| | | | | PCI(physical | | |
| | | | | cell | | |
| | | | | identity), | | |
| | | | | CGI(cell | | |
| | | | | global | | |
| | | | | identity) | | |
| Space | O | | | | | |
| Area | | | | | | |
| Information | | | | | | |
| >Space | O | | | indicates a | | |
| Area id | | | | specified | | |
| | | | | space | | |
| | | | | area | | |
| >height | O | | | a range | | |
| threshold | | | | of space | | |
| | | | | area | | |
| Satellite | O | | | indicates | | |
| Group | | | | satellite | | |
| ID | | | | group for | | |
| | | | | service | | |
| Candidate | O | | | Satellite | | |
| Satellite | | | | set within | | |
| list | | | | space | | |
| | | | | area | | |
| >time | O | | | time | | |
| interval | | | | interval | | |
| id | | | | related to | | |
| | | | | space | | |
| | | | | area | | |
| >satellites | O | | | satellites | | |
| per time | | | | within | | |
| interval | | | | space | | |
| | | | | area in | | |
| | | | | corresponding | | |
| | | | | time | | |
| | | | | interval | | |
| Validity | O | | | | | |
| Time | | | | | | |
| Tracking | O | | | | | |
| Area | | | | | | |
| Information | | | | | | |
| >Tracking | O | | | TAC, | | |
| Area | | | | TAI, | | |
| List | | | | PLMN | | |
| | | | | Identity | | |
| Orbit ID | O | | | indicates | | |
| | | | | orbital. | | |
| | | | | e.g., | | |
| | | | | ephemeris | | |
| | | | | info, | | |
| | | | | semiMajorAxis, | | |
| | | | | eccentricity, | | |
| | | | | periapsis, | | |
| | | | | longitude, | | |
| | | | | inclination, | | |
| | | | | meanAnomaly | | |

For the IEs according to the above Table 9, the 3GPP TS 38.423 standard may be referred to.

According to an embodiment, the first message may be an S-node addition request message, and the second message may be an S-node addition response message. The satellite 620 may transmit the S-node addition request message to the base station 1020 through the XN interface. The base station 1020 may transmit the S-node addition response message to the satellite 620 through the XN interface. The S-node addition request message may include at least one item of the information in Table 5. The S-node addition response message may include at least one item of the information in Table 5. For example, the first message may include the following IEs as exemplified in Table 10.

TABLE 10

| IE/Group | | | IE type and | Semantics | | Assigned |
|---|---|---|---|---|---|---|
| Name | Presence | Range | reference | description | Criticality | Criticality |
| Message | M | | 9.2.3.1 | | YES | reject |
| Type | | | | | | |
| M-NG-RAN | M | | NG-RAN | Allocated at | YES | reject |
| node UE | | | node UE | the M-NG- | | |
| XnAP ID | | | XnAP ID | RAN node | | |
| | | | 9.2.3.16 | | | |
| UE Security | M | | 9.2.3.49 | | YES | reject |
| Capabilities | | | | | | |
| S-NG-RAN | M | | 9.2.3.51 | | YES | reject |
| node | | | | | | |
| Security Key | | | | | | |
| S-NG-RAN | M | | UE | The UE | YES | reject |
| node UE | | | Aggregate | Aggregate | | |
| Aggregate | | | Maximum | Maximum | | |
| Maximum | | | Bit Rate | Bit Rate is | | |
| Bit Rate | | | 9.2.3.17 | split into M- | | |
| | | | | NG-RAN | | |
| | | | | node UE | | |
| | | | | Aggregate | | |
| | | | | Maximum | | |
| | | | | Bit Rate and | | |
| | | | | S-NG-RAN | | |
| | | | | node UE | | |
| | | | | Aggregate | | |
| | | | | Maximum | | |
| | | | | Bit Rate | | |
| | | | | which are | | |
| | | | | enforced by | | |
| | | | | M-NG-RAN | | |
| | | | | node and S- | | |
| | | | | NG-RAN | | |
| | | | | node | | |
| | | | | respectively. | | |
| Selected | O | | PLMN | The | YES | ignore |
| PLMN | | | Identity | selected | | |
| | | | 9.2.2.4 | PLMN of | | |
| | | | | the SCG in | | |
| | | | | the S-NG- | | |
| | | | | RAN node. | | |
| Mobility | O | | 9.2.3.53 | | YES | ignore |
| Restriction | | | | | | |
| List | | | | | | |
| Index to | O | | 9.2.3.23 | | YES | reject |
| RAT/ | | | | | | |
| Frequency | | | | | | |
| Selection | | | | | | |
| Priority | | | | | | |
| PDU | | 1 | | | YES | reject |
| Session | | | | | | |
| Resources | | | | | | |
| To Be | | | | | | |
| Added List | | | | | | |
| >PDU | | 1 . . . | | NOTE: If | — | |
| Session | | <maxnoofPDUSessions> | | neither the | | |
| Resources | | | | PDU | | |
| To Be | | | | Session | | |
| Added Item | | | | Resource | | |
| | | | | Setup Info - | | |
| | | | | SN | | |
| | | | | terminated | | |
| | | | | IE | | |
| | | | | nor the | | |
| | | | | PDU | | |
| | | | | Session | | |
| | | | | Resource | | |
| | | | | Setup Info - | | |
| | | | | MN | | |
| | | | | terminated | | |
| | | | | IE | | |
| | | | | is present in | | |
| | | | | a PDU | | |
| | | | | Session | | |
| | | | | Resources | | |
| | | | | To Be | | |
| | | | | Added Item | | |
| | | | | IE, | | |
| | | | | abnormal | | |
| | | | | conditions | | |
| | | | | as specified | | |
| | | | | in clause | | |
| | | | | 8.3.1.4 | | |
| | | | | apply. | | |
| >>PDU | M | | 9.2.3.18 | | — | |
| Session ID | | | | | | |
| >>S-NSSAI | M | | 9.2.3.21 | | — | |
| >>S-NG- | O | | PDU | | — | |
| RAN node | | | Session | | | |
| PDU | | | Aggregate | | | |
| Session | | | Maximum | | | |
| Aggregate | | | Bit Rate | | | |
| Maximum | | | 9.2.3.69 | | | |
| Bit Rate | | | | | | |
| >>PDU | O | | 9.2.1.5 | | — | |
| Session | | | | | | |
| Resource | | | | | | |
| Setup Info - | | | | | | |
| SN | | | | | | |
| terminated | | | | | | |
| >>PDU | O | | 9.2.1.7 | | — | |
| Session | | | | | | |
| Resource | | | | | | |
| Setup Info - | | | | | | |
| MN | | | | | | |
| terminated | | | | | | |
| M-NG-RAN | M | | OCTET | Includes the | YES | reject |
| node to S- | | | STRING | CG- | | |
| NG-RAN | | | | ConfigInfo | | |
| node | | | | message as | | |
| Container | | | | defined in | | |
| | | | | subclause | | |
| | | | | 11.2.2 of TS | | |
| | | | | 38.331 [10] | | |
| S-NG-RAN | O | | NG-RAN | Allocated at | YES | reject |
| node UE | | | node UE | the S-NG- | | |
| XnAP ID | | | XnAP ID | RAN node | | |
| | | | 9.2.3.16 | | | |
| Expected | O | | 9.2.3.81 | | YES | ignore |
| UE | | | | | | |
| Behaviour | | | | | | |
| Requested | O | | ENUMERATED | Indicates | YES | reject |
| Split SRBs | | | (srb1, | that | | |
| | | | srb2, | resources | | |
| | | | srb1&2, . . . ) | for Split | | |
| | | | | SRBs are | | |
| | | | | requested. | | |
| PCell ID | O | | Global NG- | | YES | reject |
| | | | RAN Cell | | | |
| | | | Identity | | | |
| | | | 9.2.2.27 | | | |
| Desired | O | | 9.2.3.77 | | YES | ignore |
| Activity | | | | | | |
| Notification | | | | | | |
| Level | | | | | | |
| Available | C- | | DRB List | Indicates | YES | reject |
| DRB IDs | ifSNterminated | | 9.2.1.29 | the list of | | |
| | | | | DRB IDs | | |
| | | | | that the S- | | |
| | | | | NG-RAN | | |
| | | | | node may | | |
| | | | | use for SN- | | |
| | | | | terminated | | |
| | | | | bearers. | | |
| S-NG-RAN | O | | Bit Rate | The S-NG- | YES | reject |
| node | | | 9.2.3.4 | RAN node | | |
| Maximum | | | | Maximum | | |
| Integrity | | | | Integrity | | |
| Protected | | | | Protected | | |
| Data Rate | | | | Data Rate | | |
| Uplink | | | | Uplink is a | | |
| | | | | portion of | | |
| | | | | the UE's | | |
| | | | | Maximum | | |
| | | | | Integrity | | |
| | | | | Protected | | |
| | | | | Data Rate | | |
| | | | | in the | | |
| | | | | Uplink, | | |
| | | | | which is | | |
| | | | | enforced by | | |
| | | | | the S-NG- | | |
| | | | | RAN node | | |
| | | | | for the UE's | | |
| | | | | SN | | |
| | | | | terminated | | |
| | | | | PDU | | |
| | | | | sessions. If | | |
| | | | | the S-NG- | | |
| | | | | RAN node | | |
| | | | | Maximum | | |
| | | | | Integrity | | |
| | | | | Protected | | |
| | | | | Data Rate | | |
| | | | | Downlink IE | | |
| | | | | is not | | |
| | | | | present, this | | |
| | | | | IE applies to | | |
| | | | | both UL and | | |
| | | | | DL. | | |
| S-NG-RAN | O | | Bit Rate | The S-NG- | YES | reject |
| node | | | 9.2.3.4 | RAN node | | |
| Maximum | | | | Maximum | | |
| Integrity | | | | Integrity | | |
| Protected | | | | Protected | | |
| Data Rate | | | | Data Rate | | |
| Downlink | | | | Downlink is | | |
| | | | | a portion of | | |
| | | | | the UE's | | |
| | | | | Maximum | | |
| | | | | Integrity | | |
| | | | | Protected | | |
| | | | | Data Rate | | |
| | | | | in the | | |
| | | | | Downlink, | | |
| | | | | which is | | |
| | | | | enforced by | | |
| | | | | the S-NG- | | |
| | | | | RAN node | | |
| | | | | for the UE's | | |
| | | | | SN | | |
| | | | | terminated | | |
| | | | | PDU | | |
| | | | | sessions. | | |
| Location | O | | ENUMERATED | Indicates | YES | ignore |
| Information | | | (pscell, . . . ) | that the | | |
| at S-NODE | | | | user's | | |
| reporting | | | | Location | | |
| | | | | Information | | |
| | | | | at S-NODE | | |
| | | | | is to be | | |
| | | | | provided. | | |
| MR-DC | O | | 9.2.2.33 | Information | YES | ignore |
| Resource | | | | used to | | |
| Coordination | | | | coordinate | | |
| Information | | | | resource | | |
| | | | | utilisation | | |
| | | | | between M- | | |
| | | | | NG-RAN | | |
| | | | | node and S- | | |
| | | | | NG-RAN | | |
| | | | | node. | | |
| Masked | O | | 9.2.3.32 | | YES | ignore |
| IMEISV | | | | | | |
| NE-DC TDM | O | | 9.2.2.38 | | YES | ignore |
| Pattern | | | | | | |
| SN Addition | O | | ENUMERATED | This IE | YES | reject |
| Trigger | | | (SN change, | indicates | | |
| Indication | | | inter-MN | the trigger | | |
| | | | HO, intra- | for S-NG- | | |
| | | | MN HO, . . . ) | RAN node | | |
| | | | | Addition | | |
| | | | | Preparation | | |
| | | | | procedure | | |
| Trace | O | | 9.2.3.55 | | YES | ignore |
| Activation | | | | | | |
| Requested | O | | ENUMERATED | Indicates | YES | ignore |
| Fast MCG | | | (true, . . . ) | that the | | |
| recovery via | | | | resources | | |
| SRB3 | | | | for fast | | |
| | | | | MCG | | |
| | | | | recovery via | | |
| | | | | SRB3 are | | |
| | | | | requested. | | |
| UE Radio | O | | 9.2.3.138 | | YES | reject |
| Capability ID | | | | | | |
| Source NG- | O | | Global NG- | The NG- | YES | ignore |
| RAN Node | | | RAN Node | RAN Node | | |
| ID | | | ID | ID of the | | |
| | | | 9.2.2.3 | source NG- | | |
| | | | | RAN node | | |
| | | | | or the | | |
| | | | | source SN. | | |
| Management | O | | MDT PLMN | | YES | ignore |
| Based | | | List | | | |
| MDT PLMN | | | 9.2.3.133 | | | |
| List | | | | | | |
| UE History | O | | 9.2.3.64 | | YES | ignore |
| Information | | | | | | |
| UE History | O | | 9.2.3.110 | | YES | ignore |
| Information | | | | | | |
| from the UE | | | | | | |
| PSCell | O | | ENUMERATED | | YES | ignore |
| Change | | | (reporting | | | |
| History | | | full | | | |
| | | | history, . . . ) | | | |
| IAB Node | O | | ENUMERATED | | YES | reject |
| Indication | | | (true, . . . ) | | | |
| No PDU | O | | ENUMERATED | This IE | YES | ignore |
| Session | | | (true, . . . ) | applies only | | |
| Indication | | | | if the UE is | | |
| | | | | an IAB-MT. | | |
| CHO | O | | | | YES | reject |
| Information | | | | | | |
| SN | | | | | | |
| Addition | | | | | | |
| >Source M- | M | | Global NG- | | — | |
| NG-RAN | | | RAN Node | | | |
| node ID | | | ID | | | |
| | | | 9.2.2.3 | | | |
| >Source M- | M | | NG-RAN | Allocated at | — | |
| NG-RAN | | | node UE | the source | | |
| node UE | | | XnAP ID | M-NG-RAN | | |
| XnAP ID | | | 9.2.3.16 | node | | |
| >Estimated | O | | INTEGER | | — | |
| Arrival | | | (1 . . . 100) | | | |
| Probability | | | | | | |
| SCG | O | | 9.2.3.154 | | YES | ignore |
| Activation | | | | | | |
| Request | | | | | | |
| Conditional | O | | | | YES | reject |
| PSCell | | | | | | |
| Addition | | | | | | |
| Information | | | | | | |
| Request | | | | | | |
| >Maximum | M | | INTEGER | Indicates | — | |
| Number of | | | (1 . . . 8, . . . ) | the | | |
| PSCells To | | | | maximum | | |
| Prepare | | | | number of | | |
| | | | | PSCells that | | |
| | | | | the target | | |
| | | | | SN may | | |
| | | | | prepare. | | |
| >Estimated | O | | INTEGER | Indicates | — | |
| Arrival | | | (1 . . . 100) | the arrival | | |
| Probability | | | | probability | | |
| | | | | for the UE | | |
| | | | | towards the | | |
| | | | | candidate | | |
| | | | | target SN. | | |
| S-NG-RAN | O | | UE Slice | This IE | YES | reject |
| node UE | | | Maximum | indicates | | |
| Slice | | | Bit Rate List | the S-NG- | | |
| Maximum | | | 9.2.3.167 | RAN node | | |
| Bit Rate | | | | portion of | | |
| | | | | the UE Slice | | |
| | | | | Aggregate | | |
| | | | | Maximum | | |
| | | | | Bit Rate as | | |
| | | | | specified in | | |
| | | | | TS 23.501 | | |
| | | | | [7] | | |
| F1- | O | | ENUMERATED | This IE | YES | reject |
| terminating | | | (true, . . . ) | applies only | | |
| IAB-donor | | | | if the UE is | | |
| Indicator | | | | an IAB-MT. | | |
| Serving | O | | | indicates | | |
| Satellite ID | | | | serving | | |
| | | | | satellite for | | |
| | | | | UE-to-UE | | |
| | | | | communication | | |
| | | | | using | | |
| | | | | satellite | | |
| Target | O | | | indicates | | |
| Satellite ID | | | | next | | |
| | | | | satellite | | |
| | | | | subsequent | | |
| | | | | to serving | | |
| | | | | satellite for | | |
| | | | | UE-to-UE | | |
| | | | | communication | | |
| | | | | using | | |
| | | | | satellite | | |
| Serving | O | | | indicates | | |
| Satellite | | | | spotbeam | | |
| Beam ID | | | | for serving | | |
| | | | | satellite | | |
| Target | O | | | indicates | | |
| Satellite | | | | spotbeam | | |
| Beam ID | | | | for target | | |
| | | | | satellite | | |
| UE #1 ID | O | | | first UE for | | |
| | | | | UE-to-UE | | |
| | | | | communication | | |
| | | | | using | | |
| | | | | satellite | | |
| | | | | e.g., IMSI, | | |
| | | | | GUTI, | | |
| UE #2 ID | O | | | second UE | | |
| | | | | for UE-to- | | |
| | | | | UE | | |
| | | | | communication | | |
| | | | | using | | |
| | | | | satellite | | |
| Session | O | | | Session ID | | |
| Information | | | | maintained | | |
| | | | | between | | |
| | | | | serving | | |
| | | | | satellite and | | |
| | | | | target | | |
| | | | | satellite. | | |
| | | | | e.g., PDU | | |
| | | | | session | | |
| Bearer | O | | | e.g., DRB | | |
| Information | | | | ID, SRB ID | | |
| Cell | O | | | cell | | |
| Information | | | | information, | | |
| | | | | PCI(physical | | |
| | | | | cell | | |
| | | | | identity), | | |
| | | | | CGI(cell | | |
| | | | | global | | |
| | | | | identity) | | |
| Space Area | O | | | | | |
| Information | | | | | | |
| >Space | O | | | indicates a | | |
| Area id | | | | specified | | |
| | | | | space area | | |
| >height | O | | | a range of | | |
| threshold | | | | space area | | |
| Satellite | O | | | indicates | | |
| Group ID | | | | satellite | | |
| | | | | group for | | |
| | | | | service | | |
| Candidate | O | | | Satellite set | | |
| Satellite list | | | | within space | | |
| | | | | area | | |
| >time | O | | | time interval | | |
| interval id | | | | related to | | |
| | | | | space area | | |
| >satellites | O | | | satellites | | |
| per time | | | | within space | | |
| interval | | | | area in | | |
| | | | | corresponding | | |
| | | | | time | | |
| | | | | interval | | |
| Validity | O | | | | | |
| Time | | | | | | |
| Tracking | O | | | | | |
| Area | | | | | | |
| Information | | | | | | |
| >Tracking | O | | | TAC, TAI, | | |
| Area List | | | | PLMN | | |
| | | | | Identity | | |
| Orbit ID | O | | | indicates | | |
| | | | | orbital. | | |
| | | | | e.g., | | |
| | | | | ephemeris | | |
| | | | | info, | | |
| | | | | semiMajorAxis, | | |
| | | | | eccentricity, | | |
| | | | | periapsis, | | |
| | | | | longitude, | | |
| | | | | inclination, | | |
| | | | | meanAnomaly | | |

For the IEs according to the above Table 10, the 3GPP TS 38.423 standard may be referred to.

According to an embodiment, the first message may be an S-node modification request message, and the second message may be an S-node modification response message. The satellite 620 may transmit the S-node modification request message to the base station 1020 through the XN interface. The base station 1020 may transmit the S-node modification response message to the satellite 620 through the XN interface. The S-node modification request message may include at least one item of the information in Table 5. The S-node modification response message may include at least one item of the information in Table 5. For example, the first message may include the following IEs as exemplified in Table 11 below.

TABLE 11

| IE/Group | | | IE type and | Semantics | | Assigned |
|---|---|---|---|---|---|---|
| Name | Presence | Range | reference | description | Criticality | Criticality |
| Message | M | | 9.2.3.1 | | YES | reject |
| Type | | | | | | |
| M-NG-RAN | M | | NG-RAN | Allocated at | YES | reject |
| node UE | | | node UE | the M-NG- | | |
| XnAP ID | | | XnAP ID | RAN node | | |
| | | | 9.2.3.16 | | | |
| S-NG-RAN | M | | NG-RAN | Allocated at | YES | reject |
| node UE | | | node UE | the S-NG- | | |
| XnAP ID | | | XnAP ID | RAN node | | |
| | | | 9.2.3.16 | | | |
| Cause | M | | 9.2.3.2 | | YES | ignore |
| PDCP | O | | 9.2.3.74 | | YES | ignore |
| Change | | | | | | |
| Indication | | | | | | |
| Selected | O | | PLMN | The | YES | ignore |
| PLMN | | | Identity | selected | | |
| | | | 9.2.2.4 | PLMN of the | | |
| | | | | SCG in the | | |
| | | | | S-NG-RAN | | |
| | | | | node. | | |
| Mobility | O | | 9.2.3.53 | | YES | ignore |
| Restriction | | | | | | |
| List | | | | | | |
| SCG | O | | 9.2.3.27 | | YES | ignore |
| Configuration | | | | | | |
| Query | | | | | | |
| UE Context | | 0 . . . 1 | | | YES | reject |
| Information | | | | | | |
| >UE Security | O | | 9.2.3.49 | | — | |
| Capabilities | | | | | | |
| >S-NG-RAN | O | | 9.2.3.51 | | — | |
| node | | | | | | |
| Security Key | | | | | | |
| >S-NG-RAN | O | | UE | | — | |
| node UE | | | Aggregate | | | |
| Aggregate | | | Maximum | | | |
| Maximum Bit | | | Bit Rate | | | |
| Rate | | | 9.2.3.17 | | | |
| >Index to | | | 9.2.3.23 | | — | |
| RAT/ | | | | | | |
| Frequency | | | | | | |
| Selection | | | | | | |
| Priority | | | | | | |
| >Lower | O | | 9.2.3.60 | | — | |
| Layer | | | | | | |
| presence | | | | | | |
| status | | | | | | |
| change | | | | | | |
| >PDU | | 0 . . . 1 | | | — | |
| Session | | | | | | |
| Resources | | | | | | |
| To Be | | | | | | |
| Added List | | | | | | |
| >>PDU | | 1 . . . | | NOTE: If | — | |
| Session | | <maxnoofPDUSessions> | | neither the | | |
| Resources | | | | PDU | | |
| To Be | | | | Session | | |
| Added Item | | | | Resource | | |
| | | | | Setup Info - | | |
| | | | | SN | | |
| | | | | terminated | | |
| | | | | IE | | |
| | | | | nor the | | |
| | | | | PDU | | |
| | | | | Session | | |
| | | | | Resource | | |
| | | | | Setup Info - | | |
| | | | | MN | | |
| | | | | terminated | | |
| | | | | IE | | |
| | | | | is present in | | |
| | | | | a PDU | | |
| | | | | Session | | |
| | | | | Resources | | |
| | | | | To Be | | |
| | | | | Added Item | | |
| | | | | IE, | | |
| | | | | abnormal | | |
| | | | | conditions | | |
| | | | | as specified | | |
| | | | | in clause | | |
| | | | | 8.3.3.4 | | |
| | | | | apply. | | |
| >>>PDU | M | | 9.2.3.18 | | — | |
| Session ID | | | | | | |
| >>>S-NSSAI | M | | 9.2.3.21 | | — | |
| >>>S-NG- | O | | PDU | | — | |
| RAN node | | | Session | | | |
| PDU | | | Aggregate | | | |
| Session | | | Maximum | | | |
| Aggregate | | | Bit Rate | | | |
| Maximum Bit | | | 9.2.3.69 | | | |
| Rate | | | | | | |
| >>>PDU | O | | 9.2.1.5 | | — | |
| Session | | | | | | |
| Resource | | | | | | |
| Setup Info - | | | | | | |
| SN | | | | | | |
| terminated | | | | | | |
| >>>PDU | O | | 9.2.1.7 | | — | |
| Session | | | | | | |
| Resource | | | | | | |
| Setup Info - | | | | | | |
| MN | | | | | | |
| terminated | | | | | | |
| >>>PDU | O | | Expected | Expected | YES | ignore |
| Session | | | UE Activity | UE Activity | | |
| Expected UE | | | Behaviour | Behaviour | | |
| Activity | | | 9.2.3.82 | for the PDU | | |
| Behaviour | | | | Session. | | |
| >PDU | | 0 . . . 1 | | | — | |
| Session | | | | | | |
| Resources | | | | | | |
| To Be | | | | | | |
| Modified | | | | | | |
| List | | | | | | |
| >>PDU | | 1 . . . | | NOTE: If | — | |
| Session | | <maxnoofPDUSessions> | | neither the | | |
| Resources | | | | PDU | | |
| To Be | | | | Session | | |
| Modified | | | | Resource | | |
| Item | | | | Modification | | |
| | | | | Info - SN | | |
| | | | | terminated | | |
| | | | | IE | | |
| | | | | nor the | | |
| | | | | PDU | | |
| | | | | Session | | |
| | | | | Resource | | |
| | | | | Modification | | |
| | | | | Info - MN | | |
| | | | | terminated | | |
| | | | | IE | | |
| | | | | is present in | | |
| | | | | a PDU | | |
| | | | | Session | | |
| | | | | Resources | | |
| | | | | To Be | | |
| | | | | Modified | | |
| | | | | Item IE, | | |
| | | | | abnormal | | |
| | | | | conditions | | |
| | | | | as specified | | |
| | | | | in clause | | |
| | | | | 8.3.3.4 | | |
| | | | | apply. | | |
| >>>PDU | M | | 9.2.3.18 | | — | |
| Session ID | | | | | | |
| >>>S-NG- | O | | PDU | | — | |
| RAN node | | | Session | | | |
| PDU | | | Aggregate | | | |
| Session | | | Maximum | | | |
| Aggregate | | | Bit Rate | | | |
| Maximum Bit | | | 9.2.3.69 | | | |
| Rate | | | | | | |
| >>>PDU | O | | 9.2.1.9 | | — | |
| Session | | | | | | |
| Resource | | | | | | |
| Modification | | | | | | |
| Info - SN | | | | | | |
| terminated | | | | | | |
| >>>PDU | O | | 9.2.1.11 | | — | |
| Session | | | | | | |
| Resource | | | | | | |
| Modification | | | | | | |
| Info - MN | | | | | | |
| terminated | | | | | | |
| >>>S-NSSAI | O | | 9.2.3.21 | | YES | reject |
| >>>PDU | O | | Expected | Expected | YES | ignore |
| Session | | | UE Activity | UE Activity | | |
| Expected UE | | | Behaviour | Behaviour | | |
| Activity | | | 9.2.3.82 | for the PDU | | |
| Behaviour | | | | Session. | | |
| >PDU | O | | PDU | | — | |
| Session | | | session List | | | |
| Resources | | | with Cause | | | |
| To Be | | | 9.2.1.26 | | | |
| Released | | | | | | |
| List | | | | | | |
| M-NG-RAN | O | | OCTET | Includes the | YES | ignore |
| node to S- | | | STRING | CG- | | |
| NG-RAN | | | | ConfigInfo | | |
| node | | | | message as | | |
| Container | | | | defined in | | |
| | | | | subclause | | |
| | | | | 11.2.2. of | | |
| | | | | TS 38.331 | | |
| | | | | [10]. | | |
| Requested | O | | ENUMERATED | Indicates | YES | ignore |
| Split SRBs | | | (srb1, | that | | |
| | | | srb2, | resources | | |
| | | | srb1&2, . . . ) | for Split | | |
| | | | | SRBs are | | |
| | | | | requested. | | |
| Requested | O | | ENUMERATED | Indicates | YES | ignore |
| Split SRBs | | | (srb1, | that | | |
| release | | | srb2, | resources | | |
| | | | srb1&2, . . . ) | for Split | | |
| | | | | SRBs are | | |
| | | | | requested to | | |
| | | | | be released. | | |
| Desired | O | | 9.2.3.77 | | YES | ignore |
| Activity | | | | | | |
| Notification | | | | | | |
| Level | | | | | | |
| Additional | O | | DRB List | Indicates | YES | reject |
| DRB IDs | | | 9.2.1.29 | additional | | |
| | | | | list of DRB | | |
| | | | | IDs that the | | |
| | | | | S-NG-RAN | | |
| | | | | node may | | |
| | | | | use for SN- | | |
| | | | | terminated | | |
| | | | | bearers. | | |
| S-NG-RAN | O | | Bit Rate | The S-NG- | YES | reject |
| node | | | 9.2.3.4 | RAN node | | |
| Maximum | | | | Maximum | | |
| Integrity | | | | Integrity | | |
| Protected | | | | Protected | | |
| Data Rate | | | | Data Rate | | |
| Uplink | | | | Uplink is a | | |
| | | | | portion of | | |
| | | | | the UE's | | |
| | | | | Maximum | | |
| | | | | Integrity | | |
| | | | | Protected | | |
| | | | | Data Rate in | | |
| | | | | the Uplink, | | |
| | | | | which is | | |
| | | | | enforced by | | |
| | | | | the S-NG- | | |
| | | | | RAN node | | |
| | | | | for the UE's | | |
| | | | | SN | | |
| | | | | terminated | | |
| | | | | PDU | | |
| | | | | sessions. If | | |
| | | | | the S-NG- | | |
| | | | | RAN node | | |
| | | | | Maximum | | |
| | | | | Integrity | | |
| | | | | Protected | | |
| | | | | Data Rate | | |
| | | | | Downlink IE | | |
| | | | | is not | | |
| | | | | present, this | | |
| | | | | IE applies to | | |
| | | | | both UL and | | |
| | | | | DL. | | |
| S-NG-RAN | O | | Bit Rate | The S-NG- | YES | reject |
| node | | | 9.2.3.4 | RAN node | | |
| Maximum | | | | Maximum | | |
| Integrity | | | | Integrity | | |
| Protected | | | | Protected | | |
| Data Rate | | | | Data Rate | | |
| Downlink | | | | Downlink is | | |
| | | | | a portion of | | |
| | | | | the UE's | | |
| | | | | Maximum | | |
| | | | | Integrity | | |
| | | | | Protected | | |
| | | | | Data Rate in | | |
| | | | | the | | |
| | | | | Downlink, | | |
| | | | | which is | | |
| | | | | enforced by | | |
| | | | | the S-NG- | | |
| | | | | RAN node | | |
| | | | | for the UE's | | |
| | | | | SN | | |
| | | | | terminated | | |
| | | | | PDU | | |
| | | | | sessions. | | |
| Location | O | | ENUMERATED | Indicates | YES | ignore |
| Information | | | (pscell, . . . ) | that the | | |
| at S-NODE | | | | user's | | |
| reporting | | | | Location | | |
| | | | | Information | | |
| | | | | at S-NODE | | |
| | | | | is to be | | |
| | | | | provided. | | |
| MR-DC | O | | 9.2.2.33 | Information | YES | ignore |
| Resource | | | | used to | | |
| Coordination | | | | coordinate | | |
| Information | | | | resource | | |
| | | | | utilisation | | |
| | | | | between M- | | |
| | | | | NG-RAN | | |
| | | | | node and S- | | |
| | | | | NG-RAN | | |
| | | | | node. | | |
| PCell ID | O | | Global NG- | | YES | reject |
| | | | RAN Cell | | | |
| | | | Identity | | | |
| | | | 9.2.2.27 | | | |
| NE-DC TDM | O | | 9.2.2.38 | | YES | ignore |
| Pattern | | | | | | |
| Requested | O | | ENUMERATED | Indicates | YES | ignore |
| Fast MCG | | | (true, . . . ) | that the | | |
| recovery via | | | | resources | | |
| SRB3 | | | | for fast | | |
| | | | | MCG | | |
| | | | | recovery via | | |
| | | | | SRB3 are | | |
| | | | | requested. | | |
| Requested | O | | ENUMERATED | Indicates | YES | ignore |
| Fast MCG | | | (true, . . . ) | that | | |
| recovery via | | | | resources | | |
| SRB3 | | | | for fast | | |
| Release | | | | MCG | | |
| | | | | recovery via | | |
| | | | | SRB3 are | | |
| | | | | requested to | | |
| | | | | be released. | | |
| SN triggered | O | | ENUMERATED | | YES | ignore |
| | | | (TRUE . . . ) | | | |
| Target Node | O | | Global NG- | Indicates | YES | ignore |
| ID | | | RAN Node | the target | | |
| | | | ID | node ID of | | |
| | | | 9.2.2.3 | the | | |
| | | | | handover | | |
| | | | | procedure | | |
| | | | | decided by | | |
| | | | | the M-NG- | | |
| | | | | RAN node. | | |
| PSCell | O | | ENUMERATED | Indicates | YES | ignore |
| History | | | (query, . . . ) | that the SN | | |
| Information | | | | UE history | | |
| Retrieve | | | | information | | |
| | | | | is | | |
| | | | | requested. | | |
| UE History | O | | 9.2.3.110 | | YES | ignore |
| Information | | | | | | |
| from the UE | | | | | | |
| CHO | O | | | | YES | ignore |
| Information | | | | | | |
| SN | | | | | | |
| Modification | | | | | | |
| >Conditional | M | | ENUMERATED | | — | |
| Reconfiguration | | | (intra-MN- | | | |
| | | | CHO, . . . ) | | | |
| >Estimated | O | | INTEGER | | — | |
| Arrival | | | (1 . . . 100) | | | |
| Probability | | | | | | |
| SCG | O | | 9.2.3.154 | | YES | ignore |
| Activation | | | | | | |
| Request | | | | | | |
| Conditional | O | | | This IE may | YES | ignore |
| PSCell | | | | be sent to | | |
| Addition | | | | the target | | |
| Information | | | | SN. | | |
| Modification | | | | | | |
| Request | | | | | | |
| >Maximum | O | | INTEGER | Indicates | — | |
| Number of | | | (1 . . . 8, . . . ) | the | | |
| PSCells To | | | | maximum | | |
| Prepare | | | | number of | | |
| | | | | PSCells that | | |
| | | | | the target | | |
| | | | | SN may | | |
| | | | | prepare. | | |
| >Estimated | O | | INTEGER | Indicates | | |
| Arrival | | | (1 . . . 100) | the arrival | | |
| Probability | | | | probability | | |
| | | | | for the UE | | |
| | | | | towards the | | |
| | | | | candidate | | |
| | | | | target SN. | | |
| Conditional | O | | | This IE may | YES | ignore |
| PSCell | | | | be sent to | | |
| Change | | | | the source | | |
| Information | | | | SN. | | |
| Update | | | | | | |
| >Multiple | | 1 | | | — | |
| Target S- | | | | | | |
| NG-RAN | | | | | | |
| Node List | | | | | | |
| >>Multiple | | 1 . . . | | | — | |
| Target S- | | <maxnoofTargetSNs> | | | | |
| NG-RAN | | | | | | |
| Node Item | | | | | | |
| >>>Target | M | | Global NG- | | — | |
| S-NG-RAN | | | RAN Node | | | |
| node ID | | | ID | | | |
| | | | 9.2.2.3 | | | |
| >>>Candidate | | 1 | | | — | |
| PSCell | | | | | | |
| List | | | | | | |
| >>>>Candidate | | 1 . . . | | | — | |
| PSCell | | <maxnoofPSCellCandidate> | | | | |
| Item | | | | | | |
| >>>>>PSCell | M | | NR CGI | | — | |
| ID | | | 9.2.2.7 | | | |
| S-NG-RAN | O | | UE Slice | This IE | YES | ignore |
| node UE | | | Maximum | indicates | | |
| Slice | | | Bit Rate List | the S-NG- | | |
| Maximum Bit | | | 9.2.3.167 | RAN node | | |
| Rate | | | | portion of | | |
| | | | | the UE Slice | | |
| | | | | Aggregate | | |
| | | | | Maximum | | |
| | | | | Bit Rate as | | |
| | | | | specified in | | |
| | | | | TS 23.501 | | |
| | | | | [7] | | |
| Management | O | | MDT PLMN | | YES | ignore |
| Based MDT | | | Modification | | | |
| PLMN | | | List | | | |
| Modification | | | 9.2.3.169 | | | |
| List | | | | | | |
| Serving | O | | | indicates | | |
| Satellite ID | | | | serving | | |
| | | | | satellite for | | |
| | | | | UE-to-UE | | |
| | | | | communication | | |
| | | | | using | | |
| | | | | satellite | | |
| Target | O | | | indicates | | |
| Satellite ID | | | | next satellite | | |
| | | | | subsequent | | |
| | | | | to serving | | |
| | | | | satellite for | | |
| | | | | UE-to-UE | | |
| | | | | communication | | |
| | | | | using | | |
| | | | | satellite | | |
| Serving | O | | | indicates | | |
| Satellite | | | | spotbeam | | |
| Beam ID | | | | for serving | | |
| | | | | satellite | | |
| Target | O | | | indicates | | |
| Satellite | | | | spotbeam | | |
| Beam ID | | | | for target | | |
| | | | | satellite | | |
| UE #1 ID | O | | | first UE for | | |
| | | | | UE-to-UE | | |
| | | | | communication | | |
| | | | | using | | |
| | | | | satellite | | |
| | | | | e.g., IMSI, | | |
| | | | | GUTI, | | |
| UE #2 ID | O | | | second UE | | |
| | | | | for UE-to- | | |
| | | | | UE | | |
| | | | | communication | | |
| | | | | using | | |
| | | | | satellite | | |
| Session | O | | | Session ID | | |
| Information | | | | maintained | | |
| | | | | between | | |
| | | | | serving | | |
| | | | | satellite and | | |
| | | | | target | | |
| | | | | satellite. | | |
| | | | | e.g., PDU | | |
| | | | | session | | |
| Bearer | O | | | e.g., DRB | | |
| Information | | | | ID, SRB ID | | |
| Cell | O | | | cell | | |
| Information | | | | information, | | |
| | | | | PCI(physical | | |
| | | | | cell | | |
| | | | | identity), | | |
| | | | | CGI(cell | | |
| | | | | global | | |
| | | | | identity) | | |
| Space Area | O | | | | | |
| Information | | | | | | |
| >Space Area | O | | | indicates a | | |
| id | | | | specified | | |
| | | | | space area | | |
| >height | O | | | a range of | | |
| threshold | | | | space area | | |
| Satellite | O | | | indicates | | |
| Group ID | | | | satellite | | |
| | | | | group for | | |
| | | | | service | | |
| Candidate | O | | | Satellite set | | |
| Satellite list | | | | within space | | |
| | | | | area | | |
| >time | O | | | time interval | | |
| interval id | | | | related to | | |
| | | | | space area | | |
| >satellites | O | | | satellites | | |
| per time | | | | within space | | |
| interval | | | | area in | | |
| | | | | corresponding | | |
| | | | | time | | |
| | | | | interval | | |
| Validity Time | O | | | | | |
| Tracking | O | | | | | |
| Area | | | | | | |
| Information | | | | | | |
| >Tracking | O | | | TAC, TAI, | | |
| Area List | | | | PLMN | | |
| | | | | Identity | | |
| Orbit ID | O | | | indicates | | |
| | | | | orbital. | | |
| | | | | e.g., | | |
| | | | | ephemeris | | |
| | | | | info, | | |
| | | | | semiMajorAxis, | | |
| | | | | eccentricity, | | |
| | | | | periapsis, | | |
| | | | | longitude, | | |
| | | | | inclination, | | |
| | | | | meanAnomaly | | |

For the IEs according to the above Table 11, the 3GPP TS 38.423 standard may be referred to.

According to an embodiment, the first message may be an S-node modification request message, and the second message may be an S-node modification confirmation message. The satellite 620 may transmit the S-node modification request message to the base station 1020 through the XN interface. The base station 1020 may transmit the S-node modification confirmation message to the satellite 620 through the XN interface. The S-node modification request message may include at least one item of the information in Table 5. The S-node modification confirmation message may include at least one item of the information in Table 5. For example, the first message may include the following IEs as exemplified in Table 12 below.

TABLE 12

| IE/Group | | | IE type and | Semantics | | Assigned |
|---|---|---|---|---|---|---|
| Name | Presence | Range | reference | description | Criticality | Criticality |
| Message | M | | 9.2.3.1 | | YES | reject |
| Type | | | | | | |
| M-NG-RAN | M | | NG-RAN node UE | Allocated | YES | reject |
| node UE | | | XnAP ID | at the M- | | |
| XnAP ID | | | 9.2.3.16 | NG-RAN | | |
| | | | | node | | |
| S-NG-RAN | M | | NG-RAN node UE | Allocated | YES | reject |
| node UE | | | XnAP ID | at the S- | | |
| XnAP ID | | | 9.2.3.16 | NG-RAN | | |
| | | | | node | | |
| Cause | M | | 9.2.3.2 | | YES | ignore |
| PDCP | O | | 9.2.3.74 | | YES | ignore |
| Change | | | | | | |
| Indication | | | | | | |
| PDU | | 0 . . . 1 | | | YES | ignore |
| Session | | | | | | |
| Resources | | | | | | |
| To Be | | | | | | |
| Modified | | | | | | |
| List | | | | | | |
| >PDU | | 1 . . . | | NOTE: If | — | |
| Session | | <maxnoofPDUSessions> | | neither the | | |
| Resources | | | | PDU | | |
| To Be | | | | Session | | |
| Modified | | | | Resource | | |
| Item | | | | Modification | | |
| | | | | Required | | |
| | | | | Info - SN | | |
| | | | | terminated | | |
| | | | | IE | | |
| | | | | nor the | | |
| | | | | PDU | | |
| | | | | Session | | |
| | | | | Resource | | |
| | | | | Modification | | |
| | | | | Required | | |
| | | | | Info - MN | | |
| | | | | terminated | | |
| | | | | IE | | |
| | | | | is present | | |
| | | | | in a PDU | | |
| | | | | Session | | |
| | | | | Resources | | |
| | | | | To Be | | |
| | | | | Modified | | |
| | | | | Item IE, | | |
| | | | | abnormal | | |
| | | | | conditions | | |
| | | | | as | | |
| | | | | specified in | | |
| | | | | clause | | |
| | | | | 8.3.4.4 | | |
| | | | | apply. | | |
| >>PDU | M | | 9.2.3.18 | | — | |
| Session ID | | | | | | |
| >>PDU | O | | 9.2.1.20 | | — | |
| Session | | | | | | |
| Resource | | | | | | |
| Modification | | | | | | |
| Required | | | | | | |
| Info - SN | | | | | | |
| terminated | | | | | | |
| >>PDU | O | | 9.2.1.22 | | — | |
| Session | | | | | | |
| Resource | | | | | | |
| Modification | | | | | | |
| Required | | | | | | |
| Info - MN | | | | | | |
| terminated | | | | | | |
| PDU | | 0 . . . 1 | | | YES | ignore |
| Session | | | | | | |
| Resources | | | | | | |
| To Be | | | | | | |
| Released | | | | | | |
| List | | | | | | |
| >PDU | | 1 . . . | | | — | |
| Session | | <maxnoofPDUSessions> | | | | |
| Resources | | | | | | |
| To Be | | | | | | |
| Released | | | | | | |
| Item | | | | | | |
| >PDU | O | | PDU session List | | — | |
| sessions to | | | with data forwarding | | | |
| be | | | request info | | | |
| released | | | 9.2.1.24 | | | |
| List - SN | | | | | | |
| terminated | | | | | | |
| >PDU | O | | PDU session List | | — | |
| sessions to | | | with Cause | | | |
| be | | | 9.2.1.26 | | | |
| released | | | | | | |
| List - MN | | | | | | |
| terminated | | | | | | |
| S-NG-RAN | O | | OCTET STRING | Includes | YES | ignore |
| node to M- | | | | the CG- | | |
| NG-RAN | | | | Config | | |
| node | | | | message | | |
| Container | | | | or the CG- | | |
| | | | | Candidate | | |
| | | | | List | | |
| | | | | message | | |
| | | | | as defined | | |
| | | | | in | | |
| | | | | subclause | | |
| | | | | 11.2.2 of | | |
| | | | | TS 38.331 | | |
| | | | | [10]. | | |
| Spare DRB | O | | DRB List | Indicates | YES | ignore |
| IDs | | | 9.2.1.29 | the list of | | |
| | | | | unnecessary | | |
| | | | | DRB IDs | | |
| | | | | that had | | |
| | | | | been used | | |
| | | | | by the S- | | |
| | | | | NG-RAN | | |
| | | | | node. | | |
| Required | O | | Number of DRBs | Indicates | YES | ignore |
| Number of | | | 9.2.3.78 | the | | |
| DRB IDs | | | | number of | | |
| | | | | DRB IDs | | |
| | | | | that the S- | | |
| | | | | NG-RAN | | |
| | | | | node | | |
| | | | | requests | | |
| | | | | more. | | |
| Location | O | | Target Cell Global | Contains | YES | ignore |
| Information | | | ID | information | | |
| at S-NODE | | | 9.2.3.25 | to support | | |
| | | | | localisation | | |
| | | | | of the UE | | |
| MR-DC | O | | 9.2.2.33 | Information | YES | ignore |
| Resource | | | | used to | | |
| Coordination | | | | coordinate | | |
| Information | | | | resource | | |
| | | | | utilisation | | |
| | | | | between | | |
| | | | | M-NG- | | |
| | | | | RAN node | | |
| | | | | and S-NG- | | |
| | | | | RAN node. | | |
| RRC | O | | 9.2.3.72 | | YES | reject |
| Config | | | | | | |
| Indication | | | | | | |
| SCG | O | | ENUMERATED(released, | | YES | ignore |
| Indicator | | | . . . ) | | | |
| SCG UE | O | | 9.2.3.151 | | Yes | ignore |
| History | | | | | | |
| Information | | | | | | |
| SCG | O | | 9.2.3.154 | | YES | ignore |
| Activation | | | | | | |
| Request | | | | | | |
| CPAC | O | | | This IE | YES | ignore |
| Information | | | | may be | | |
| Required | | | | sent from | | |
| | | | | the target | | |
| | | | | SN. | | |
| >Candidate | | 1 | | Indicates | — | |
| PSCell | | | | the full list | | |
| List | | | | of | | |
| | | | | candidate | | |
| | | | | PSCells | | |
| | | | | prepared | | |
| | | | | at the | | |
| | | | | target S- | | |
| | | | | NG-RAN | | |
| | | | | node. | | |
| >>Candidate | | 1 . . . | | | — | |
| PSCell | | <maxnoofPSCellCandidate> | | | | |
| Item | | | | | | |
| >>>PSCell | M | | NR CGI 9.2.2.7 | | — | |
| ID | | | | | | |
| SCG | O | | ENUMERATED | | YES | ignore |
| Reconfiguration | | | (executed, . . . , | | | |
| Notification | | | executed-deleted, | | | |
| | | | deleted) | | | |
| Serving | O | | | indicates | | |
| Satellite ID | | | | serving | | |
| | | | | satellite for | | |
| | | | | UE-to-UE | | |
| | | | | communication | | |
| | | | | using | | |
| | | | | satellite | | |
| Target | O | | | indicates | | |
| Satellite ID | | | | next | | |
| | | | | satellite | | |
| | | | | subsequent | | |
| | | | | to serving | | |
| | | | | satellite for | | |
| | | | | UE-to-UE | | |
| | | | | communication | | |
| | | | | using | | |
| | | | | satellite | | |
| Serving | O | | | indicates | | |
| Satellite | | | | spotbeam | | |
| Beam ID | | | | for serving | | |
| | | | | satellite | | |
| Target | O | | | indicates | | |
| Satellite | | | | spotbeam | | |
| Beam ID | | | | for target | | |
| | | | | satellite | | |
| UE #1 ID | O | | | first UE for | | |
| | | | | UE-to-UE | | |
| | | | | communication | | |
| | | | | using | | |
| | | | | satellite | | |
| | | | | e.g., IMSI, | | |
| | | | | GUTI, | | |
| UE #2 ID | O | | | second UE | | |
| | | | | for UE-to- | | |
| | | | | UE | | |
| | | | | communication | | |
| | | | | using | | |
| | | | | satellite | | |
| Session | O | | | Session ID | | |
| Information | | | | maintained | | |
| | | | | between | | |
| | | | | serving | | |
| | | | | satellite | | |
| | | | | and target | | |
| | | | | satellite. | | |
| | | | | e.g., PDU | | |
| | | | | session | | |
| Bearer | O | | | e.g., DRB | | |
| Information | | | | ID, SRB ID | | |
| Cell | O | | | cell | | |
| Information | | | | information, | | |
| | | | | PCI(physical | | |
| | | | | cell | | |
| | | | | identity), | | |
| | | | | CGI(cell | | |
| | | | | global | | |
| | | | | identity) | | |
| Space | O | | | | | |
| Area | | | | | | |
| Information | | | | | | |
| >Space | O | | | indicates a | | |
| Area id | | | | specified | | |
| | | | | space area | | |
| >height | O | | | a range of | | |
| threshold | | | | space area | | |
| Satellite | O | | | indicates | | |
| Group ID | | | | satellite | | |
| | | | | group for | | |
| | | | | service | | |
| Candidate | O | | | Satellite | | |
| Satellite list | | | | set within | | |
| | | | | space area | | |
| >time | O | | | time | | |
| interval id | | | | interval | | |
| | | | | related to | | |
| | | | | space area | | |
| >satellites | O | | | satellites | | |
| per time | | | | within | | |
| interval | | | | space area | | |
| | | | | in | | |
| | | | | corresponding | | |
| | | | | time | | |
| | | | | interval | | |
| Validity | O | | | | | |
| Time | | | | | | |
| Tracking | O | | | | | |
| Area | | | | | | |
| Information | | | | | | |
| >Tracking | O | | | TAC, TAI, | | |
| Area List | | | | PLMN | | |
| | | | | Identity | | |
| Orbit ID | O | | | indicates | | |
| | | | | orbital. | | |
| | | | | e.g., | | |
| | | | | ephemeris | | |
| | | | | info, | | |
| | | | | semiMajor | | |
| | | | | Axis, | | |
| | | | | eccentricity, | | |
| | | | | periapsis, | | |
| | | | | longitude, | | |
| | | | | inclination, | | |
| | | | | meanAnomaly | | |

For the IEs according to the above Table 12, the 3GPP TS 38.423 standard may be referred to.

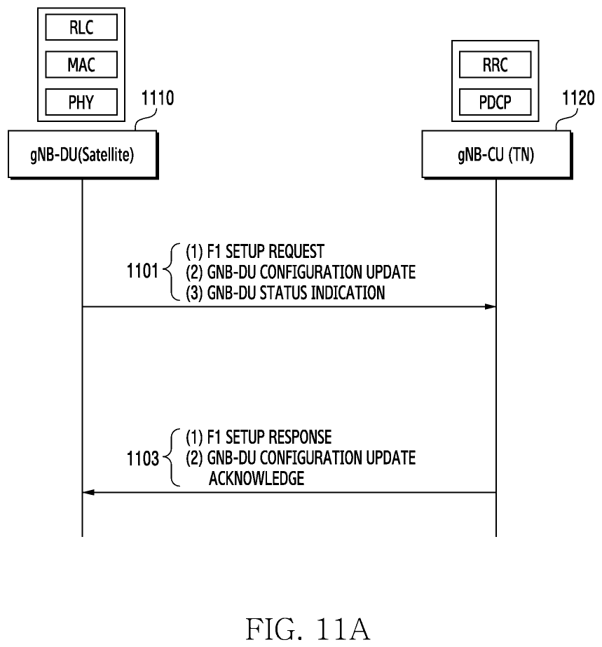

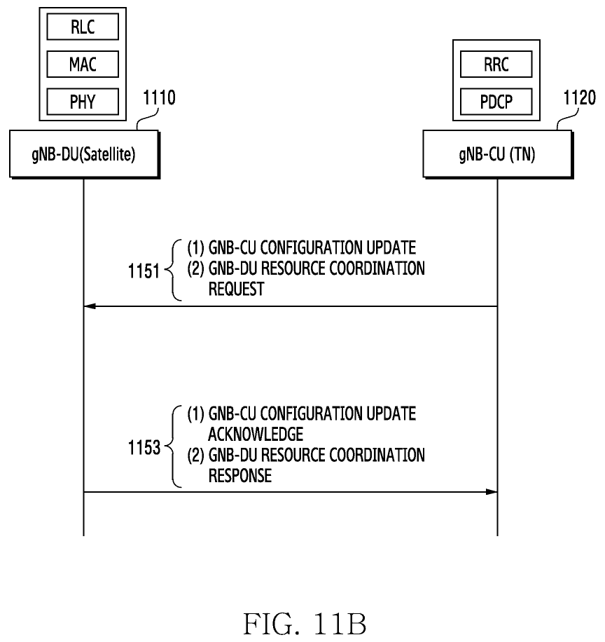

FIGS. 11A and 11B illustrate examples of signaling through an F1 interface in the NTN. A satellite group may be predefined by an operator of the satellites, an operator providing a terrestrial gateway connected to the satellites, or a network operator, or may be set by a configuration of a network entity (e.g., a gNB-CU). If each satellite corresponds to a gNB-DU, the gNB-CU connected to the satellite may control the link between the satellites, by transmitting a message to the gNB-DU. Here, the link between the satellites may be a direct communication between the DUs and may be transparent to the gNB-CU. For example, referring to FIG. 7B, as a serving satellite (e.g., satellite 751) moves along an orbit, a target satellite instead of the serving satellite may perform communication with the first vehicle UE 761. The target satellite may perform communication with the first vehicle UE 761. In order for the first vehicle UE 761 to be provided with continuous service without interruption, a terrestrial network entity (e.g., gNB-CU) connected to the serving satellite may provide the serving satellite with information about the satellite group in advance. The information related to the satellite group may include, for example, items in the table below.

TABLE 13

| Information | Description |
|---|---|
| Satellite Group ID | indicates satellite group for service |
| Satellite ID | Master Satellite within satellite group |
| Candidate Satellite list | Satellites within satellite group |
| >Satellite ID | e.g., gNB ID, DU ID, cell ID |
| >PositionVelocity | e.g., positionX, positionY, positionZ, |
| | velocityX, velocityY, velocityZ |
| >Orbit | e.g., ephemeris info, semiMajorAxis, eccentricity, |
| | periapsis, longitude, inclination, meanAnomaly |
| >type | LEO, GEO, MEO |
| >time information | indicates time zone operating as element of the |
| | satellite group |
| >Capability | e.g., # of UEs, whether to support ISL, TN-NTN |
| | dual connectivity, data forwarding, # of antennas |
| Session Information | Session ID for satellite group |
| | e.g., PDU session |
| Bearer Information | DRB(data radio bearer) ID, SRB(signaling radio |
| | bearer) ID for Satellite group |
| Cell Information | Cell list for satellite group |
| | e.g., PCI, CGI |
| Space Area | |
| Information | |
| >Space Area id | indicates a specified space area |
| >height threshold | a range of space area |
| Validity Time | time duration for satellite group because satellite |
| | moves continuously |
| Tracking Area | TA list for satellite groyp |
| Information | |
| >Tracking Area List | TAC, TAI, PLMN Identity |
| Satellite group Type | |
| GPS information | GPS information of ground entity for supporting |
| | satellite group |

For example, the gNB-CU may provide information related to the satellite group whenever a satellite operating as a gNB-DU enters the coverage. The gNB-CU may provide information related to the satellite group to the gNB-DU via the F1 interface. Further, for example, the serving satellite may provide information related to the satellite group to other satellites via ISL. The information related to the satellite group provided via the ISL may be provided through messages on the XN interface described in FIG. 10.

Referring to FIG. 11A, in operation 1101, the gNB-DU 1110 may transmit a first message to the gNB-CU 1120 via the F1 interface. The gNB-CU 1120 may receive the first message from the gNB-DU 1110.

In operation 1103, the gNB-CU 1120 may transmit a second message to the gNB-DU 1110 via the F1 interface. The gNB-DU 1110 may receive the second message from the gNB-CU 1120.

According to an embodiment, the first message may be an F1 setup request message, and the second message may be an F1 setup response message. The gNB-DU 1110 may transmit an F1 setup request message to the gNB-CU 1120 through the F1 interface. The gNB-CU 1120 may transmit an F1 setup response message to the gNB-DU 1110 through the F1 interface. The F1 setup request message may include at least one item of the information in Table 13. The F1 setup response message may include at least one item of the information in Table 13. For example, the first message may include the following IEs as exemplified in Table 14.

TABLE 14

| IE/Group | | | | Semantics | | Assigned |
|---|---|---|---|---|---|---|
| Name | Presence | Range | IE type and reference | description | Criticality | Criticality |
| Message | M | | 9.3.1.1 | | YES | reject |
| Type | | | | | | |
| Transaction | M | | 9.3.1.23 | | YES | reject |
| ID | | | | | | |
| gNB-DU ID | M | | 9.3.1.9 | | YES | reject |
| gNB-DU | O | | Printable String(SIZE(1 . . . | | YES | ignore |
| Name | | | 150, . . . )) | | | |
| gNB-DU | | 0 . . . 1 | | List of | YES | reject |
| Served | | | | cells | | |
| Cells List | | | | configured | | |
| | | | | in the | | |
| | | | | gNB-DU | | |
| >gNB-DU | | 1 . . . | | | EACH | reject |
| Served | | <maxCellingNBDU> | | | | |
| Cells Item | | | | | | |
| >>Served | M | | 9.3.1.10 | Information | — | |
| Cell | | | | about | | |
| Information | | | | the cells | | |
| | | | | configured | | |
| | | | | in the | | |
| | | | | gNB-DU | | |
| >>gNB- | O | | 9.3.1.18 | RRC | — | |
| DU | | | | container | | |
| System | | | | with | | |
| Information | | | | system | | |
| | | | | information | | |
| | | | | owned | | |
| | | | | by gNB- | | |
| | | | | DU | | |
| gNB-DU | M | | RRC version 9.3.1.70 | | YES | reject |
| RRC version | | | | | | |
| Transport | O | | 9.3.2.5 | | YES | ignore |
| Layer | | | | | | |
| Address Info | | | | | | |
| BAP Address | O | | 9.3.1.111 | Indicates | YES | ignore |
| | | | | a BAP | | |
| | | | | address | | |
| | | | | assigned | | |
| | | | | to the | | |
| | | | | IAB- | | |
| | | | | node. | | |
| Extended | O | | 9.3.1.205 | | YES | ignore |
| gNB-DU | | | | | | |
| Name | | | | | | |
| Satellite | O | | indicates satellite group | | | |
| Group ID | | | for service | | | |
| Satellite ID | O | | Master Satellite within | | | |
| | | | satellite group | | | |
| Candidate | O | | Satellites within satellite | | | |
| Satellite list | | | group | | | |
| >Satellite ID | O | | e.g., gNB ID, DU ID, cell | | | |
| | | | ID | | | |
| >PositionVelocity | O | | e.g., positionX, | | | |
| | | | positionY, positionZ, | | | |
| | | | velocityX, velocityY, | | | |
| | | | velocityZ | | | |
| >Orbit | O | | e.g., ephemeris info, | | | |
| | | | semiMajorAxis, | | | |
| | | | eccentricity, periapsis, | | | |
| | | | longitude, inclination, | | | |
| | | | meanAnomaly | | | |
| >type | O | | LEO, GEO, MEO | | | |
| >time | O | | indicates time zone | | | |
| information | | | operating as element of | | | |
| | | | the satellite group | | | |
| >Capability | O | | e.g., # of UEs, whether | | | |
| | | | to support ISL, TN-NTN | | | |
| | | | dual connectivity, data | | | |
| | | | forwarding, # of | | | |
| | | | antennas | | | |
| Session | O | | Session ID for satellite | | | |
| Information | | | group | | | |
| | | | e.g., PDU session | | | |
| Bearer | O | | DRB(data radio bearer) | | | |
| Information | | | ID, SRB(signaling radio | | | |
| | | | bearer) ID for Satellite | | | |
| | | | group | | | |
| Cell | O | | Cell list for satellite group | | | |
| Information | | | e.g., PCI, CGI | | | |
| Space Area | O | | | | | |
| Information | | | | | | |
| >Space Area | O | | indicates a specified | | | |
| id | | | space area | | | |
| >height | O | | a range of space area | | | |
| threshold | | | | | | |
| Validity Time | O | | time duration for satellite | | | |
| | | | group because satellite | | | |
| | | | moves continuously | | | |
| Tracking | O | | TA list for satellite groyp | | | |
| Area | | | | | | |
| Information | | | | | | |
| >Tracking | O | | TAC, TAI, PLMN Identity | | | |
| Area List | | | | | | |
| Satellite | O | | | | | |
| group Type | | | | | | |
| GPS | | | GPS information of | | | |
| information | | | ground entity for | | | |
| | | | supporting satellite | | | |
| | | | group | | | |

For the IEs according to the above Table 14, the 3GPP TS 38.473 standard may be referred to.

According to an embodiment, the first message may be a GNB-DU configuration update message, and the second message may be a gNB-DU configuration update acknowledge message. The gNB-DU 1110 may transmit the GNB-DU configuration update message to the gNB-CU 1120 through the F1 interface. The gNB-CU 1120 may transmit the gNB-DU configuration update acknowledge message to the gNB-DU 1110 through the F1 interface. The GNB-DU configuration update message may include at least one item of the information in Table 13. The GNB-DU configuration update acknowledge message may include at least one item of the information in Table 13. For example, the first message may include the following IEs as exemplified in Table 15.

TABLE 15

| IE/Group | | | IE type and | Semantics | | Assigned |
|---|---|---|---|---|---|---|
| Name | Presence | Range | reference | description | Criticality | Criticality |
| Message | M | | 9.3.1.1 | | YES | reject |
| Type | | | | | | |
| Transaction | M | | 9.3.1.23 | | YES | reject |
| ID | | | | | | |
| Served | | 0 . . . 1 | | Complete | YES | reject |
| Cells To | | | | list of | | |
| Add List | | | | added | | |
| | | | | cells | | |
| | | | | served | | |
| | | | | by the | | |
| | | | | gNB-DU | | |
| >Served | | 1 . . . | | | EACH | reject |
| Cells To | | <maxCellingNBDU> | | | | |
| Add Item | | | | | | |
| >>Served | M | | 9.3.1.10 | Information | — | |
| Cell | | | | about | | |
| Information | | | | the cells | | |
| | | | | configured | | |
| | | | | in the | | |
| | | | | gNB-DU | | |
| >>gNB-DU | O | | 9.3.1.18 | RRC | — | |
| System | | | | container | | |
| Information | | | | with | | |
| | | | | system | | |
| | | | | information | | |
| | | | | owned | | |
| | | | | by gNB- | | |
| | | | | DU | | |
| Served | | 0 . . . 1 | | Complete | YES | reject |
| Cells To | | | | list of | | |
| Modify List | | | | modified | | |
| | | | | cells | | |
| | | | | served | | |
| | | | | by the | | |
| | | | | gNB-DU | | |
| >Served | | 1 . . . | | | EACH | reject |
| Cells To | | <maxCellingNBDU> | | | | |
| Modify Item | | | | | | |
| >>Old NR | M | | NR CGI 9.3.1.12 | | — | |
| CGI | | | | | | |
| >>Served | M | | 9.3.1.10 | Information | — | |
| Cell | | | | about | | |
| Information | | | | the cells | | |
| | | | | configured | | |
| | | | | in the | | |
| | | | | gNB-DU | | |
| >>gNB-DU | O | | 9.3.1.18 | RRC | — | |
| System | | | | container | | |
| Information | | | | with | | |
| | | | | system | | |
| | | | | information | | |
| | | | | owned | | |
| | | | | by gNB- | | |
| | | | | DU | | |
| Served | | 0 . . . 1 | | Complete | YES | reject |
| Cells To | | | | list of | | |
| Delete List | | | | deleted | | |
| | | | | cells | | |
| | | | | served | | |
| | | | | by the | | |
| | | | | gNB-DU | | |
| >Served | | 1 . . . | | | EACH | reject |
| Cells To | | <maxCellingNBDU> | | | | |
| Delete Item | | | | | | |
| >>Old NR | M | | NR CGI 9.3.1.12 | | — | |
| CGI | | | | | | |
| Cells Status | | 0 . . . 1 | | Complete | YES | reject |
| List | | | | list of | | |
| | | | | active | | |
| | | | | cells | | |
| >Cells | | 0 . . . | | | EACH | reject |
| Status Item | | <maxCellingNBDU> | | | | |
| >>NR CGI | M | | 9.3.1.12 | | — | |
| >>Service | M | | 9.3.1.68 | | — | |
| Status | | | | | | |
| Dedicated | | 0 . . . 1 | | List of | YES | ignore |
| SI Delivery | | | | UEs | | |
| Needed UE | | | | unable | | |
| List | | | | to | | |
| | | | | receive | | |
| | | | | system | | |
| | | | | information | | |
| | | | | from | | |
| | | | | broadcast | | |
| >Dedicated | | 1 . . . | | | EACH | ignore |
| SI Delivery | | <maxnoofUEIDs> | | | | |
| Needed UE | | | | | | |
| Item | | | | | | |
| >>gNB-CU | M | | 9.3.1.4 | | — | |
| UE F1AP ID | | | | | | |
| >>NR CGI | M | | 9.3.1.12 | | — | |
| gNB-DU ID | O | | 9.3.1.9 | | YES | reject |
| gNB-DU | | 0 . . . 1 | | | YES | reject |
| TNL | | | | | | |
| Association | | | | | | |
| To Remove | | | | | | |
| List | | | | | | |
| >gNB-DU | | 1 . . . | | | EACH | reject |
| TNL | | <maxnoofTNLAssociation> | | | | |
| Association | | | | | | |
| To Remove | | | | | | |
| Item IEs | | | | | | |
| >>TNL | M | | CP Transport Layer | Transport | — | — |
| Association | | | Address | Layer | | |
| Transport | | | 9.3.2.4 | Address | | |
| Layer | | | | of the | | |
| Address | | | | gNB- | | |
| | | | | DU. | | |
| >>TNL | O | | CP Transport Layer | Transpo | — | — |
| Association | | | Address | rt Layer | | |
| Transport | | | 9.3.2.4 | Address | | |
| Layer | | | | of the | | |
| Address | | | | gNB-CU | | |
| gNB-CU | | | | | | |
| Transport | O | | 9.3.2.5 | | YES | ignore |
| Layer | | | | | | |
| Address | | | | | | |
| Info | | | | | | |
| Coverage | O | | 9.3.1.213 | | YES | Ignore |
| Modification | | | | | | |
| Notification | | | | | | |
| gNB-DU | O | | Printable String(SIZE(1 . . . | Human | YES | ignore |
| Name | | | 150, . . .)) | readable | | |
| | | | | name of | | |
| | | | | the | | |
| | | | | gNB- | | |
| | | | | DU. | | |
| Extended | O | | 9.3.1.205 | | YES | ignore |
| gNB-DU | | | | | | |
| Name | | | | | | |
| Satellite | O | | indicates satellite | | | |
| Group ID | | | group for service | | | |
| Satellite ID | O | | Master Satellite within | | | |
| | | | satellite group | | | |
| Candidate | O | | Satellites within | | | |
| Satellite list | | | satellite group | | | |
| >Satellite ID | O | | e.g., gNB ID, DU ID, | | | |
| | | | cell ID | | | |
| >PositionVelocity | O | | e.g., positionX, | | | |
| | | | positionY, positionZ, | | | |
| | | | velocityX, velocityY, | | | |
| | | | velocityZ | | | |
| >Orbit | O | | e.g., ephemeris info, | | | |
| | | | semiMajorAxis, | | | |
| | | | eccentricity, periapsis, | | | |
| | | | longitude, inclination, | | | |
| | | | meanAnomaly | | | |
| >type | O | | LEO, GEO, MEO | | | |
| >time | O | | indicates time zone | | | |
| information | | | operating as element | | | |
| | | | of the satellite group | | | |
| >Capability | O | | e.g., # of UEs, | | | |
| | | | whether to support | | | |
| | | | ISL, TN-NTN dual | | | |
| | | | connectivity, data | | | |
| | | | forwarding, # of | | | |
| | | | antennas | | | |
| Session | O | | Session ID for satellite | | | |
| Information | | | group | | | |
| | | | e.g., PDU session | | | |
| Bearer | O | | DRB(data radio | | | |
| Information | | | bearer) ID, | | | |
| | | | SRB(signaling radio | | | |
| | | | bearer) ID for Satellite | | | |
| | | | group | | | |
| Cell | O | | Cell list for satellite | | | |
| Information | | | group | | | |
| | | | e.g., PCI, CGI | | | |
| Space Area | O | | | | | |
| Information | | | | | | |
| >Space | O | | indicates a specified | | | |
| Area id | | | space area | | | |
| >height | O | | a range of space area | | | |
| threshold | | | | | | |
| Validity | O | | time duration for | | | |
| Time | | | satellite group | | | |
| | | | because satellite | | | |
| | | | moves continuously | | | |
| Tracking | O | | TA list for satellite | | | |
| Area | | | groyp | | | |
| Information | | | | | | |
| >Tracking | O | | TAC, TAI, PLMN | | | |
| Area List | | | Identity | | | |
| Satellite | O | | | | | |
| group Type | | | | | | |
| GPS | O | | GPS information of | | | |
| information | | | ground entity for | | | |
| | | | supporting satellite | | | |
| | | | group | | | |

For the IEs according to the above Table 15, the 3GPP TS 38.473 standard may be referred to.

According to an embodiment, the first message may be a GNB-DU status indication message. If the first message is a GNB-DU status indication message, transmission of the second message may be omitted. The GNB-DU status indication message may include at least one item of the information of Table 13. For example, the first message may include the following IEs as exemplified in Table 16.

TABLE 16

| | | | | | | |
|---|---|---|---|---|---|---|
| | | | IE type and | Semantics | | Assigned |
| IE/Group Name | Presence | Range | reference | description | Criticality | Criticality |

| | | | | |
|---|---|---|---|---|
| Message Type | M | 9.3.1.1 | YES | ignore |
| Transaction ID | M | 9.3.1.23 | YES | reject |
| gNB-DU Overload | M | ENUMERATED | YES | reject |
| Information | | (overloaded, | | |
| | | not- | | |
| | | overloaded) | | |
| IAB Congestion | O | 9.3.1.227 | YES | ignore |
| Indication | | | | |
| Satellite Group ID | O | indicates | | |
| | | satellite | | |
| | | group for | | |
| | | service | | |
| Satellite ID | O | Master | | |
| | | Satellite | | |
| | | within | | |
| | | satellite | | |
| | | group | | |
| Candidate Satellite | O | Satellites | | |
| list | | within | | |
| | | satellite | | |
| | | group | | |
| >Satellite ID | O | e.g., gNB ID, | | |
| | | DU ID, cell ID | | |
| >PositionVelocity | O | e.g., | | |
| | | positionX, | | |
| | | positionY, | | |
| | | positionZ, | | |
| | | velocityX, | | |
| | | velocityY, | | |
| | | velocityZ | | |
| >Orbit | O | e.g., | | |
| | | ephemeris | | |
| | | info, | | |
| | | semiMajorAxis, | | |
| | | eccentricity, | | |
| | | periapsis, | | |
| | | longitude, | | |
| | | inclination, | | |
| | | meanAnomaly | | |
| >type | O | LEO, GEO, | | |
| | | MEO | | |
| >time information | O | indicates time | | |
| | | zone | | |
| | | operating as | | |
| | | element of | | |
| | | the satellite | | |
| | | group | | |
| >Capability | O | e.g., # of | | |
| | | UEs, whether | | |
| | | to support | | |
| | | ISL, TN-NTN | | |
| | | dual | | |
| | | connectivity, | | |
| | | data | | |
| | | forwarding, # | | |
| | | of antennas | | |
| Session Information | O | Session ID for | | |
| | | satellite group | | |
| | | e.g., PDU | | |
| | | session | | |
| Bearer Information | O | DRB(data | | |
| | | radio bearer) | | |
| | | ID, | | |
| | | SRB(signaling | | |
| | | radio | | |
| | | bearer) ID for | | |
| | | Satellite | | |
| | | group | | |
| Cell Information | O | Cell list for | | |
| | | satellite group | | |
| | | e.g., PCI, | | |
| | | CGI | | |
| Space Area | O | | | |
| Information | | | | |
| >Space Area id | O | indicates a | | |
| | | specified | | |
| | | space area | | |
| >height threshold | O | a range of | | |
| | | space area | | |
| Validity Time | O | time duration | | |
| | | for satellite | | |
| | | group | | |
| | | because | | |
| | | satellite | | |
| | | moves | | |
| | | continuously | | |
| Tracking Area | O | TA list for | | |
| Information | | satellite groyp | | |
| >Tracking Area List | O | TAC, TAI, | | |
| | | PLMN | | |
| | | Identity | | |
| Satellite group Type | O | | | |
| GPS information | O | GPS | | |
| | | information of | | |
| | | ground entity | | |
| | | for supporting | | |
| | | satellite | | |
| | | group | | |

For the IEs according to the above Table 16, the 3GPP TS 38.473 standard may be referred to.

Referring to FIG. 11B, in operation 1151, the gNB-CU 1120 may transmit a first message to the gNB-DU 1110 via the F1 interface. The gNB-DU 1110 may receive the first message from the gNB-CU 1120.

In operation 1153, the gNB-DU 1110 may transmit a second message to the gNB-CU 1120 via the F1 interface. The gNB-CU 1120 may receive the second message from the gNB-DU 1110.

According to an embodiment, the first message may be a GNB-CU configuration update message, and the second message may be a gNB-CU configuration update acknowledge message. The gNB-CU 1120 may transmit the gNB-CU configuration update message to the gNB-DU 1110 through the F1 interface. The gNB-DU 1110 may transmit the GNB-CU configuration update acknowledge message to the gNB-CU 1120 through the F1 interface. The GNB-CU configuration update message may include at least one item of the information of Table 13. The GNB-CU configuration update acknowledge message may include at least one item of the information of Table 13. For example, the first message may include the following IEs as exemplified in Table 17.

TABLE 17

| IE/Group | | | IE type and | Semantics | | Assigned |
|---|---|---|---|---|---|---|
| Name | Presence | Range | reference | description | Criticality | Criticality |
| Message | M | | 9.3.1.1 | | YES | reject |
| Type | | | | | | |
| Transaction | M | | 9.3.1.23 | | YES | reject |
| ID | | | | | | |
| Cells to be | | 0 . . . 1 | | List of | YES | reject |
| Activated | | | | cells to | | |
| List | | | | be | | |
| | | | | activated | | |
| | | | | or | | |
| | | | | modified | | |
| >Cells to | | 1 . . . | | | EACH | reject |
| be | | <maxCellingNBDU> | | | | |
| Activated | | | | | | |
| List Item | | | | | | |
| >>NR | M | | 9.3.1.12 | | — | |
| CGI | | | | | | |
| >>NR | O | | INTEGER (0 . . . 1007) | Physical | — | |
| PCI | | | | Cell ID | | |
| >>gNB- | O | | 9.3.1.42 | RRC | YES | reject |
| CU | | | | container | | |
| System | | | | with | | |
| Information | | | | system | | |
| | | | | information | | |
| | | | | owned | | |
| | | | | by gNB- | | |
| | | | | CU | | |
| >>Available | O | | 9.3.1.65 | | YES | ignore |
| PLMN | | | | | | |
| List | | | | | | |
| >>Extended | O | | 9.3.1.76 | This is | YES | ignore |
| Available | | | | included | | |
| PLMN | | | | if | | |
| List | | | | Available | | |
| | | | | PLMN | | |
| | | | | List IE is | | |
| | | | | included | | |
| | | | | and if | | |
| | | | | more | | |
| | | | | than 6 | | |
| | | | | Available | | |
| | | | | PLMNs | | |
| | | | | is to be | | |
| | | | | signalled | | |
| >>IAB | O | | 9.3.1.105 | IAB- | YES | ignore |
| Info | | | | related | | |
| IAB- | | | | configuration | | |
| donor- | | | | sent by | | |
| CU | | | | the IAB- | | |
| | | | | donor- | | |
| | | | | CU. | | |
| >>Available | O | | 9.3.1.163 | Indicates | YES | ignore |
| SNPN | | | | the | | |
| ID List | | | | available | | |
| | | | | SNPN | | |
| | | | | ID list. | | |
| | | | | If this IE | | |
| | | | | is | | |
| | | | | included, | | |
| | | | | the | | |
| | | | | content | | |
| | | | | of the | | |
| | | | | Available | | |
| | | | | PLMN | | |
| | | | | List IE | | |
| | | | | and | | |
| | | | | Extended | | |
| | | | | Available | | |
| | | | | PLMN | | |
| | | | | List IE if | | |
| | | | | present | | |
| | | | | in the | | |
| | | | | Cells to | | |
| | | | | be | | |
| | | | | Activated | | |
| | | | | List | | |
| | | | | Item IE | | |
| | | | | is | | |
| | | | | ignored. | | |
| >>MBS | O | | 9.3.1.226 | | YES | ignore |
| Broadcast | | | | | | |
| Neighbour | | | | | | |
| Cell | | | | | | |
| List | | | | | | |
| Cells to be | | 0 . . . 1 | | List of | YES | reject |
| Deactivated | | | | cells to | | |
| List | | | | be | | |
| | | | | deactivated | | |
| >Cells to | | 1 . . . | | | EACH | reject |
| be | | <maxCellingNBDU> | | | | |
| Deactivated | | | | | | |
| List | | | | | | |
| Item | | | | | | |
| >> NR | M | | 9.3.1.12 | | — | |
| CGI | | | | | | |
| gNB-CU | | 0 . . . 1 | | | YES | ignore |
| TNL | | | | | | |
| Association | | | | | | |
| To Add List | | | | | | |
| >gNB-CU | | 1 . . . | | | EACH | ignore |
| TNL | | <maxnoofTNLAssociations> | | | | |
| Association | | | | | | |
| To | | | | | | |
| Add Item | | | | | | |
| IEs | | | | | | |
| >>TNL | M | | CP Transport Layer | Transport | — | |
| Association | | | Address | Layer | | |
| Transport | | | 9.3.2.4 | Address | | |
| Layer | | | | of the | | |
| Information | | | | gNB-CU. | | |
| >>TNL | M | | ENUMERATED (ue, | Indicates | — | |
| Association | | | non-ue, both, . . . ) | whether | | |
| Usage | | | | the TNL | | |
| | | | | association | | |
| | | | | is | | |
| | | | | only | | |
| | | | | used for | | |
| | | | | UE- | | |
| | | | | associated | | |
| | | | | signalling, | | |
| | | | | or | | |
| | | | | non-UE- | | |
| | | | | associated | | |
| | | | | signalling, | | |
| | | | | or | | |
| | | | | both. For | | |
| | | | | usage of | | |
| | | | | this IE, | | |
| | | | | refer to | | |
| | | | | TS | | |
| | | | | 38.472 | | |
| | | | | [22]. | | |
| gNB-CU | | 0 . . . 1 | | | YES | ignore |
| TNL | | | | | | |
| Association | | | | | | |
| To Remove | | | | | | |
| List | | | | | | |
| >gNB-CU | | 1 . . . | | | EACH | ignore |
| TNL | | <maxnoofTNLAssociation> | | | | |
| Association | | | | | | |
| To | | | | | | |
| Remove | | | | | | |
| Item IEs | | | | | | |
| >>TNL | M | | CP Transport Layer | Transport | — | |
| Association | | | Address | Layer | | |
| Transport | | | 9.3.2.4 | Address | | |
| Layer | | | | of the | | |
| Address | | | | gNB-CU. | | |
| >>TNL | O | | CP Transport Layer | Transport | YES | reject |
| Association | | | Address | Layer | | |
| Transport | | | 9.3.2.4 | Address | | |
| Layer | | | | of the | | |
| Address | | | | gNB-DU. | | |
| gNB- | | | | | | |
| DU | | | | | | |
| gNB-CU | | 0 . . . 1 | | | YES | ignore |
| TNL | | | | | | |
| Association | | | | | | |
| To Update | | | | | | |
| List | | | | | | |
| >gNB-CU | | 1 . . . | | | EACH | ignore |
| TNL | | <maxnoofTNLAssociations> | | | | |
| Association | | | | | | |
| To | | | | | | |
| Update | | | | | | |
| Item IEs | | | | | — | |
| >>TNL | M | | CP Transport Layer | Transport | | |
| Association | | | Address | Layer | | |
| Transport | | | 9.3.2.4 | Address | | |
| Layer | | | | of the | | |
| | | | | gNB-CU. | | |
| Address | | | | | | |
| >>TNL | O | | ENUMERATED (ue, | Indicates | — | |
| Association | | | non-ue, both, . . . ) | whether | | |
| Usage | | | | the TNL | | |
| | | | | association | | |
| | | | | is | | |
| | | | | only | | |
| | | | | used for | | |
| | | | | UE- | | |
| | | | | associated | | |
| | | | | signalling, | | |
| | | | | or | | |
| | | | | non-UE- | | |
| | | | | associated | | |
| | | | | signalling, | | |
| | | | | or | | |
| | | | | both. For | | |
| | | | | usage of | | |
| | | | | this IE, | | |
| | | | | refer to | | |
| | | | | TS | | |
| | | | | 38.472 | | |
| | | | | [22]. | | |
| Cells to be | | 0 . . . 1 | | List of | YES | ignore |
| barred List | | | | cells to | | |
| | | | | be | | |
| | | | | barred. | | |
| >Cells to | | 1 . . . | | | EACH | ignore |
| be barred | | <maxCellingNBDU> | | | | |
| List Item | | | | | | |
| >>NR | M | | 9.3.1.12 | | — | |
| CGI | | | | | | |
| >>Cell | M | | ENUMERATED | | — | |
| Barred | | | (barred, not- | | | |
| | | | barred, . . . ) | | | |
| >>IAB | O | | ENUMERATED | | — | |
| Barred | | | (barred, not- | | | |
| | | | barred, . . . ) | | | |
| Protected | | 0 . . . 1 | | List of | YES | reject |
| E-UTRA | | | | Protected | | |
| Resources | | | | E- | | |
| List | | | | UTRA | | |
| | | | | Resources. | | |
| >Protected | | 1 . . . <maxCellineNB> | | | EACH | reject |
| E- | | | | | | |
| UTRA | | | | | | |
| Resources | | | | | | |
| List | | | | | | |
| Item | | | | | | |
| >>Spectrum | M | | INTEGER (1 . . . | Indicates | — | |
| Sharing | | | maxCellineNB) | the E- | | |
| Group | | | | UTRA | | |
| ID | | | | cells | | |
| | | | | involved | | |
| | | | | in | | |
| | | | | resource | | |
| | | | | coordination | | |
| | | | | with | | |
| | | | | the NR | | |
| | | | | cells | | |
| | | | | affiliated | | |
| | | | | with the | | |
| | | | | same | | |
| | | | | Spectrum | | |
| | | | | Sharing | | |
| | | | | Group | | |
| | | | | ID. | | |
| >>E- | | 1 | | List of | — | |
| UTRA | | | | applicable | | |
| Cells | | | | E- | | |
| List | | | | UTRA | | |
| | | | | cells. | | |
| >>>E- | | 1 . . . <maxCellineNB> | | | — | |
| UTRA Cells | | | | | | |
| List Item | | | | | | |
| >>>>EUTRA | M | | BIT STRING | Indicates | — | |
| Cell ID | | | (SIZE(28)) | the E- | | |
| | | | | UTRAN | | |
| | | | | Cell | | |
| | | | | Identifier | | |
| | | | | IE | | |
| | | | | contained | | |
| | | | | in the | | |
| | | | | ECGI as | | |
| | | | | defined | | |
| | | | | in | | |
| | | | | subclause | | |
| | | | | 9.2.14 | | |
| | | | | in TS | | |
| | | | | 36.423 | | |
| | | | | [9]. | | |
| >>>>Served | M | | 9.3.1.64 | | — | |
| E-UTRA | | | | | | |
| Cell | | | | | | |
| Information | | | | | | |
| Neighbour | | 0 . . . 1 | | | YES | ignore |
| Cell | | | | | | |
| Information | | | | | | |
| List | | | | | | |
| >Neighbour | | 1 . . . | | | EACH | ignore |
| Cell | | <maxCellingNBDU> | | | | |
| Information | | | | | | |
| List | | | | | | |
| Item | | | | | | |
| >>NR | M | | 9.3.1.12 | | — | |
| CGI | | | | | | |
| >>Intended | O | | 9.3.1.89 | | — | |
| TDD | | | | | | |
| DL-UL | | | | | | |
| Configuration | | | | | | |
| Transport | O | | 9.3.2.5 | | YES | ignore |
| Layer | | | | | | |
| Address Info | | | | | | |
| Uplink BH | O | | 9.3.1.103 | | YES | reject |
| Non-UP | | | | | | |
| Traffic | | | | | | |
| Mapping | | | | | | |
| BAP | O | | 9.3.1.111 | Indicates | YES | ignore |
| Address | | | | a BAP | | |
| | | | | address | | |
| | | | | assigned | | |
| | | | | to the | | |
| | | | | IAB- | | |
| | | | | donor- | | |
| | | | | DU. | | |
| CCO | O | | 9.3.1.211 | Indicates | YES | Ignore |
| Assistance | | | | CCO | | |
| Information | | | | Assistance | | |
| | | | | Information | | |
| | | | | for | | |
| | | | | cells and | | |
| | | | | beams | | |
| | | | | served | | |
| | | | | by the | | |
| | | | | gNB-DU | | |
| | | | | of the | | |
| | | | | same | | |
| | | | | NG-RAN | | |
| | | | | node or | | |
| | | | | for cells | | |
| | | | | and | | |
| | | | | beams | | |
| | | | | not | | |
| | | | | served | | |
| | | | | by the | | |
| | | | | gNB-DU. | | |
| Cells for | O | | 9.3.1.214 | | YES | ignore |
| SON List | | | | | | |
| gNB-CU | O | | Printable String(SIZE(1 | Human | YES | ignore |
| Name | | | . . . 150, . . . )) | readable | | |
| | | | | name of | | |
| | | | | the gNB- | | |
| | | | | CU. | | |
| Extended | O | | 9.3.1.206 | | YES | ignore |
| gNB-CU | | | | | | |
| Name | | | | | | |
| Satellite | O | | indicates satellite | | | |
| Group ID | | | group for service | | | |
| Satellite ID | O | | Master Satellite within | | | |
| | | | satellite group | | | |
| Candidate | O | | Satellites within | | | |
| Satellite list | | | satellite group | | | |
| >Satellite ID | O | | e.g., gNB ID, DU ID, | | | |
| | | | cell ID | | | |
| >PositionVelocity | O | | e.g., positionX, | | | |
| | | | positionY, positionZ, | | | |
| | | | velocityX, velocityY, | | | |
| | | | velocityZ | | | |
| >Orbit | O | | e.g., ephemeris info, | | | |
| | | | semiMajorAxis, | | | |
| | | | eccentricity, periapsis, | | | |
| | | | longitude, inclination, | | | |
| | | | meanAnomaly | | | |
| >type | O | | LEO, GEO, MEO | | | |
| >time | O | | indicates time zone | | | |
| information | | | operating as element | | | |
| | | | of the satellite group | | | |
| >Capability | O | | e.g., # of UEs, | | | |
| | | | whether to support | | | |
| | | | ISL, TN-NTN dual | | | |
| | | | connectivity, data | | | |
| | | | forwarding, # of | | | |
| | | | antennas | | | |
| Session | O | | Session ID for satellite | | | |
| Information | | | group | | | |
| | | | e.g., PDU session | | | |
| Bearer | O | | DRB(data radio | | | |
| Information | | | bearer) ID, | | | |
| | | | SRB(signaling radio | | | |
| | | | bearer) ID for Satellite | | | |
| | | | group | | | |
| Cell | O | | Cell list for satellite | | | |
| Information | | | group | | | |
| | | | e.g., PCI, CGI | | | |
| Space Area | O | | | | | |
| Information | | | | | | |
| >Space | O | | indicates a specified | | | |
| Area id | | | space area | | | |
| >height | O | | a range of space area | | | |
| threshold | | | | | | |
| Validity Time | O | | time duration for | | | |
| | | | satellite group | | | |
| | | | because satellite | | | |
| | | | moves continuously | | | |
| Tracking | O | | TA list for satellite | | | |
| Area | | | groyp | | | |
| Information | | | | | | |
| >Tracking | O | | TAC, TAI, PLMN | | | |
| Area List | | | Identity | | | |
| Satellite | O | | | | | |
| group Type | | | | | | |
| GPS | O | | GPS information of | | | |
| information | | | ground entity for | | | |
| | | | supporting satellite | | | |
| | | | group | | | |

For the IEs according to the above Table 17, the 3GPP TS 38.473 standard may be referred to.

According to an embodiment, the first message may be a GNB-DU resource adjustment request message, and the second message may be a gNB-DU resource adjustment response message. The gNB-CU 1120 may transmit a GNB-DU resource adjustment request message to the gNB-DU 1110 through the Fr interface. The gNB-DU 1110 may transmit a GNB-DU resource adjustment response message to the gNB-CU 1120 through the F1 interface. The GNB-DU resource adjustment request message may include at least one item of the information in Table 5. The GNB-DU resource adjustment response message may include at least one item of the information in Table 5. For example, the first message may include the following IEs as exemplified in Table 18.

TABLE 18

| | | | | | | |
|---|---|---|---|---|---|---|
| | | | IE type and | Semantics | | Assigned |
| IE/Group Name | Presence | Range | reference | description | Criticality | Criticality |

| | | | | | |
|---|---|---|---|---|---|
| Message Type | M | 9.3.1.1 | | YES | reject |
| Transaction ID | M | 9.3.1.23 | | YES | reject |
| Request type | M | ENUMERATED | | YES | reject |
| | | (offer, | | | |
| | | execution, . . . ) | | | |
| E-UTRA - NR | M | OCTET | In EN-DC case, | YES | reject |
| Cell Resource | | STRING | includes the | | |
| Coordination | | | X2AP E-UTRA - | | |
| Request | | | NR CELL | | |
| Container | | | RESOURCE | | |
| | | | COORDINATION | | |
| | | | REQUEST | | |
| | | | message as | | |
| | | | defined in | | |
| | | | subclause | | |
| | | | 9.1.4.24 in TS | | |
| | | | 36.423 [9]. | | |
| | | | In NG-RAN | | |
| | | | cases, includes | | |
| | | | the XnAP E- | | |
| | | | UTRA - NR | | |
| | | | CELL | | |
| | | | RESOURCE | | |
| | | | COORDINATION | | |
| | | | REQUEST | | |
| | | | message as | | |
| | | | defined in | | |
| | | | subclause | | |
| | | | 9.1.2.23 in TS | | |
| | | | 38.423 [28]. | | |
| Ignore | O | ENUMERATED | | YES | reject |
| Coordination | | (yes, . . . ) | | | |
| Request | | | | | |
| Container | | | | | |
| Satellite Group | O | indicates | | | |
| ID | | satellite group | | | |
| | | for service | | | |
| Satellite ID | O | Master Satellite | | | |
| | | within satellite | | | |
| | | group | | | |
| Candidate | O | Satellites within | | | |
| Satellite list | | satellite group | | | |
| >Satellite ID | O | e.g., gNB ID, | | | |
| | | DU ID, cell ID | | | |
| >PositionVelocity | O | e.g., positionX, | | | |
| | | positionY, | | | |
| | | positionZ, | | | |
| | | velocityX, | | | |
| | | velocityY, | | | |
| | | velocityZ | | | |
| >Orbit | O | e.g., ephemeris | | | |
| | | info, | | | |
| | | semiMajorAxis, | | | |
| | | eccentricity, | | | |
| | | periapsis, | | | |
| | | longitude, | | | |
| | | inclination, | | | |
| | | meanAnomaly | | | |
| >type | O | LEO, GEO, | | | |
| | | MEO | | | |
| >time | O | indicates time | | | |
| information | | zone operating | | | |
| | | as element of | | | |
| | | the satellite | | | |
| | | group | | | |
| >Capability | O | e.g., # of UEs, | | | |
| | | whether to | | | |
| | | support ISL, | | | |
| | | TN-NTN dual | | | |
| | | connectivity, | | | |
| | | data | | | |
| | | forwarding, # of | | | |
| | | antennas | | | |
| Session | O | Session ID for | | | |
| Information | | satellite group | | | |
| | | e.g., PDU | | | |
| | | session | | | |
| Bearer | O | DRB(data radio | | | |
| Information | | bearer) ID, | | | |
| | | SRB(signaling | | | |
| | | radio bearer) | | | |
| | | ID for Satellite | | | |
| | | group | | | |
| Cell Information | O | Cell list for | | | |
| | | satellite group | | | |
| | | e.g., PCI, CGI | | | |
| Space Area | O | | | | |
| Information | | | | | |
| >Space Area id | O | indicates a | | | |
| | | specified space | | | |
| | | area | | | |
| >height | O | a range of | | | |
| threshold | | space area | | | |
| Validity Time | O | time duration | | | |
| | | for satellite | | | |
| | | group because | | | |
| | | satellite moves | | | |
| | | continuously | | | |
| Tracking Area | O | TA list for | | | |
| Information | | satellite groyp | | | |
| >Tracking Area | O | TAC, TAI, | | | |
| List | | PLMN Identity | | | |
| Satellite group | O | | | | |
| Type | | | | | |
| GPS information | O | GPS | | | |
| | | information of | | | |
| | | ground entity | | | |
| | | for supporting | | | |
| | | satellite group | | | |

For the IEs according to the above Table 18, the 3GPP TS 38.473 specification may be referred to.

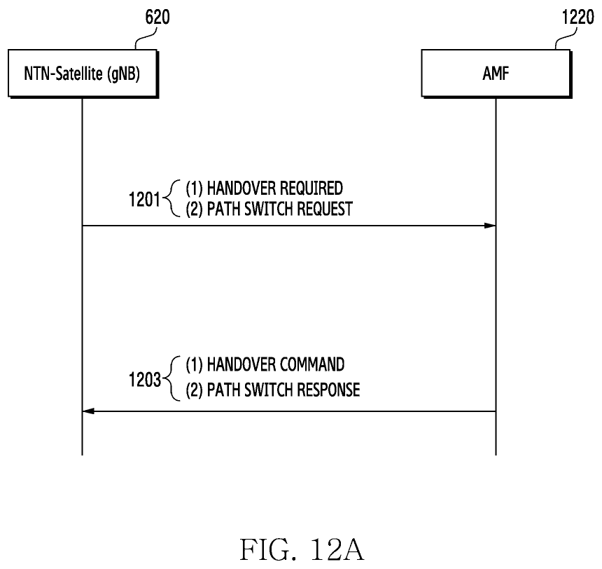

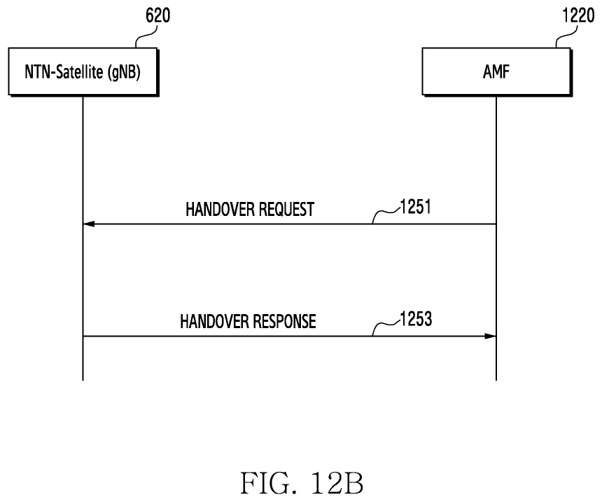

FIGS. 12A and 12B illustrate examples of signaling through an NG interface in the NTN. For the AMF for the NG interface, the descriptions of AMF 235 and AMF 640 may be referred to. A satellite group may be predefined by an operator of the satellites, an operator providing a ground gateway connected to the satellites, or a network operator, or may be set by a configuration of a network entity (e.g., AMF). If each satellite corresponds to a base station, i.e., gNB (or gNB-CU/gNB-DU), then the AMF connected to the satellite may control the link between satellites by transmitting a message to each gNB. Here, the link between satellites may be a direct communication between DUs and may be transparent to the AMF. For example, referring to FIG. 7B, as a serving satellite (e.g., the satellite 751) moves along an orbit, a target satellite instead of the serving satellite may perform communication with the first vehicle UE 761. The target satellite may perform communication with the first vehicle UE 761. In order for the first vehicle UE 761 to be continuously provided with the services without interruption, a terrestrial network entity (e.g., AMF) connected to the serving satellite may provide the serving satellite with information about the satellite group in advance. For the information related to the satellite group, the items in Table 13 may be referred to.

Referring to FIG. 12A, in operation 1201, the satellite 620 may transmit a first message to the AMF 1220 through an NG interface (e.g., N2 interface). The AMF 1220 may receive the first message from the satellite 620.

In operation 1203, the AMF 1220 may transmit a second message to the satellite 620 through the NG interface (e.g., N2 interface). The satellite 620 may receive the second message from the AMF 1220.

According to an embodiment, the first message may be a handover request message, and the second message may be a handover command message. The satellite 620 may transmit the handover request message to the AMF 1220 through the NG interface (e.g., N2 interface). The AMF 1220 may transmit the handover command message to the satellite 620 through the NG interface (e.g., N2 interface). The handover request message may include at least one item of the information of Table 13. The handover command message may include at least one item of the information of Table 13. For example, the first message may include the following IEs as exemplified in Table 19 below.

TABLE 19

| IE/Group | | | IE type and | Semantics | | Assigned |
|---|---|---|---|---|---|---|
| Name | Presence | Range | reference | description | Criticality | Criticality |
| Message | M | | 9.3.1.1 | | YES | reject |
| Type | | | | | | |
| AMF UE | M | | 9.3.3.1 | | YES | reject |
| NGAP ID | | | | | | |
| RAN UE | M | | 9.3.3.2 | | YES | reject |
| NGAP ID | | | | | | |
| Handover | M | | 9.3.1.22 | | YES | reject |
| Type | | | | | | |
| Cause | M | | 9.3.1.2 | | YES | ignore |
| Target ID | M | | 9.3.1.25 | | YES | reject |
| Direct | O | | 9.3.1.64 | | YES | ignore |
| Forwarding | | | | | | |
| Path | | | | | | |
| Availability | | | | | | |
| PDU Session | | 1 | | | YES | reject |
| Resource List | | | | | | |
| >PDU | | 1 . . . <maxnoofPDUSessions> | | | — | |
| Session | | | | | | |
| Resource | | | | | | |
| Item | | | | | | |
| >>PDU | M | | 9.3.1.50 | | — | |
| Session ID | | | | | | |
| >>Handover | M | | OCTET | Containing | — | |
| Required | | | STRING | the | | |
| Transfer | | | | Handover | | |
| | | | | Required | | |
| | | | | Transfer | | |
| | | | | IE | | |
| | | | | specified | | |
| | | | | in | | |
| | | | | subclause | | |
| | | | | 9.3.4.14. | | |
| Source to | M | | 9.3.1.20 | | YES | reject |
| Target | | | | | | |
| Transparent | | | | | | |
| Container | | | | | | |
| Satellite | O | | indicates | | | |
| Group ID | | | satellite | | | |
| | | | group for | | | |
| | | | service | | | |
| Satellite ID | O | | Master | | | |
| | | | Satellite | | | |
| | | | within | | | |
| | | | satellite | | | |
| | | | group | | | |
| Candidate | O | | Satellites | | | |
| Satellite list | | | within | | | |
| | | | satellite | | | |
| | | | group | | | |
| >Satellite ID | O | | e.g., gNB ID, | | | |
| | | | DU ID, cell | | | |
| | | | ID | | | |
| >PositionVelocity | O | | e.g., | | | |
| | | | positionX, | | | |
| | | | positionY, | | | |
| | | | positionZ, | | | |
| | | | velocityX, | | | |
| | | | velocityY, | | | |
| | | | velocityZ | | | |
| >Orbit | O | | e.g., | | | |
| | | | ephemeris | | | |
| | | | info, | | | |
| | | | semiMajorA | | | |
| | | | xis, | | | |
| | | | eccentricity, | | | |
| | | | periapsis, | | | |
| | | | longitude, | | | |
| | | | inclination, | | | |
| | | | meanAnomaly | | | |
| >type | O | | LEO, GEO, | | | |
| | | | MEO | | | |
| >time | O | | indicates | | | |
| information | | | time zone | | | |
| | | | operating as | | | |
| | | | element of | | | |
| | | | the satellite | | | |
| | | | group | | | |
| >Capability | O | | e.g., # of | | | |
| | | | UEs, | | | |
| | | | whether to | | | |
| | | | support ISL, | | | |
| | | | TN-NTN | | | |
| | | | dual | | | |
| | | | connectivity, | | | |
| | | | data | | | |
| | | | forwarding, | | | |
| | | | # of | | | |
| | | | antennas | | | |
| Session | O | | Session ID | | | |
| Information | | | for satellite | | | |
| | | | group | | | |
| | | | e.g., PDU | | | |
| | | | session | | | |
| Bearer | O | | DRB(data | | | |
| Information | | | radio bearer) | | | |
| | | | ID, | | | |
| | | | SRB(signaling | | | |
| | | | radio | | | |
| | | | bearer) ID | | | |
| | | | for Satellite | | | |
| | | | group | | | |
| Cell | O | | Cell list for | | | |
| Information | | | satellite | | | |
| | | | group | | | |
| | | | e.g., PCI, | | | |
| | | | CGI | | | |
| Space Area | O | | | | | |
| Information | | | | | | |
| >Space Area | O | | indicates a | | | |
| id | | | specified | | | |
| | | | space area | | | |
| >height | O | | a range of | | | |
| threshold | | | space area | | | |
| Validity Time | O | | time | | | |
| | | | duration for | | | |
| | | | satellite | | | |
| | | | group | | | |
| | | | because | | | |
| | | | satellite | | | |
| | | | moves | | | |
| | | | continuously | | | |
| Tracking Area | O | | TA list for | | | |
| Information | | | satellite | | | |
| | | | groyp | | | |
| >Tracking | O | | TAC, TAI, | | | |
| Area List | | | PLMN | | | |
| | | | Identity | | | |
| Satellite group | O | | | | | |
| Type | | | | | | |
| GPS | O | | GPS | | | |
| information | | | information | | | |
| | | | of ground | | | |
| | | | entity for | | | |
| | | | supporting | | | |
| | | | satellite | | | |
| | | | group | | | |

For the IEs according to Table 19, the 3GPP TS 38.413 standard may be referred to.

According to an embodiment, the first message may be a path switch request message, and the second message may be a path switch response message. The satellite 620 may transmit the path switch request message to the AMF 1220 through the NG interface (e.g., N2 interface). The AMF 1220 may transmit the path switch response message to the satellite 620 through the NG interface (e.g., N2 interface). The path switch request message may include at least one item of the information of Table 13. The path switch response message may include at least one item of the information in Table 13. For example, the first message may include the following IEs as exemplified in Table 20 below.

TABLE 20

| IE/Group | | | IE type and | Semantics | | Assigned |
|---|---|---|---|---|---|---|
| Name | Presence | Range | reference | description | Criticality | Criticality |
| Message | M | | 9.3.1.1 | | YES | reject |
| Type | | | | | | |
| RAN UE | M | | 9.3.3.2 | | YES | reject |
| NGAP ID | | | | | | |
| Source AMF | M | | AMF UE | | YES | reject |
| UE NGAP ID | | | NGAP ID | | | |
| | | | 9.3.3.1 | | | |
| User Location | M | | 9.3.1.16 | | YES | ignore |
| Information | | | | | | |
| UE Security | M | | 9.3.1.86 | | YES | ignore |
| Capabilities | | | | | | |
| PDU Session | | 1 | | | YES | reject |
| Resource to | | | | | | |
| be Switched | | | | | | |
| in Downlink | | | | | | |
| List | | | | | | |
| >PDU | | 1 . . . <maxnoofPDUSessions> | | | — | |
| Session | | | | | | |
| Resource to | | | | | | |
| be Switched | | | | | | |
| in Downlink | | | | | | |
| Item | | | | | | |
| >>PDU | M | | 9.3.1.50 | | — | |
| Session ID | | | | | | |
| >>Path Switch | M | | OCTET | Containing | — | |
| Request | | | STRING | the Path | | |
| Transfer | | | | Switch | | |
| | | | | Request | | |
| | | | | Transfer | | |
| | | | | IE | | |
| | | | | specified | | |
| | | | | in | | |
| | | | | subclause | | |
| | | | | 9.3.4.8. | | |
| PDU Session | | 0 . . . 1 | | | YES | ignore |
| Resource | | | | | | |
| Failed to | | | | | | |
| Setup List | | | | | | |
| >PDU | | 1 . . . <maxnoofPDUSessions> | | | — | |
| Session | | | | | | |
| Resource | | | | | | |
| Failed to | | | | | | |
| Setup Item | | | | | | |
| >>PDU | M | | 9.3.1.50 | | — | |
| Session ID | | | | | | |
| >>Path Switch | M | | OCTET | Containing | — | |
| Request | | | STRING | the Path | | |
| Setup Failed | | | | Switch | | |
| Transfer | | | | Request | | |
| | | | | Setup | | |
| | | | | Failed | | |
| | | | | Transfer | | |
| | | | | IE | | |
| | | | | specified | | |
| | | | | in | | |
| | | | | subclause | | |
| | | | | 9.3.4.15. | | |
| RRC Resume | O | | RRC | | YES | ignore |
| Cause | | | Establishment | | | |
| | | | Cause | | | |
| | | | 9.3.1.111 | | | |
| RedCap | O | | 9.3.1.228 | | YES | ignore |
| Indication | | | | | | |
| Satellite | O | | indicates | | | |
| Group ID | | | satellite | | | |
| | | | group for | | | |
| | | | service | | | |
| Satellite ID | O | | Master | | | |
| | | | Satellite | | | |
| | | | within | | | |
| | | | satellite | | | |
| | | | group | | | |
| Candidate | O | | Satellites | | | |
| Satellite list | | | within | | | |
| | | | satellite | | | |
| | | | group | | | |
| >Satellite ID | O | | e.g., gNB ID, | | | |
| | | | DU ID, cell | | | |
| | | | ID | | | |
| >PositionVelo | O | | e.g., | | | |
| city | | | positionX, | | | |
| | | | positionY, | | | |
| | | | positionZ, | | | |
| | | | velocityX, | | | |
| | | | velocityY, | | | |
| | | | velocityZ | | | |
| >Orbit | O | | e.g., | | | |
| | | | ephemeris | | | |
| | | | info, | | | |
| | | | semiMajorAxis, | | | |
| | | | eccentricity, | | | |
| | | | periapsis, | | | |
| | | | longitude, | | | |
| | | | inclination, | | | |
| | | | meanAnomaly | | | |
| >type | O | | LEO, GEO, | | | |
| | | | MEO | | | |
| >time | O | | indicates | | | |
| information | | | time zone | | | |
| | | | operating as | | | |
| | | | element of | | | |
| | | | the satellite | | | |
| | | | group | | | |
| >Capability | O | | e.g., # of | | | |
| | | | UEs, | | | |
| | | | whether to | | | |
| | | | support ISL, | | | |
| | | | TN-NTN | | | |
| | | | dual | | | |
| | | | connectivity, | | | |
| | | | data | | | |
| | | | forwarding, | | | |
| | | | # of | | | |
| | | | antennas | | | |
| Session | O | | Session ID | | | |
| Information | | | for satellite | | | |
| | | | group | | | |
| | | | e.g., PDU | | | |
| | | | session | | | |
| Bearer | O | | DRB(data | | | |
| Information | | | radio bearer) | | | |
| | | | ID, | | | |
| | | | SRB(signaling | | | |
| | | | radio | | | |
| | | | bearer) ID | | | |
| | | | for Satellite | | | |
| | | | group | | | |
| Cell | O | | Cell list for | | | |
| Information | | | satellite | | | |
| | | | group | | | |
| | | | e.g., PCI, | | | |
| | | | CGI | | | |
| Space Area | O | | | | | |
| Information | | | | | | |
| >Space Area | O | | indicates a | | | |
| id | | | specified | | | |
| | | | space area | | | |
| >height | O | | a range of | | | |
| threshold | | | space area | | | |
| Validity Time | O | | time | | | |
| | | | duration for | | | |
| | | | satellite | | | |
| | | | group | | | |
| | | | because | | | |
| | | | satellite | | | |
| | | | moves | | | |
| | | | continuously | | | |
| Tracking Area | O | | TA list for | | | |
| Information | | | satellite | | | |
| | | | groyp | | | |
| >Tracking | O | | TAC, TAI, | | | |
| Area List | | | PLMN | | | |
| | | | Identity | | | |
| Satellite group | O | | | | | |
| Type | | | | | | |
| GPS | O | | GPS | | | |
| information | | | information | | | |
| | | | of ground | | | |
| | | | entity for | | | |
| | | | supporting | | | |
| | | | satellite | | | |
| | | | group | | | |

For the IEs according to the above Table 20, the 3GPP TS 38.413 standard may be referred to.

Referring to FIG. 12B, in operation 1251, the AMF 1220 may transmit a first message to the satellite 620 through the NG interface (e.g., N2 interface). The satellite 620 may receive the first message from the AMF 1220.

In operation 1253, the satellite 620 may transmit a second message to the AMF 1220 through the NG interface (e.g., N2 interface). The AMF 1220 may receive the second message from the satellite 620.

According to an embodiment, the first message may be a handover request message, and the second message may be a handover response message. The AMF 1220 may transmit the handover request message to the satellite 620 through the NG interface (e.g., N2 interface). The Satellite 620 may transmit the handover response message to the AMF 1220 through the NG interface (e.g., N2 interface). The handover request message may include at least one item of the information in Table 13. The handover response message may include at least one item of the information in Table 13. For example, the first message may include the following IEs as illustrated in Table 21 below.

TABLE 21

| IE/Group | | | IE type and | Semantics | | Assigned |
|---|---|---|---|---|---|---|
| Name | Presence | Range | reference | description | Criticality | Criticality |
| Message | M | | 9.3.1.1 | | YES | reject |
| Type | | | | | | |
| AMF UE | M | | 9.3.3.1 | | YES | reject |
| NGAP ID | | | | | | |
| Handover | M | | 9.3.1.22 | | YES | reject |
| Type | | | | | | |
| Cause | M | | 9.3.1.2 | | YES | ignore |
| UE Aggregate | M | | 9.3.1.58 | | YES | reject |
| Maximum Bit | | | | | | |
| Rate | | | | | | |
| Core Network | O | | 9.3.1.15 | | YES | ignore |
| Assistance | | | | | | |
| Information for | | | | | | |
| RRC | | | | | | |
| INACTIVE | | | | | | |
| UE Security | M | | 9.3.1.86 | | YES | reject |
| Capabilities | | | | | | |
| Security | M | | 9.3.1.88 | | YES | reject |
| Context | | | | | | |
| New Security | O | | 9.3.1.55 | | YES | reject |
| Context | | | | | | |
| Indicator | | | | | | |
| NASC | O | | NAS-PDU | Refers to | YES | reject |
| | | | 9.3.3.4 | either the | | |
| | | | | “Intra N1 | | |
| | | | | mode | | |
| | | | | NAS | | |
| | | | | transparent | | |
| | | | | container” | | |
| | | | | or the “S1 | | |
| | | | | mode to | | |
| | | | | N1 mode | | |
| | | | | NAS | | |
| | | | | transparent | | |
| | | | | container”, | | |
| | | | | the | | |
| | | | | details of | | |
| | | | | the IE | | |
| | | | | definition | | |
| | | | | and the | | |
| | | | | encoding | | |
| | | | | arespecified | | |
| | | | | in TS | | |
| | | | | 24.501 | | |
| | | | | [26] | | |
| PDU Session | | 1 | | | YES | reject |
| Resource | | | | | | |
| Setup List | | | | | | |
| >PDU | | 1 . . . <maxnoofPDUSessions> | | | — | |
| Session | | | | | | |
| Resource | | | | | | |
| Setup Item | | | | | | |
| >>PDU | M | | 9.3.1.50 | | — | |
| Session ID | | | | | | |
| >>S-NSSAI | M | | 9.3.1.24 | | — | |
| >>Handover | M | | OCTET | Containing | — | |
| Request | | | STRING | the | | |
| Transfer | | | | PDU | | |
| | | | | Session | | |
| | | | | Resource | | |
| | | | | Setup | | |
| | | | | Request | | |
| | | | | Transfer | | |
| | | | | IE | | |
| | | | | specified | | |
| | | | | in | | |
| | | | | subclause | | |
| | | | | 9.3.4.1 | | |
| >>PDU | O | | Expected | Expected | YES | ignore |
| Session | | | UE Activity | UE | | |
| Expected UE | | | Behaviour | Activity | | |
| Activity | | | 9.3.1.94 | Behaviour | | |
| Behaviour | | | | for the | | |
| | | | | PDU | | |
| | | | | Session. | | |
| Allowed | M | | 9.3.1.31 | Indicates | YES | reject |
| NSSAI | | | | the S- | | |
| | | | | NSSAIs | | |
| | | | | permitted | | |
| | | | | by the | | |
| | | | | network. | | |
| Trace | O | | 9.3.1.14 | | YES | ignore |
| Activation | | | | | | |
| Masked | O | | 9.3.1.54 | | YES | ignore |
| IMEISV | | | | | | |
| Source to | M | | 9.3.1.20 | | YES | reject |
| Target | | | | | | |
| Transparent | | | | | | |
| Container | | | | | | |
| Mobility | O | | 9.3.1.85 | | YES | ignore |
| Restriction | | | | | | |
| List | | | | | | |
| Location | O | | 9.3.1.65 | | YES | ignore |
| Reporting | | | | | | |
| Request Type | | | | | | |
| RRC Inactive | O | | 9.3.1.91 | | YES | ignore |
| Transition | | | | | | |
| Report | | | | | | |
| Request | | | | | | |
| GUAMI | M | | 9.3.3.3 | | YES | reject |
| Redirection | O | | 9.3.1.116 | | YES | ignore |
| for Voice EPS | | | | | | |
| Fallback | | | | | | |
| CN Assisted | O | | 9.3.1.119 | | YES | ignore |
| RAN | | | | | | |
| Parameters | | | | | | |
| Tuning | | | | | | |
| SRVCC | O | | 9.3.1.128 | | YES | ignore |
| Operation | | | | | | |
| Possible | | | | | | |
| IAB | O | | 9.3.1.129 | | YES | reject |
| Authorized | | | | | | |
| Enhanced | O | | 9.3.1.140 | | YES | ignore |
| Coverage | | | | | | |
| Restriction | | | | | | |
| UE | O | | 9.3.1.144 | | YES | ignore |
| Differentiation | | | | | | |
| Information | | | | | | |
| NR V2X | O | | 9.3.1.146 | | YES | ignore |
| Services | | | | | | |
| Authorized | | | | | | |
| LTE V2X | O | | 9.3.1.147 | | YES | ignore |
| Services | | | | | | |
| Authorized | | | | | | |
| NR UE | O | | 9.3.1.148 | This IE | YES | ignore |
| Sidelink | | | | applies | | |
| Aggregate | | | | only if the | | |
| Maximum Bit | | | | UE is | | |
| Rate | | | | authorized | | |
| | | | | for NR | | |
| | | | | V2X | | |
| | | | | services. | | |
| LTE UE | O | | 9.3.1.149 | This IE | YES | ignore |
| Sidelink | | | | applies | | |
| Aggregate | | | | only if the | | |
| Maximum Bit | | | | UE is | | |
| Rate | | | | authorized | | |
| | | | | for LTE | | |
| | | | | V2X | | |
| | | | | services. | | |
| PC5 QoS | O | | 9.3.1.150 | This IE | YES | ignore |
| Parameters | | | | applies | | |
| | | | | only if the | | |
| | | | | UE is | | |
| | | | | authorized | | |
| | | | | for NR | | |
| | | | | V2X | | |
| | | | | services. | | |
| CE-mode-B | O | | 9.3.1.155 | | YES | ignore |
| Restricted | | | | | | |
| UE User | O | | 9.3.1.160 | | YES | ignore |
| Plane CloT | | | | | | |
| Support | | | | | | |
| Indicator | | | | | | |
| Management | O | | MDT PLMN | | YES | ignore |
| Based MDT | | | List | | | |
| PLMN List | | | 9.3.1.168 | | | |
| UE Radio | O | | 9.3.1.142 | | YES | reject |
| Capability ID | | | | | | |
| Extended | O | | 9.3.3.31 | | YES | ignore |
| Connected | | | | | | |
| Time | | | | | | |
| Time | O | | 9.3.1.220 | | YES | ignore |
| Synchronisation | | | | | | |
| Assistance | | | | | | |
| Information | | | | | | |
| UE Slice | O | | 9.3.1.231 | | YES | ignore |
| Maximum Bit | | | | | | |
| Rate List | | | | | | |
| 5G ProSe | O | | 9.3.1.233 | | YES | ignore |
| Authorized | | | | | | |
| 5G ProSe UE | O | | NR UE | This IE | YES | ignore |
| PC5 | | | Sidelink | applies | | |
| Aggregate | | | Aggregate | only if the | | |
| Maximum Bit | | | Maximum | UE is | | |
| Rate | | | Bit Rate | authorize | | |
| | | | 9.3.1.148 | d for 5G | | |
| | | | | ProSe | | |
| | | | | services. | | |
| 5G ProSe | O | | 9.3.1.234 | This IE | YES | ignore |
| PC5 QoS | | | | applies | | |
| Parameters | | | | only if the | | |
| | | | | UE is | | |
| | | | | authorized | | |
| | | | | for 5G | | |
| | | | | ProSe | | |
| | | | | services. | | |
| Satellite | O | | indicates | | | |
| Group ID | | | satellite | | | |
| | | | group for | | | |
| | | | service | | | |
| Satellite ID | O | | Master | | | |
| | | | Satellite | | | |
| | | | within | | | |
| | | | satellite | | | |
| | | | group | | | |
| Candidate | O | | Satellites | | | |
| Satellite list | | | within | | | |
| | | | satellite | | | |
| | | | group | | | |
| >Satellite ID | O | | e.g., gNB ID, | | | |
| | | | DU ID, cell | | | |
| | | | ID | | | |
| >PositionVelocity | O | | e.g., | | | |
| | | | positionX, | | | |
| | | | positionY, | | | |
| | | | positionZ, | | | |
| | | | velocityX, | | | |
| | | | velocityY, | | | |
| | | | velocityZ | | | |
| >Orbit | O | | e.g., | | | |
| | | | ephemeris | | | |
| | | | info, | | | |
| | | | semiMajorAxis, | | | |
| | | | eccentricity, | | | |
| | | | periapsis, | | | |
| | | | longitude, | | | |
| | | | inclination, | | | |
| | | | meanAnomaly | | | |
| >type | O | | LEO, GEO, | | | |
| | | | MEO | | | |
| >time | O | | indicates | | | |
| information | | | time zone | | | |
| | | | operating as | | | |
| | | | element of | | | |
| | | | the satellite | | | |
| | | | group | | | |
| >Capability | O | | e.g., # of | | | |
| | | | UEs, | | | |
| | | | whether to | | | |
| | | | support ISL, | | | |
| | | | TN-NTN | | | |
| | | | dual | | | |
| | | | connectivity, | | | |
| | | | data | | | |
| | | | forwarding, | | | |
| | | | # of | | | |
| | | | antennas | | | |
| Session | O | | Session ID | | | |
| Information | | | for satellite | | | |
| | | | group | | | |
| | | | e.g., PDU | | | |
| | | | session | | | |
| Bearer | O | | DRB(data | | | |
| Information | | | radio bearer) | | | |
| | | | ID, | | | |
| | | | SRB(signaling | | | |
| | | | radio | | | |
| | | | bearer) ID | | | |
| | | | for Satellite | | | |
| | | | group | | | |
| Cell | O | | Cell list for | | | |
| Information | | | satellite | | | |
| | | | group | | | |
| | | | e.g., PCI, | | | |
| | | | CGI | | | |
| Space Area | O | | | | | |
| Information | | | | | | |
| >Space Area | O | | indicates a | | | |
| id | | | specified | | | |
| | | | space area | | | |
| >height | O | | a range of | | | |
| threshold | | | space area | | | |
| Validity Time | O | | time | | | |
| | | | duration for | | | |
| | | | satellite | | | |
| | | | group | | | |
| | | | because | | | |
| | | | satellite | | | |
| | | | moves | | | |
| | | | continuously | | | |
| Tracking Area | O | | TA list for | | | |
| Information | | | satellite | | | |
| | | | groyp | | | |
| >Tracking | O | | TAC, TAI, | | | |
| Area List | | | PLMN | | | |
| | | | Identity | | | |
| Satellite group | O | | | | | |
| Type | | | | | | |
| GPS | O | | GPS | | | |
| information | | | information | | | |
| | | | of ground | | | |
| | | | entity for | | | |
| | | | supporting | | | |
| | | | satellite | | | |
| | | | group | | | |

For the IEs according to the above Table 21, the 3GPP TS 38.413 standard may be referred to.

Although FIG. 12B illustrates the handover request message and the handover response message as an example, the embodiment of the disclosure is not limited thereto. In addition to the handover in which a cell is changed, a mobility order message and a mobility response message may be used in an embodiment of the disclosure as messages used to confirm the mobility of a terminal.

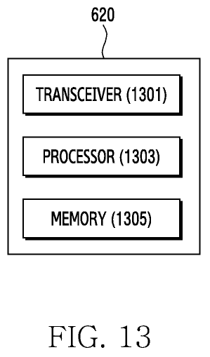

FIG. 13 illustrates an example of components of a satellite (e.g., satellite 260, satellite 620). As used herein, terms such as ‘ . . . part’, ‘ . . . unit’, etc. may refer to a unit that processes at least one function or operation, which may be implemented by hardware, software, or a combination of hardware and software.

Referring to FIG. 13, the satellite 620 may include a transceiver 1301, a processor 1303, and a memory 1305. The transceiver 1301 may perform functions for transmitting and receiving signals over a wireless channel. For example, the transceiver 1301 may up-converts a baseband signal into an RF band signal and then transmits it through an antenna, and down-convert an RF band signal received through an antenna into a baseband signal. For example, the transceiver 1301 may include a transmit filter, a receive filter, an amplifier, a mixer, an oscillator, a DAC, an ADC, and so on.

The transceiver 1301 may include a plurality of transmit/receive paths. Furthermore, the transceiver 1301 may include an antenna section. The transceiver 1301 may include at least one antenna array including a plurality of antenna elements. In terms of hardware, the transceiver 1301 may be composed of digital circuitry and analog circuitry (e.g., a radio frequency integrated circuit (RFIC)). Here, the digital circuitry and the analog circuitry may be implemented in one package. Further, the transceiver 1301 may include a plurality of RF chains. The transceiver 1301 may perform beamforming. The transceiver 1301 may apply a beamforming weight to a signal in order to impart directionality according to the settings of the processor 1303 to the signal to be transmitted and received. According to an embodiment, the transceiver 1301 may include an RF (radio frequency) block (or RF part).

The transceiver 1301 may transmit and receive signals over a radio access network. For example, the transceiver 1301 may transmit a downlink signal. The downlink signal may include a synchronization signal (SS), a reference signal (RS) (e.g., a cell-specific reference signal (CRS), a demodulation (DM)-RS), system information (e.g., MIB, SIB, remaining system information (RMSI), other system information (OSI)), a configuration message, control information, downlink data or the like. Further, for example, the transceiver 1301 may receive an uplink signal. The uplink signal may include a random access related signal (e.g., a random access preamble (RAP) (or Msg1 (message 1), Msg3 (message 3)), a reference signal (e.g., a sounding reference signal (SRS), DM-RS), a power headroom report (PHR) or the like. While FIG. 13 illustrates only the transceiver 1301, according to another example of implementation, the satellite 620 may include two or more RF transceivers.

The processor 1303 controls the overall operations of the satellite 620. The processor 1303 may be referred to as a control unit. For example, the processor 1303 transmits and receives signals through the transceiver 1301. Further, the processor 1303 writes and reads data to/from the memory 1305. Further, the processor 1303 may perform functions of a protocol stack required by the relevant communication standard. Although only the processor 1303 is illustrated in FIG. 13, according to another example of implementation, the satellite 620 may include two or more processors. The processor 1303 may be a set of instructions or codes stored in the memory 1105, and may be instructions/codes that are at least temporarily resided in the processor 1303 or a storage space that stores the instructions/codes, or may be a part of the circuitry that constitutes the processor 1303. Further, the processor 1303 may include various modules for performing communication. The processor 1303 may control the satellite 620 to perform operations according to the embodiments.

The memory 1305 stores data such as basic programs, applications, and setting information for the operation of the satellite 620. The memory 1305 may be referred to as a storage unit. The memory 1305 may be configured as volatile memory, nonvolatile memory, or a combination of volatile memory and nonvolatile memory. Further, the memory 1305 provides stored data according to a request of the processor 1303. According to an embodiment, the memory 1305 may include memory for conditions, commands, or setting values related to an SRS transmission scheme.

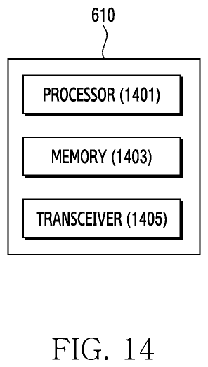

FIG. 14 illustrates an example of components of a terminal (e.g., UE 610). The terminal exemplifies a UE 610. The UE 610 may perform access to a gNB (e.g., gNB 120) that provides NR access through NTN.

Referring to FIG. 14, the UE 610 may include at least one processor 1401, at least one memory 1403, and at least one transceiver 1405. Hereinafter, the components are described in singular, but implementation of multiple components or sub-components is not excluded.

The processor 1401 controls the overall operations of the UE 610. For example, the processor 1401 writes and reads data to/from the memory 1403. For example, the processor 1401 transmits and receives signals through the transceiver 1405. Although FIG. 14 illustrates one processor, the embodiments of the disclosure are not limited thereto. The UE 610 may include at least one processor to perform the embodiments of the disclosure. The processor 1401 may be referred to as a control unit or a control means. According to embodiments, the processor 1401 may control the UE 610 to perform at least one of the operations or methods according to embodiments of the disclosure.

The memory 1403 may store data such as a basic program, an application program, and setting information for the operation of the UE 610. The memory 1403 may store various data used by at least one component (e.g., the transceiver 1405, the processor 1401). The data may include, for example, input data or output data for software and commands related thereto. The memory 1403 may be configured as a volatile memory, a nonvolatile memory, or a combination of a volatile memory and a nonvolatile memory. Further, the memory 1403 may provide the stored data upon a request of the processor 1410.

The transceiver 1405 performs functions for transmitting and receiving signals through a wireless channel. For example, the transceiver 1405 performs a conversion function between a baseband signal and a bit stream according to the physical layer specifications of the system. For example, when transmitting data, the transceiver 1405 encodes and modulates a transmission bit stream to generate complex symbols. Further, when receiving data, the transceiver 1405 restores a reception bit stream by demodulating and decoding a baseband signal. Further, the transceiver 1405 up-converts a baseband signal into an RF (radio frequency) band signal and then transmits it through an antenna, and down-converts an RF band signal received through the antenna into a baseband signal.

To this end, the transceiver 1405 may include a transmission filter, a reception filter, an amplifier, a mixer, an oscillator, a digital-to-analog convertor (DAC), an analog-to-digital convertor (ADC), or the like. Further, the transceiver 1405 may include a plurality of transmit/receive paths. Furthermore, the transceiver 1405 may include at least one antenna array including a plurality of antenna elements. In terms of hardware, the transceiver 1405 may include a digital unit and an analog unit, wherein the analog unit may be composed of a plurality of sub-units depending upon operating power, operating frequency, and so on.

The transceiver 1405 transmits and receives signals as described above. Accordingly, the transceiver 1405 may be referred to as ‘transmitter’, ‘receiver’, or ‘transceiver unit’. Further, in the following description, transmission and/or reception performed via a wireless channel, a backhaul network, an optical cable, Ethernet, or other wired paths are used in the sense including that the aforementioned processing is performed by the transceiver 1405. According to an embodiment, the transceiver 1405 may provide an interface for performing communication with other nodes in the network. That is, the transceiver 1405 may convert a bit stream transmitted from the UE 610 to another node, such as another access node, another base station, an upper node, a core network, etc., into a physical signal, and may convert a physical signal received from another node into a bit stream.

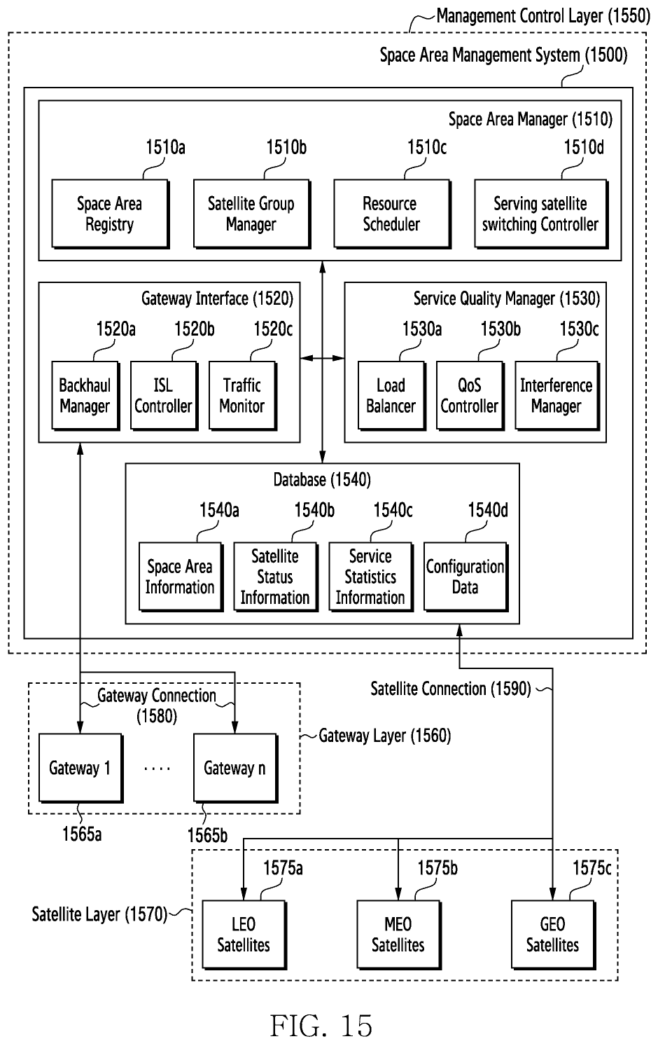

Referring to FIG. 15, components of the space area management system 1500 may include the following structures and functions.

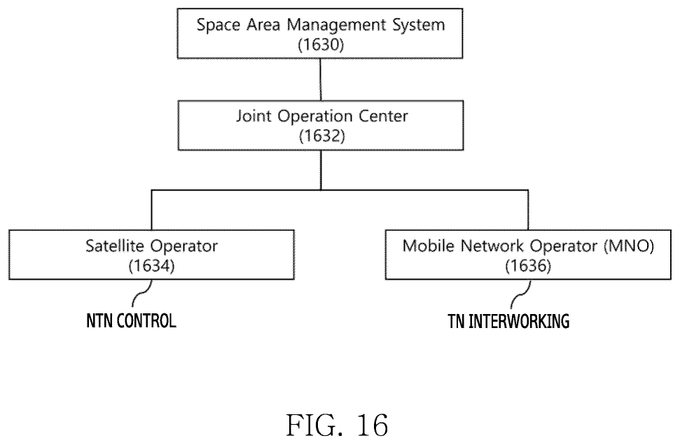

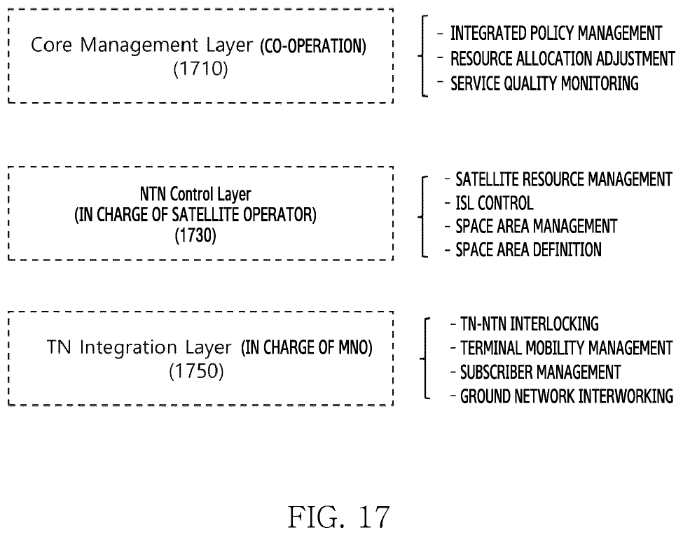

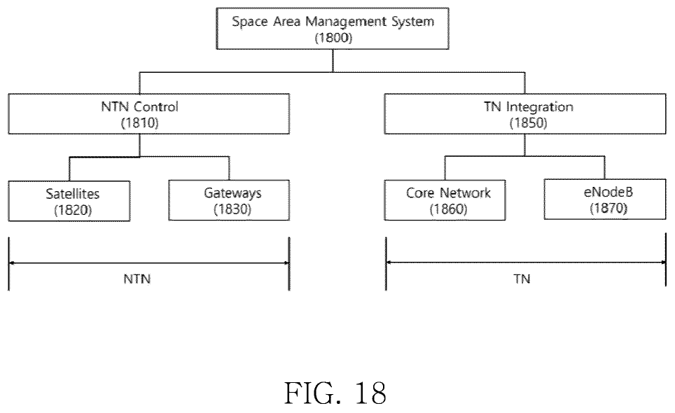

The data structures and/or objects used in the embodiments of FIGS. 15 to 19 described below may be represented using various data serialization formats. These data serialization formats have the following common characteristics, depending on their respective characteristics:
Allow for text-based representation of data
Support hierarchical structures
Allow for parsing by a variety of programming languages
Structured in a human-readable form

The main data serialization formats that may be used in the disclosure are as follows:

### 1. JSON (JavaScript Object Notation):

JSON is a lightweight data exchange format, using a hierarchical structure based on key-value pairs. In particular, JSON is a lightweight data exchange format, expressing data based on text, which is widely used in web applications and is suitable for data serialization and deserialization.

### 2. XML (Extensible Markup Language):

XML is a tag-based markup language that is used to represent and structure data. XML supports user-defined tags and is useful for expressing complex data structures. In particular, it has the characteristics of allowing structured representation of data and being suitable for expressing complex data structures.

### 3. YAML (YAML Ain't Markup Language):

YAML is a human-readable data serialization format that uses a hierarchical structure using indentation. YAML is widely used in configuration files, data exchange, etc., and has the characteristics of providing a hierarchical structure using indentation and being optimized for writing configuration files.

Further, the following additional data serialization formats may be used in the embodiments of the disclosure:
TOML (Tom's Obvious, Minimal Language): TOML is a simple and human-readable configuration file format.
HJSON (Human JSON): HJSON is similar to JSON, but allows annotations and spaces to make it human-readable.
MessagePack: MessagePack adopts a binary serialization format and is characterized by being relatively smaller and faster than JSON.
Protocol Buffers: Protocol Buffers adopts a binary serialization format developed by Google, and is efficient and highly scalable.
Apache Avro: Apache Avro is a schema-based format for data serialization, deserialization, and data transmission.

Those skilled in the art would be able to implement the data structure of the disclosure in a new data serialization format that is currently under development or may appear in the future, in addition to the formats mentioned above. This implies that the data structure of the disclosure is not dependent on a specific serialization format and may be extended to various other formats. Each of these data serialization formats has its own advantages and disadvantages, and an appropriate format may be selected and utilized depending on the purpose of use and environment.

In a space area registry 1510a, space area identity (SAI) may be configured in the following format:
{PLMN_ID}-{Operator_ID}-{SpaceArea_Type}-{Geographic_ID}-{Height_Range}

Wherein:
PLMN_ID is a mobile communication operator identifier and may be configured with 3 bytes.
Operator_ID is a satellite operator identifier and may be configured of 2 bytes.
SpaceArea_Type may be configured of 1 byte value indicating a space area type. The space area type is classified as shown in Table 22 below and may be represented in 16 bits.

TABLE 22

| SpaceArea_Type | Description | Field Value |
|---|---|---|
| Earth-fixed beam | Service areas fixed to a particular | 0x00 |
| | geographic location on the planet | (0000 0000 in binary |
| | Providing services to the same | number) |
| | geographic location regardless of | |
| | satellite movement | |
| | (e.g., in case a GEO satellite | |
| | continuously covers a particular area) | |
| Quasi-earth-fixed | Service areas that remain semi- | 0x01 |
| beam | fixed for a certain period of time | (0000 0001 in binary |
| | Service areas may change at | number) |
| | regular intervals | |
| | (e.g. in case a cluster of LEO satellites | |
| | covers a particular area semi-fixedly | |
| | via a relay) | |
| Earth-moving beam | Service areas moving along the | 0x02 |
| | earth's surface according to orbital | (0000 0010 in binary |
| | motion of a satellite | number) |
| | Service areas continuously change | |
| | as satellites move | |
| | (e.g. a service area provided by a | |
| | single LEO satellite) | |

In the embodiments of the disclosure, the space area types are defined in terms of a beam, for the following reasons:

### 1) Physical Implementation of Satellite Service:

The service area of a satellite is actually implemented by means of the satellite antenna beam
The characteristics of the beam directly determine the characteristics of the service area
The beam pattern corresponds to the space area by 1:1

### 2) Efficiency of Resource Management:

Resource allocation and management in beam units are possible
Optimization of service area is possible with beam pattern adjustment
Easy interference management between adjacent beams

### 3) Guaranteed Service Continuity:

Service continuity provided through beam-based handover
Uninterrupted service provided through switching between beams
Service area optimization through beam overlapping

Therefore, defining space area types based on the characteristics of the beam enables effective integration of the physical implementation and the logical service area management of the satellite service.

The characteristics of each space area type may include parameters of Earth-fixed type, parameters of Quasi-earth-fixed type, and parameters of Earth-moving type:

The parameters of the Earth-fixed type may be configured as shown in Table 23 below. For further explanation, the table has a structure that as it goes from left to right, it goes down from higher to lower layers, with its hierarchical structure indicated by a hyphen (-). This hierarchical structure may be directly utilized upon implementation in JSON or other programming languages:

TABLE 23
Earth-fixed Type Parameters

| Item | Content |
|---|---|
| Fixed_Parameters | Fixed Parameters |
| Geographic_Center | Center Coordinates |
| | (latitude, longitude) |
| Coverage_Radius | Service Radius (km) |
| Beam_Pattern - | Bean Width (degree) |
| Beam_Width | |
| Beam_Pattern - | Pointing Angle (degree) |
| Pointing_Angle | |
| Beam_Pattern - | Power Level (dBm) |
| Power_Level | |
| Service_Continuity - | Make_Before_Break |
| Satellite_Switching_Type | |
| Service_Continuity - | Overlap Region Size (km) |
| Overlap_Region | |
| Service_Continuity - | Minimum Signal Level (dBm) |
| Minimum_Signal_Level | |

If the parameters of the Earth-fixed type in the above Table 23 are represented using JSON Syntax, they are as shown in the Table 24 below:

TABLE 24

{
Fixed_Parameters: {
Geographic_Center: Center Coordinates (latitude, longitude),
Coverage_Radius: Service Radius (km),
Beam_Pattern: {
Beam_Width: Bean Width (degree),
Pointing_Angle: Pointing Angle (degree),
Power_Level: Power Level (dBm)
},
Service_Continuity: {
Satellite_Switching_Type: “Make_Before_Break”,
Overlap_Region: Overlap Region Size (km),
Minimum_Signal_Level: Minimum Signal Level (dBm)
}
}
}

In the following, due to space limitations, the data structure according to the embodiment of the disclosure will not be represented using the actual JSON syntax, but will be described only with a simplified table.

Further, the data structure in the table according to the embodiment of the disclosure below has a structure in which as it goes from the left to the right, it goes down from the upper layer to the lower layer, and its hierarchical structure will be indicated by a hyphen (-). This hierarchical structure may be directly utilized when implementing in JSON or other programming languages, and in order to avoid unnecessary repetition of substantially the same description, the description of the data structure of this table will not be reiterated in the following disclosure:

Parameters of Quasi-earth-fixed type may be configured as in Table 25 below:

TABLE 25
Quasi-earth-fixed Type Parameters

| Item | Content |
|---|---|
| Time_Window - | Duration Time |
| Duration | (minute) |
| Time_Window - | Update Interval |
| Update_Interval | (minute) |
| Time_Window - | Transition Time |
| Transition_Period | (second) |
| Area_Adjustment - | Maximum Shift |
| Maximum_Shift | Distance (km) |
| Area_Adjustment - | Adjustment |
| Adjustment_Step | Unit (km) |
| Area_Adjustment - | Update |
| Update_Threshold | Threshold (km) |
| Service_Parameters - | Number of |
| Required_Satellites | Required Satellites |
| Service_Parameters - | Soft_Switching |
| Satellite_Switching_Strategy | |
| Service_Parameters - | Resource |
| Resource_Reservation | Reservation |
| | Rate (%) |

Parameters of Earth-moving type may be configured as in Table 26 below.

TABLE 26
Earth-moving Type Parameters

| Item | Content |
|---|---|
| Movement_Pattern - Orbit_Type | Orbit Type (LEO/MEO) |
| Movement_Pattern - Ground_Speed | Ground Moving |
| | Speed (km/s) |
| Movement_Pattern - | Coverage Duration |
| Coverage_Duration | Time (minute) |
| Dynamic_Adjustment - | Beam Tracking Method |
| Beam_Tracking | |
| Dynamic_Adjustment - | Power Control Method |
| Power_Control | |
| Dynamic_Adjustment - | Resource Allocation |
| Resource_Allocation | Method |
| Satellite_Switching_Parameters - | Prediction Time |
| Prediction_Window | (second) |
| Satellite_Switching_Parameters - | Switching Margin (dB) |
| Switching_Margin | |
| Satellite_Switching_Parameters - | Minimum Service |
| Minimum_Duration | Time (second) |

In the embodiments of the disclosure, parameters related to satellite switching may be defined as follows:

Switching_Margin may be configured as in the following Table 27:

TABLE 27

| Item | Content |
|---|---|
| Switching_Margin_Parameters - | Threshold of signal strength |
| Definition | difference threshold |
| | between current and next |
| | service providing satellites |
| Switching_Margin_Parameters - | dB |
| Unit | |
| Switching_Margin_Parameters - | 3 dB (minimum |
| Typical_Range - Minimum | allowable margin) |
| Switching_Margin_Parameters - | 6 dB (typical |
| Typical_Range - Nominal | operating margin) |
| Switching_Margin_Parameters - | 10 dB (maximum |
| Typical_Range - Maximum | allowable margin) |
| Switching_Margin_Parameters - | Ensuring sufficient signal |
| Purpose - Signal_Quality | quality for reliable service |
| | switching |
| Switching_Margin_Parameters - | Prevention of inter-satellite |
| Purpose - Interference_Prevention | interference |
| Switching_Margin_Parameters - | Prevention of ping-pong |
| Purpose - Hysteresis_Control | phenomenon |

Satellite_Switching_Type may be configured as in the following Table 28:

TABLE 28
Satellite_Switching_Type Configuration

| Item | Content |
|---|---|
| Make_Before_Break - Definition | Disconnect from existing satellites |
| | after establishing a connection to |
| | a new satellite |
| Make_Before_Break - Characteristics - Service_Continuity | No service interruption |
| Make_Before_Break - Characteristics - Resource_Usage | Temporary simultaneous use of |
| | resources from both satellites |
| Make_Before_Break - Characteristics - Data_Duplication | Enables overlapped data transfer |
| | during switching |
| Make_Before_Break - Application_Scenario - High_Priority_Service | Emergency communications, |
| | real-time services |
| Make_Before_Break - Application_Scenario - Critical_Data | Loss-sensitive data transfer |
| Make_Before_Break - Application_Scenario - Premium_Users | High-quality |
| | service-demanding users |
| Break_Before_Make - Definition | Setting connection with a new |
| | satellite after disconnecting from |
| | an existing satellite |
| Break_Before_Make - Characteristics - Service_Interruption | Occurrence of temporary |
| | service interruption |
| Break_Before_Make - Characteristics - Resource_Efficiency | Efficient use of resources |
| Break_Before_Make - Characteristics - Simple_Control | Simple control mechanism |
| Break_Before_Make - Application_Scenario - Best_Effort_Service | Non-real-time data service |
| Break_Before_Make - Application_Scenario - Resource_Limited | resource-constrained situation |
| Break_Before_Make - Application_Scenario - Delay_Tolerant | Services that are less |
| | sensitive to delays |

Soft_Switching of Satellite_Switching_Strategy may be configured as in the following Table 29:

TABLE 29
Soft_Switching Characteristics

| Item | content |
|---|---|
| Soft_Switching - Definition | Gradual and smooth |
| | satellite switching method |
| Soft_Switching - Operation_Mechanism - | Start gradual moving of |
| Traffic_Migration - Initial_Phase | traffic to new satellites |
| Soft_Switching - Operation_Mechanism - | Traffic distribution |
| Traffic_Migration - Transition_Phase | between two satellites |
| Soft_Switching - Operation_Mechanism - | Fully moving traffic to |
| Traffic_Migration - Completion_Phase | new satellites |
| Soft_Switching - Operation_Mechanism - | Dynamic allocation of |
| Resource_Management - | resources according to |
| Dynamic_Allocation | traffic movement |
| Soft_Switching - Operation_Mechanism - | Load balancing in |
| Resource_Management - Load_Balancing | switching process |
| Soft_Switching - Operation_Mechanism - | Maintaining quality of |
| Resource_Management - QoS_Maintenance | service |
| Soft_Switching - Operation_Mechanism - | Total transition duration |
| Time_Parameters - Transition_Duration | (typically in several |
| | seconds) |
| Soft_Switching - Operation_Mechanism - | Stepwise switching |
| Time_Parameters - Step_Interval | interval (hundreds of |
| | milliseconds) |
| Soft_Switching - Operation_Mechanism - | Performance monitoring |
| Time_Parameters - Monitoring_Period | cycle (several tens of |
| | milliseconds) |
| Soft_Switching - Advantages - | Minimize service quality |
| Service_Quality | degradation |
| Soft_Switching - Advantages - | Improved network |
| Network_Stability | reliability |
| Soft_Switching - Advantages - | Optimizing resource use |
| Resource_Optimization | |

Another type of Satellite_Switching_Strategy includes “Hard_Switching”, which has the following characteristics as in Table 30 below:

TABLE 30
Hard_Switching Characteristics

| Item | Content |
|---|---|
| Definition | Immediate and direct |
| | satellite switching |
| | method |
| Operation_Mechanism - | Disconnect existing |
| Connection_Management - | satellite connections |
| Disconnection_Phase | immediately |
| Operation_Mechanism - | Immediately switching |
| Connection_Management - Switching_Phase | to new satellite |
| Operation_Mechanism - | Perform quick |
| Connection_Management - Recovery_Phase | recovery when needed |
| Operation_Mechanism - | Immediately release |
| Resource_Management - Immediate_Release | existing resources |
| Operation_Mechanism - | New resource |
| Resource_Management - Instant_Allocation | immediate allocation |
| Operation_Mechanism - | Minimum buffering |
| Resource_Management - Buffer_Management | |
| Operation_Mechanism - Time_Parameters - | Total switching time |
| Switching_Time | (within hundreds of |
| | milliseconds) |
| Operation_Mechanism - Time_Parameters - | Recovery time |
| Recovery_Time | (hundreds of |
| | milliseconds) |
| Operation_Mechanism - Time_Parameters - | Validation Time |
| Verification_Time | (several tens of |
| | milliseconds) |
| Advantages - Resource_Efficiency | Resource utilization |
| | efficiency |
| Advantages - Implementation_Simplicity | Low implementation |
| | complexity |
| Advantages - Quick_Response | Quick switch response |

Satellite switching performance indicators may be defined as in Table 31 below:

TABLE 31
Satellite Switching Performance Indicators

| Item | Content |
|---|---|
| Performance_Metrics - Switching_Success_Rate - | Successful |
| Definition | percentage of |
| | total switching |
| | attempts |
| Performance_Metrics - Switching_Success_Rate - | 99.999% |
| Target_Value | |
| Performance_Metrics - Switching_Success_Rate - | One hour unit |
| Measurement_Period | |
| Performance_Metrics - Service_Interruption_Time - | Service outage |
| Definition | time during |
| | switching |
| | process |
| Performance_Metrics - Service_Interruption_Time - | 0 seconds |
| Maximum_Value - Soft_Switching | (theoretical) |
| Performance_Metrics - Service_Interruption_Time - | 200 milliseconds |
| Maximum_Value - Hard_Switching | |
| Performance_Metrics - Resource_Utilization - | System resource |
| Definition | utilization in |
| | switching |
| | process |
| Performance_Metrics - Resource_Utilization - | 70% |
| Thresholds - Normal_Operation | |
| Performance_Metrics - Resource_Utilization - | 90% |
| Thresholds - Peak_Operation | |
| Performance_Metrics - Resource_Utilization - | 95% |
| Thresholds - Critical_Operation | |

The processing methods for each satellite switching situation may be divided into a normal switching and an emergency switching depending on the switching scenario.

The normal switching according to an embodiment of the disclosure may occur in the following predictable situations:
Planned satellite switching according to the orbital motion of the satellite
Preemptive switching based on signal quality
Planned switching for network load distribution

An emergency switching according to an embodiment of the disclosure may occur in the following unpredictable situations:
Upon occurrence of a sudden failure of the satellite system
Upon occurrence of a sudden deterioration of service quality
Upon occurrence of a system overload condition

A satellite switching situation-specific processing scheme according to an embodiment of the disclosure may be implemented as shown in the following Table 32:

TABLE 32
Satellite Switching Situation-specific Processing Scheme

| Item | Content | |
|---|---|---|
| Normal_Switching - Trigger_Condition - Orbit_Based | Predicted shift in the orbital | |
| | motion of satellites | |
| Normal_Switching - Trigger_Condition - Signal_Quality | Signal quality based switching | |
| Normal_Switching - Trigger_Condition - Load_Based | Switching for load distribution | |
| Normal_Switching - Process_Flow - Preparation_Phase - | 120 | seconds |
| Time_Window | | |
| Normal_Switching - Process_Flow - Preparation_Phase - Actions_1 | Select next service satellite | |
| Normal_Switching - Process_Flow - Preparation_Phase - Actions_2 | Verifying resource availability | |
| Normal_Switching - Process_Flow - Preparation_Phase - Actions_3 | Establishing switching Plan | |
| Normal_Switching - Process_Flow - Execution_Phase - | 10 | seconds |
| Time_Window | | |
| Normal_Switching - Process_Flow - Execution_Phase - Actions_1 | Set up new satellite connection | |
| Normal_Switching - Process_Flow - Execution_Phase - Actions_2 | Traffic switching | |
| Normal_Switching - Process_Flow - Execution_Phase - Actions_3 | Clean up existing connections | |
| Emergency_Switching - Trigger_Condition - Failure_Based | Satellite failure occurrence | |
| Emergency_Switching - Trigger_Condition - Quality_Degradation | Sharp degradation in quality | |
| Emergency_Switching - Trigger_Condition - System_Overload | System overload | |
| Emergency_Switching - Process_Flow - Detection_Phase - | 1 | second |
| Time_Window | | |
| Emergency_Switching - Process_Flow - Detection_Phase - | Problem situation detection | |
| Actions_1 | | |
| Emergency_Switching - Process_Flow - Detection_Phase - | Severity assessment | |
| Actions_2 | | |
| Emergency_Switching - Process_Flow - Detection_Phase - | Determining the need for | |
| Actions_3 | immediate response | |
| Emergency_Switching - Process_Flow - Recovery_Phase - | 5 | seconds |

| | |
|---|---|
| Time_Window | |
| Emergency_Switching - Process_Flow - Recovery_Phase - | Enable backup satellite |
| Actions_1 | |
| Emergency_Switching - Process_Flow - Recovery_Phase - | Execution of emergency |
| Actions_2 | switching |
| Emergency_Switching - Process_Flow - Recovery_Phase - | Verifying service recovery |
| Actions_3 | |

Data processing during satellite switching may be implemented as shown in Table 33 below:

TABLE 33
Data Processing During Satellite Switching

| Item | Content | |
|---|---|---|
| Buffer_Management - Pre_Switching_Buffer - Size | 100MB | |
| Buffer_Management - Pre_Switching_Buffer - Retention_Time | 5 | seconds |
| Buffer_Management - Pre_Switching_Buffer - Priority_Levels_1 | Critical_Data: | |
| | immediate transfer | |
| Buffer_Management - Pre_Switching_Buffer - Priority_Levels_2 | Normal_Data: general | |
| | processing | |
| Buffer_Management - Pre_Switching_Buffer - Priority_Levels_3 | Background_Data: | |
| | allow delay | |
| Buffer_Management - Switching_Process - Data_Synchronization - Method | Two-Phase Commit | |
| Buffer_Management - Switching_Process - Data_Synchronization - Steps_1 | buffer synchronization | |
| Buffer_Management - Switching_Process - Data_Synchronization - Steps_2 | Transfer transport | |
| | pointer | |
| Buffer_Management - Switching_Process - Data_Synchronization - Steps_3 | Confirmation of | |
| | completion | |
| Buffer_Management - Switching_Process - Loss_Prevention - Mechanism | Selective | |
| | Retransmission | |
| Buffer_Management - Switching_Process - Loss_Prevention - Window_Size | 1 | second |
| Buffer_Management - Switching_Process - Loss_Prevention - | 3 | |
| Maximum_Retries | | |
| QoS_Maintenance - Service_Classes - Real_Time_Service - Max_Latency | 50 | ms |
| QoS_Maintenance - Service_Classes - Real_Time_Service - Jitter_Bound | 10 | ms |
| QoS_Maintenance - Service_Classes - Real_Time_Service - Priority | Highest | |
| QoS_Maintenance - Service_Classes - Interactive_Service - Max_Latency | 200 | ms |
| QoS_Maintenance - Service_Classes - Interactive_Service - Jitter_Bound | 50 | ms |
| QoS_Maintenance - Service_Classes - Interactive_Service - Priority | High | |
| QoS_Maintenance - Service_Classes - Background_Service - Max_Latency | 1s | |
| QoS_Maintenance - Service_Classes - Background_Service - Jitter_Bound | 100 | ms |
| QoS_Maintenance - Service_Classes - Background_Service - Priority | Normal | |
| QoS_Maintenance - Performance_Metrics - Monitoring_Interval | 100 | ms |

| | |
|---|---|
| QoS_Maintenance - Performance_Metrics - Recovery_Threshold | 95% |
| QoS_Maintenance - Performance_Metrics - Alert_Threshold | 90% |

State management during satellite switching may be implemented as shown in Table 34 below:

TABLE 34
State Management upon Satellite Switching

| Item | Content |
|---|---|
| State_Management - Connection_States - | Active |
| Pre_Switching - Current_Satellite | |
| State_Management - Connection_States - | Preparing |
| Pre_Switching - Target_Satellite | |
| State_Management - Connection_States - | Normal |
| Pre_Switching - Data_Flow | |
| State_Management - Connection_States - | Continuous |
| Pre_Switching - Monitoring - Signal_Quality | monitoring |
| State_Management - Connection_States - | Check |
| Pre_Switching - Monitoring - Resource_Status | availability |
| State_Management - Connection_States - | Check load |
| Pre_Switching - Monitoring - Load_Level | level |

Real-time control of satellite switching may be implemented as shown in Table 35 below:

TABLE 35
Real-Time Control of Satellite Switching

| Item | Content | |
|---|---|---|
| Real_Time_Control - Timing_Control - Synchronization - Time_Source | GPS-based visual | |
| | synchronization | |
| Real_Time_Control - Timing_Control - Synchronization - Accuracy | Microsecond level | |
| Real_Time_Control - Timing_Control - Synchronization - Update_Rate | 1 second interval | |
| Real_Time_Control - Timing_Control - Synchronization - Parameters - | 10 | microseconds |
| Max_Time_Drift | | |
| Real_Time_Control - Timing_Control - Synchronization - Parameters - | 100 | milliseconds |
| Sync_Interval | | |
| Real_Time_Control - Timing_Control - Synchronization - Parameters - | 1 | microsecond |
| Error_Bound | | |
| Real_Time_Control - Timing_Control - Event_Scheduling - Priority_Levels_1 | Critical: Immediate | |
| | processing (0-10 ms) | |
| Real_Time_Control - Timing_Control - Event_Scheduling - Priority_Levels_2 | High: Preferential | |
| | processing | |
| | (10-50 ms) | |
| Real_Time_Control - Timing_Control - Event_Scheduling - Priority_Levels_3 | Normal: General | |
| | processing | |
| | (50-200 ms) | |
| Real_Time_Control - Timing_Control - Event_Scheduling - Schedule_Window | 1 | second |
| Real_Time_Control - Timing_Control - Event_Scheduling - Update_Frequency | 10 | ms |
| Real_Time_Control - Resource_Control - Dynamic_Allocation - | Beam_Power: Power | |
| Resource_Types_1 | resource | |
| Real_Time_Control - Resource_Control - Dynamic_Allocation - | Bandwidth: | |
| Resource_Types_2 | Frequency resource | |
| Real_Time_Control - Resource_Control - Dynamic_Allocation - | Processing: | |
| Resource_Types_3 | Computing recourse | |
| Real_Time_Control - Resource_Control - Dynamic_Allocation - | Predictive_Allocation | |
| Allocation_Strategy - Method | | |
| Real_Time_Control - Resource_Control - Dynamic_Allocation - | 500 | ms |
| Allocation_Strategy - Look_Ahead | | |
| Real_Time_Control - Resource_Control - Dynamic_Allocation - | 50 | ms |

| | |
|---|---|
| Allocation_Strategy - Adjustment_Interval | |
| Real_Time_Control - Resource_Control - Load_Balance - Metrics - CPU_Load | Up to 80% |
| Real_Time_Control - Resource_Control - Load_Balance - Metrics - | Up to 85% |
| Memory_Usage | |
| Real_Time_Control - Resource_Control - Load_Balance - Metrics - | Up to 90% |
| Link_Utilization | |
| Real_Time_Control - Resource_Control - Load_Balance - Balance_Triggers - | Over 75% |
| Threshold | |
| Real_Time_Control - Resource_Control - Load_Balance - Balance_Triggers - | 100 ms continuing |
| Duration | |
| Real_Time_Control - Resource_Control - Load_Balance - Balance_Triggers - | Load redistribution |
| Action | |

With this real-time control mechanism, time synchronization, event processing, resource allocation, and load distribution during the satellite switching may be effectively managed. In particular, stable service switching is possible using GPS-based precise time synchronization and predictive resource allocation.

The implementation for failure recovery and stability assurance of the satellite switching may be defined as in the following Table 36:

TABLE 36
Satellite Switching Failure Recovery and Stability Assurance

| Item | Content |
|---|---|
| Reliability_Assurance - Failure_Prevention - Pre_Check_Mechanism - | 12 db |
| Signal_Quality - Minimum_SINR | |
| Reliability_Assurance - Failure_Prevention - Pre_Check_Mechanism - | 500 ms |
| Signal_Quality - Required_Duration | |
| Reliability_Assurance - Failure_Prevention - Pre_Check_Mechanism - | Within ±2 db of variation |
| Signal_Quality - Stability_Check | |
| Reliability_Assurance - Failure_Prevention - Pre_Check_Mechanism - | More than 40% margin |
| Resource_Availability - Computing_Resource | |
| Reliability_Assurance - Failure_Prevention - Pre_Check_Mechanism - | More than 30% margin |
| Resource_Availability - Memory_Resource | |
| Reliability_Assurance - Failure_Prevention - Pre_Check_Mechanism - | More than 50% margin |
| Resource_Availability - Link_Capacity | |
| Reliability_Assurance - Failure_Prevention - Pre_Check_Mechanism - | Check active status |
| Path_Validation - ISL_Status | |
| Reliability_Assurance - Failure_Prevention - Pre_Check_Mechanism - | Maximum allowable |
| Path_Validation - Latency_Check | delay of 50 ms |
| Reliability_Assurance - Failure_Prevention - Pre_Check_Mechanism - | At least 2 paths |
| Path_Validation - Route_Redundancy | |
| Reliability_Assurance - Fault_Tolerance - Redundancy_Management - | Triple |
| Service_Level - Critical_Service | |
| Reliability_Assurance - Fault_Tolerance - Redundancy_Management - | Double |
| Service_Level - Normal_Service | |
| Reliability_Assurance - Fault_Tolerance - Redundancy_Management - | Single configuration |
| Service_Level - Best_Effort | |
| Reliability_Assurance - Fault_Tolerance - Redundancy_Management - | Best path |
| Switching_Paths - Primary_Path | |
| Reliability_Assurance - Fault_Tolerance - Redundancy_Management - | Alternative path |
| Switching_Paths - Backup_Path | |
| Reliability_Assurance - Fault_Tolerance - Redundancy_Management - | Emergency recovery |
| Switching_Paths - Emergency_Path | path |
| Reliability_Assurance - Fault_Tolerance - Recovery_Procedures - | Within 10 ms |
| Response_Time - Detection_Time | |
| Reliability_Assurance - Fault_Tolerance - Recovery_Procedures - | Within 20 ms |
| Response_Time - Decision_Time | |
| Reliability_Assurance - Fault_Tolerance - Recovery_Procedures - | Within 50 ms |
| Response_Time - Action_Time | |
| Reliability_Assurance - Fault_Tolerance - Recovery_Procedures - | Fault detection and |
| Recovery_Steps_1 | isolation |
| Reliability_Assurance - Fault_Tolerance - Recovery_Procedures - | Enable recovery path |
| Recovery_Steps_2 | |
| Reliability_Assurance - Fault_Tolerance - Recovery_Procedures - | Confirmation of service |
| Recovery_Steps_3 | resumption |

The implementation for performance monitoring and analysis of satellite switching may be defined as in the following Table 37:

TABLE 37
Satellite Switching Performance Monitoring and Analysis

| Item | Content |
|---|---|
| Performance_Analytics - Monitoring_Framework - Real_Time_Metrics - | 100 ms |
| Collection_Interval | |
| Performance_Analytics - Monitoring_Framework - Real_Time_Metrics - Metrics_Type - | Transmission |
| Network_Metrics_1 | delay (ms) |
| Performance_Analytics - Monitoring_Framework - Real_Time_Metrics - Metrics_Type - | Throughput |
| Network_Metrics_2 | (mbps) |
| Performance_Analytics - Monitoring_Framework - Real_Time_Metrics - Metrics_Type - | Packet loss |
| Network_Metrics_3 | rate (%) |
| Performance_Analytics - Monitoring_Framework - Real_Time_Metrics - Metrics_Type - | CPU |
| Resource_Metrics_1 | utilization (%) |
| Performance_Analytics - Monitoring_Framework - Real_Time_Metrics - Metrics_Type - | Memory |
| Resource_Metrics_2 | utilization (%) |
| Performance_Analytics - Monitoring_Framework - Real_Time_Metrics - Metrics_Type - | Storage |
| Resource_Metrics_3 | utilization (%) |
| Performance_Analytics - Monitoring_Framework - Real_Time_Metrics - Metrics_Type - | Service |
| Service_Metrics_1 | availability (%) |
| Performance_Analytics - Monitoring_Framework - Real_Time_Metrics - Metrics_Type - | User |
| Service_Metrics_2 | experience |
| | quality |
| Performance_Analytics - Monitoring_Framework - Real_Time_Metrics - Metrics_Type - | Switching |
| Service_Metrics_3 | success rate |
| | (%) |
| Performance_Analytics - Monitoring_Framework - Analysis_Engine - | 1 second |
| Processing_Methods - Real_Time_Analysis - Window_Size | |
| Performance_Analytics - Monitoring_Framework - Analysis_Engine - | 100 ms |
| Processing_Methods - Real_Time_Analysis - Update_Rate | |
| Performance_Analytics - Monitoring_Framework - Analysis_Engine - | Immediately |
| Processing_Methods - Real_Time_Analysis - Threshold_Check | |
| Performance_Analytics - Monitoring_Framework - Analysis_Engine - | 1 hour |
| Processing_Methods - Trend_Analysis - Window_Size | |
| Performance_Analytics - Monitoring_Framework - Analysis_Engine - | Enabled |
| Processing_Methods - Trend_Analysis - Pattern_Recognition | |
| Performance_Analytics - Monitoring_Framework - Analysis_Engine - | 10 minutes |
| Processing_Methods - Trend_Analysis - Prediction_Horizon | |
| Performance_Analytics - Performance_Optimization - Optimization_Targets - | Up to 75% |
| Resource_Efficiency - CPU_Target | utilization |
| Performance_Analytics - Performance_Optimization - Optimization_Targets - | Up to 80% |
| Resource_Efficiency - Memory_Target | utilization |
| Performance_Analytics - Performance_Optimization - Optimization_Targets - | Up to 85% |
| Resource_Efficiency - Network_Target | utilization |
| Performance_Analytics - Performance_Optimization - Optimization_Targets - | Up to 50 ms |
| Service_Quality - Latency_Target | |
| Performance_Analytics - Performance_Optimization - Optimization_Targets - | At least |
| Service_Quality - Throughput_Target | 100Mbps |
| Performance_Analytics - Performance_Optimization - Optimization_Targets - | 99.999% |
| Service_Quality - Reliability_Target | |
| Performance_Analytics - Performance_Optimization - Adaptation_Mechanisms - | 200 ms |
| Dynamic_Adjustment - Response_Time | |
| Performance_Analytics - Performance_Optimization - Adaptation_Mechanisms - | Stepwise |
| Dynamic_Adjustment - Adjustment_Steps | change |
| Performance_Analytics - Performance_Optimization - Adaptation_Mechanisms - | Verification |
| Dynamic_Adjustment - Verification | after change |

The satellite switching mechanism defined in the embodiments of the disclosure may provide the following advantages:

### 1. Service Continuity Assurance:

Uninterrupted service provision
Predictable switching time
Maintaining stable service quality

### 2. Efficient Resource Management:

Optimized resource allocation
Dynamic load balancing
Flexible capacity adjustment

### 3. Reliable Operation:

Automated Disaster recovery
Real-time performance monitoring
Predictive maintenance

The embodiments of the disclosure may provide a technical base for efficient operation and stable service provision of a satellite communication system, and ensure the scalability and reliability of a satellite communication network in the future.

Satellite_Switching_Parameters of the above Table 26 are parameters for managing service switching according to the orbital movement of the satellite, and are distinguished from handover according to terminal mobility in a terrestrial network. This is for managing the service switching between satellites according to changes in service areas that may occur while the satellite orbits the Earth.

The operation characteristics of the Earth-fixed type may be configured as shown in the following Table 38:

TABLE 38
Operation Characteristics of Earth-Fixed Type

| Item | Content |
|---|---|
| Resource_Management - Static_Allocation - | Fixed frequency |
| Frequency_Plan | allocation |
| Resource_Management - Static_Allocation - | Fixed power Allocation |
| Power_Plan | |
| Resource_Management - Static_Allocation - | Fixed capacity allocation |
| Capacity_Plan | |
| Resource_Management - Quality_Control - | 95% or more coverage |
| Coverage_Quality | guaranteed |
| Resource_Management - Quality_Control - | −95dbm or more signal |
| Signal_Quality | strength |
| Resource_Management - Quality_Control - | 99.9% or more service |
| Service_Stability | reliability |
| Service_Management - Priority_Handling | Fixed area priority |
| | service |
| Service_Management - Load_Balancing | Static load balancing |
| Service_Management - Backup_Strategy | N + 1 redundant |
| | configuration |

The operation characteristics of the Earth-fixed type of the above Table 38 are more specifically described as follows. The Earth-fixed type refers to the method in which a satellite provides a fixed service area at a specific geographic location on the Earth. This is mainly used in geostationary orbit (GEO) satellites, and provides continuous service at the same geographic location regardless of the movement of the satellite. This service is implemented in the form of an antenna beam continuously directed to a specific point on the Earth.

The Resource_Management characteristics of the Earth-fixed type are as follows. Static_Allocation provides stable service with fixed frequency, power, and capacity planning. Quality_Control guarantees coverage of 95% or more and signal strength of −95 dBm or more. Service_Stability aims for service stability of 99.9% or more.

The Service_Management characteristics of the Earth-fixed type include Priority Handling, which provides priority service for fixed areas. Load_Balancing implements stable service through static load distribution. Backup_Strategy secures reliability with an N+1 redundancy configuration, where ‘N’ refers to the number of primary service satellites required to provide the service, and ‘+1’ refers to a redundant satellite in case of a failure. For example, a 3+1 configuration includes three primary service satellites and one redundant satellite, and the redundant satellite is ready to be replaced immediately in the event of a failure in any one of the primary service satellites.

The operation characteristics of the Quasi-earth-fixed type may be configured as shown in Table 39 below:

TABLE 39
Quasi-Earth-Fixed Type Operation Characteristics

| Item | Content |
|---|---|
| Transition_Management - Satellite_Switching_Control - Preparation_Time | 120 seconds |
| Transition_Management - Satellite_Switching_Control - Execution_Time | 10 seconds |
| Transition_Management - Satellite_Switching_Control - Recovery_Time | 30 seconds |
| Transition_Management - Service_Continuity - Minimum_Overlap | 30 seconds |
| Transition_Management - Service_Continuity - Data_Buffering | 5 seconds |
| Transition_Management - Service_Continuity - QoS_Maintenance | 99% or more |
| Dynamic_Adjustment - Coverage_Optimization | Optimizing real-time coverage |
| Dynamic_Adjustment - Resource_Reallocation | Periodic resource reallocation |
| Dynamic_Adjustment - Performance_Tuning | Adaptive performance adjustment |

The operation characteristics of the Quasi-earth-fixed type of Table 39 above are specified as follows. The Quasi-earth-fixed type refers to a method of providing a service area that is maintained quasi-fixedly for a specific period of time. This is mainly used when a low-Earth Orbit (LEO) satellite constellation covers a specific area quasi-fixedly through a relay. The service area may be changed at regular time intervals, and it may be implemented in the form of providing continuous service for the specific area with cooperation of multiple satellites.

Transition_Management characteristics of the Quasi-earth-fixed type are as follows. In Satellite_Switching_Control, the next service providing satellite is prepared with a preparation time of 120 seconds, and the actual service switching is performed with an execution time of 10 seconds. The recovery time is 30 seconds, so that the recovery may be performed in case of a malfunction. In terms of Service_Continuity, the service continuity is guaranteed with an overlap time of at least 30 seconds, data loss is prevented during the switching with 5 seconds of data buffering, and the service quality is guaranteed with a QoS maintenance rate of 99% or more.

Dynamic_Adjustment characteristics of the Quasi-earth-fixed type include real-time coverage optimization with Coverage_Optimization, periodic resource reallocation with Resource_Reallocation, and adaptive performance adjustment with Performance_Tuning.

The operation characteristics of the Earth-moving type may be configured as shown in Table 40 below:

TABLE 40
Earth-Moving Type Operation Characteristics

| Item | Content |
|---|---|
| Movement_Management - Path_Prediction - Prediction_Horizon | 300 seconds |
| Movement_Management - Path_Prediction - Update_Interval | 10 seconds |
| Movement_Management - Path_Prediction - Accuracy_Level | 95% or more |
| Movement_Management - Service_Scheduling - Coverage_Planning | Trajectory-based plan |
| Movement_Management - Service_Scheduling - Resource_Planning | Dynamic resource |
| | planning |
| Movement_Management - Service_Scheduling - Maintenance_Window | Maintenance time zone |
| Performance_Management - Dynamic_Control - Power_Adjustment | Real-time power |
| | adjustment |
| Performance_Management - Dynamic_Control - Beam_Adjustment | Real-time beam |
| | adjustment |
| Performance_Management - Dynamic_Control - Resource_Adjustment | Real-time resource |
| | coordination |
| Performance_Management - Quality_Assurance - Minimum_Duration | Minimum service |
| | duration |
| Performance_Management - Quality_Assurance - | 99% or more success |
| Satellite_Switching_Success | rate |
| Performance_Management - Quality_Assurance - Service_Recovery | Recovery in 1 second |

The operation characteristics of the Earth-moving type of the above Table 40 are described in detail as follows. The Earth-moving type refers to a method of providing a service area that moves along the Earth's surface according to the satellite's orbital movement. This mainly corresponds to the service area provided by a single low-Earth orbit (LEO) satellite, and has the characteristic that the service area continuously changes according to the satellite's movement. This service is implemented with a beam pattern that moves along with the satellite's orbital motion.

Movement Management characteristics of the Earth-moving type include Path_Prediction and Service_Scheduling. The Path_Prediction predicts the satellite path for the next 5 minutes with a prediction range of 300 seconds, periodically updates the prediction information with a 10-second update cycle, and maintains high prediction accuracy with an accuracy of 95% or more. The Service_Scheduling plans the service area according to the satellite orbit with an orbit-based coverage planning, plans resource allocation according to movement with a dynamic resource planning, and minimizes service impact using maintenance time zone management.

Performance_Management characteristics of the Earth-moving type include Dynamic_Control and Quality_Assurance. The Dynamic_Control adjusts the power level according to distance through real-time power adjustment, adjusts the beam direction according to movement through real-time beam adjustment, and adjusts resources according to changes in demand through real-time resource adjustment. The Quality_Assurance guarantees single satellite coverage time through minimum service duration time, provides stable service switching with a satellite switching success rate of 99% or more, and performs rapid failure recovery with service recovery within 1 second.

These three types of distinction are intended to effectively define and manage the characteristics and operation methods of satellite services, enabling optimized resource management and service provision for each type.

Geographic_ID is geographic location information configured with 4 bytes of latitude/longitude-based grid identifiers.

Height_Range is configured of 2 bytes of altitude range information, and may be expressed as 16 bits as shown in Table 41 below.

TABLE 41

| Altitude Range | Value |
|---|---|
| LEO region | 0x00 (0000 0000 in binary number) |
| MEO region | 0x01 (0000 0001 in binary number) |
| GEO region | 0x02 (0000 0010 in binary number) |

For example, if SAI is “450-ST-00-1234-00”, it may represent Korea MNO PLMN_ID (450), Starlink Operator_ID (ST), Earth-fixed beam (00), specific geographic grid ID (12345678), and LEO area (00).

A space area registry 1510a may create and manage tables such as the following Table 42:

TABLE 42

| | |
|---|---|
| Table | Description |

Space_Area_Table
Space_Area_List_Entry

Space_Area_Table may include the fields shown in the following Table 43:

TABLE 43

| Field | Description |
|---|---|
| SAI | Space area identification (space area identifier) |
| Status | Active/Inactive |
| Creation_Time | Generation time |
| Valid_Duration | Validity period |
| Geographic_Info | Center point coordinates (latitude, longitude) and radius (km) |
| Serving_Satellites | Service providing satellite id list |
| Backup_Satellites | Backup satellite id list |

Geographic_Info of the Table 43 above may be expressed as the following Table 44.

```
TABLE 44
Geographic_Info: {
  Center_Coordinates: Center point coordinates (latitude, longitude)
  Coverage_Radius: radius (km)
}
```

Space_Area_List_Entry may include the fields shown in the following Table 45:

TABLE 45

| Field | Description |
|---|---|
| SAI | Space Area Identification (Space Area Identifier) |
| Constellation_Info | Satellite group identifier, orbital type (LEO/MEO/GEO), total |
| | number of satellites |
| Service_Parameters | Maximum number of terminals, available resources, service |
| | quality rating |

Constellation_Info and Service_Parameters of the above Table 45 may be expressed as shown in the following Table 46.

TABLE 46

```
Constellation_Info: {
  Constellation_ID: Satellite group identifier
  Orbit_Type: LEO/MEO/GEO
  Total_Satellites: Total number of satellites
}
- Service_Parameters: {
  Max_UEs: Maximum number of terminals
  Available_Resources: Amount of available resources
  QoS_Class: service quality rating
}
```

A space area registry 1510a may create and manage data in the following procedures:

In creating a new space area, processing may be performed in order of:
Geographic area definition
SAI assignment
Space_Area_Table entry creation
Constellation information mapping.

In activating the space area, processing may be performed in order of
Status update
Serving_Satellites assignment
Service parameter setting.

Periodic updates may include:
Serving_Satellites update according to satellite position change
Service_Parameters recalculation
Valid_Duration check and update.

A satellite group manager 1510b may include the following satellite grouping algorithm:

### Input Parameters:

Satellite List[ ]: List of satellites to be managed
Space_Area_Info: Space area information

### Output:

Satellite_Group[ ]: Configured satellite group information

Satellite selection criteria may be configured as follows:
Primary serving satellite: Satellite with the shortest distance to the center point of the space area
Secondary satellite: adjacent satellites capable of ISL configuration with the primary serving satellite
Backup satellite: Satellites scheduled to enter the corresponding space area within 30 minutes

Satellite grouping may be performed as follows:

The satellite orbit information collection phase may include:
Current 3D coordinates (X, Y, Z)
Movement speed and direction vector
Expected trajectory calculation.

The ISL configuration possibility assessment phase may include:
Calculation of distance between satellites (maximum allowable distance: 1000 km)
Consideration of antenna beam direction (maximum steering angle: ±60°)
Link capacity checking (minimum required capacity: 10 Gbps).

The satellite group configuration phase may include:
Primary_Group: Satellites capable of currently providing service
Backup_Group: Satellites scheduled to provide service in the future.

A resource scheduler 835c may operate with the following scheduling mechanism:

Time-division scheduling frame structure may include:
Super_Frame: 100 ms
Sub_Frame: Ims
Time_Slot: 0.125 ms.

Resource allocation unit may be defined as in the following Table 47:

TABLE 47

```
Resource_Block = {
  Time_Duration: Time interval
  Frequency_Band: Frequency band
  Beam_ID: Beam identifier
}
```

Scheduling priorities may be defined as follows:
1) Emergency_Service: Emergency communication
2) Real_Time_Service: Real-time service
3) Throughput_Sensitive: Large-scale data
4) Best_Effort: General data

Predictive resource allocation may be performed in the following time ranges:

Short-term forecast (within 5 minutes) may include:
Real-time traffic trend analysis
Buffer status monitoring
Immediate response resource allocation.

Medium-term forecasting (5 to 30 minutes) may include:
Forecasting of change in satellite orbit-based coverage
Resource reservation for service continuity assurance.

Long-term forecasting (30 minutes or more) may include:
Analysis of historical traffic patterns
Event-based demand forecasting
Strategic resource planning.

A serving satellite switching controller 1510d may operate according to the following switching decision mechanism:

Switching triggering conditions may be configured as follows:

### Time-Based Conditions:

Expected end time of visibility of current serving satellite
Optimal visibility start time of next serving satellite
Minimum overlap time (Overlap Duration): 5 seconds

### Quality-Based Conditions:

Signal strength <approximately −105 dBm
Link quality <approximately 70 dBm
Interference level >approximately −90 dBm

### Load-Based Conditions:

Resource utilization rate >approximately 90%
Buffer occupancy rate >approximately 80%
Processing load >approximately 85%

Serving satellite switching may be performed in the following three phase:

### Phase 1 (Preparation Phase):

Target satellite selection (check orbital position, available resources, ISL status)
Resource reservation (bandwidth, buffer space, processing capacity)
Pre-synchronization (time, frequency, beam alignment)

### Phase 2 (Execution Phase):

Data mirroring over ISL
Buffer status synchronization
Progressive traffic switching may be performed.

### Phase 3 (Completion Phase):

Service continuity verification
Previous resource release
Status information update may be performed.

In the event of a failure, the following recovery procedures may be performed:

In the failure detection phase, the following may be performed:
Switching failure type classification
Impact assessment
Urgency determination.

In the recovery action phase, the following may be performed:
Emergency backup satellite activation
Data recovery performing
Service resumption attempt.

In the post-processing phase, the following may be performed:
Failure log recording
Cause analysis
Preventive measures.

A gateway interface 1520 includes a backhaul manager 1520a, an ISL controller 1520b, and a traffic monitor 1520c, and each component may operate as follows:

The backhaul manager 1520a may manage data traffic with gateways 1565a and 1565b and perform the following functions, including the following configuration:

Gateway link management may include Active_Gateway_Table for managing a list of available gateways, and the Active_Gateway_Table may be represented as shown in Table 48 below:

TABLE 48

```
{
  Gateway_ID: Gateway identifier
  Location: (latitude, longitude) coordinates
  Status: Active/Standby/Maintenance
  Capacity: Maximum throughput capacity
  Current_Load: Current Load
  Connected_Satellites: [satellite ID list]
}
```

Gateway allocation algorithm may include the following allocation criteria:
Distance between gateway and satellite
Current load of gateway
Required bandwidth

Allocation procedure may be performed in the following order:
1) Selection of candidate gateway (distance<maximum communication radius)
2) Calculation of load distribution
3) Selection of optimal gateway.

Backhaul path optimization may include the following path selection criteria:
Maximum allowable delay: 50 ms
Minimum bandwidth: 10 Gbps
Maximum number of hops: 3

Path management may be represented as in Table 49 below:

TABLE 49

```
Primary_Path: Primary path
Backup_Path: Backup path
Path_Quality_Metrics: {
  Delay: Current delay value
  Available_BW: Available bandwidth
  Reliability: Reliability Index
}
```

An ISL controller 1520b may include ISL_Configuration_Table as in Table 50 below:

TABLE 50

| Item | Content |
|---|---|
| Link_ID | Link Identifier |
| Source_Satellite | Departure satellites starting ISL links (satellites leading link setup and |
| | resource allocation) |
| Target_Satellite | Destination satellites receiving ISL links (satellites performing link |
| | acceptance and resource synchronization) |
| Link_Type | Fixed: Fixed link for stable connection between fixed-orbit satellites |
| | Dynamic: variable link dynamically established based on relative position |
| | between non-stationary-orbit satellites |
| Link_Status | Active: activated status capable of current data transfer |
| | inactive: disconnected or waiting deactivated status |
| Link_Capacity | Maximum Capacity (maximum data transfer rate supported by |
| | corresponding ISL in Gbp units) |
| Current_Utilization | Current utilization (percentage of current data transfer rate relative to |
| | Link_Capacity) |

Conditions for dynamic ISL configuration may include inter-satellite distance conditions, relative velocity conditions, and line-of-sight conditions, and the details of each condition are as follows:

### 1. Inter-Satellite Distance Condition:

Conditions defining the maximum allowable distance between satellites of which ISL configuration is possible
Setting considering RF signal path loss, propagation delay, etc.
Performing link quality management through real-time distance monitoring
Determining whether the conditions are met using variables of Distance_Parameters

### 2. Relative Velocity Condition:

Condition defining the maximum allowable relative velocity between two satellites for which ISL is to be set
Setting to ensure frequency shift due to the Doppler effect and beam aiming accuracy
Determining whether the conditions are met using variables of Speed_Parameters

### 3. Line of Sight Condition:

Condition defining whether a direct communication path may be secured between two satellites
Considering curvature of the Earth, atmospheric influence, and interference with other satellites or objects
Determining whether the conditions are met using variables of LOS_Parameters

These three conditions are configured as in Table 51 below, and the specific variables used for evaluating and monitoring each condition are defined as in Table 52 below.

Conditions for dynamic ISL (Inter-Satellite Link) setup may be configured as shown in Table 51 below:

TABLE 51
Dynamic ISL Setup Conditions

| Item | Content |
|---|---|
| Distance_Condition - Maximum_Distance | Less than 1000 km |
| Distance_Condition - Path_Loss_Control | Considering path loss of RF signal |
| Distance_Condition - Propagation_Delay | Considering propagation delay |
| Distance_Condition - Quality_Monitoring | Monitor link quality by real-time distance |
| Relative_Speed_Condition - Maximum_Speed | Less than 1 km/s |
| Relative_Speed_Condition - Doppler_Effect | Consideration of Doppler effect |
| Relative_Speed_Condition - Beam_Accuracy | Ensure beam aiming accuracy |
| Relative_Speed_Condition - Frequency_Compensation | Frequency correction according to speed |
| Line_of_Sight_Condition - Direct_Path | Obtain direct line-of-sight paths |
| Line_of_Sight_Condition - Earth_Curvature | Consideration of effects of curvature of the earth |
| Line_of_Sight_Condition - Atmospheric_Effect | Atmospheric Impact Consideration |
| Line_of_Sight_Condition - Interference_Avoidance | Avoidance of other satellite/object interference |

The main variables used in the dynamic ISL setup conditions of Table 51 above may be defined as shown in Table 52 below:

TABLE 52
Variable Definitions of Dynamic ISL Setup Conditions

| Item | Definition and Description |
|---|---|
| Distance_Parameters - | Maximum allowable distance (km), maximum distance |
| Max_Distance | between satellites capable of ISL setup |
| Distance_Parameters - | Path loss threshold (dB), maximum allowable signal |
| Path_Loss_Threshold | attenuation |
| Distance_Parameters - | Maximum allowable delay (ms), maximum propagation delay |
| Max_Delay | time over distance |
| Distance_Parameters - | Link Quality Index (0-100), Scoring Link Quality by Distance |
| Link_Quality_Index | |
| Speed_Parameters - | Maximum relative speed (km/s), maximum relative speed with |
| Max_Relative_Speed | ISL settings |
| Speed_Parameters - | Doppler transition amount (Hz), frequency variation due to |
| Doppler_Shift | relative speed |
| Speed_Parameters - | Beam orientation error (degrees), maximum allowable beam |
| Beam Pointing_Error | aiming error |
| Speed_Parameters - | Frequency offset (Hz), frequency deviation requiring correction |
| Frequency_Offset | |
| LOS_Parameters - | Route margin (km), minimum separation distance for ensuring |
| Path_Clearance | visibility |
| LOS_Parameters - | Earth shield angle (degrees), Earth shield avoidance angle |
| Earth_Obstruction_Angle | |
| LOS_Parameters - | Atmospheric loss (dB), signal loss occurring in passing through |
| Atmosphere_Loss | the atmosphere |
| LOS_Parameters - | Protection distance (km), minimum separation from other |
| Protection_Distance | satellites |

The setup procedure of dynamic ISL includes three phases such as link possibility assessment, resource allocation, and link activation, and the details of each phase are as follows:

### 1. Link Possibility Assessment Phase:

Evaluating whether the above three setup conditions are met
Quantitative evaluating whether each condition is met using variables of Assessment_Parameters
Determining whether ISL setup is possible based on the evaluation results.

### 2. Resource Allocation Phase:

Allocating resources required for an actual ISL setup if link possibility is confirmed
Determining the type and amount of required resources using the variables of Resource_Parameters
Determining whether to proceed to a next phase according to the resource allocation results

### 3. Link Activation Phase:

Setting up actual ISL based on the allocated resources
Controlling the link setup process using the variables of Activation_Parameters
Performing monitoring and quality control according to the link setup results.

The setup procedure of these three stages is structured as in Table 53 below, and the specific variables used in each stage are defined as in Table 54 below.

By clearly explaining the relationship between each condition and procedure and their related variables, the overall system and implementation scheme for dynamic ISL setup may be more clearly understood.

The setup procedure of dynamic ISL may be configured as in Table 53 below:

TABLE 53
Dynamic ISL Setup Procedure

| Item | Content |
|---|---|
| Link_Feasibility_Assessment - Distance_Calculation | Real-time calculation of distances |
| | between satellites |
| Link_Feasibility_Assessment - Speed_Calculation | Real-time calculation of relative |
| | speeds |
| Link_Feasibility_Assessment - LOS_Verification | Validation of line of sight |
| | Conditions |
| Link_Feasibility_Assessment - Interference Analysis | RF Interference Analysis |
| Link_Feasibility_Assessment - Frequency_Availability | Check frequency availability |
| Link_Feasibility_Assessment - Link_Quality_Estimation - SNR | signal-to-noise ratio calculation |
| Link_Feasibility_Assessment - Link_Quality_Estimation - BER | Calculate bit error rates |
| Link_Feasibility_Assessment - Resource_Estimation | Calculation of required resource |
| | amount |
| Resource_Allocation - Frequency_Assignment | frequency band allocation |
| Resource_Allocation - Power_Level_Setting | Set the transmit/receive power |
| | level |
| Resource_Allocation - Antenna_Beam_Control | Antenna beam orientation |
| | adjustment |
| Resource_Allocation - Buffer_Reservation | Reserve buffer capacity |
| Resource_Allocation - Processing_Capacity | Reserve Processing Capacity |
| Link_Activation - Initial_Synchronization | Initial synchronization signal |
| | exchange |
| Link_Activation - Channel_Establishment | Two-way Communication Channel |
| | Setting |
| Link_Activation - Quality_Verification | Link Quality Verification |
| Link_Activation - Quality_Optimization | Optimizing Link Quality |
| Link_Activation - Data_Transfer_Control | Start and monitor data transfer |

The main variables used in the dynamic ISL setup procedure of the above Table 53 may be defined as in Table 54 below:

TABLE 54
Variable Definition of Dynamic ISL Setup Procedure

| Item | Description |
|---|---|
| Assessment_Parameters - Position_Accuracy | Position accuracy (m), accuracy of satellite |
| | positioning |
| Assessment_Parameters - Velocity_Accuracy | Speed accuracy (m/s), accuracy of satellite |
| | speed measurements |
| Assessment_Parameters - LOS_Probability | Probability of line of sight (%), possibility of |
| | securing line of sight |
| Assessment_Parameters - Interference_Margin | Interference Margin (dB), Acceptable |
| | Interference Level |
| Assessment_Parameters - Link_Quality - Min_SNR | Minimum SNR (dB), minimum signal-to- |
| | noise ratio required |
| Assessment_Parameters - Link_Quality - Max_BER | Maximum BER, maximum allowed bit error |
| | rate |
| Resource_Parameters - Frequency_Band | Frequency band (GHz), allocable |
| | frequency range |
| Resource_Parameters - Power_Range | Power range (dBm), configurable transmit |
| | and receive power range |
| Resource_Parameters - Beam_Width | Beam width (degrees), angle range of |
| | antenna beam |
| Resource_Parameters - Min_Buffer_Size | Minimum buffer size (MB), minimum buffer |
| | capacity required |
| Resource_Parameters - Processing_Power | Processing capability (MIPS), required |
| | signal processing power |
| Activation_Parameters - Sync_Time | Synchronization time (ms), time required to |
| | obtain initial synchronization |
| Activation_Parameters - Channel_Setup_Time | Channel setup time (ms), communication |
| | channel configuration time |
| Activation_Parameters - Quality_Threshold | Quality thresholds, minimum quality criteria |
| | for link activation |
| Activation_Parameters - Transfer_Rate | Transfer rate (Mbps), Initial Data Transfer |
| | Rate |

The ISL routing control is to manage efficient data transmission paths between satellites that satisfy the dynamic ISL setup conditions, managing routing information through Route_Entry (route item).

The Route_Entry of ISL routing control may be configured as shown in Table 55 below:

TABLE 55
Route_Entry Configuration of ISL Routing Control

| Item | Content | Definition |
|---|---|---|
| Route_Entry - Destination | destination | Identifier of target satellite to which data |
| | satellite | should finally be transferred |
| Route_Entry - Next_Hop | Next hop | Identifier of next satellite directly connected |
| | satellite | on the route to destination |
| Route_Entry - Metric | Route cost | Figures indicating efficiency of the path |
| | | (totally considering delays, bandwidth, hops, |
| | | etc.) |
| Route_Entry - Update_Time | Update Time | Time when routing information was last |
| | | updated |

The Route_Entry is configured based on the connection information between satellites that satisfy the dynamic ISL configuration conditions of Table 51 above, and reflects the status of links generated according to the ISL configuration procedure of Table 53 above. The ISL routing optimization criteria based on this Route_Entry may be configured as shown in Table 56 below:

TABLE 56
ISL Routing Optimization Criteria

| Item | Content | Definition |
|---|---|---|
| Optimization_Criteria - End_to_End_Delay | End-to-end delay | Total transmission latency from |
| | | origin to destination |
| Optimization_Criteria - | Available | Minimum available bandwidth on |
| Available_Bandwidth | Bandwidth | path |
| Optimization_Criteria - Link_Stability | Link Stability | Estimated retention time of ISL |
| | | connection |
| Update_Period - Regular_Update | 10 seconds | Periodic Routing Information Update |
| | | Cycle |
| Update_Period - Event_Based_Update | When link state | Immediate Renewal Conditions |
| | changes | according to Link Status Changes |

The Backhaul route optimization is for connection with ground gateways, and selects a path that satisfies the criteria shown in the following Table 57 among the links configured through the ISL setup procedure of the above Table 52:

TABLE 57
ISL Backhaul Route Optimization Criteria

| Item | Content | | Definition |
|---|---|---|---|
| Path_Selection_Criteria - Maximum_Delay | 50 | ms | Maximum allowable |
| | | | transmission delay to |
| | | | gateway |
| Path_Selection_Criteria - Minimum_Bandwidth | 10 | Gbps | Minimum bandwidth |
| | | | required for gateway |
| | | | connectivity |
| Path_Selection_Criteria - Maximum_Hops | 3 | | Maximum number of hops |
| | | | allowed to the gateway |

These Route_Entry-based routing control, optimization criteria, and backhaul route optimization may provide an efficient data transmission path in a dynamic ISL network, and ensure the operation efficiency of the ISL network configured according to the configuration conditions of the Table 51 and the configuration procedures of the Table 53.

A traffic monitor 1520c is a component that monitors and analyzes the traffic status in the dynamic ISL network in real time, and performs functions to continuously monitors whether the ISL configuration conditions are met and to optimize network performance.

A traffic monitor 1520c performs the following main functions in the ISL network configured according to the dynamic ISL configuration conditions of the Table 51 and the configuration procedures of the Table 53:
1. Real-time traffic performance measurement
2. Quality of service (QoS) monitoring
3. Network abnormality detection
4. Automatic response procedure execution

The components of the traffic monitor 1520c may be defined as in the following Table 58 to Table 62:

TABLE 58
Traffic Metrics (Traffic Measurement Indicator) Configuration

| Item | Content | Unit |
|---|---|---|
| Traffic_Metrics - Throughput (throughput) | Amount of data processed per unit | bps |
| | time | |
| Traffic_Metrics - Packet_Loss (packet loss | Percentage of packets that failed to | % |
| rate) | be transmitted | |
| Traffic_Metrics - Delay (delay) | Time taken to send packets | ms |
| Traffic_Metrics - Jitter (jitter) | Rate of variation in packet delay | ms |
| Traffic_Metrics - Queue_Length (queue | The number of packets waiting to be | Number |
| length) | processed | |

TABLE 59
Traffic_Metrics Measurement Cycle

| Item | Content | Cycle | |
|---|---|---|---|
| Measurement_Period - | Real-time performance | 100 | ms |
| Real_time_Metrics | metrics measurement | | |
| (real time metrics) | | | |
| Measurement_Period - | Integrated performance | 1 | s |
| Aggregated_Metrics | metrics measurement | | |
| (aggregated Metrics) | | | |
| Measurement_Period - | Statistical performance | 60 | s |
| Statistical_Metrics | metrics measurement | | |
| (Statistical_Metrics) | | | |

TABLE 60
Traffic_Analysis (Traffic Analysis) Configuration

| Item | Content | Description |
|---|---|---|
| Traffic_Analysis - Peak_Rate | Maximum | Maximum data |
| | Transmission | transfer per unit time |
| | Rate | |
| Traffic_Analysis - Average_Rate | Average | Average data transfer |
| | Transmission | per unit time |
| | Rate | |
| Traffic_Analysis - Burst_Size | Burst Size | Momentary traffic |
| | | increase |
| Traffic_Analysis - Flow_Pattern | Traffic | Temporal |
| | Pattern | Characteristics |
| | | of Traffic Flows |

TABLE 61
Service_Class_Metrics (Service Class
Metrics Indicators) Configuration

| Item | Content | Description |
|---|---|---|
| Service_Class_Metrics - | Service | Service classes |
| Class_ID | classes | identifier |
| Service_Class_Metrics - | Target | Target |
| Target_KPI | performance | performance |
| | indicators | values by |
| | | service class |
| Service_Class_Metrics - | Current | Current |
| Current_KPI | performance | performance |
| | indicators | values by |
| | | service class |
| Service_Class_Metrics - | Number of | Number of |
| Violation_Count | violations | performance |
| | | criteria violations |

TABLE 62
Abnormality detection criteria and response procedures

| | | Reference |
|---|---|---|
| Item | Content | Value/Procedure |
| Anomaly_Detection - | Throughput | ±30% or more |
| Throughput_Change | rapid change | |
| Anomaly_Detection - | Increased | More than twice |
| Delay_Increase | latency | the reference |
| | | value |
| Anomaly_Detection - | Loss rate | 1% or more |
| Loss_Rate | | |
| Anomaly_Detection - | Queue overflow | 80% or more |
| Queue_Overflow | | |
| Response_Procedure - | Abnormal | Abnormal |
| Step1 | situation | situation |
| | logging | recording |
| Response_Procedure - | Create | Administrator |
| Step2 | notifications | notification |
| Response_Procedure - | Traffic bypass | Alternate route |
| Step3 - Action1 | | bypass |
| Response_Procedure - | Additional | Additional |
| Step3 - Action2 | resource | allocation of |
| | allocation | available |
| | | resources |
| Response_Procedure - | Adjusting QoS | Service |
| Step3 - Action3 | policies | quality policy |
| | | reorganization |

The traffic monitoring components defined above monitor the performance of the ISL network in real time and enable a rapid response when an abnormality occurs. In particular, each component is linked to the dynamic ISL setting conditions of Table 51 and the setting procedures of Table 53 to support stable operation of the network.

The components of the traffic monitor defined above are linked to the operation of the ISL network as follows:

### 1. Traffic_Metrics (Traffic Measurement Indicator):

Real-time verification of whether the dynamic ISL configuration conditions of the Table 51 are met
Performing link quality monitoring according to the configuration procedure of the Table 53
Providing basic data for calculating the path cost (Metric) of Route_Entry

### 2. Traffic Analysis (Traffic Analysis):

Providing analysis information for optimizing load distribution and resource allocation of the ISL network
Providing traffic pattern information for Route_Entry update
Providing performance data for backhaul path optimization

### 3. Service_Class_Metrics (Service Class Indicator):

Performing monitoring to ensure the service quality of the ISL network
Supporting resource allocation differentiated for service class
Providing performance data for QoS policy adjustment

### 4. Abnormal Detection and Response Procedures Include:

Performing real-time monitoring to ensure the stability of the ISL network
Ensuring service continuity through rapid response in case of a problem
Providing automated measures to improve network resilience

These traffic monitor components perform key monitoring and control functions for efficient operation and stable service provision of the ISL network.

The measurement method for each indicator of traffic monitor may be defined as in Table 63 below:

TABLE 63
Traffic Metrics Measurement Method

| | | Measurement |
|---|---|---|
| Item | Measurement Method | cycle |
| Throughput_Measurement - | Calculate total amount of data | 100 ms |
| Data_Collection | transferred per unit time | |
| Throughput_Measurement - | (Total number of bits | 100 ms |
| Calculation | transmitted)/(Measurement time) | |
| Packet_Loss_Measurement - | Counting number of packets | 100 ms |
| Data_Collection | failed for transmission | |
| Packet_Loss_Measurement - | (Number of lost packets)/(total number | 1 s |
| Calculation | of transmitted packets) × 100 | |
| Delay_Measurement - | Departure-arrival time log | 100 ms |
| Data_Collection | for each packet | |
| Delay_Measurement - | Calculate mean value of | 1 s |
| Calculation | end-to-end transmission time | |
| Jitter_Measurement - | Record delay time difference | 100 ms |
| Data_Collection | between consecutive packets | |
| Jitter_Measurement - | Calculate standard deviation | 1 s |
| Calculation | of delay time difference | |
| Queue_Length_Measurement - | Check current number of | 100 ms |
| Data_Collection | packets in queue | |
| Queue_Length_Measurement - | Queue occupancy calculation (current | 100 ms |
| Calculation | packet count)/(maximum packet count) | |

The threshold setting criteria for Traffic Monitor may be defined as in Table 64 below:

TABLE 64
Traffic Monitor Threshold Setting Criteria

| Item | Threshold | basis for setting |
|---|---|---|
| Throughput_Threshold - | 70% of | Early warning for |
| Warning_Level | design | preemptive response |
| | capacity | |
| Throughput_Threshold - | 90% of | Thresholds for |
| Critical_Level | design | preventing service |
| | capacity | quality degradation |
| Delay_Threshold - | 150% of | Detect delay |
| Warning_Level | reference | increasing trend |
| | value | |
| Delay_Threshold - | 200% of | Service quality |
| Critical_Level | reference | guarantee threshold |
| | value | |
| Packet_Loss_Threshold - | 0.5% | Detect network |
| Warning_Level | | status deterioration |
| Packet_Loss_Threshold - | 1.0% | Service quality |
| Critical_Level | | guarantee threshold |
| Queue_Length_Threshold - | 70% | Alert level to prevent |
| Warning_Level | | buffer overflow |
| Queue_Length_Threshold - | 80% | Limit for packet loss |
| Critical_Level | | prevention |

The detailed phases of the response procedure in the event of occurrence of an abnormal situation may be defined as in Table 65 below:

TABLE 65
Detailed Phases of Abnormal Situation Response Procedure

| | detailed | |
|---|---|---|
| Item | procedures | Content of performance |
| Anomaly_Logging - Event_Recording | Abnormal event | Record time of occurrence, |
| | recording | event type, and associated |
| | | indicator values |
| Anomaly_Logging - Context_Recording | Recording | Record network status, |
| | Situation | resource usage, and related |
| | Information | link information |
| Alert_Generation - Priority_Assignment | Priority | Critical/Warning/Info rating |
| | assignment | classification |
| Alert_Generation - Notification_Distribution | Propagate | Notification to administrator |
| | Notifications | and related systems |
| Automatic_Response - Traffic_Rerouting | Traffic bypass | Alternate path discovery and |
| | processing | traffic switching |
| Automatic_Response - Resource_Allocation | Additional | Additional allocation of |
| | Resource | buffers, bandwidth, and |
| | Allocation | processing capacity |
| Automatic_Response - QoS_Adjustment | Adjusting QoS | Adjust service priority and |
| | Policies | Resource Redistribution |
| Recovery_Verification - Performance_Check | Check Recovery | Re-confirm performance |
| | Performance | indicators after action |
| Recovery_Verification - Stability_Check | Check of stability | Monitor additional anomalies |

The method of association of traffic monitor with other components may be defined as in Table 66 below:

TABLE 66
Method of Association Between Components

| | Interworking | |
|---|---|---|
| Item | Target | Interworking Content |
| ISL_Controller_Integration - Status_Reporting | ISL | Real-time reporting of link status |
| | Controller | and performance information |
| ISL_Controller_Integration - Command_Reception | ISL | Receive and execute link |
| | Controller | control commands |
| Route_Entry_Integration - Metric_Update | Route Entry | Provide performance metrics |
| | | for path cost calculation |
| Route_Entry_Integration - Route_Verification | Route Entry | Provide performance verification |
| | | data for established path |
| Resource_Management_Integration - Status_Report | Resource | Resource usage report |
| | Manager | |
| Resource_Management_Integration - | Resource | Verifying Additional Resource |
| Resource_Request | Manager | Requests and Allocations |
| QoS_Control_Integration - Performance_Report | QoS | Report service quality |
| | Controller | measurement results report |
| QoS_Control_Integration - Policy_Update | QoS | Receiving and applying service |
| | Controller | policy changes |

The format of real-time data exchange between the traffic monitor and other components may be defined as in Table 67 below:

TABLE 67
Data Exchange Format Between Components

| Item | Data Type | Data Format |
|---|---|---|
| Performance_Data - | Real-time | {timestamp, |
| Real_Time_Metrics | Performance | metric_type, value} |
| | Indicators | |
| Performance_Data - | Aggregated | {period, metric_type, |
| Aggregated_Stats | Statistics Data | min, max, avg} |
| Control_Messages - | Update Status | {component_id, |
| Status_Updates | | status_type, |
| | | status_value} |
| Control_Messages - | control | {command_type, |
| Command_Messages | command | parameters, priority} |
| Event_Data - | Report on | {event_id, severity, |
| Anomaly_Reports | anomaly | description, metrics} |
| | situation | |
| Event_Data - | result of action | {action_id, |
| Action_Results | | result_status, |
| | | performance_impact} |

Systematic association and data exchange between these components enable efficient operation and rapid response to failures of the ISL network.

A service quality manager 1530 may include the following configurations:

A load balancer 1530a is a core component that efficiently distributes system resources and network load in the ISL network, and performs functions of maintaining load balance of the dynamic ISL and optimizing performance of the entire network based on a monitoring result of the traffic monitor.

A load balancer 1530a performs the following main functions in the ISL network configured according to the dynamic ISL configuration conditions of the Table 51 and the configuration procedures of the Table 53:
1. Real-time monitoring of system load status
2. Step-by-step response according to load level
3. Execution of efficient load distribution policy
4. Resource allocation based on service priority

The components and operating criteria of the load balancer 1530a may be defined as follows:

TABLE 68
System_Load_Metrics (System Load
Measurement Indicator) Configuration

| Item | Content | Unit |
|---|---|---|
| System_Load_Metrics - | Gateway/Satellite | ID |
| Entity_ID | Identifier | value |
| System_Load_Metrics - | Central processing | % |
| CPU_Usage | unit utilization | |
| System_Load_Metrics - | Memory utilization | % |
| Memory_Usage | | |
| System_Load_Metrics - | Communication | % |
| Link_Usage | link utilization | |
| System_Load_Metrics - | Buffer memory | % |
| Buffer_Usage | utilization | |
| System_Load_Metrics - | Overall Processing | % |
| Processing_Load | Load Rate | |

TABLE 69
Load Distribution Threshold Setting

| Item | Threshold | Definition |
|---|---|---|
| Load_Threshold - | 70% | Load threshold at pre-alert level |
| Warning_Threshold | | |
| Load_Threshold - | 85% | Load threshold at risk level |
| Critical_Threshold | | requiring action |
| Load_Threshold - | 95% | load thresholds at severity level |
| Emergency_Threshold | | requiring emergency response |

TABLE 70
Load_Distribution_Criteria (Load
Distribution Criteria) configuration

| Item | Content | Evaluation Method |
|---|---|---|
| Distribution_Criteria - | Current load | Real-time system load |
| Current_Load | | status assessment |
| Distribution_Criteria - | Available | Calculation of additional |
| Available_Capacity | capacity | acceptable loads |
| Distribution_Criteria - | Geographical | Consideration of delay |
| Geographic_Distance | distance | due to physical distance |
| Distribution_Criteria - | Service | Service criticality based |
| Service_Priority | priorities | priority assessment |

A load balancer 1530a efficiently distributes the load of the ISL network based on the above-defined measurement indicators, thresholds, and distribution criteria, and supports optimal use of network resources in association with the monitoring results of the traffic monitor.

The components of the load balancer 1530a defined above are linked to the operation of the ISL network as follows:

### 1. System_Load_Metrics is Used for:

Evaluating the system load status in association with the traffic metrics measurement results of Table 63
Verifying whether the dynamic ISL configuration conditions of Table 51 are met
Providing load information for Route_Entry update.

### 2. Load Distribution Threshold is Used for:

Providing step-by-step response criteria in association with the traffic monitor threshold of Table 64
Providing judgment criteria for executing the abnormal situation response procedure of Table 65
Presenting preemptive measure criteria for maintaining the system stability.

### 3. Load_Distribution_Criteria is Used for:

Resource allocation optimization according to the ISL configuration procedure of Table 53
Execution of efficient load distribution through association between components of Table 66
Supporting for differentiated resource management according to service priority

The load balancer 1530a plays an important role, especially in the following situations:
1. Maintaining system stability through load distribution in case of traffic congestion
2. Guaranteeing service quality through efficient use of system resources
3. Securing service continuity by rapid load redistribution in a failure situation

This configuration and operation of the load balancer 1530a play a key role in improving the overall performance and stability of the ISL network.

The distribution procedure may include the following phases:

In the load status evaluation phase, the following phrases may be performed:
Calculation of the load index for each entity
Analysis of the overall system load distribution.

In the distribution target selection phase, the following phrases may be performed:
Overload entity identification (load>Critical_Threshold)
Redundant entity identification (load<Waming_Threshold).

In the load relocation phase, the following phases may be performed:
Service transfer plan establishment
Phased load transfer execution.

A QoS controller 1530b is a core component for ensuring service quality in the ISL network, and performs quality management differentiated for each service class based on the monitoring results of the traffic monitor 1520c.

The QoS controller 1530b performs the following main functions in the ISL network configured according to the dynamic ISL configuration conditions of Table 51 and the configuration procedures of Table 53:
1. Defining and managing quality criteria by service class
2. Real-time service quality monitoring
3. Differentiated resource allocation by class
4. Detecting and responding to QoS violations

Service_Class_Definition of the QoS controller 1530b may be configured as shown in Table 71 below.

TABLE 71
Service_Class_Definition (Service
Class Definition) Configuration

| Item | Content | Description |
|---|---|---|
| Service_Class - | QoS class | Unique identifiers |
| Class_ID | identifier | distinguishing service |
| | | ratings |
| Service_Class - | Priority | Service processing priority |
| Priority | (1-10) | (10 is the highest priority) |
| Service_Class - | Minimum | Minimum bandwidth |
| Bandwidth_Guarantee | guaranteed | guaranteed for that |
| | bandwidth | service class |
| Service_Class - | Maximum | Maximum allowed packet |
| Max_Latency | allowable | transmission latency time |
| | latency | |
| Service_Class - | Maximum | Maximum allowed packet |
| Max_Jitter | allowable | latency variation |
| | jitter | |
| Service_Class - | Maximum | Maximum allowed packet |
| Max_Loss_Rate | allowable | loss rate |
| | loss rate | |

QoS_Mapping_Table may be configured as shown in Table 72 below:

TABLE 72
QoS_Mapping_Table Configuration

| Item | Content | Description |
|---|---|---|
| QoS_Mapping - | Traffic type | Characteristic classification |
| Traffic_Type | | of data traffic |
| QoS_Mapping - | Diffserv | Differentiated service level |
| DSCP | Code Point | identifiers |
| QoS_Mapping - | QoS class | Service quality |
| Service_Class | | classification |
| QoS_Mapping - | Scheduling | Traffic handling priority |
| Schedule_Policy | policy | policy |

Resource_Control_Parameters may be configured as shown in Table 73 below:

TABLE 73
Resource_Control_Parameters Configuration

| Item | Content | Unit/Description |
|---|---|---|
| Resource_Control - Min_Rate | Minimum | bps |
| | transfer rate | |
| Resource_Control - Max_Rate | Maximum | bps |
| | transfer rate | |
| Resource_Control - Burst_Size | Burst size | bytes |
| Resource_Control - Queue_Length | Queue length | packets |
| Resource_Control - Drop_Policy | Packet drop | Drop priority |
| | policy | rules |

Dynamic resource adjustment conditions and procedures may be defined as shown in Table 74 below:

TABLE 74
Dynamic Resource Adjustment

| Item | Content | Description |
|---|---|---|
| Adjustment_Conditions - QoS_Violation | QoS Violations | the service quality |
| | Occurred | standards not met |
| Adjustment_Conditions - Resource_Usage | Change in resource | When changing resource |
| | utilization | usage patterns |
| Adjustment_Conditions - Priority_Change | Changing priorities | When adjusting service |
| | | priority |
| Adjustment_Steps - Monitoring | Monitoring | Real-time performance data |
| | performance | collection |
| | indicators | |
| Adjustment_Steps - Detection | Detection of violations | Identifying QoS Violations |
| Adjustment_Steps - Reallocation | Performing resource | Perform dynamic resource |
| | reallocation | redistribution |

The QoS controller 1530b effectively manages the service quality of the ISL network through the above-defined components, and performs resource management for service quality assurance based on the dynamic ISL setting conditions of the Table 51 and the Traffic Metrics measurement result of the Table 63.

The components of the QoS controller 1530b defined above are associated with other components of the ISL network as shown in Table 75 below:

TABLE 75
QoS Controller 1530b Associated Operation

| | Associating | |
|---|---|---|
| Item | Target | Association Content |
| Traffic_Monitor_Integration - Performance_Data | Traffic monitor | Receive performance |
| | | indicators related to quality of |
| | | service |
| Traffic_Monitor_Integration - QoS_Alerts | Traffic monitor | Receive QoS Violation |
| | | Notification |
| Load_Balancer_Integration - Resource_Status | Load balancer | Receiving system resource |
| | | status information |
| Load_Balancer_Integration - Load_Distribution | Load balancer | Request load distribution by |
| | | service class |
| Route_Entry_Integration - Path_Selection | Route entry | QoS requirement-based path |
| | | selection |
| Route_Entry_Integration - Route_Update | Route entry | Service quality based path |
| | | renewal |

The phased control operation of the QoS controller 1530b may be defined as shown in Table 76 below:

TABLE 76
QoS Controller 1530b Control Operation

| Item | operating conditions | Control Content |
|---|---|---|
| Normal_Operation - Load < 70% | All classes normal service | General operations based on set |
| | | QoS criteria |
| Warning_Operation - Load 70~85% | Preemptive QoS control | Start lower-class service limit |
| Critical_Operation - Load 85~95% | Differential QoS control | Providing differentiated service by |
| | | class |
| Emergency_Operation - Load > | Urgent QoS control | Ensure top-class service priorities |
| 95% | | |

The service class-specific resource allocation policy of the QoS controller 1530b may be defined as shown in Table 77 below:

TABLE 77
Service Class-specific Resource Allocation Policy

| | Resource Allocation | |
|---|---|---|
| Item | Ratio | Level of Coverage Ensured |
| Premium_Class - Priority(8-10) | 50% of all resources | Ensuring priority resource |
| | | allocation |
| Business_Class - Priority(5-7) | 30% of all resources | Ensuring conditional resource |
| | | allocation |
| Basic_Class - Priority(1-4) | 20% of all resources | Residual resource-based |
| | | allocation |

The configuration and operation of this QoS controller 1530b enable differentiated quality assurance by service class and efficient resource utilization in the ISL network. In particular, with close association with the traffic monitor 1520c and the load balancer 1530a, stable service quality may be maintained even in a dynamic network environment.

An interference manager 1530c is a key component that manages and controls various types of interference that may occur in an ISL network, and performs functions of minimizing interference and optimizing network performance based on the monitoring results of the traffic monitor 1520c and the service quality requirements of the QoS controller 1530b.

The interference manager 1530c performs the following main functions in the ISL network configured according to the dynamic ISL configuration conditions of Table 51 and the configuration procedures of Table 52:
1. Real-time interference monitoring and analysis
2. Interference impact assessment and response
3. Preventive interference management
4. Resource optimization for interference avoidance

TABLE a
<Interference_Metrics (Interference Measurement Indicator) Configuration>

| Item | Content | Unit/Description |
|---|---|---|
| Interference_Metrics - Source_ID | Interference source | ID of source that causes |
| | identifier | interference |
| Interference_Metrics - Target_ID | Interference target | ID of interference affected target |
| | identifier | |
| Interference_Metrics - Frequency_Band | frequency band | Frequency range in MHz |
| Interference_Metrics - Power_Level | Interference power | Interference signal strength in dBm |
| | level | |
| Interference_Metrics - SINR | signal-to- | signal-to-interference ratio in dB |
| | interference ratio | |
| Interference_Metrics - Time_Stamp | Measurement time | Interference measurement time |
| | | point |

TABLE b
<Interference tolerance threshold criteria>

| Item | Treshold | Description |
|---|---|---|
| Interference_Threshold - Co_channel | −130 dBm/MHz | Same channel interference allowable criteria |
| Interference_Threshold - | −110 dBm/MHz | Adjacent channel interference allowable |
| Adjacent_channel | | criteria |

TABLE c
<Minimum SINR Requirements For Each Service>

| | Required | |
|---|---|---|
| Item | Level | Use |
| SINR_Requirement - Voice_Service | 12 dB | Ensuring 12 dB voice service |
| | | quality |
| SINR_Requirement - Data_Service | 8 dB | Ensuring 8 dB data service |
| | | quality |
| SINR_Requirement - loT_Service | 5 dB | Ensuring 5 dB IoT service quality |

TABLE 78
Interference Control Mechanism

| Item | Content | control method |
|---|---|---|
| Frequency_Coordination - | Channel allocation | Interference minimization-based |
| Channel_Assignment | information | channel assignment |
| Frequency_Coordination - Guard_Band | Guard band | Inter-channel interference band |
| Frequency_Coordination - | Power control | Adaptive power level adjustment |
| Power_Control | parameters | |
| Beam_Control - Beam_Pattern | Beam pattern | Optimizing beam shape |
| Beam_Control - Pointing_Direction | Pointing direction | Beam orientation control |
| Beam_Control - Null_Steering | Null steering | Forming null in direction of |
| | information | interference |

TABLE 79
Interference Management Procedure

| Item | Phase | detailed Operation |
|---|---|---|
| Detection_Phase - Monitoring | Real-time monitoring | Real-time monitoring of interference |
| | | levels |
| Detection_Phase - Threshold_Check | Detection threshold | Check if allowable criteria is |
| | exceeded | exceeded |
| Impact_Assessment - Service_Quality | Service quality impact | QoS degradation assessment |
| | analysis | |
| Impact_Assessment - User_Impact | Identify extent of user | Identifying Affected Users |
| | impact | |
| Mitigation_Action - Resource_Reallocation | Resource reallocation | Relocation of resources to avoid |
| | | interference |
| Mitigation_Action - | Adjusting beam patterns | Beam adjustment to minimize |
| Beam_Pattern_Adjustment | | interference |
| Mitigation_Action - Power_Level_Control | Power level adjustment | Power control for interference |
| | | reduction |

TABLE 80
Preventive Interference Management

| Item | Content | management method |
|---|---|---|
| Predictive_Control - Orbit_Analysis | Orbital analysis | Satellite orbit-based interference |
| | | prediction |
| Predictive_Control - | Coverage prediction | Analysis of service area |
| Coverage_Prediction | | overlapping |
| Predictive_Control - | Interference prediction | Potential interference predictions |
| Interference_Forecast | | |
| Preventive_Measures - | Maintain safe distances between | Ensure minimum separation |
| Safety_Distance | satellites | distance |
| Preventive_Measures - | Establish frequency reuse plan | Efficient frequency reuse |
| Frequency_Reuse | | |
| Preventive_Measures - | Optimizing dynamic resource | Preemptive resource optimization |
| Resource_Optimization | allocation | |

The operation associated with other components of the interference manager 1530c may be defined as shown in Table 81 below:

TABLE 81
Interference Manager Association Operation

| | Association | |
|---|---|---|
| Item | Target | Association Content |
| Traffic_Monitor_Integration - SINR_Data | Traffic Monitor | Receive and analyze SINR |
| | | measurements |
| Traffic_Monitor_Integration - Power_Level_Data | Traffic Monitor | Receive signal strength information |
| QoS_Controller_Integration - | QoS Controller | Receiving SINR requirements by |
| Service_Requirements | | service |
| QoS_Controller_Integration - Quality_Impact | QoS Controller | QoS impact report due to interference |
| Load_Balancer_Integration - Resource_Status | Load Balancer | Receiving resource allocation status |
| | | information |
| Load_Balancer_Integration - Load_Distribution | Load Balancer | Load balancing request for interference |
| | | avoidance |

The operation of the interference manager 1530c for each operation mode may be defined as in Table 82 below:

TABLE 82
Interference Manager Operation Mode
Conditions

| | Operating | |
|---|---|---|
| Item | Conditions | Control Content |
| Normal_Mode - SINR > Required | Normal | Periodic monitoring and preventive |
| | operation | management |
| Warning_Mode - SINR ≈ Required | Careful | Preemptive measures to reduce interference |
| | operation | |
| Critical_Mode - SINR < Required | Risk operation | Implementation of immediate interference |
| | | mitigation measures |
| Emergency_Mode - Severe Interference | Emergency | Urgent action to protect services |
| | operation | |

The response strategy of the interference manager 1530c for each interference type may be defined as in Table 83 below:

TABLE 83
Response Strategy For Each Interference Type

| Item | Responding Method | Detailed Measures |
|---|---|---|
| Co_Channel_Interference | Same channel | Frequency reallocation, power control, |
| | interference response | beam adjustment |
| Adjacent_Channel_Interference | Adjacent channel | Adjusted protection bands, enhanced |
| | interference response | filtering |
| Cross_Polarization_Interference | Cross-polarized | Improved polarization separation, beam |
| | interference response | alignment |
| Inter_Satellite_Interference | Inter-satellite interference | Secure safe distance, optimize beam |
| | response | pattern |

The configuration and operation of the interference manager 1530c plays a key role in effectively managing various types of interference that may occur in the ISL network and optimizing the performance of the entire network. In particular, close association with the traffic monitor and the QoS controller supports to enable efficient resource utilization while guaranteeing service quality.

The specific parameters and configurations of the above-described components may be adjusted according to the system requirements and the operating environment, and the numerical values presented in the embodiments are merely of examples so that other values may be used in actual implementations.

Database 1540 may include the following data structures:

Space_Area_Master_Table may be configured as shown in Table 84 below:

TABLE 84
Space_Area_Master_Table Configuration

| Item | Content |
|---|---|
| SAI | Space Area identifier (Primary Key) |
| Area_Type | Earth-fixed/Quasi-earth- |
| | fixed/Earth-moving |
| Geographic_Info - Center_Coordinates | (Latitude, Longitude) |
| Geographic_Info - Coverage_Radius | Radius (km) |
| Geographic_Info - Height_Range - Min_Height | Minimum altitude (km) |
| Geographic_Info - Height_Range - Max_Height | Maximum altitude (km) |
| Time_Info - Creation_Time | Generation time |
| Time_Info - Last_Update | Last update time |
| Time_Info - Valid_Period | Validity period |
| Service_Info - Max_Capacity | Maximum service capacity |
| Service_Info - Current_Load | Current load |
| Service_Info - Active_UEs | Number of active terminals |

Space_Area_Satellite_Mapping may be configured as in Table 85 below:

TABLE 85
Space_Area_Satellite_Mapping configuration

| Item | Content |
|---|---|
| SAI | Space Area identifier |
| Satellite_Info - Satellite_ID | Satellite identifier |
| Satellite_Info - Role | Primary/Secondary/Backup |
| Satellite_Info - Service_Time_Window - Start_Time | Service start time |
| Satellite_Info - Service_Time_Window - End_Time | Service end time |
| Satellite_Info - Service_Quality_Metrics - Coverage_Quality | Coverage quality index |
| Satellite_Info - Service_Quality_Metrics - Link_Stability | Link stability index |
| Satellite_Info - Service_Quality_Metrics - Resource_Availability | Resource availability |

Satellite_Status_Table of satellite status information may be configured as in Table 86 below:

TABLE 86
Satellite_Status_Table Configuration

| Item | Content |
|---|---|
| Satellite_ID | Satellite identifier |
| | (Primary Key) |
| Orbital_Info - Position | (X, Y, Z) Coordinates |
| Orbital_Info - Velocity | (Vx, Vy, Vz) Velocity |
| | vector |
| Orbital_Info - Orbital_Parameters - | Long radius |
| Semi_Major_Axis | |
| Orbital_Info - Orbital_Parameters - | Eccentricity |
| Eccentricity | |
| Orbital_Info - Orbital_Parameters - | Orbital inclination angle |
| Inclination | |
| Orbital_Info - Orbital_Parameters - | Longitude of ascending |
| RAAN | node |
| Orbital_Info - Orbital_Parameters - | Perigee defection angle |
| Argument_of_Perigee | |
| Orbital_Info - Orbital_Parameters - | Mean periapsis anomaly |
| Mean_Anomaly | |
| Health_Status - Power_Level | Power status (%) |
| Health_Status - Memory_Usage | Memory utilization (%) |
| Health_Status - CPU_Usage | CPU utilization (%) |
| Health_Status - Temperature | Temperature status |
| Health_Status - Component_Status - | Normal/abnormal |
| Solar_Panels | |
| Health_Status - Component_Status - | Normal/abnormal |
| Battery | |
| Health_Status - Component_Status - | Normal/abnormal |
| Communication_System | |
| Health_Status - Component_Status - | Normal/abnormal |
| Propulsion_System | |

Resource_Status of Satellite_Status_Table of the satellite status information 850b may be configured as in Table 87 below:

TABLE 87
Resource_Status Configuration of Satellite_Status_Table

| Item | Content |
|---|---|
| Resource_Status - Beam_Resources - | Beam identifier |
| Beam_ID | |
| Resource_Status - Beam_Resources - | Frequency band |
| Frequency_Band | |
| Resource_Status - Beam_Resources - | Power level |
| Power_Level | |
| Resource_Status - Beam_Resources - | Utilization rate |
| Utilization | |
| Resource_Status - ISL_Resources - | ISL identifier |
| Link_ID | |
| Resource_Status - ISL_Resources - | Connected |
| Connected_Satellite | satellite ID |
| Resource_Status - ISL_Resources - | Link capacity |
| Link_Capacity | |
| Resource_Status - ISL_Resources - | Current load |
| Current_Load | |
| Resource_Status - Processing_Resources - | Available |
| Available_Capacity | processing |
| | capacity |
| Resource_Status - Processing_Resources - | Buffer status |
| Buffer_Status | |
| Resource_Status - Processing_Resources - | Queue length |
| Queue_Length | |

Service_Statistics_Table of service statistics information may be configured as in Table 88 below:

TABLE 88
Service_Statistics_Table Configuration

| Item | Content |
|---|---|
| Time_Window - Start_Time | Measurement start time |
| Time_Window - End_Time | Measurement end time |
| Time_Window - Granularity | Statistics collection units |
| Traffic_Statistics - Total_Volume | Total traffic amount |
| Traffic_Statistics - Peak_Rate | Peak transfer rate |
| Traffic_Statistics - Average_Rate | Average transfer rate |
| Traffic_Statistics - | Voice traffic ratio |
| Service_Type_Distribution - Voice | |
| Traffic_Statistics - | Data traffic ratio |
| Service_Type_Distribution - Data | |
| Traffic_Statistics - | Image traffic ratio |
| Service_Type_Distribution - Video | |
| Traffic_Statistics - | IoT traffic ratio |
| Service_Type_Distribution - IoT | |
| QoS_Statistics - Average_Latency | Average latency |
| QoS_Statistics - Jitter | Jitter |
| QoS_Statistics - Packet_Loss_Rate | Packet loss rate |
| QoS_Statistics - Error_Rate | Error rate |
| QoS_Statistics - Service_Availability | Service availability |

User_Statistics of Service_Statistics_Table of service statistics information may be configured as in Table 89 below:

TABLE 89
User_Statistics Configuration of Service_Statistics_Table

| Item | Content |
|---|---|
| User_Statistics - Total_Users | Total number |
| | of users |
| User_Statistics - Active_Users | Number of |
| | active users |
| User_Statistics - | Static users ratio |
| Mobility_Pattern - Static | |
| User_Statistics - | Low-speed |
| Mobility_Pattern - Low_Mobility | movement ratio |
| User_Statistics - | High-speed |
| Mobility_Pattern - High_Mobility | movement ratio |
| User_Statistics - | Urban area ratio |
| Geographic_Distribution - Urban | |
| User_Statistics - | Sub-urban |
| Geographic_Distribution - Suburban | area ratio |
| User_Statistics - | Rural area ratio |
| Geographic_Distribution - Rural | |

System_Configuration_Table of configuration data may be configured as in Table 90 below:

TABLE 90
System_Configuration_Table configuration

| Item | Content |
|---|---|
| Network_Config - ISL_Parameters - | Number of |
| Max_Links | maximum ISLs |
| Network_Config - ISL_Parameters - | Link capacity |
| Link_Capacity | |
| Network_Config - ISL_Parameters - | Protocol version |
| Protocol_Version | |
| Network_Config - Gateway_Parameters - | Connection |
| Connection_Timeout | timeout |
| Network_Config - Gateway_Parameters - | Retry count |
| Retry_Count | |
| Network_Config - Gateway_Parameters - | Buffer size |
| Buffer_Size | |
| Network_Config - Routing_Parameters - | Update cycle |
| Update_Interval | |
| Network_Config - Routing_Parameters - | Path selection |
| Path_Selection_Algorithm | algorithm |
| Network_Config - Routing_Parameters - | Convergence |
| Convergence_Time | time |

The additional configuration of System_Configuration_Table of configuration data may be configured as in Table 91 below:

TABLE 91
Additional Configuration of System_Configuration_Table

| Item | Content |
|---|---|
| QoS_Config - Service_Classes - Class_ID | Service Class ID |
| QoS_Config - Service_Classes - Priority | Priority |
| QoS_Config - Service_Classes - | Bandwidth guarantees |
| Bandwidth_Guarantee | |
| QoS_Config - Service_Classes - | Maximum delay |
| Max_Latency | |
| QoS_Config - Service_Classes - | Buffer allocation |
| Buffer_Allocation | |
| QoS_Config - Scheduling_Policy - Algorithm | Scheduling algorithm |
| QoS_Config - Scheduling_Policy - | Weight distribution |
| Weight_Distribution | |
| QoS_Config - Scheduling_Policy - | Preemption rules |
| Preemption_Rules | |
| Resource_Management_Config - | Higher threshold |
| Load_Balancing - Threshold_High | |
| Resource_Management_Config - | Lower threshold |
| Load_Balancing - Threshold_Low | |
| Resource_Management_Config - | Balancing interval |
| Load_Balancing - Balance_Interval | |
| Resource_Management_Config - | Maximum number |
| Admission_Control - Max_Users_Per_Beam | of users per beam |
| Resource_Management_Config - | Resource |
| Admission_Control - Resource_Reservation | reservation rate |
| Resource_Management_Config - | Acceptance criteria |
| Admission_Control - Admission_Criteria | |

The configuration of the space area management system 1500 by operation mode may be defined as in Table 92 to Table 94 below:

TABLE 92
Normal Operation Configuration

| Item | Entity in charge | Operation Content |
|---|---|---|
| Resource_Assignment - | Satellite operators | Satellite resource |
| Satellite_Resources | | allocation and |
| | | management |
| Resource_Assignment - | Mobile | Ground resource |
| Ground_Resources | communication | allocation and |
| | service provider | management |
| Resource_Assignment - | Joint management | Shared resource |
| Shared_Resources | | integration |
| | | operations |
| Service_Delivery - | Satellite operator | Provision satellite |
| Space_Segment | leading | section service |
| Service_Delivery - | Mobile | Providing ground |
| Ground_Segment | communication | section service |
| | operator leading | |
| Service_Delivery - | Integrated | Integrated |
| Integrated_Services | operation | management of |
| | | the entire service |

TABLE 93
Operation Configuration by Emergency Scenario

| Item | Operation entity | Responding Content |
|---|---|---|
| Natural_Disaster - | Satellite operator | Configuring emergency |
| Primary_Control | | satellite communication |
| | | network |
| Natural_Disaster - | Mobile | Auxiliary |
| Support_Functions | communication | communication support |
| | operator | |
| Natural_Disaster - | Joint response | Perform disaster |
| Recovery_Procedures | | recovery procedures |
| Network_Congestion - | Mobile | Lead traffic control |
| Primary_Control | communication | |
| | operator | |
| Network_Congestion - | Satellite operator | Provides backup path |
| Support_Functions | | |
| Network_Congestion - | Joint | Integrated traffic |
| Traffic_Management | management | management |
| Large_Event - | Integrated | Integrated management |
| Resource_Pooling | operation | of entire resources |
| Large_Event - | Load distribution | Efficient load |
| Load_Balancing | management | distribution |
| Large_Event - | Ensuring service | Providing reliable |
| Service_Continuity | continuity | service |

TABLE 94
System Operation Characteristics

| Item | Characteristics | Implementation Method |
|---|---|---|
| Operation_Features - | Real-time renewable | Application of |
| Dynamic_Structure | dynamic structure | context-adaptive |
| | | structure |
| Operation_Features - | Context-optimized | Customized policies |
| Optimized_Policy | operational policies | by scenario |
| Operation_Features - | Flexible scalability | Requirement-based |
| Flexible_Scalability | | scaling |
| Operation_Features - | Ensuring service | Availability with |
| Service_Redundancy | continuity | redundant |
| | | configurations |

Service Redundancy configurations

The configuration and operation schemes of this system are only of examples and may be modified as required according to their system requirements and operation environments for actual implementations, and may be comprehensively managed using a space area manager 1510 including a space area registry 1510a, a satellite group manager 1510b, a resource scheduler 1510c, and a serving satellite switching controller 1510d, in an integrated manner.

The configuration and operation of this space area management system 1500 enable efficient integrated operation of satellite networks and terrestrial networks through organic association with a gateway interface 1520 and a service quality manager 1530, and ensure stable service provision in various operation situations through systematic information management utilizing database 1540.

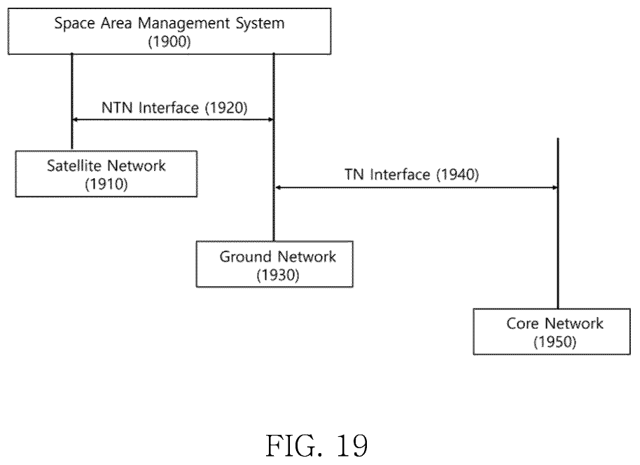

FIG. 19 is a diagram illustrating a system interworking interface of a space area management system 1900 according to an embodiment of the disclosure. The space area management system 1900 may include the following interface configurations:

The Protocol_Stack of the NTN interface 1920 may be configured as shown in Table 95 below:

TABLE 95
Protocol_Stack Configuration

| Item | Content |
|---|---|
| Control_Plane - Signaling_Protocols - | Connection setting |
| Connection_Setup | protocol |
| Control_Plane - Signaling_Protocols - | Resource |
| Resource_Management | management protocol |
| Control_Plane - Signaling_Protocols - | Mobility |
| Mobility_Management | management protocol |
| Control_Plane - Message_Formats - | Control message |
| Control_Messages | format |
| Control_Plane - Message_Formats - | Status message format |
| Status_Messages | |
| Control_Plane - Message_Formats - | Error message format |
| Error_Messages | |
| User_Plane - Data_Protocols - | Transmission protocol |
| Transmission | |
| User_Plane - Data_Protocols - | Error control protocol |
| Error_Control | |
| User_Plane - Data_Protocols - | Flow control protocol |
| Flow_Control | |
| User_Plane - QoS_Control - | Traffic classification |
| Traffic_Classification | |
| User_Plane - QoS_Control - | Priority processing |
| Priority_Handling | |
| User_Plane - QoS_Control - | Bandwidth |
| Bandwidth_Management | management |

The Satellite_Network_Integration of the NTN interface 1920 may be configured as shown in Table 96 below:

TABLE 96
Satellite_Network_Integration Configuration

| Item | Content |
|---|---|
| Resource_Management - Bandwidth_Control - | Allocation |
| Allocation_Policy | policy |
| Resource_Management - Bandwidth_Control - | Dynamic |
| Dynamic_Adjustment | adjustment |
| Resource_Management - Bandwidth_Control - | Monitoring |
| Monitoring_Parameters | parameters |
| Resource_Management - Link_Management - | Link quality |
| Link_Quality | management |
| Resource_Management - Link_Management - | Power control |
| Power_Control | |
| Resource_Management - Link_Management - | Interference |
| Interference_Management | management |

The Service_Integration of the NTN interface 1920 may be configured as shown in Table 97 below:

TABLE 97
Service_Integration Configuration

| Item | Content |
|---|---|
| Service_Mapping - Service_Types | Service type |
| | mapping |
| Service_Mapping - QoS_Classes | QoS class |
| | mapping |
| Service_Mapping - Priority_Levels | Priority level |
| | mapping |
| Performance_Management - | KPI monitoring |
| KPI_Monitoring | |
| Performance_Management - | Performance |
| Performance_Analysis | Analysis |
| Performance_Management - | Service |
| Service_Optimization | optimization |

The Ground_Network_Integration of the TN interface 1940 may be configured as shown in Table 98 below:

TABLE 98
Ground_Network_Integration Configuration

| Item | Content |
|---|---|
| Network_Management - Configuration_Management - | Configuring |
| Network_Elements | Network |
| | Elements |
| Network_Management - Configuration_Management - | Setting |
| Parameter_Settings | Parameters |
| Network_Management - Configuration_Management - | Resource |
| Resource_Configuration | configuration |
| Network_Management - Operation_Management - | Performance |
| Performance_Monitoring | Monitoring |
| Network_Management - Operation_Management - | Fault |
| Fault_Management | Management |
| Network_Management - Operation_Management - | Security |
| Security_Management | Management |
| Service_Coordination - Service_Control - | Service |
| Service_Activation | Activation |
| Service_Coordination - Service_Control - | Service |
| Service_Modification | Modification |
| Service_Coordination - Service_Control - | Service |
| Service_Termination | Termination |
| Service_Coordination - Resource_Coordination - | Resource |
| Resource_Sharing | Sharing |
| Service_Coordination - Resource_Coordination - | Load Balancing |
| Load_Balancing | |
| Service_Coordination - Resource_Coordination - | Capacity |
| Capacity_Planning | Planning |

Operation_Mode_Configuration for interworking with a core network 1950 may include the following configuration:

Normal_Operation of Operation_Mode_Configuration may be configured as in Table 99 below:

TABLE 99
Normal_Operation Configuration

| Item | Content |
|---|---|
| Resource_Management - Space_Area_Management - | Setting |
| Area_Definition - Geographic_Boundaries | geographic |
| | boundary |
| Resource_Management - Space_Area_Management - | Coverage |
| Area_Definition - Coverage_Parameters | parameter |
| Resource_Management - Space_Area_Management - | Service |
| Area_Definition - Service_Requirements | requirements |
| Resource_Management - Space_Area_Management - | Satellite resource |
| Resource_Allocation - Satellite_Resources | allocation |
| Resource_Management - Space_Area_Management - | Terrestrial |
| Resource_Allocation - Ground_Resources | resource |
| | allocation |
| Resource_Management - Space_Area_Management - | Shared resource |
| Resource_Allocation - Shared_Resources | management |
| Resource_Management - Network_Optimization - | Service quality |
| Performance_Metrics - Service_Quality | indicator |
| Resource_Management - Network_Optimization - | Resource |
| Performance_Metrics - Resource_Utilization | utilization |
| Resource_Management - Network_Optimization - | Network |
| Performance_Metrics - Network_Efficiency | efficiency |
| Resource_Management - Network_Optimization - | Load distribution |
| Optimization_Policies - Load_Distribution | policy |
| Resource_Management - Network_Optimization - | Resource sharing |
| Optimization_Policies - Resource_Sharing | policy |
| Resource_Management - Network_Optimization - | QoS management |
| Optimization_Policies - QoS_Management | policies |

Natural_Disaster_Mode of Emergency_Operation may be configured as in Table 100 below:

TABLE 100
Natural_Disaster_Mode Configuration

| Item | Content |
|---|---|
| Satellite_Priority - | Resource priority |
| Resource_Allocation | allocation |
| Satellite_Priority - | Coverage expansion |
| Coverage_Extension | |
| Satellite_Priority - | Provision of |
| Emergency_Services | emergency services |
| Recovery_Procedures - | Service recovery |
| Service_Restoration | |
| Recovery_Procedures - | Network reconfiguring |
| Network_Reconfiguration | |
| Recovery_Procedures - | Resource reallocation |
| Resource_Reallocation | |

Network_Congestion_Mode of Emergency_Operation may be configured as in Table 101 below:

TABLE 101
Network Congestion Mode Configuration

| Item | Content |
|---|---|
| Traffic Management - Congestion_Control | Congestion control |
| Traffic_Management - Traffic_Rerouting | Traffic bypass |
| Traffic_Management - Resource_Optimization | Resource |
| | optimization |
| Service_Prioritization - Critical_Services | Critical services |
| | priority |
| Service_Prioritization - QoS_Adjustment | QoS Adjustment |
| Service_Prioritization - Resource_Reservation | Resource reservation |

Emergency_Operation Large_Event_Mode may be configured as shown in Table 102 below:

TABLE 102
Large Event Mode Configuration

| Item | Content |
|---|---|
| Joint_Operation - Resource_Pooling | Resource pooling |
| Joint_Operation - Capacity_Enhancement | Increased capacity |
| Joint_Operation - Service_Coordination | Service coordination |
| Dynamic_Optimization - Real_Time_Monitoring | Real-time monitoring |
| Dynamic_Optimization - Adaptive_Control | Adaptive control |
| Dynamic_Optimization - Performance_Optimization | Performance |
| | optimization |

The space area management system 1900 according to the embodiments of the disclosure may provide the following characteristic effects:

### 1) Efficient Resource Management Between Satellite Networks and Terrestrial Networks:

Application of integrated resource allocation policy
Dynamic load distribution mechanism
Optimized service quality assurance

### 2) Flexible Response to Various Operating Situations:

Optimized resource management for normal operation
Rapid service recovery in emergency situations
Efficient capacity management in case of large-scale events

### 3) Ensuring Continuity:

Seamless service switching between satellites
Integrated operation between satellite and terrestrial networks
Maintaining service quality through predictive resource allocation

### 4) Scalable System Structure:

Modularized components
Standardized interface
Support for flexible configuration changes

Each component of the space area management system 1500 according to the embodiments of the disclosure may be implemented in the following manner:

### Hardware Implementation:

Dedicated server system
Distributed processing system
Centralized database

### Software Implementation:

Microservice architecture
Container-based virtualization
Cloud native application

### Network Implementation:

SDN (Software Defined Networking)-based control
NFV (Network Function Virtualization)-based function implementation
API (Application Programming Interface)-based interworing

The data structure and system requirements of the space area management system 1500 according to the embodiments of the disclosure may be defined as follows:

TABLE 103
Data Storage And Management Structure

| Item | Management Method | Features |
|---|---|---|
| Space_Area_Data - NoSQL_Database | Key-Value format storage | Flexible schema |
| | | structure |
| Space_Area_Data - In_Memory_Database | Real-time data processing | High-speed data |
| | | access |
| Space_Area_Data - Time_Series_Database | Historical data management | Support for time series |
| | | analysis |
| Satellite_Status - Realtime_Data | 10 ms cycle update | Real-time status |
| | | monitoring |
| Satellite_Status - Statistics_Data | 1 minute cycle update | Statistical data |
| | | analysis |
| Satellite_Status - Historical_Data | 1 hour cycle update | Long-term trend |
| | | analysis |

TABLE 104
System Configuration Information Management

| Item | Content | Management Method |
|---|---|---|
| Configuration_Info - Version | Configuration version | Version management system |
| Configuration_Info - Last_Update | Last update time | Timestamp logging |
| Configuration_Info - Update_Author | Update entity | Tracking changed history |
| Configuration_Items - Item_ID | Item identifier | Unique identifier system |
| Configuration_Items - Category | Configuration item | Category-based management |
| | classification | |
| Configuration_Items - Value | Setting value | Managing parameter values |
| Configuration_Items - Valid_Period | Valid period | Validity management |

TABLE 105
Performance and Management Requirements

| Item | Requirements | Target value/Content | |
|---|---|---|---|
| Response_Time - Normal_Operation | Normal operation response | <100 | ms |
| | time | | |
| Response_Time - Emergency_Operation | Emergency operation | <50 | ms |
| | response time | | |
| Response_Time - Critical_Operation | Critical operation response | <10 | ms |
| | time | | |
| Throughput - Control_Plane | Control plane throughput | >100,000 messages/s | |
| Throughput - User_Plane | User control plane | >1 | Tbps |
| | throughput | | |
| Availability - System_Availability | System availability | >99.999% | |
| Availability - Service_Availability | Service availability | >99.99% | |
| Scalability - Max_Satellites | Maximum number of | 10,000 | |
| | satellites | | |
| Scalability - Max_Ground_Stations | Maximum number of | 1,000 | |
| | ground stations | | |

| | | |
|---|---|---|
| Scalability - Max_Users | Maximum number of users | 1,000,000 |

TABLE 106
System Management Functions

| Item | Management Area | Key Features |
|---|---|---|
| System_Management - Configuration | Configuration | Optimizing system |
| | management | configuration |
| System_Management - Performance | Performance | Performance |
| | management | monitoring/improving |
| System_Management - Fault | Fault management | Failure detection/recovery |
| System_Management - Security | Security management | Security policy operation |
| System_Management - Accounting | Billing management | Usage-based billing |
| Operation_Management - Service | Service management | Ensuring Quality of Service |
| Operation_Management - Resource | Resource | Resource optimization |
| | management | |
| Operation_Management - Network | Network management | Network operation |

maintenance

| | | |
|---|---|---|
| Maintenance_Management - Preventive | Preventive | Preemptive failure |
| | maintenance | prevention |
| Maintenance_Management - Corrective | Corrective | Failure recovery response |
| | maintenance | |
| Maintenance_Management - Adaptive | Adaptive maintenance | Response to |
| | | Environmental Change |

The system according to the embodiments of the disclosure may satisfy the following security requirements:

TABLE 107
Security Requirements

| Item | Implementation Method | Detailed Features |
|---|---|---|
| Access_Control - Authentication | Multi-factor authentication | Enhanced user authentication |
| Access_Control - Authorization | Role-based access control | Segmented authority |
| | | Management |
| Access_Control - Accounting | Access history logging | Complete audit tracking |
| Data_Security - Encryption | Data encryption | Protect transfer/storage data |
| Data_Security - Integrity | Integrity verification | Data tampering prevention |
| Data_Security - Privacy | Privacy protection | Information protection system |
| Network_Security - Firewall | Multi-layer firewall | Network security |
| Network_Security - IPS_IDS | Intrusion | Responding to security threats |
| | detection/prevention | |
| Network_Security - VPN | Virtual private network | Ensuring secure communication |

In the terms of the technical effects and implementation of the space area management system 1500, considerations for each of the system aspect, service aspect, and operation aspect may be defined as follows:

TABLE 108
System Main Effects

| Item | Effect | Detailed Content |
|---|---|---|
| System_Effects - | Optimizing system | Implementing efficient resource |
| Resource_Management | performance | management |
| System_Effects - System_Structure | Ensuring system flexibility | Scalable structural design |
| System_Effects - Interface | Ensuring interoperability | Provides standardized interface |
| Service_Effects - User_Experience | Improved user experience | Providing seamless service |
| Service_Effects - Service_Quality | Securing service reliability | Ensure differentiated quality |
| Service_Effects - Service_Diversity | Securing service diversity | Accepting various requirements |
| Operation_Effects - Management | Improve operational | Automated operations |
| | efficiency | management |
| Operation_Effects - Maintenance | Ensuring system reliability | Implementing predictive |
| | | maintenance |
| Operation_Effects - Consistency | Maintaining operational | Integrated management system |
| | consistency | |

The considerations for implementation according to the embodiments of the disclosure are as follows:

System Implementation Requirements

| Item | Requirements | Implementation Method |
|---|---|---|
| Hardware - Processing_Power | High performance server | Distributed processing |
| | cluster | architecture |
| Hardware - Storage_Capacity | Petabyte-level storage | Distributed storage systems |
| Hardware - Network_Capacity | Terabit-level network | High-speed network |
| | | infrastructure |
| Software - Operating_System | Real-time operating | Real-time processing support |
| | system | |
| Software - Database | Distributed database | Distributed data management |
| Software - Middleware | Message queuing | Asynchronous communication |
| | system | support |
| Integration - Protocol_Support | Standard protocol | Standards-based |
| | | communication |
| Integration - API_Support | Restful API | Web-based interface |
| Integration - Legacy_Support | Interworking an existing | Legacy system integration |
| | system | |

TABLE 110
Operation Optimization Plan

| Item | Optimization Plan | Implementation Content |
|---|---|---|
| Performance - Resource_Allocation | Dynamic resource allocation | Real-time resource allocation |
| Performance - Load_Balancing | Adaptive load balancing | Dynamic load adjustment |
| Performance - Cache_Management | Multilayer cache management | Hierarchical cache structure |
| Reliability - Redundancy | N+1 redundant configuration | Redundancy configuration |
| Reliability - Failover | Automatic fault recovery | Uninterrupted switching |
| Reliability - Backup | Real-time data backup | Continuous data protection |
| Cost - Resource_Sharing | Optimizing resource sharing | Efficient resource utilization |
| Cost - Energy_Efficiency | Energy efficiency optimization | Optimizing power consumption |
| Cost - Maintenance_Efficiency | Optimized maintenance efficiency | Reduce maintenance costs |

TABLE 111
Scalability Design Plan

| | | Implementation |
|---|---|---|
| Item | Design Plan | Method |
| Horizontal - Node_Addition | Add node | Horizontal scalability |
| Horizontal - Load_Distribution | Load distribution | Structural |
| | | distribution |
| | | processing |
| Horizontal - State_Management | Managing status information | Distributed state |
| | | management |
| Vertical - Resource_Upgrade | Resource upgrade | Vertical scalability |
| Vertical - Performance_Enhancement | Performance enhancing | Improved |
| | | performance |
| Vertical - Capacity_Increase | Increasing capacity | Extended capacity |
| Functional - Service_Addition | Adding service | Extended services |
| Functional - Feature_Enhancement | Enhanced feature | Extended feature |
| Functional - Interface_Extension | Extended interface | Extended API |

The embodiments of the disclosure may provide the following advantages:
1) Efficient integrated operation of satellite networks and terrestrial networks
2) Stable service provision through service continuity assurance
3) Optimization of resource utilization efficiency
4) Reduction of operating costs
5) Securing system scalability and flexibility
6) Providing standardized management system
7) Supporting automated operation management
8) Enabling predictive maintenance

Utilization scenarios of the space area management system 1500 may be defined as follows:

TABLE 113
Disaster response scenario

| Item | Content | Implementation Method |
|---|---|---|
| Initial_Response - Network_Reconfiguration - | Activating | Initiating priority-based services |
| Priority_Service | emergency services | |
| Initial_Response - Network_Reconfiguration - | Resource | Deployment of emergency |
| Resource | reallocation | resources |
| Initial_Response - Network_Reconfiguration - | Coverage expansion | Expanding service area |
| Coverage | | |
| Initial_Response - Communication_Support - | Emergency call | Emergency communication |
| Emergency_Call | processing | priority processing |
| Initial_Response - Communication_Support - | Priority data transfer | Important data priority transfer |
| Priority_Data | | |
| Initial_Response - Communication_Support - | Disaster broadcast | Emergency message |
| Broadcast | | propagation |
| Service_Continuity - Backup_Path | Activating backup | Securing backup paths |
| | path | |
| Service_Continuity - Load_Distribution | Load distribution | Network load balancing |
| Service_Continuity - QoS_Adjustment | QoS adjustment | QoS parameter adjustment |

TABLE 114
Large-scale Event Support Scenario

| Item | Content | Implementation Method |
|---|---|---|
| Capacity_Planning - Traffic_Forecast | Traffic prediction | Traffic pattern analysis |
| Capacity_Planning - Resource_Reservation | Resource reservation | Securing preemptive resources |
| Capacity_Planning - Service_Priority | Service Priority setup | Service rating management |
| Dynamic_Adjustment - Monitoring | Real-time monitoring | Real-time performance monitoring |
| Dynamic_Adjustment - | Resource optimization | Dynamic resource allocation |
| Resource_Optimization | | |
| Dynamic_Adjustment - Performance_Tuning | Performance | Optimizing performance parameters |
| | adjustment | |

TABLE 115
Network evolution scenario

| | | Implementation |
|---|---|---|
| Item | Content | Method |
| Network_Evolution - Technology_Integration | Integration of new | Introduction of latest |
| | technologies | technology |
| Network_Evolution - System_Migration | Switching to existing | Stepwise system |
| | system | switching |
| Network_Evolution - Service_Enhancement | Service improvement | Service advancement |
| Capacity_Evolution - Coverage | Coverage expansion | Expanding service area |
| Capacity_Evolution - Throughput | Improved throughput | Improved performance |
| Capacity_Evolution - Feature | Add features | Implementation of new |
| | | features |

These utilization scenarios may be effectively implemented with the gateway interface 1520 and the service quality manager 1530 of the space area management system 1500, and optimal response for each scenario is possible through systematic data management of the database 1540.

Embodiments of the disclosure may include the following additional technical features:

AI/ML-based optimization may be configured as shown in the following Table 116:

TABLE 116
AI/ML-based Optimization Configuration

| Item | Content |
|---|---|
| Predictive_Analytics - Traffic_Prediction | Traffic prediction |
| Predictive_Analytics - Failure_Prediction | Failure prediction |
| Predictive_Analytics - Resource_Optimization | Resource optimization |
| Autonomous_Operation - Self_Configuration | Automatic configuration |
| Autonomous_Operation - Self_Healing | Automatic recovery |
| Autonomous_Operation - Self_Optimization | Automatic optimization |

The security implementation according to embodiments of the disclosure may include the following details:

The network security implementation may be configured as shown in the following Table 117:

TABLE 117
Network Security Implementation

| Item | Content |
|---|---|
| Layer_Security - Physical_Layer - Signal_Protection | Signal protection |
| Layer_Security - Physical_Layer - Jamming_Prevention | Jamming |
| | prevention |
| Layer_Security - Physical_Layer - Interference_Mitigation | Interference |
| | mitigation |
| Layer_Security - Network_Layer - Access_Control | Access control |
| Layer_Security - Network_Layer - Traffic_Filtering | Filtering traffic |
| Layer_Security - Network_Layer - Route_Protection | Path protection |
| Layer_Security - Application_Layer - Data_Encryption | Data encryption |
| Layer_Security - Application_Layer - Session_Protection | Session protection |
| Layer_Security - Application_Layer - | Certification of |
| Service_Authentication | service |

The data security implementation may be configured as shown in the following Table 118:

TABLE 118
Data Security Implementation

| Item | Content |
|---|---|
| Data_Protection - Storage_Security - Encryption_At_Rest | Encryption of stored data |
| Data_Protection - Storage_Security - Access_Control | Access control |
| Data_Protection - Storage_Security - Backup_Protection | Protect backup data |
| Data_Protection - Transmission_Security - Encryption_In_Transit | Transmission data |
| | encryption |
| Data_Protection - Transmission_Security - Secure_Protocol | Security protocol |
| Data_Protection - Transmission_Security - Channel_Protection | Channel protection |
| Key_Management - Key_Generation | Key generation |
| Key_Management - Key_Distribution | Key distribution |
| Key_Management - Key_Rotation | Key replacement |

Systems according to embodiments of the disclosure may provide the following standardized interfaces:

External system interworking interface may be configured as shown in the following Table 119:

TABLE 119
External System Interworking Interface

| Item | Content |
|---|---|
| API_Interface - REST_API | RESTful web service |
| API_Interface - SOAP_API | SOAP based web service |
| API_Interface - Streaming_API | Streaming data interface |
| Protocol_Interface - Standard_Protocols | Standard protocol |
| Protocol_Interface - Custom_Protocols | Customer-defined protocol |
| Protocol_Interface - Legacy_Protocols | Legacy system protocol |

The service management according to embodiments of the disclosure may include the following implementation:

Service life cycle management may be configured as shown in the following Table 120:

TABLE 120
Service Life Cycle Management

| Item | Content |
|---|---|
| Service_Lifecycle - Service_Planning - Requirement_Analysis | Requirements |
| | analysis |
| Service_Lifecycle - Service_Planning - Resource_Planning | Resource planning |
| Service_Lifecycle - Service_Planning - Capacity_Planning | Capacity planning |
| Service_Lifecycle - Service_Development - Service_Design | Service design |
| Service_Lifecycle - Service_Development - Service_Implementation | Service |
| | implementation |
| Service_Lifecycle - Service_Development - Service_Testing | Service test |
| Service_Lifecycle - Service_Operation - Service_Activation | Service activation |
| Service_Lifecycle - Service_Operation - Service_Monitoring | Service monitoring |
| Service_Lifecycle - Service_Operation - Service_Maintenance | Service maintenance |
| Service_Lifecycle - Service_Termination - Resource_Recovery | Resource recovery |
| Service_Lifecycle - Service_Termination - Data_Cleanup | Data organization |
| Service_Lifecycle - Service_Termination - Service_Deactivation | Disabling service |

The service quality management may be configured as shown in the following Table 121:

TABLE 121
Service Quality Management

| Item | Content |
|---|---|
| QoS_Management - Performance_Metrics - Response_Time | Response time |
| QoS_Management - Performance_Metrics - Throughput | Throughput |
| QoS_Management - Performance_Metrics - Availability | Availability |
| QoS_Management - Performance_Metrics - Reliability | Reliability |
| QoS_Management - Service_Level_Agreements - SLA_Definition | SLA definition |
| QoS_Management - Service_Level_Agreements - SLA_Monitoring | SLA monotoring |
| QoS_Management - Service_Level_Agreements - SLA_Reporting | SLA reporting |
| QoS_Management - Quality_Parameters - Network_Quality | Network quality |
| QoS_Management - Quality_Parameters - Service_Quality | Service quality |
| QoS_Management - Quality_Parameters - User_Experience | User experience |

The operation management according to embodiments of the disclosure may include the following features:

The automated operation management may be configured as shown in the following Table 122:

TABLE 122
Automated Operation Management

| Item | Content |
|---|---|
| Automation_features - configuration_automation - auto_discovery | Automatic discovery |
| Automation_features - configuration_automation - auto_configuration | Automatic configuration |
| Automation_features - configuration_automation - auto_verification | Automatic verification |
| Automation_features - operation_automation - monitoring_automation | Automate monitoring |
| Automation_features - operation_automation - problem_resolution | Automate problem |
| | resolution |
| Automation_features - operation_automation - performance_optimization | Automate performance |
| | optimization |
| Automation_features - maintenance_automation - update_automation | Automate update |
| Automation_features - maintenance_automation - backup_automation | Automate backup |
| Automation_features - maintenance_automation - recovery_automation | Automate recovery |

Embodiments of the disclosure may include the implementation considering future scalability as follows:

Next generation technology integration may be configured as shown in the following Table 123:

TABLE 123
Next-Generation Technology Integration

| Item | Content |
|---|---|
| Future_Technologies - 6G_Integration - Ultra_High_Speed | High-speed |
| | communication |
| Future_Technologies - 6G_Integration - Ultra_Low_Latency | Ultra-low latency |
| Future_Technologies - 6G_Integration - Massive_Connectivity | Large-scale |
| | connections |
| Future_Technologies - Advanced_AI - Cognitive_Network | Cognitive network |
| Future_Technologies - Advanced_AI - Autonomous_Operation | Autonomous operation |
| Future_Technologies - Advanced_AI - Intelligent_Decision | Intelligent decision- |
| | making |
| Future_Technologies - Quantum_Communications - | Quantum key |
| Quantum_Key_Distribution | distribution |
| Future_Technologies - Quantum_Communications - Quantum_Security | Quantum security |
| Future_Technologies - Quantum_Communications - Quantum_Networking | Quantum networking |

All the specific numbers and parameters presented in the embodiments of the disclosure are of examples, and different values may be used depending on system requirements and operating environments upon actual implementation.

Further, the embodiments of the disclosure may be implemented by selectively combining some or all of the components described above, and each component may be modified, added, or deleted depending on the system requirements.

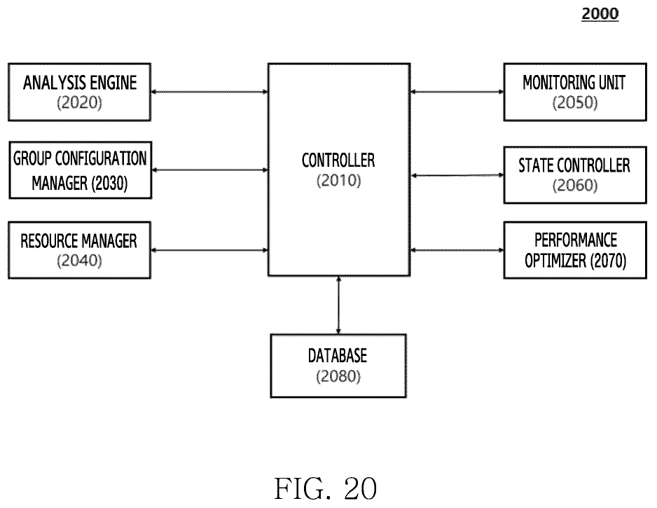

FIG. 20 illustrates a block diagram of a satellite group management unit 2000 according to an embodiment of the disclosure.

Referring to FIG. 20, the satellite group management unit 2000 includes an analysis engine 2020, a group configuration manager 2030, a resource manager 2040, a monitoring unit 2050, a state controller 2060, a performance optimizer 2070, and a database 2080 centered around a central controller 2010.

The controller 2010 is a central control unit of the satellite group management unit 2000 to control communication and data flow between sub-blocks. The controller 2010 is configured to manage task scheduling and priorities, monitor system status, and transmit control commands. Further, the controller 2010 coordinates response procedures in the event of an emergency.

The analysis engine 2020 calculates real-time location based on satellite orbital elements and analyzes relative distances and visibility between satellites. Further, the analysis engine 2020 analyzes resource status and performance of each satellite, analyzes service area coverage, and analyzes optimal combinations for satellite grouping.

The group configuration manager 2030 configures and manages primary/backup groups, and establishes and applies a group membership policy. Further, the group configuration manager 2030 optimizes ISL configurations between satellites, manages group switching scenarios, and manages group configuration history.

The resource manager 2040 allocates and adjusts communication resources for each satellite, and manages processing capacity for each group. Further, the resource manager 2040 optimizes power resources, reserves resources for guaranteeing QoS, and performs dynamic resource redistribution.

The monitoring unit 2050 monitors satellite status in real time and measures service quality indicators. Further, the monitoring unit 2050 monitors resource utilization rate, collects performance indicators, and detects abnormal symptoms.

The state controller 2060 controls satellite and group status and manages operation mode switching. Further, the state controller 2060 responds to failure situations, adjusts performance parameters, and performs system recovery procedures.

The performance optimizer 2070 establishes a system performance optimization policy and optimizes resource utilization rate. Further, the performance optimizer 2070 improves service quality, enhances operational efficiency, and performs predictive performance management.

The database 2080 stores system configuration information and manages operational status data. Further, the database 2080 stores performance data, manages history information, and generates statistical data.

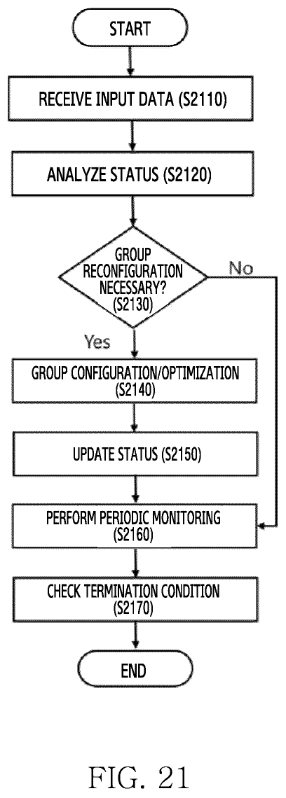

FIG. 21 is an operation flowchart of a satellite group management unit 2000 according to an embodiment of the disclosure.

Referring to FIG. 21, the satellite group management unit 2000 performs the following step-by-step operations.

In an input data reception step 2110, the satellite group management unit 2000 receives satellite status information, service area information, and service requirement data through the controller 2010.

In a status analysis step S2120, the satellite group management unit 2000 performs a satellite status comprehensive analysis, a group configuration appropriateness evaluation, and a resource status analysis through the analysis engine 2020.

In a group reconfiguration necessity judgment step S2130, the satellite group management unit 2000 evaluates necessity of reconfiguration based on determination criteria of the controller 2010 and determines a processing path according to an analysis result.

In a group configuration/optimization step S2140, the satellite group management unit 2000 configures a new group through the group configuration manager 2030 and performs resource reallocation and ISL configuration optimization of the resource manager 2040.

In a status update step S2150, the satellite group management unit 2000 updates the information of the database 2080, propagates the updated information to each component, and generates a status report.

In a periodic monitoring performance step S2160, the satellite group management unit 2000 performs continuous status monitoring, real-time monitoring of performance indicators, and abnormal status detection through the monitoring unit 2050.

In a termination condition check step S2170, the satellite group management unit 2000 checks a termination condition of the controller 2010, performs a final check of a system status, and performs a restart procedure if necessary.

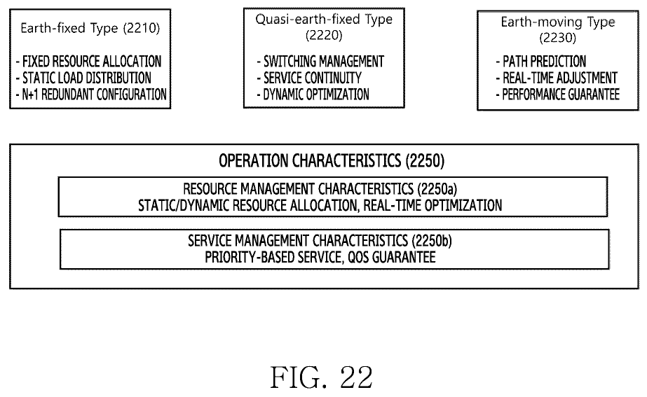

FIG. 22 is a diagram illustrating satellite switching operation characteristics according to an embodiment of the disclosure.

Referring to FIG. 22, the satellite switching operation characteristics are largely divided into an earth-fixed type 2210, a quasi-earth-fixed type 2220, and an earth-moving type 2230, and the operation characteristics 2300 are determined according to the characteristics of each type.

The earth-fixed type 2210 is for providing services for a fixed geographical location, and features fixed resource allocation, static load distribution, and N+1 redundant configuration. Here, the N+1 redundant configuration includes N primary service satellites and 1 backup satellite to ensure provision of stable service.

The quasi-earth-fixed type 2220 is for a semi-fixed service area, and features switching management, service continuity, and dynamic optimization. This is to provide uninterrupted service even in situations where switching between satellites is required.

The earth-moving type 2230 is for a service area that changes according to the movement of the satellites, and features path prediction, real-time adjustment, and performance guarantee. This is to respond to changes in the service area according to the orbital movement of the satellites.

The operation characteristics 2250 are divided into resource management characteristics 2250a and service management characteristics 2250b. The resource management characteristics 2250a include static or dynamic resource allocation and real-time optimization for each type, wherein the static allocation is mainly applied to the earth-fixed type 2210, and the dynamic allocation is mainly applied to the quasi-earth-fixed type 2220 and the earth-moving type 2230.

The service management characteristics 2250b include priority-based service provision and QoS guarantee. The earth-fixed type 2210 focuses on the stable QoS guarantee, the quasi-earth-fixed type 2220 focuses on QoS maintenance upon switching, and the earth-moving type 2230 focuses on the QoS guarantee during movement.

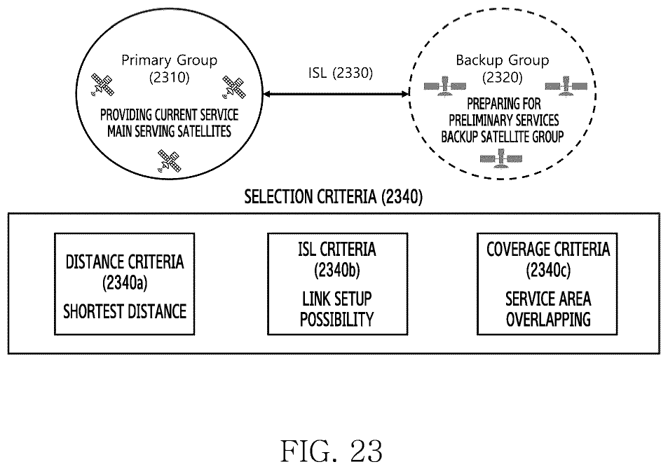

FIG. 23 is a diagram illustrating a satellite grouping structure according to an embodiment of the disclosure.

Referring to FIG. 23, the satellite grouping structure includes a primary group 2310, a backup group 2320, an ISL 2330 connecting them, and selection criteria 2340.

The primary group 2310 is a group of main serving satellites that actually provide current services and is responsible for providing real-time services within the space area. The satellites belonging to the primary group 2310 provide direct coverage of the service area and have sufficient resources to ensure the required service quality.

The backup group 2320 includes a group of backup satellites preparing for preliminary services, waiting to replace the primary group 2310 immediately in the event of a satellite failure or a deterioration in service quality. The satellites of backup group 2320 are always in a state where they can provide the service and are prepared to enable rapid switching when necessary.

The ISL 2330 indicates an inter-satellite communication link between the primary group 2310 and the backup group 2320, through which real-time status information is exchanged between the two groups and data is transmitted for the service switching. The ISL 2330 ensures smooth communication and uninterrupted service switching between these groups.

The selection criteria 2340 provides criteria for classifying satellites into the primary group 2310 and the backup group 2320, and includes distance criteria 2340a, ISL criteria 2340b, and coverage criteria 2340c.

The distance criteria 2440a selects satellites by considering the shortest distance from the center point of the space area. Satellites closest to the service area are preferentially assigned to the primary group 2310, which is to keep signal quality and minimize service latency.

The ISL criteria 2340b is a criterion for evaluating the possibility of establishing a link between satellites, and determines whether stable communication is possible between the primary group 2310 and the backup group 2320. This is an essential element for smooth service switching and cooperation between groups.

The coverage criteria 2340c is a criterion for evaluating the degree of overlapping for the service area, and determines whether the primary group 2310 and the backup group 2320 can provide appropriate coverage for the same service area. This is an important factor for ensuring service continuity and stability.

Through such a satellite grouping structure, stable service provision and efficient satellite resource management become possible, and rapid service recovery may be guaranteed even in a failure situation.

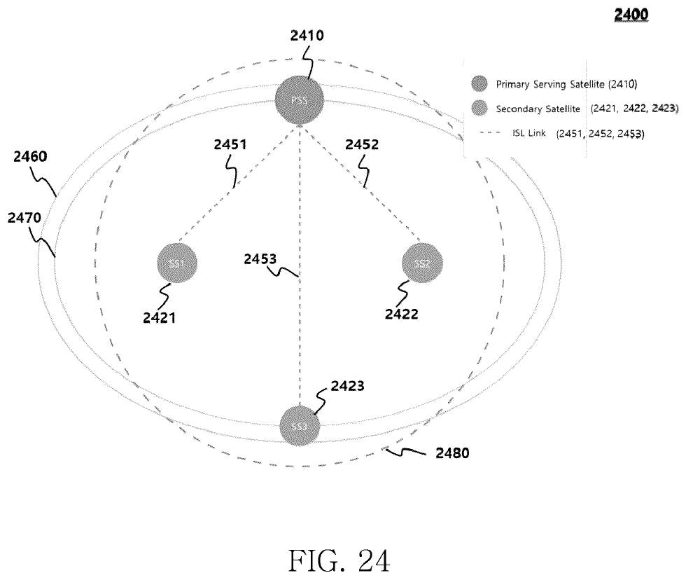

FIG. 24 is a diagram illustrating a configuration of a space area-based edge computing layer 2400 according to an embodiment of the disclosure.

In the embodiments of the disclosure, satellites in the edge computing layer 2400 may be defined as follows:

A primary serving satellite (PSS) 2410: This refers to a satellite that is the center of the edge computing layer, which performs the core control function of the edge computing layer and oversees the service operation within the space area.

Secondary satellites (SS) 2421, 2422 and 2423: These refer to satellites that assist the primary service satellite 2410 to provide expansion of service areas, load distribution, and service continuity. They are classified as follows, based on their location and roles:
SS1 2421/SS2 2422: Secondary service satellites located on the left and right sides of the primary service satellite and responsible for expansion and continuity of service areas; and
SS3 2423: Secondary service satellite located diagonally from the primary service satellite and responsible for load distribution and service backup.

Referring to FIG. 24, the space area-based edge computing layer 2400 is configured around the primary service satellite (PSS, 2410). The primary service satellite 2410 performs a central control function of the edge computing layer 2400 and oversees edge computing resource management and service quality control. The first auxiliary service satellite (SS1, 2421) and the second auxiliary service satellite (SS2, 2422) are located on the left and right sides of the PSS 2410 to ensure expansion and continuity of the service area. Further, the third auxiliary service satellite (SS3, 2423) is located diagonally to handle load distribution and service backup. Inter-satellite links (ISLs) 2451, 2452 and 2453 are established between those satellites to exchange real-time data and control information, and the status of each ISL is continuously monitored and optimized by the space area management system.

The edge computing layer 2400 utilizes a satellite numbering system for unique identification of each satellite. The primary service satellite 2410 has a fixed identifier, and the auxiliary service satellites 2421, 2422 and 2423 are sequentially assigned numbers according to their respective locations and roles.

The ISL (Inter-Satellite Link) is classified as 2451, 2452, and 2453, and each link ensures stable communication between the PSS 2410 and the auxiliary satellites. In particular, these ISLs are indicated by dotted lines, which means flexible communication paths that may be dynamically configured.

The operating area of the edge computing layer 2400 is distinguished by boundary identifiers such as 2460, 2470, and 2480. These boundaries define the physical limits of the service area and are utilized as criteria for efficient resource management and service provision within the space area.

A notable point in this configuration is the geometric deployment structure formed by each satellite. The SS1 2421 and the SS2 2422 are symmetrically located around the PSS 2410 to provide balanced service coverage, and the SS3 2423 is located in a position that complements this symmetrical structure to enhance the overall system stability.

For efficient operation of the edge computing layer based on the space area, each satellite has its own status monitoring function 2451, 2452, and 2453, through which it reports the system status to the PSS 2410 in real time. This monitoring data is used as basic data for optimized operation of the entire system and rapid problem solving.

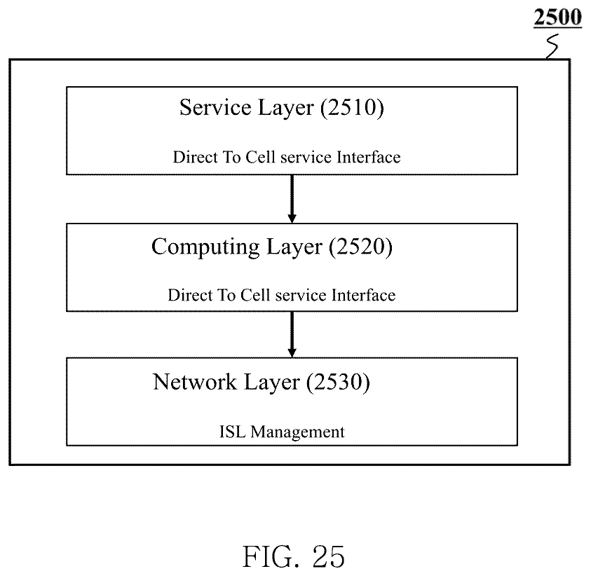

FIG. 25 is a diagram illustrating a hierarchical structure of the edge computing layer 2500 according to an embodiment of the disclosure.

Referring to FIG. 25, the hierarchical structure 2500 of the edge computing layer includes a service layer 2510, a computing layer 2520, and a network layer 2530.

The service layer 2510 is responsible for interface and QoS management for providing direct-to-cell service, and performs the following core functions:
Service coordination and priority management between PSS 2410 and 3 SSs 2421, 2422, and 2423
Service quality monitoring and control
Handover management for service continuity
Real-time traffic analysis and optimization

The computing layer 2520 performs distributed processing and data management centered on the PSS 2410, and is responsible for the following functions:
Distributed processing coordination between PSS 2410 and three SSs 2421, 422, and 2423
Real-time data processing and caching
Service area expansion management through SS1 2421)/SS2 2422
Load distribution and backup management through SS3 2423

The network layer 2530 is responsible for inter-satellite communication and network optimization, and provides the following functions:
ISL connection management between PSS 2410-SS1 2421, PSS 2410-SS2 2422, PSS 2410-SS3 2423
Mesh type network topology configuration between SS1 2421-SS2 2422-SS3 2423
Optimal routing path setting
ISL performance monitoring and quality assurance

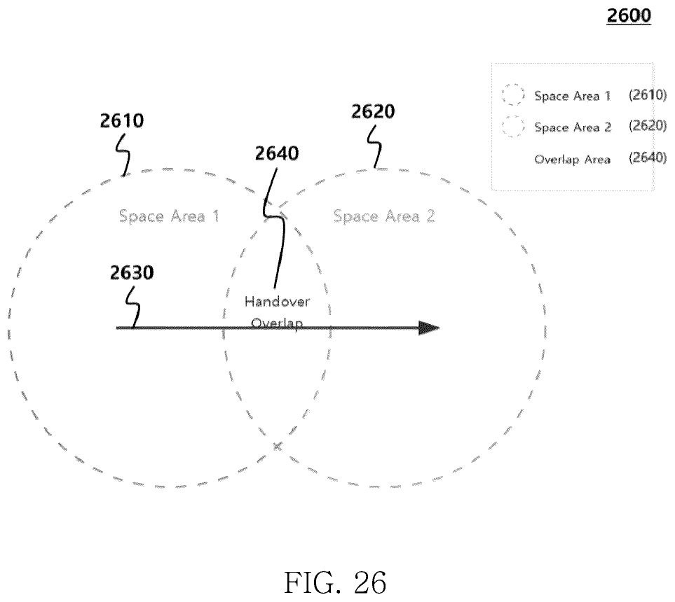

FIG. 26 is a diagram illustrating an edge computing layer switching process between space areas according to an embodiment of the disclosure.

Referring to FIG. 26, an edge computing layer switching process 2600 between the space areas is illustrated. The switching from the edge computing layer 2610 of the first space area to the edge computing layer 2620 of the second space area is performed in the following step-by-step procedure.

In a switching preparation step, the switching conditions between PSSs are monitored, the overlapping rate of service areas is calculated through SS1 and SS2, and a backup path is prepared through SS3.

In a switching execution step, data is transferred 2630 between the PSSs in a Make-Before-Break manner, services are gradually switched through the SS1 and the SS2, and traffic load is distributed through the SS3.

In an overlap area management step, a temporary overlap area 2640 is formed between the PSSs, bidirectional services are provided through the SS1 and the SS2, and service stability is guaranteed through the SS3.

In a switching completion step, services are stabilized around the new PSS, resources of the previous PSS are recovered, and configuration of a fresh edge computing layer is completed.

Through the aforementioned process, stable switching of the edge computing layer between the space areas is possible.

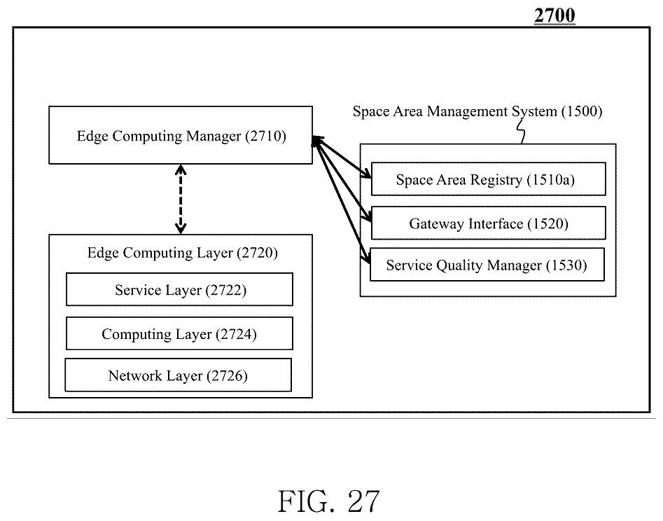

FIG. 27 is a diagram illustrating an integrated structure of a space area management system 1500 and an edge computing layer 2720 according to an embodiment of the disclosure.

Referring to FIG. 27, an edge computing manager 2710 is linked with components of the space area management system 1500 and manages the edge computing layer centered on the PSS in an integrated manner. The edge computing manager 2710 manages the configuration information of the PSS 2410 and the SSs 2421, 2422, and 2423 in association with the space area registry 1510a, controls network connection between satellites through the gateway interface 1520, and guarantees the service quality in cooperation with the service quality manager 1530.

Each layer of the edge computing layer 2720 is associated with components of the space area management system 1500 as follows. A service layer 2722 is linked to the service quality manager 1530 to manage the integrated QoS of satellites, a computing layer 2724 is linked to the space area registry 1510a to perform distributed processing centered on the PSS, and a network layer 2726 is linked to the gateway interface 1520 to configure and manage an ISL mesh network.

The operating scenario of the edge computing layer is as follows. In a emergency response scenario, when a hardware error occurs in the PSS, the monitoring unit detects abnormality within 1 second, the SS3 switches to backup mode within 3 seconds, the SS1 and the SS2 expand the service area within 5 seconds, and new PSS selection and switching are completed within 30 seconds. In a traffic surge response scenario, when the traffic within the service area increases by 200%, this is detected through 10-second periodic monitoring, the resources of the computing layer are reallocated within 30 seconds, the load is distributed to the SS1 and the SS2 within 60 seconds, and cooperative processing is performed with an adjacent space area as required.

The edge computing manager 2710 is a component that manages the edge computing layer 2720 based on the space area, and is in charge of the execution layer that provides and operates actual services within the satellite group. The edge computing manager 2710 configures the edge computing layer 2720 based on five satellites, including two auxiliary service satellites on the same orbital plane and two auxiliary service satellites on an adjacent orbital plane, centered on the primary serving satellite. An ISL (Inter-Satellite Link) is established between the satellites to exchange real-time data and control information.

The edge computing layer 2720 includes three layers: a service layer 2722, a computing layer 2724, and a network layer 2726. The service layer 2722 is responsible for interface and QoS management for providing Direct-To-Cell service, and guarantees service quality in conjunction with the service quality manager 1530. The computing layer 2724 performs distributed processing and data management, and efficiently manages resources within the satellite groups in conjunction with the space area registry 1510a. The network layer 2726 is responsible for inter-satellite communication and network optimization, and manages communication infrastructure in conjunction with the gateway interface (1520).

When switching between the edge computing layers 2720, user connection information is transmitted in a Make-Before-Break manner, and during the switching process, the two edge computing layers 2720 temporarily form an overlapping area to provide uninterrupted service. This ensures service continuity in association with the serving satellite switching controller 1510d. Owing to this edge computing layer management method, stable service provision, efficient resource management, and flexible scalability may be achieved.

Edge_Computing_Layer_Table may be configured as shown in Table 124 below:

TABLE 124
Edge_Computing_Layer_Table Configuration

| Item | Content |
|---|---|
| Layer_ID | Edge Computing Layer Identifier |
| Primary_Satellite | Primary Service Satellite ID |
| Secondary_Satellites | Secondary Service Satellite ID List |
| Service_Status | Service Status (Active/Standby) |
| Layer_Type | Layer Type (Service/Computing/Network) |
| Created_Time | Created Time |
| Valid_Duration | Valid Duration |
| Resource_Status | Resource Status Information |
| Performance_Metrics | Performance Indicator |

Then, the satellite grouping algorithm and operation mechanism will be explained, hereinafter.

The main configuration and operation of the satellite group manager 1510b and 2000 may be defined as follows:

The basic input/output structure of the satellite group manager is as shown in Table 125 below:

TABLE 125
Satellite Group Manager Input/Output Structure

| Category | Item | Content |
|---|---|---|
| Input | Satellite_List | Full list of satellites to be managed |
| | Space_Area_Info | Space area information to provide service |
| | Service_Requirements | Service requirements and quality standards |
| Output | Primary_Group | List of satellites selected as primary service groups |
| | Backup_Group | List of satellites selected as backup service groups |
| | Group_Status | Current status information for each group |

The satellite grouping criteria are defined as follows for the primary service group and the backup group. For the selection criteria for the primary service group, applied are a distance-based criterion of being located within 500 km from the center of the space area, a coverage-based criterion of covering more than 90% of the service area with a signal strength of −95 dBm or higher, and a resource-based criterion of having 70% or more of the total processing capacity.

The selection criteria for the backup group include an orbital position criterion capable of entering the service area within 30 minutes, an ISL connectivity criterion capable of directly connecting to the primary group, and a resource availability criterion of having more than 50% of available resources. The satellite group configuration procedure is conducted in three steps as shown in Table 126 below.

TABLE 126
Satellite Group Configuration Procedure

| | | Processing |
|---|---|---|
| Phase | Detailed Phase | Time |
| Phase 1 | Orbital element-based positional calculation | 100 ms |
| (Analysis) | Service area mapping | 200 ms |
| | Evaluation of available resources | 100 ms |
| Phase 2 | Configuring primary service groups | 300 ms |
| (Selection) | Configuring backup groups | 300 ms |
| | Configuring ISL between groups | 200 ms |
| Phase 3 | Coverage verification | 200 ms |
| (Validation) | Resource verification | 200 ms |
| | Validation stability check | 100 ms |

Real-time monitoring and update for dynamic group management are performed as shown in Table 127 below.

TABLE 127
Dynamic Group Management System

| Category | Item | Reference Valie/Period | |
|---|---|---|---|
| Monitoring | Coverage status | 1 | second |
| | Resource status | 1 | second |
| | ISL status | 500 | ms |

| | | |
|---|---|---|
| Update | Coverage Change | 10% or more |
| Triggering | Resource depletion | Over 80% |
| | ISL quality deterioration | −3 dB or more |
| Group | Adjust primary groups | Immediately in the event of |
| Updating | | condition |
| | Adjust backup groups | Immediately in the event of |
| | | condition |
| | ISL reconfiguration | As soon as necessary |

The group-to-group switching management is divided into general switching and emergency switching, and the respective processing procedure is as shown in Table 128 below.

TABLE 128
Group-To-Group Switching Management Procedure

| Switching Type | Processing Phase | time required | |
|---|---|---|---|
| General switching | Ready | 120 | seconds |
| General switching | Execution | 10 | seconds |
| General switching | Verification | 5 | seconds |
| Emergency switching | Detection | 1 | second |
| Emergency switching | Execution | 3 | seconds |
| Emergency switching | Recovery | 5 | seconds |

Performance management is performed in three aspects: coverage, resources, and reliability, and the respective performance indices and target values are as shown in Table 129 below.

TABLE 129
Performance Management Indices and Target Values

| Performance | | |
|---|---|---|
| Classification | Item | Target value |
| Coverage | Area coverage | 95% or more |
| | Signal strength | −95 dBm or more |
| | Overlap ratio | 20% or more |
| Resource | Processing load | 70% or less |
| | Storage usage | 80% or less |
| | Link utilization | 85% or less |
| Reliability | Group availability | 99.999% |
| | Switching success rate | 99.9% |
| | Recovery time | Within 5 seconds |

The satellite grouping method according to the embodiments of the disclosure may provide the following multiple advantages.

First, the disclosure provides an advantage in terms of stable service provision. Service continuity is guaranteed through a backup group that is always on standby, and efficient service provision is possible by managing the resources by group unit. Further, the service quality may be stably maintained through predictive switching management.

Second, the disclosure enables efficient resource management. Allocating and optimizing the resources by group unit allow for improved efficiency of resource utilization, and maximized resource utilization through dynamic load distribution. Further, data may be efficiently transmitted based on ISL (Inter-Satellite Link).

Third, the disclosure provides flexible scalability. The groups may be dynamically reconfigured even when satellites are added or removed, and the size of the grouping may be appropriately adjusted according to changes in service demands. Further, it is possible to operate satellites in various orbits in an integrated manner.

Real-time control for satellite group management may be implemented as shown in Table 130 below:

TABLE 130
Real-time Control Implementation

| Item | Content | Cycle | |
|---|---|---|---|
| Real_Time_Control - Position_Tracking | Satellite location tracking | 100 | ms |
| Real_Time_Control - Resource_Monitoring | Monitoring resource status | 100 | ms |
| Real_Time_Control - Quality_Assessment | Quality of Service assessment | 100 | ms |
| Predictive_Control - Path_Prediction | Path prediction | 1 | second |
| Predictive_Control - Load_Prediction | Load prediction | 1 | second |
| Predictive_Control - Quality_Prediction | Quality prediction | 1 | second |
| Adaptive_Control - Group_Optimization | Group optimization | 10 | seconds |
| Adaptive_Control - Resource_Balancing | Resource balancing | 10 | seconds |
| Adaptive_Control - Performance_Tuning | Performance adjustment | 10 | seconds |

With this satellite grouping mechanism, efficient and stable satellite network operation is possible, and service quality assurance and resource utilization efficiency may be achieved.

The real-time control may be implemented by dividing into real-time control, predictive control, and adaptive control depending on the cycle, and the contents of each control are as follows. The real-time control performs satellite position tracking, resource status monitoring, and service quality evaluation in 100 ms cycles. The predictive control performs path prediction, load prediction, and quality prediction in 1 second cycles, and the adaptive control performs group optimization, resource balancing, and performance adjustment in 10 second cycles.

The entire operation cycle is basically set to 800 ms, and in case of an emergency, it is shortened to and operated within 200 ms. Each module is implemented to have an independent processing thread, and these are configured to enable parallel processing under the coordination of the main controller 2010.

The structure and operational flow of the satellite group management unit 1510b and 2000) according to the embodiment of the disclosure provide the following advantages as shown in Table 131.

TABLE 131
Main advantages of satellite group management unit

| Item | Details |
|---|---|
| Structural | Modular structure enables flexible expansion, independent operation of |
| Advantage | each module ensures system stability, and facilitates addition and change |
| | of new features |
| Processing | Implement process flows optimized for real-time processing, ensure |
| Efficiency | emergency-ready processing time, and improve system performance |
| | through parallel processing |
| Operational | Ensure systematic group management structure, implement clear state |
| Stability | transition and recovery procedures, and ensure stable service continuity |
| Resource | Implementation of integrated resource management system, monitoring |
| Efficiency | and optimizing status of real-time resources, and enabling efficient |
| | resource allocation and rebalancing |

With these advantages, the disclosure may greatly improve the stability and efficiency of satellite communication services.

The main interface specifications of the space area management system 1500 are divided into a management control layer interface, a gateway layer interface, and a satellite layer interface. The management control layer interface uses a RESTful API protocol and has a 100 ms communication cycle in JSON/Protocol Buffers data format. The gateway layer interface uses a gRPC protocol and supports a maximum delay time of 50 ms and a QoS of 4-step priorities. The satellite layer interface uses a custom binary protocol and applies a bandwidth of up to 100 Mbps and FEC error correction.

In describing the embodiments of the disclosure, the terms and messages defined in 3GPP are used to describe messages between a satellite (e.g., satellite 620) and a terminal (e.g., UE 610), but the embodiments of the disclosure are not limited thereto. It goes without saying that the terms and messages having technical meanings equivalent to the terms and messages described above may be used in substitution. Further, as a satellite, not only gNB, gNB-CU, gNB-DU, but also gNB-CU-CP (control plane) (e.g., the C-plane in FIG. 3A) and gNB-CU-UP (user plane) (e.g., the U-plane in FIG. 3B) may be utilized. Further, not only a satellite is utilized as a base station (e.g. gNB) or a part of a base station (e.g. DU), but also a core network entity (e.g. AMF 235) connected to the base station may be implemented as a satellite. For example, communication between a satellite operating as an AMF 235 and the satellite 620 may be defined. For example, logical nodes including the AMF 235 and the gNB 120 may be implemented in one satellite. With the network virtualization, it may be implemented in a software manner, and thus separate logical nodes may be disposed in a satellite of one hardware.

In embodiments, provided is a device of a first satellite for providing non-terrestrial network (NTN) access. The device may include memory including instructions, at least one processor, and at least one transceiver. The instructions may, when executed by the at least one processor, cause the device to perform a communication between a first terminal and a second terminal via the first satellite by transmitting data received from the first terminal to the second terminal or transmitting data received from the second terminal to the first terminal, identify, within a satellite group associated with the first satellite, a second satellite different from the first satellite, and transmit a configuration message including configuration information related to the communication to the second satellite through the at least one transceiver.

For example, the satellite group may include satellites that have a same space area in a designated time interval, and the space area may indicate, among division areas of a sphere surrounding a planet at an altitude of an orbit of a satellite, an area in which the satellite is located.

For example, the satellite group may include satellites configured to move along an orbit same as the first satellite's orbit, and the satellites may include the first satellite and the second satellite.

For example, cells provided by the satellites in the satellite group are associated with a same tracking area (TA), and the satellites may include the first satellite and the second satellite.

For example, the configuration information related to the communication may include at least one of session information for the communication between the first terminal and the second terminal, identification information of the first terminal, identification information of the second terminal, or cell information.

For example, the instructions may, when executed by the at least one processor, cause the device to receive a request message from an access and mobility management function (AMF) node via an NG interface, and transmit a response message to the AMF node via the NG interface. The request message may include at least one of information on the satellite group to which the first satellite belongs, information on a validity period of the satellite group, identification information of a service area associated with the satellite group, or ephemeris information of a satellite in the satellite group.

For example, the instructions may, when executed by the at least one processor, cause the device to receive a request message from a gNB-CU via an F1 interface, and transmit a response message to the gNB-CU via the F1 interface. The request message may include at least one of information on the satellite group to which the first satellite belongs, information on a validity period of the satellite group, identification information of a service area associated with the satellite group, or ephemeris information of a satellite in the satellite group.

For example, the instructions may, when executed by the at least one processor, cause the device to receive a request message via an XN interface from a master satellite of the satellite group. The request message may include at least one of information on the satellite group to which the first satellite belongs, information on a validity period of the satellite group, identification information of a service area associated with the satellite group, or ephemeris information of a satellite in the satellite group.

For example, the satellite group may include satellites configured to move along an orbit same as the first satellite's orbit. The configuration message may include a list of the satellites and information on a moving speed of each satellite.

For example, the first satellite may include a low earth orbit (LEO) satellite or a medium earth orbit (MEO) satellite, and the second satellite may include a geostationary earth orbit (GEO) satellite.

In embodiments, provided is a device of a satellite for providing non-terrestrial network (NTN) access. The device may include memory including instructions, at least one processor, and at least one transceiver. The instructions may, when executed by the at least one processor, cause the device to: perform a communication between a first terminal and a second terminal via the satellite by transmitting data received from the first terminal to the second terminal or transmitting data received from the second terminal to the first terminal; based on detecting that the second terminal is located outside the coverage of a first cell of the satellite, identify a second cell for the second terminal; and transmit a configuration message including configuration information related to the communication via a network entity to a node providing the second cell.

For example, the instructions may, when executed by the at least one processor, cause the device to receive a request message from the network entity, and transmit a response message to the network entity. The request message may include identification information of the second terminal that is located outside the coverage of the first cell of the satellite and identification information of the second cell associated with the second terminal.

For example, the network entity may include an access and mobility management function (AMF) node. The network entity may be connected to the node providing the second cell via an NG interface. The network entity may be connected to the satellite via the NG interface.

For example, the instructions may, when executed by the at least one processor, cause the device to transmit a radio resource control (RRC) reconfiguration message for handover from the first cell to the second cell to the terminal.

For example, the configuration information related to the communication may include at least one of session information for communication between the first terminal and the second terminal, identification information of the first terminal, identification information of the second terminal, identification information of the first cell, or identification information of the second cell.

For example, the satellite group may include satellites configured to move along the same orbit as the first satellite's orbit. The configuration message may include a list of the satellites and information on a moving speed of each satellite.

For example, the instructions may, when executed by the at least one processor, cause the device to, based on detecting that the second terminal is located within the coverage of a first cell of the satellite, perform communication between a first terminal and a second terminal.

For example, the instructions may, when executed by the at least one processor, cause the device to receive a request message from the network entity, and transmit a response message to the network entity. The request message may identification information of the second terminal that is located within the coverage of the first cell of the satellite and identification information of the first cell associated with the second terminal.

The methods according to various embodiments described in the claims and/or specification of the disclosure may be implemented in hardware, software, or a combination of hardware and software.

In case of implementation as software, a computer-readable storage medium for storing one or more programs (software modules) may be provided. The one or more programs stored in the computer-readable storage medium are configured for execution by one or more processors in an electronic device. The one or more programs include instructions that cause the electronic device to execute the methods according to embodiments described in the claims or specifications of the disclosure.

Such a program (software module, software) may be stored in a random access memory, a non-volatile memory including a flash memory, a read only memory (ROM), an electrically erasable programmable read only memory (EEPROM), a magnetic disc storage device, a compact disc-ROM (CD-ROM), digital versatile discs (DVDs), other type of optical storage device, or a magnetic cassette. Alternatively, the program may be stored in a memory composed of a combination of some or all of those. In addition, a plurality of respective constituent memories may be included therein.

Further, the program may be stored in an attachable storage device that may be accessed through a communication network such as e.g., Internet, Intranet, local area network (LAN), wide area network (WAN), or storage area network (SAN), or a combination thereof. Such a storage device may be connected to a device performing an embodiment of the disclosure via an external port. In addition, a separate storage device on the communication network may also access a device performing an embodiment of the disclosure.

In the above-described specific embodiments of the disclosure, an element included in the disclosure is expressed in a singular or plural form depending on a presented specific embodiment. However, the singular form or plural form is selected to better suit its presented situation for the convenience of description, and the disclosure is not limited to that singular element or the plural element presented, and even a component expressed in plural may be configured in a singular form, or even a component expressed in singular may be configured in a plural form.

While the detailed description of the disclosure has been described with reference to specific embodiments thereof, it will be apparent that various changes and modifications may be made without departing form the scope of the disclosure.

What is claimed is:

1. A device of a first satellite for providing non-terrestrial network (NTN) access, comprising:
memory including instructions;
at least one processor; and
at least one transceiver,
wherein the instructions, when executed by the at least one processor, cause the device to:
perform a communication between a first terminal and a second terminal via the first satellite by transmitting data received from the first terminal to the second terminal or transmitting data received from the second terminal to the first terminal;
identify, within a satellite group associated with the first satellite, a second satellite different from the first satellite; and
transmit a configuration message including configuration information related to the communication to the second satellite through the at least one transceiver.

2. The device of claim 1,
wherein the satellite group includes satellites that have a same space area in a designated time interval, and
wherein the space area indicates, among division areas of a sphere surrounding a planet at an altitude of an orbit of a satellite, an area in which the satellite is located.

3. The device of claim 1,
wherein the satellite group includes satellites configured to move along an orbit same as the first satellite's orbit, and
wherein the satellites include the first satellite and the second satellite.

4. The device of claim 1,
wherein cells provided by the satellites in the satellite group are associated with a same tracking area (TA), and
wherein the satellites include the first satellite and the second satellite.

5. The device of claim 1,
wherein the configuration information related to the communication includes at least one of session information for the communication between the first terminal and the second terminal, identification information of the first terminal, identification information of the second terminal, or cell information.

6. The device of claim 1, wherein the instructions, when executed by the at least one processor, cause the device to:
receive a request message from an access and mobility management function (AMF) node via an NG interface;
transmit a response message to the AMF node via the NG interface; and
wherein the request message includes at least one of information on the satellite group to which the first satellite belongs, information on a validity period of the satellite group, identification information of a service area associated with the satellite group, or ephemeris information of a satellite in the satellite group.

7. The device of claim 1, wherein the instructions, when executed by the at least one processor, cause the device to:
receive a request message from a gNB-CU via an F1 interface;
transmit a response message to the gNB-CU via the F1 interface; and
wherein the request message includes at least one of information on the satellite group to which the first satellite belongs, information on a validity period of the satellite group, identification information of a service area associated with the satellite group, or ephemeris information of a satellite in the satellite group.

8. The device of claim 1,
wherein the instructions, when executed by the at least one processor, cause the device to receive a request message via an XN interface from a master satellite of the satellite group, and
wherein the request message includes at least one of information on the satellite group to which the first satellite belongs, information on a validity period of the satellite group, identification information of a service area associated with the satellite group, or ephemeris information of a satellite in the satellite group.

9. The device of claim 1,
wherein the satellite group includes satellites configured to move along an orbit same as the first satellite's orbit, and
wherein the configuration message includes a list of the satellites and information on a moving speed of each satellite.

10. The device of claim 1,
wherein the first satellite is a low earth orbit (LEO) satellite or a medium earth orbit (MEO) satellite, and
wherein the second satellite is a geostationary earth orbit (GEO) satellite.

11. A device of a satellite for providing non-terrestrial network (NTN) access, comprising:
memory including instructions;
at least one processor; and
at least one transceiver,
wherein the instructions, when executed by the at least one processor, cause the device to:
perform a communication between a first terminal and a second terminal via the satellite by transmitting data received from the first terminal to the second terminal or transmitting data received from the second terminal to the first terminal,
based on detecting that the second terminal is located outside the coverage of a first cell of the satellite, identify a second cell for the second terminal, and
transmit a configuration message including configuration information related to the communication via a network entity to a node providing the second cell.

12. The device of claim 11,
wherein the instructions, when executed by the at least one processor, cause the device to:
receive a request message from the network entity, and
transmit a response message to the network entity,
wherein the request message includes identification information of the second terminal that is located outside the coverage of the first cell of the satellite and identification information of the second cell associated with the second terminal.

13. The device of claim 11,
wherein the network entity includes an access and mobility management function (AMF) node;
wherein the network entity is connected to the node providing the second cell via an NG interface; and
wherein the network entity is connected to the satellite via the NG interface.

14. The device of claim 11, wherein the instructions, when executed by the at least one processor, cause the device to:
transmit a radio resource control (RRC) reconfiguration message for handover from the first cell to the second cell to the terminal.

15. The device of claim 11,
wherein the configuration information related to the communication includes at least one of session information for communication between the first terminal and the second terminal, identification information of the first terminal, identification information of the second terminal, identification information of the first cell, or identification information of the second cell.

16. The device of claim 11, wherein the instructions, when executed by the at least one processor, cause the device to:
receive a request message from the network entity, and
transmit a response message to the network entity, and
wherein the request message includes at least one of information on a satellite group to which the satellite belongs, information on a validity period of the satellite group, identification information of a service area associated with the satellite group, or ephemeris information of a satellite in the satellite group is included.

17. The device of claim 16,
wherein the satellite group includes satellites that have a same space area in a designated time interval, and
wherein the space area indicates, among division areas of a sphere surrounding a planet at an altitude of an orbit of a satellite, an area in which the satellite is located.

18. The device of claim 16,
wherein the satellite group includes satellites configured to move along an orbit same as the first satellite's orbit, and
wherein the request message includes a list of the satellites and information on a moving speed of each satellite.

19. The device of claim 11,
wherein the instructions, when executed by the at least one processor, cause the device to:
based on detecting that the second terminal is located within the coverage of the first cell of the satellite, perform communication between the first terminal and the second terminal via the satellite.

20. The device of claim 19, wherein the instructions, when executed by the at least one processor, cause the device to:
receive a request message from the network entity, and
transmit a response message to the network entity, and
wherein the request message includes identification information of the second terminal that is located within the coverage of the first cell of the satellite and identification information of the first cell associated with the second terminal.
